(19) United States
(12) Patent Application Publication
(10) Pub. No.: US 2016/0004236 A1
(43) Pub. Date: Jan. 7, 2016

(54) A CONTROL SYSTEM

(71) Applicant: Margot STUBBS, New South Wales (AU)

(72) Inventor: Margot Stubbs, Katoomba (AU)

(21) Appl. No.: 14/769,762

(22) PCT Filed: Feb. 25, 2014
(86) PCT No.: PCT/AU2014/000177

§ 371 Date: Aug. 21, 2015

(30) Foreign Application Priority Data
Feb. 25, 2013 (AU) 2013900631

(51) Int. Cl. G05B 15/02; G06N 5/04

(52) U.S. Cl. CPC G05B 15/02; G06N 5/045

(57) ABSTRACT

This invention concerns a control system that makes use of a computer user interface to control a process having a plurality of different stages of operation, in particular a multi-stage legal process. The system comprises a computer memory that stores a decision tree having a network of interconnected nodes, each of which represents a stage of the multi-stage process. The system further includes historical patterns of entries made by users and a plurality of different types of resource information for each stage of the multi-stage process. In use, each node requires an input to satisfy specified criterion, in response to which, one of the downstream nodes is automatically selected and the computer screen is updated. Input is made by a user either directly or automatically as determined by a selected historical pattern of entries.

### TECHNICAL FIELD

This invention concerns a control system that makes use of a computer-user interface to control a process having plural different stages of operation.

### BACKGROUND ART

Control systems are widely used to control processes, from washing machines to steel rolling mills. Some processes are fully automated using computers, whereas others require some human input. For instance, the control of each cycle of an internal combustion engine may be fully automated from fuel injection to the processing of the exhaust gases. However, more complex processes require human intervention, for instance large complex chemical processing plants or power stations have sophisticated control rooms where people oversee and regulate operations.

Any discussion of documents, acts, materials, devices, articles or the like which has been included in the present specification is not to be taken as an admission that any or all of these matters form part of the prior art base or were common general knowledge in the field relevant to the present invention as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### DISCLOSURE OF THE INVENTION

A control system for control of a multi-stage process, the system comprising:
A computer memory that stores:
   A decision tree having a network of plural interconnected nodes, each of which represents a stage of the multi-stage process being controlled.
   Historical patterns of entries made by users between first and second nodes in the network
   Plural different types of resource information for each stage of the multi stage process.
A computer input device to receive commands from a user:
   To select a node in the decision tree.
   To enter data into a selected node
A computer processor operable to interpret computer program code, resource information and user input.
A computer screen that, in use, displays a user interface to a user including
   At least part of the decision tree including the selected node and at least one generation of downstream nodes;
   And in another mode at least part of the decision tree including the selected node

Wherein in use:
Each node requires an input to satisfy a specified criterion.
In response to input into a selected node that satisfies a specified criterion, one of the downstream nodes is automatically selected and the computer screen is updated.
And input is made by a user either directly into the currently selected node, or automatically into a string of one or more successive nodes as determined by a selected historical pattern of entries.
Input into nodes includes input into linked resources such as a Data Window linked to the node

Such a control system permits a user to select any stage of the process, to check resource information relevant to that stage and to ensure correct data is entered for the corresponding node in the decision tree, so that the stage is properly before the next stage is begun.

The user interface may include a persistent menu identifying the plural different types of resource information.

The computer processor may operate to cause the resource information accessible via the persistent menu to automatically change, in a context aware manner, each time the user selects a different node in the decision tree.

The control system may include a navigation tool that allows backtracking to any earlier node of the decision tree.

The control system may include a search function to permit search of the nodes of the decision tree

The control system may further include a data entry port to receive updated resource information.

The control system may further include a data entry port to receive data relating to the stages of the process. Such data could be provided, for instance from sensors associated with corresponding stages of the process

The computer memory of the control system may store status information about one or more of the stages of the process; for instance ‘processing complete’ or ‘process incomplete’ status.

The computer memory of the control system may store user input provided at one or more nodes so that the same input is available for consideration or reuse at a later time.

Optional features of any aspect of the invention described here are also optional features of the other aspects of the invention described here.

### BRIEF DESCRIPTION OF THE DRAWINGS

Examples of the invention will now be described with reference to the accompanying drawings, in which:

FIG. 1 illustrates a computer system for control of a multi-stage process.

FIG. 2 illustrates a method for controlling a multi-stage process as performed by processor.

FIG. 3 illustrates a decision tree.

FIG. 4 illustrate a user interface.

FIG. 5 illustrates a user interface after selecting a Topic Node.

FIG. 6 illustrates a user interface resulting from selecting a primary node.

FIG. 7 illustrates a user interface after the decision maker then selects the sub node topic.

FIG. 8 illustrates a data matrix.

FIG. 9 illustrates a user interface where the Decision Maker selects a node in the decision tree.

FIG. 10 illustrates another user interface.

FIG. 11 illustrates yet another user interface including a generated Data Window.

FIG. 12 illustrates yet another user interface representing a next step.

FIG. 13 illustrates another user interface 1300 where the decision maker selects the primary node topic.

FIGS. 14-202 illustrates user interfaces illustrating the control systems for the multi-stage processes embodies within the invention. A revised version of the invention has been prepared using the tools available in FilemakerPro

### BEST MODES OF THE INVENTION

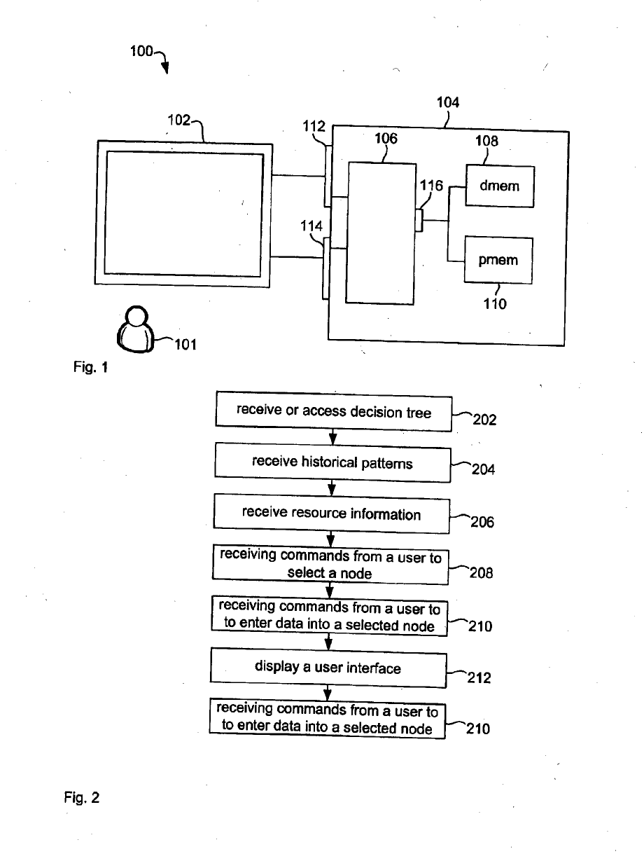

FIG. 1 illustrates a computer system 100 for control of a multi-stage process for a user 101. The computer system 100 comprises a display device 102 and a computer 104 including a processor 106, a data memory 108 and a program memory 110. The display device 102 is connected to the processor 106 of computer 104 via input port 112 and output port 114 of computer 104 and the processor 106 is connected to data memory 108 and program memory 110 via memory port 116. In use, the processor 106 creates a user interface and sends the user interface to display device 102 via output port 114.

Therefore, processor 106 executes software stored on program memory 110 that causes the processor 106 to perform the method of FIG. 2. The sending of the user interface may be as pixel values, such as a png image attached to an email, as display commands, such as Direct X, as vector graphics, or as a website using Flash and/or HTML. Processor 106 may also send the user interface to the data memory 108 to be stored for later use.

In this example, the data memory 108 and program memory 110 are both non-volatile hard disk memory, but of course, other memories may be used, such as RAM, on chip cache, optical disks or flash memory. In some examples, the computer system is implemented in a cloud computing environment. In such examples, a number of processors may be deployed as virtual machines to create the calendar display and the data memory 108 as well as the program memory 110 are implemented as cloud storage. In such examples, the display device 102 may be on a mobile device that is connected to the cloud via the Internet.

Computer system 100 may also be a desktop, laptop, netbook or other stand-alone computer with or without Internet connection and with or without using cloud services.

In this example, display 102 is a touch screen display, such as the display of a tablet computer. As a result, the display 102 is used by the user as an input device and the processor 106 receives the input, updated resource information or data relating to stages of the process via input port 112 from the input device 102.

The data memory 108 stores a decision tree, and the processor 106 queries the data memory 108 in order to create the user interface. As a result, the processor 106 receives data from the data memory 108 via memory port 116. The memory 108 stores status information about one or more of the stages of the process and user input provided at one or more nodes so that the same input is available for consideration or reuse at a later time.

Although input port 112, output port 114 and memory port 116 are shown as distinct entities, it is to be understood that any kind of data port may be used to receive and send data, such as a network connection, a memory interface, a pin of the chip package of processor 106, or logical ports, such as IP sockets or parameters of functions stored on program memory 110 and executed by processor 106. These parameters may be handled by-value or by-reference in the source code. The processor 106 may receive data through all these interfaces, which includes memory access of volatile memory, such as cache or RAM, or non-volatile memory, such as an optical disk drive, hard disk drive, storage server or cloud storage.

FIG. 2 illustrates a method 200 for controlling a multi-stage process as performed by processor 106. Processor 106 commences performing method 200 by receiving or accessing 202 a decision tree.

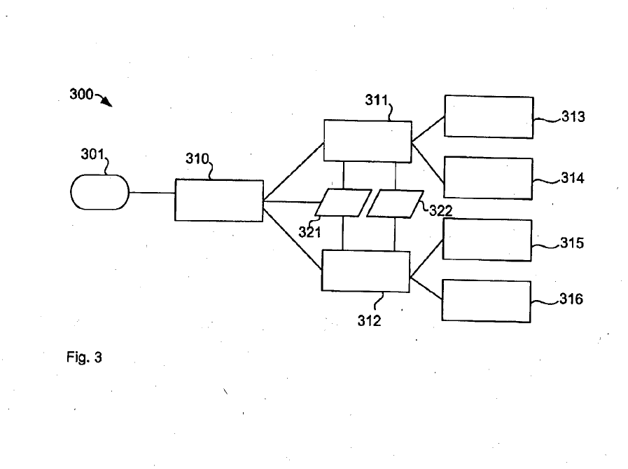

FIG. 3 illustrates a decision tree 300 having a start 301, a network of interconnected nodes 310 to 312 and terminals 313 to 316. Each node 310 to 312 represents a stage of the multi-stage process. The decision tree 300 is physically stored on data memory 108 in a suitable data format, such as at a linked list or an MySQL database where each node of the tree 300 is one record in the database and each record also stores a predecessor of each node.

In one example, computer system 100 is used by a judicial officer as a tool to facilitate access to information required for decision making. The computer system 100 provides access to the data the judicial officer needs within the decision chain relevant to the resolution of that particular problem. The judicial officer does not have to extract the data from the law reports, on line services, legislation databases, textbooks or loose leaf services, nor will they have to organise and marshal that data as appropriate to the resolution of the issue or problem before them. That task will be performed by and within the system 100.

The computer system 100 also provides guidance in that it will make available to a Magistrate historical patterns, such as the decision chain of a high level expert in respect of the legal issue or problem. In this way, the high level expert, such as a professor of law, makes entries between two nodes in the network of the decision tree 300.

The computer system 100 will not bind or remove judicial discretion, or undercut the independence of the judicial function. What it will do is provide a structure which will make readily accessible all data relevant to the resolution of the legal problem, and provide the assistance (if the judicial officer wishes to avail themselves of it) of the decision chain a high-level expert in relation to that problem would apply to all its resolution.

The computer system 100 provides a structured but flexible decision matrix which provides the decision maker with access to relevant data around the decision chain required to resolve the problem.

The organisation and complexity of the decision criteria, and the access the decision maker has to relevant and current data at each stage of the decision chain, determines the quality of the decision generated.

The computer system 100 allows an (infinitely) multidimensional decision matrix which integrates the decision steps to be taken with current data.

The next step of method 200 is receiving 204 historical patterns of entries made by users between first and second nodes in the network. The historical patterns may be court decision that constitute applicable common law. The processor 106 may receive the historical patterns by accessing a data matrix that stores the historical patterns on data store 108.

Then, the processor 106 performing method 200 receives 206 plural different types of resource information for each stage of the multi stage process. In one example, the resource information includes court decisions, statutes and other legal texts. The resource information may also be a link to a manual or technical specification of a particular machine.

In one example, the computer system 100 may be referred to as a Neural Net Decision System (NNDS). A Data Matrix is at the core of the Neural Net Decision System.

The provided Figures provide worked examples the operation of the NNDS in Data Matrix Mode.

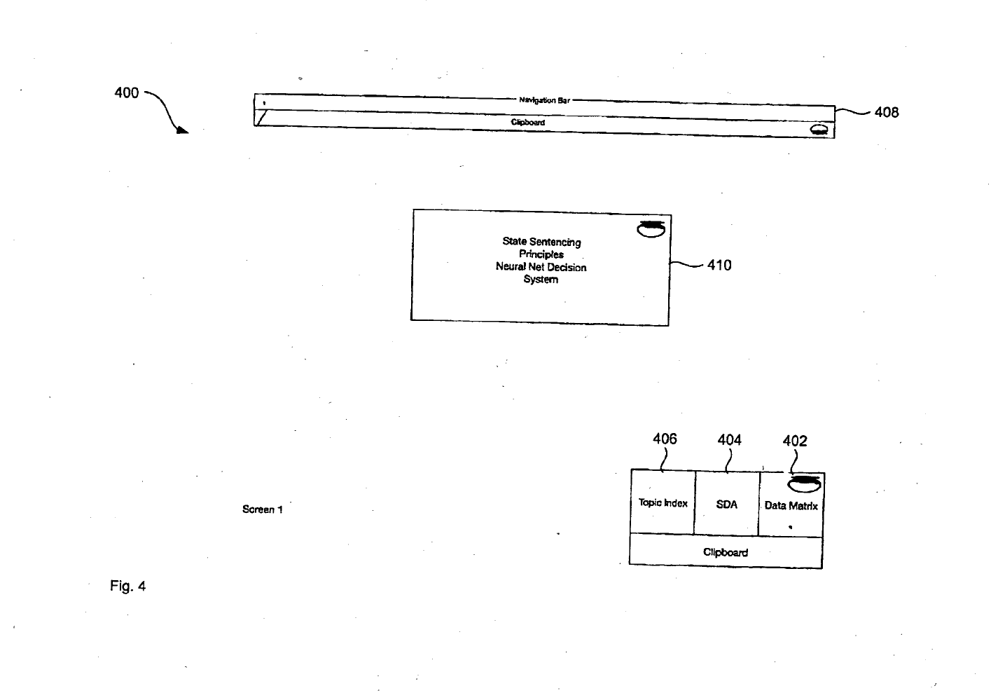

FIG. 4 illustrates a visual display 400 of the NNDS comprising a persistent menu identifying the plural different types of resource information, such as the Data Matrix 402, Structured Decision Assistance (SDA) 404, Topic Index Windows 406 and the Navigation Bar 408. The Navigation Bar 408 provides regions that the decision maker can activate in order to backtrack to earlier nodes of the decision tree. When the programme is activated and opened, the first dimension 400 of the display opens. The Decision Maker selects the Data Matrix mode 402.

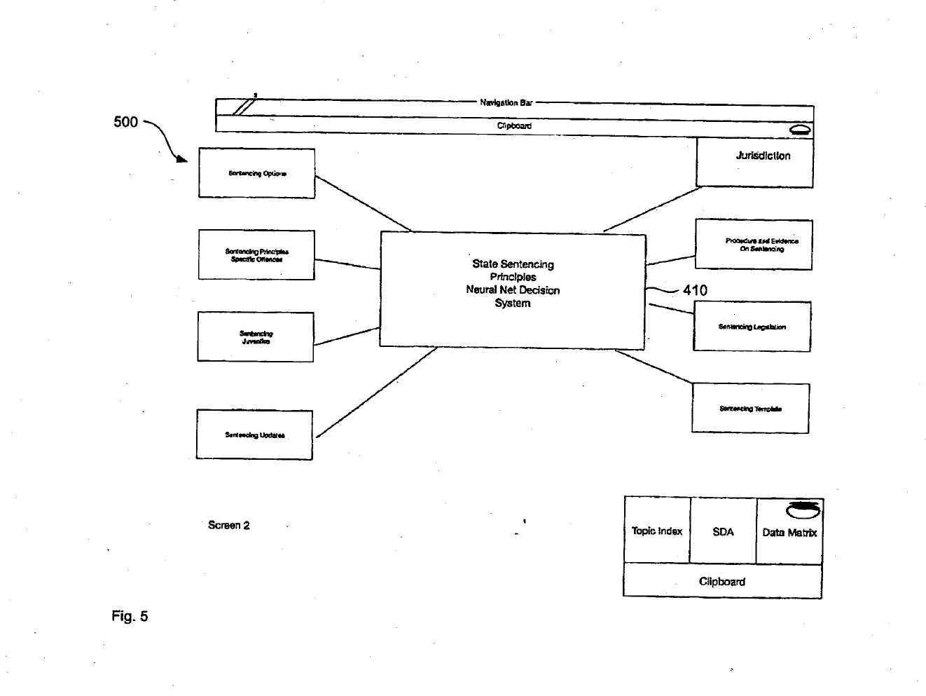

FIG. 5 illustrates a visual display 500 after selecting a Topic Node 410 for the Sentencing Neural Net. This selection takes the Decision Maker to the next dimension the key subject areas that arise in respect of the topic “Sentencing Law in New South Wales”. Each Node (whether Topic, Primary, Secondary, or Sub-Node) may have links to other Nodes in the NNDS.

By way of example, the decision maker may have an issue before them in relation to procedure and evidence on sentence. Selecting that primary node in the NNDS will open a sub-node which will have the sub topics relevant to that primary Node topic.

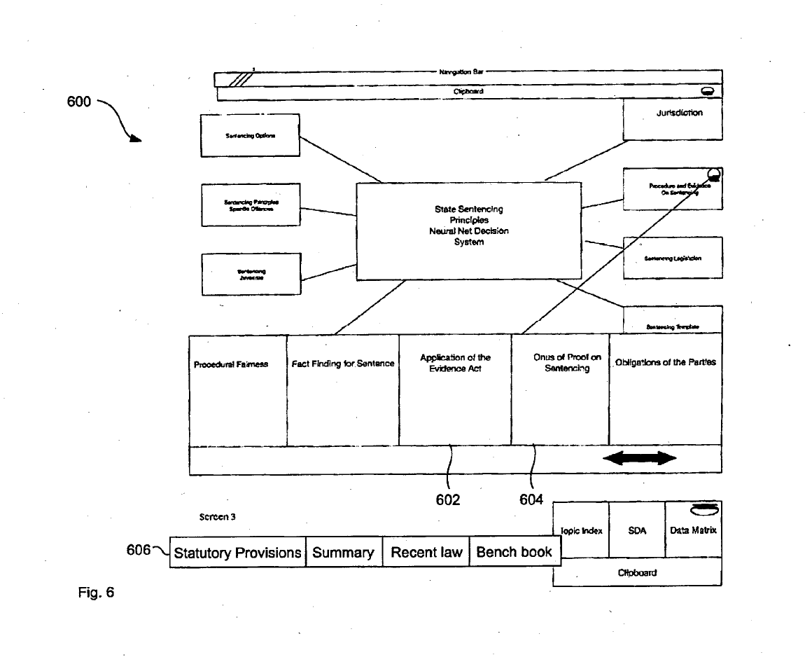

FIG. 6 illustrates the resulting user interface 600. The sub-node as a directional arrow allowing the decision maker to scroll through the topics in the sub-node. The topics in the sub-node are not restricted, accordingly, by the size or space of the visual display on the computer screen.

In one example, the user interface 600 comprises a further persistent menu 606 identifying the plural different types of resource information. When the decision maker selects node 602, the persistent menu 606 provides a set of options that is specific to node 602. The set of options are different types of resource information, such as “Statutory Provisions”, “Summary”, “Recent law” and “Bench book. This set of options may not be applicable when the decision maker selects a different node, such as node 604 and the set changes. This way the resource information accessible via the persistent menu changes automatically in a context aware manner each time the user selects a different node in the decision tree.

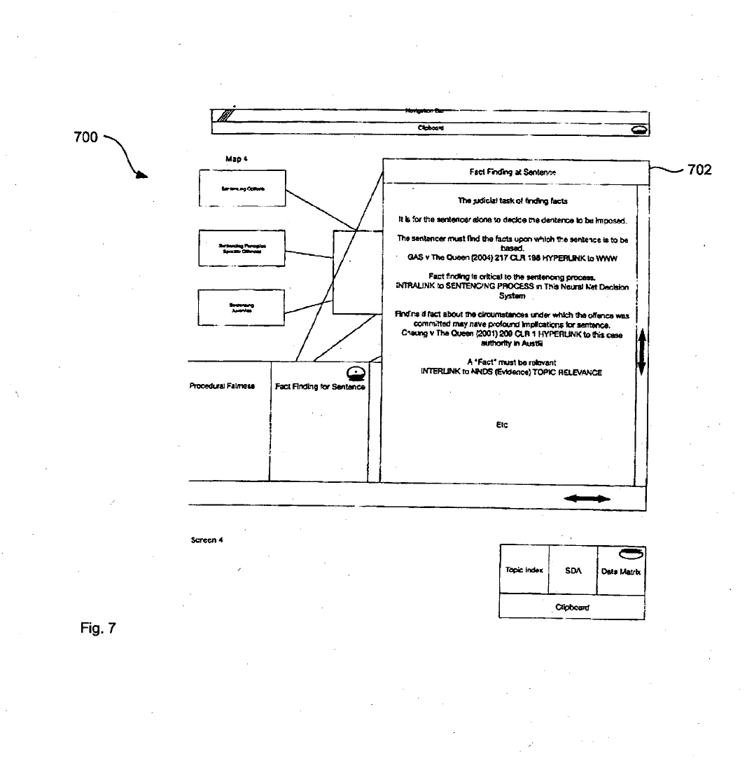

FIG. 7 illustrates a user interface 700 after the decision maker then selects the sub node topic relevant to the legal issue or problem. Selecting that sub node topic opens its associated data window. The sub-node topic selected by the decision maker in the illustrated example is “Fact Finding at Sentence”. The “Fact Finding at Sentence” data window opens.

The Data Window 700 has a Header 702 which has the same topic as it is related sub node topic. The Data Window may contain plural different types of resource information:

(1) Intralinks—between specific content in the Data Window to other pages and nodes within that neural net decision system (in this case, NNDS Sentencing);

(2) Interlinks—between specific content in the Data Window and specific nodes in linked Neural Net Decision Systems (ie NNDS (Evidence NSW)), to data files on the host computer or networked computer systems, and

(3) Hyperlinks—between specific content in the Data Window and to sites on the World Wide Web.

Selecting the Intralink associated with “Fact Finding is Central to the Sentencing Process” will take the Decision Maker to the topic “Sentencing Process” within the NNDS Sentencing; and Selecting the Interlink to “A Fact Must Be Relevant” in the NNDS Sentencing exemplar will take the Decision Maker out of the NNDS (Sentencing) to a related Node in a linked NNDS—for example, an NNDS (Evidence)

Selecting the hyperlink to the case authority Gas v The Queen (2004) or the hyperlink to Cheung v The Queen (2001) will take the Decision Maker directly to a related site on the World Wide Web (ie for example, Austlii). After the decision maker has appraised themselves all the information they require from the “Fact Finding at Sentence” Data Window, the decision maker will close that window 700 and the visual display returns to the Sub-Node topics relevant to Procedure and Evidence on Sentence.

The number of topics on new screens is the measure of the “depth” of the system. It may be represented by a nodal index, N(x), where X is a measure of the number of topics on new pages within the NNDS. An NNDS has an infinite plasticity or depth, which will be determined by the volume of data contained within the NNDS system and the extent of the interrelationships between the nodes.

The following description explains the Structured Decision Assistance (SDA), which is a meta-function of the NNDS. SDA mode provides a replication of historical patterns, that is, the steps in the decision chain taken by a high-level expert in the resolution of a problem by way of a structured paradigms of questions linked to data embedded in the Data Matrix.

Structured Decision Assistance functions is an overlay to the Data Matrix. The system 100 takes the decision maker through the data embedded in the Data Matrix through a series of questions. Each question requires an answer as an input from the decision maker. The system 100 provides a very high level of support for a decision maker in relation to the criteria to be applied to those specific steps necessary to comprehensively work their way through a problem contained in or what the subject of a particular Neural Net Decision System. This means that the answers from the decision maker needs to satisfy the specified criterion.

The responses provided by the decision maker to the criteria and questions within the Structured Decision Assistance mode will take the decision maker to different Nodal routes though the Data Matrix. This means that the system 100 responds to the input into the selected node by selecting one of the downstream nodes and the computer screen 102 is updated.

The purpose of Structured Decision Assistance is to allow a decision maker to be guided through the Data Matrix by the responses to a series of questions designed by a high-level expert in respect of the topic of the specific NNDS.

By way of illustration, in relation to the NNDS Sentencing example, the SDA may be designed by a Supreme Court judge, who has 30 years experience and an established jurisprudential reputation. This way, the historical patterns stored in the SDA between two nodes in the network are made by the Supreme Court judge. The SDA may of course be collaboratively designed. There may well be a court specific Neural Net system on a particular topic, and specific decision criteria may also be generated by collaborative work with, for example, academics in this subject area.

The experience, knowledge and expertise that this senior or judicial officer offers in respect of the approach to sentencing may be made available in SDA mode in the NNDS Sentencing to any person, whether Judge, practising lawyer, Law student or lay person who has access to this NNDS system.

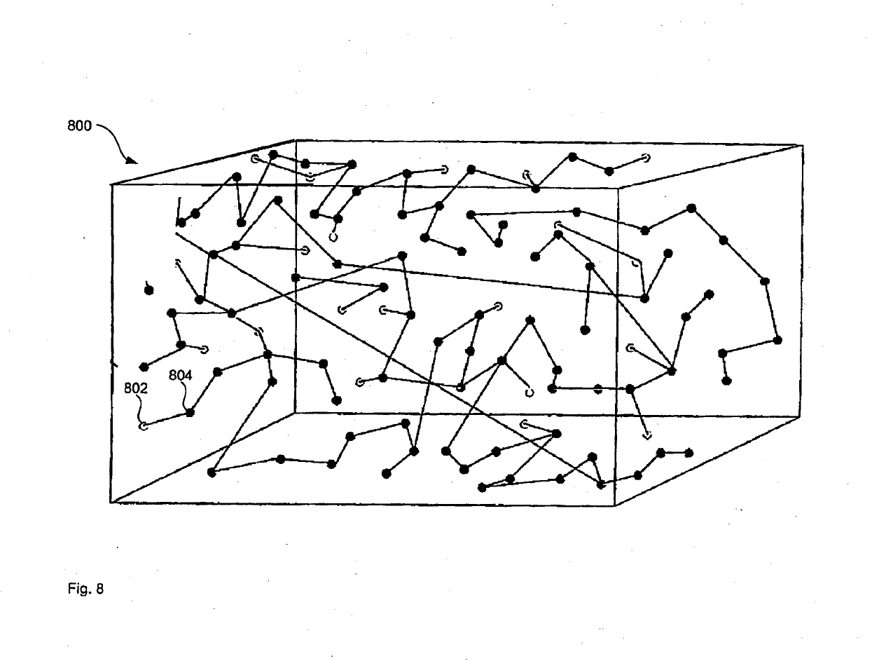

FIG. 8 illustrates a data matrix 800, where white dots, such as white dot 802, represent a link within the NNDS from within a Data Window. That link may be a link to another Node, another Data Window, or to an external side (a data file on a computer or computer network or a site on the WWW). Black dots, such as black dot 804, represent a Node in the Decision System. The Nodes embed data within the Data Matrix. Each Node (including Tooic Nodes, Primary Nodes, Secondary Nodes, and Sub-Nodes) with their related Data Windows may be linked to other Nodes (within this NNDS or a linked NNDS) or to external links (to data files on the Decision Makers computer or computer network) or to sites on the WWW.

Each Node represents a different topic. The Topic Index contains a link to each Node within the NNDS. By selecting a topic from the Tooic Index, the user may be taken directly to that Node in the Data Matrix and that page will open within the NNDS.

Referring back to FIG. 2, the next step of method 200 is to receive 208 commands from a user, such as the decision maker, to select a node in the decision tree.

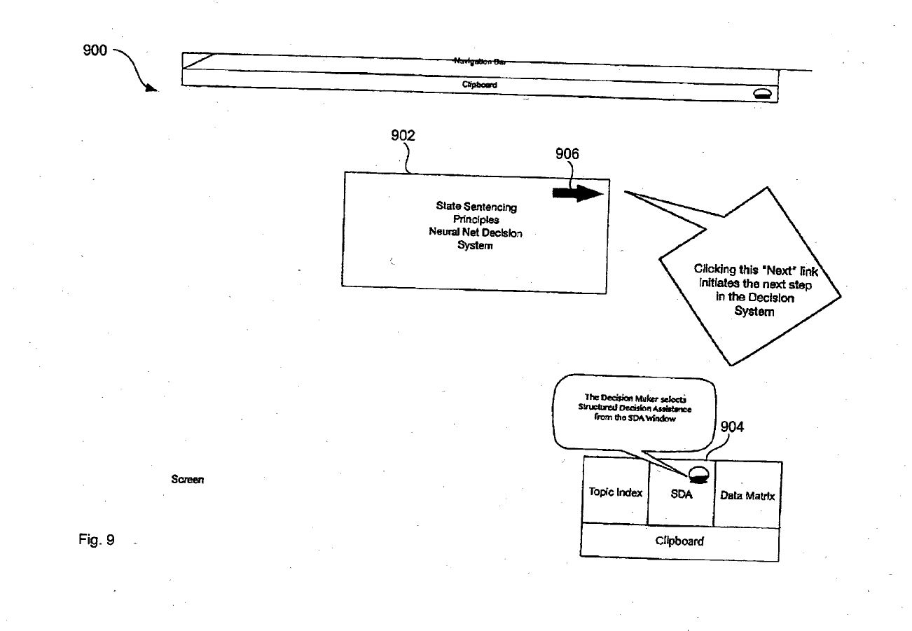

FIG. 9 illustrates a user interface where the Decision Maker selects a node in the decision tree by opening the NNDS Sentencing, and the first window opens showing the Topic Node, “state sentencing principles, neural net decision system” 902. The decision maker selects the SDA node 904 from the SDA Window.

Sentencing is typically commenced by reference to the identification of the charge and the maximum penalty which is open to the court to impose.

The first step in the NNDS Sentencing SDA, accordingly, is generated when the “Next” button 906 or link activates the next step in the sentencing decision chain, that being the identification of the specific maximum penalty applicable in relation to the offence for which the offender is before the court or sentence.

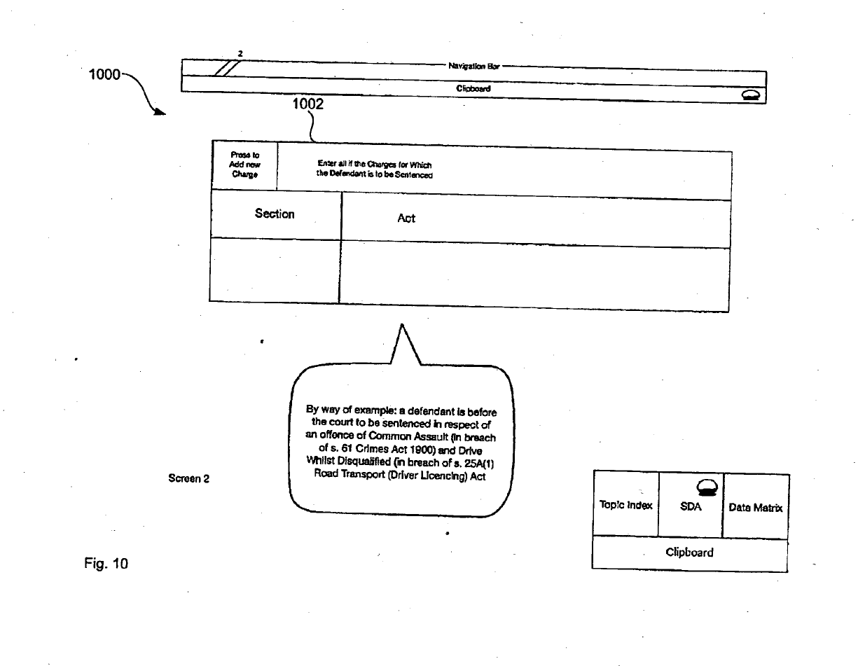

FIG. 10 illustrates another user interface 1000 as an NNDS SDA Screen that opens a window 1002 allowing for the entry of the specific section and the specific Act for which the offender is before the court for sentence.

Referring back to FIG. 2, the next step of method 200 is to receive 210 commands from a user, such as the decision maker, to enter data into a selected node.

The decision maker enters data into the selected node by entering the section and the Act. For example, an offender is before the court for sentence (inter alia) in relation to a charge of common assault in breach of s. 61 Crimes Act 1900 (NSW). That data is entered and a button indicated in the display is selected.

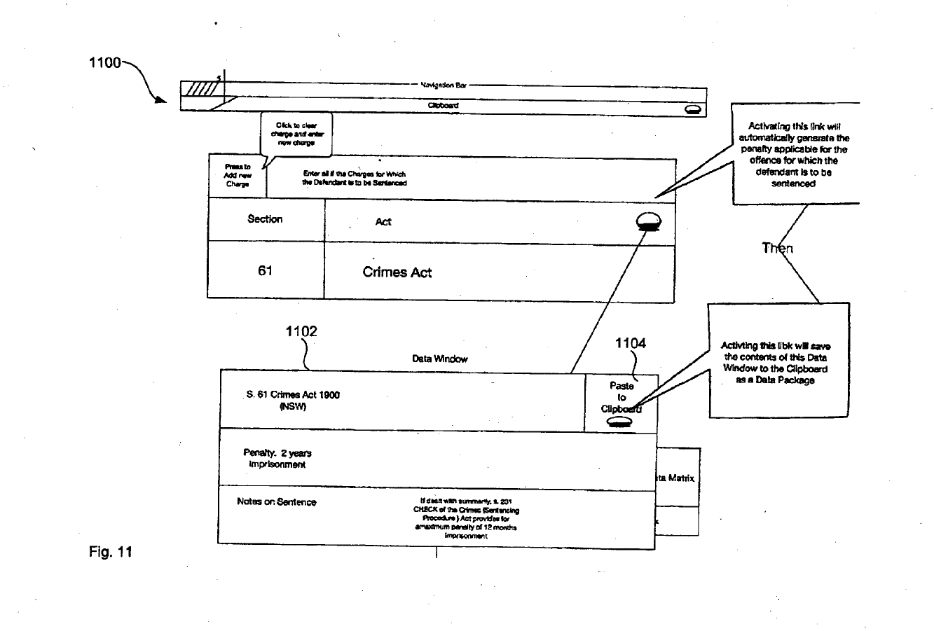

FIG. 11 illustrates another user interface 1100 including a generated Data Window 1102 which will identify the section and the Act, the applicable maximum penalty open to the court, and any specific notes applicable to that statutory offence that the decision made should be aware of all the required to take into account in relation to the penalty.

The button, “paste to clipboard” 1104, in NNDS SDA Screen 1100, will save that Data as a Data Package to the Clipboard.

The Decision Maker may repeat this process for every offence for which the offender is before the court for sentence. An offender is of course commonly before the court to be sentenced for more than one appendix.

Accordingly, before the decision maker progresses to the next step in SDA mode, the statutory provision the subject all the charge, the penalty applicable, and any specific notes on the applicable offence, are saved as Data Packages to the Clipboard.

This shows how in response to input into a selected node that satisfies a specified criterion, one of the downstream nodes is automatically selected and the computer screen is updated.

Apart from entering directly into the currently selected node, a user may also select a historical pattern of entries. As a result, the input is made automatically into a string of successive nodes as determined by the selected historical pattern of entries.

The Decision Maker then proceeds to the next step in the SDA by activating a “Next” link (not shown) in SDA mode. Activating the “Next” link will take the decision maker to the next step in the decision chain.

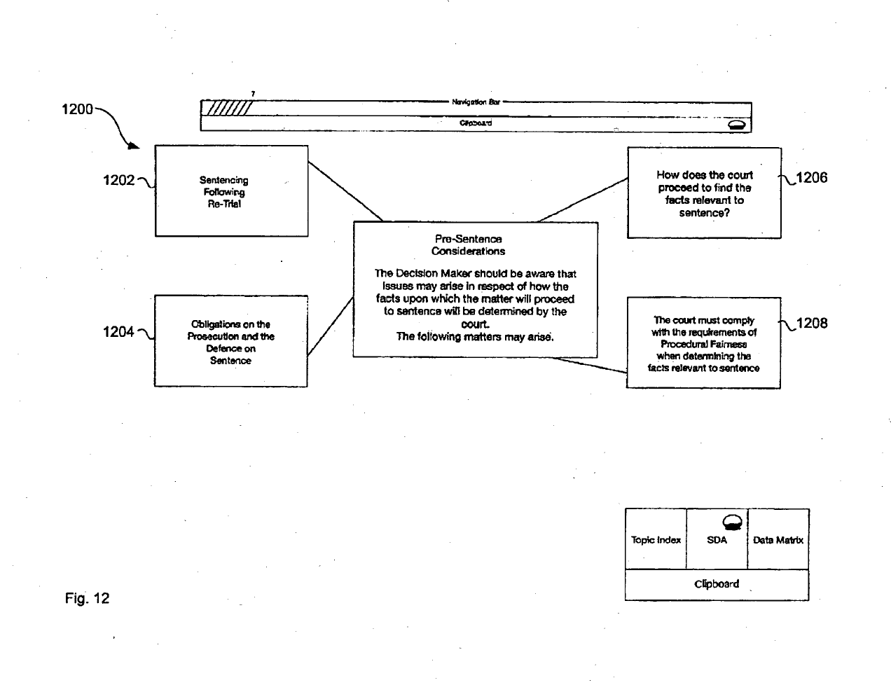

FIG. 12 illustrates another user interface 1200 representing that next step. That screen 1200 draws the decision-makers attention to the fact that in any sentencing exercise, there are 4 areas 1202, 1204, 1206 and 1208 that may require the decision maker to consider prior to embarking upon the sentencing exercise. The SDA draws the decision makers attention to each of these matters.

By way of illustration, a decision maker may not be aware how a court should appropriately proceed to find the facts relevant to sentence. The decision maker may not be aware of what legal principles and procedures should guide the judicial officer in the important function of deciding what facts are to constitute the basis upon which the court will proceeded to determine sentence, if there is a dispute between the prosecution and the defence in respect of those facts.

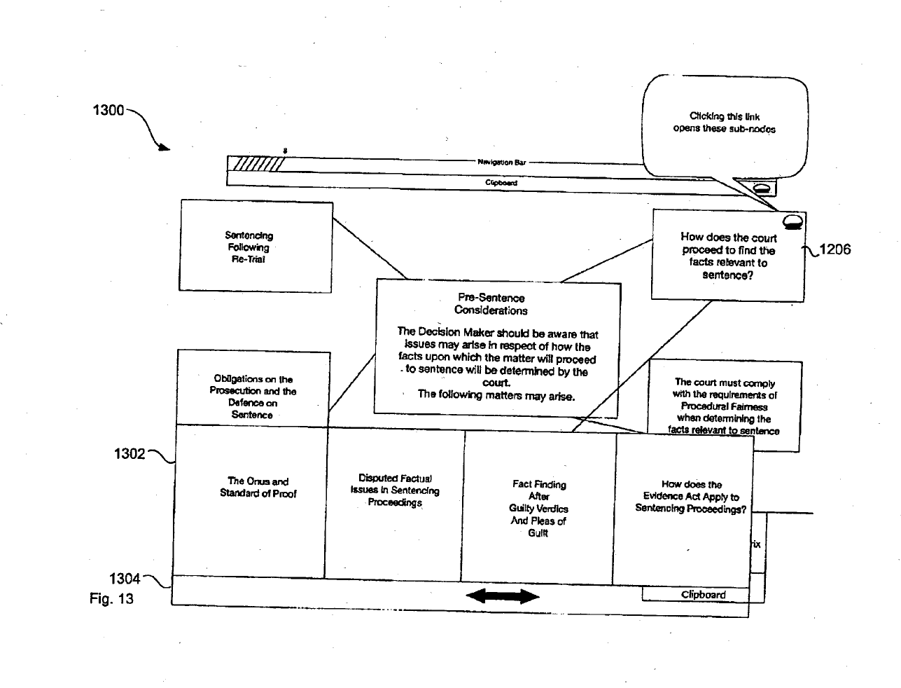

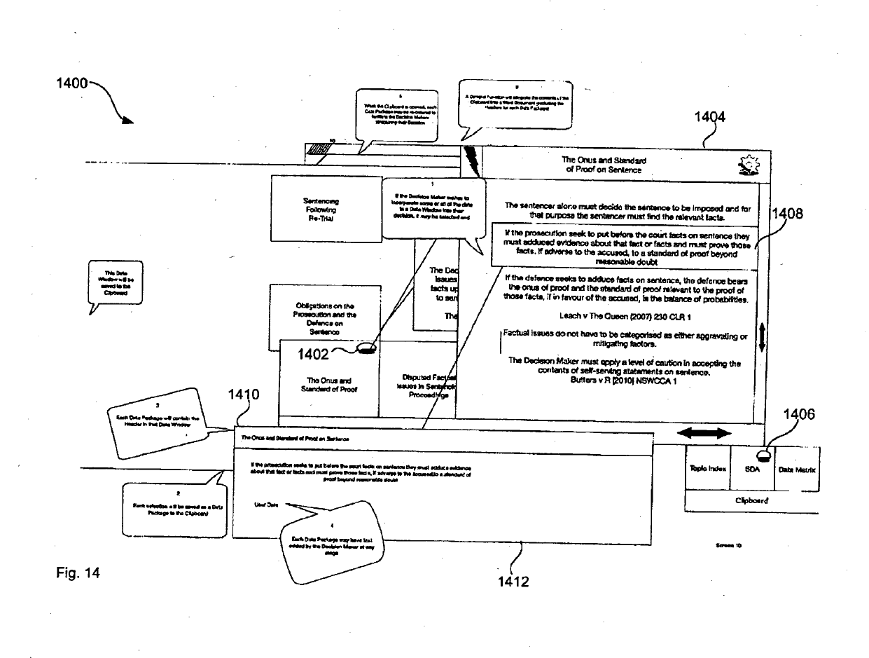

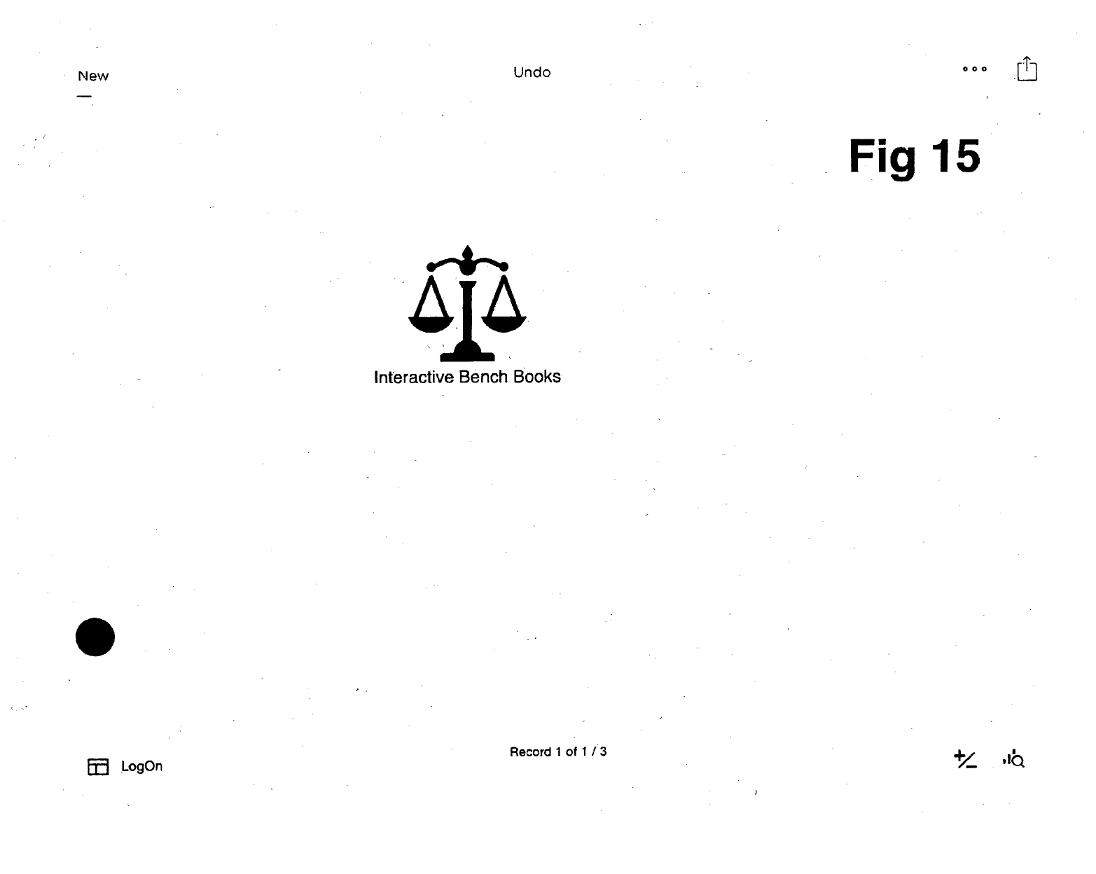

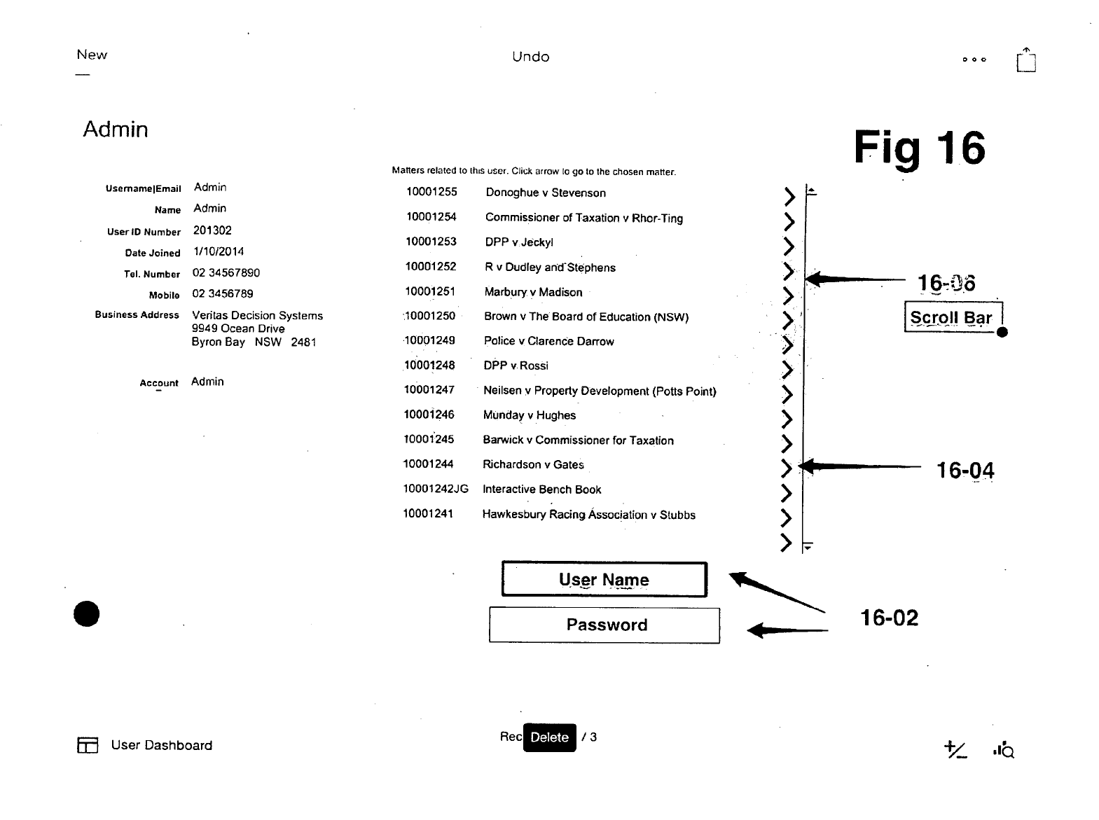

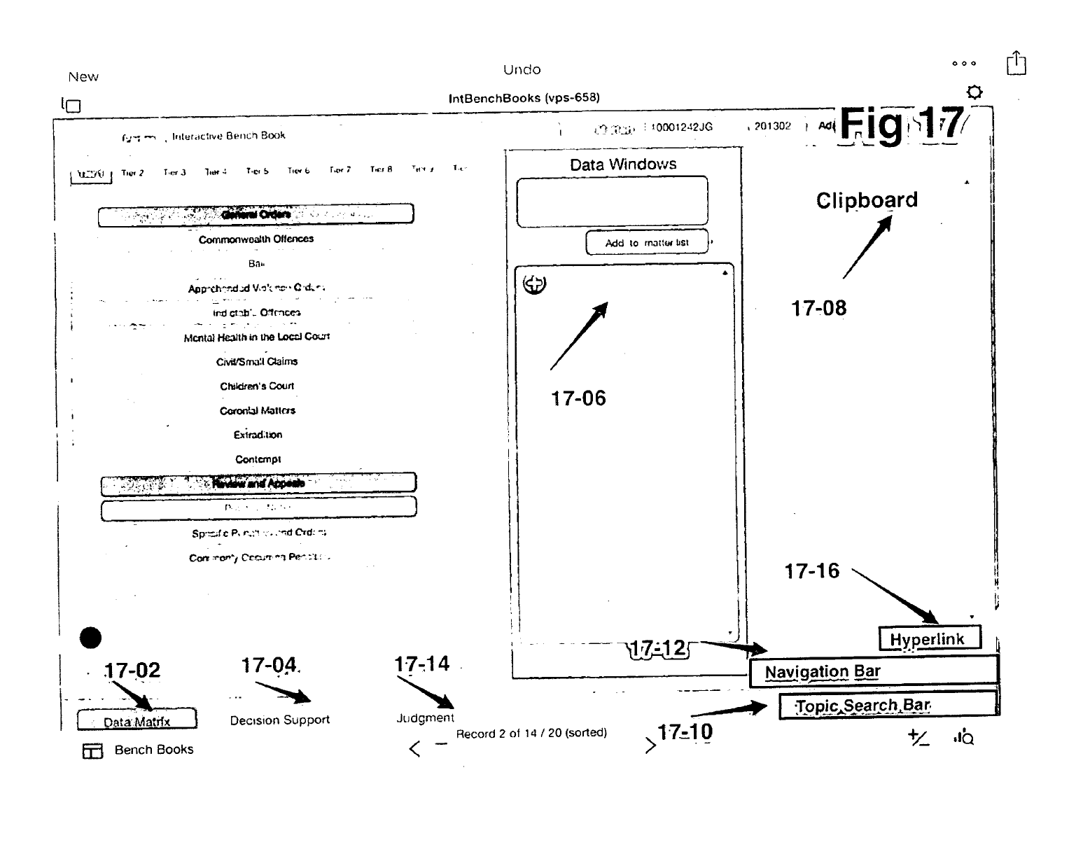

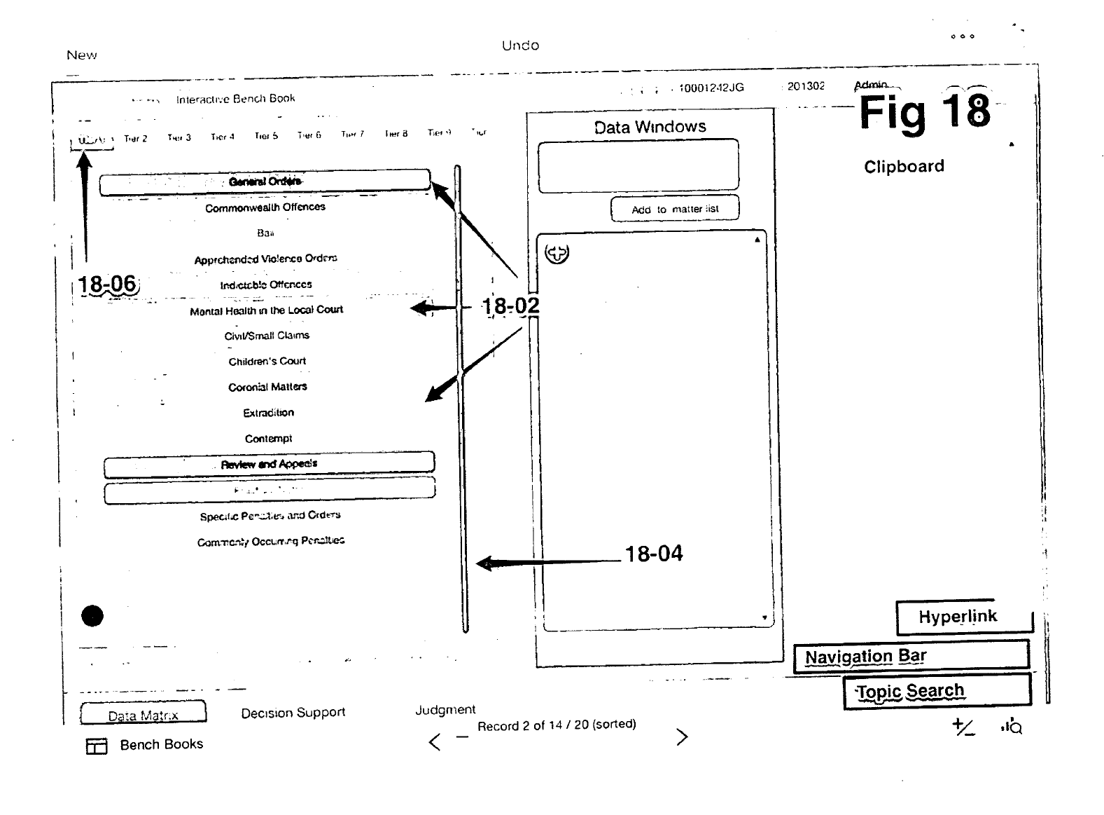

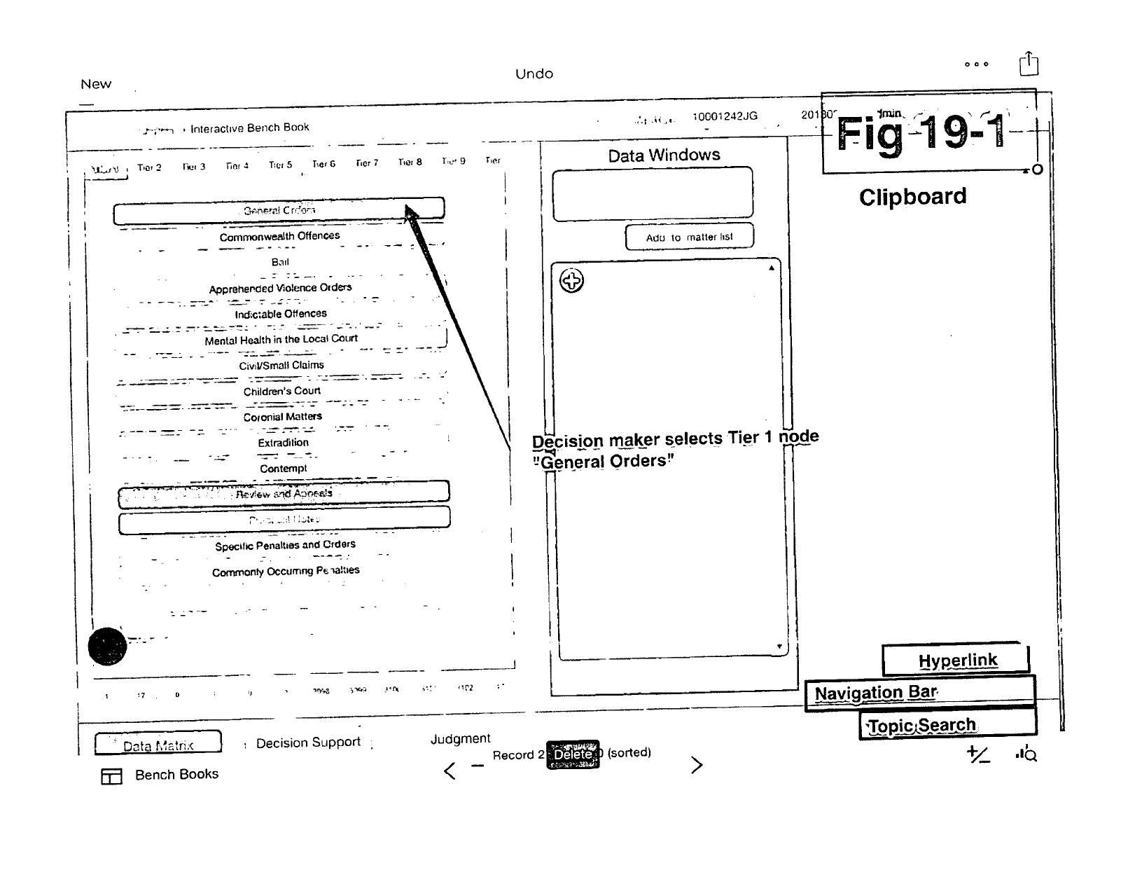

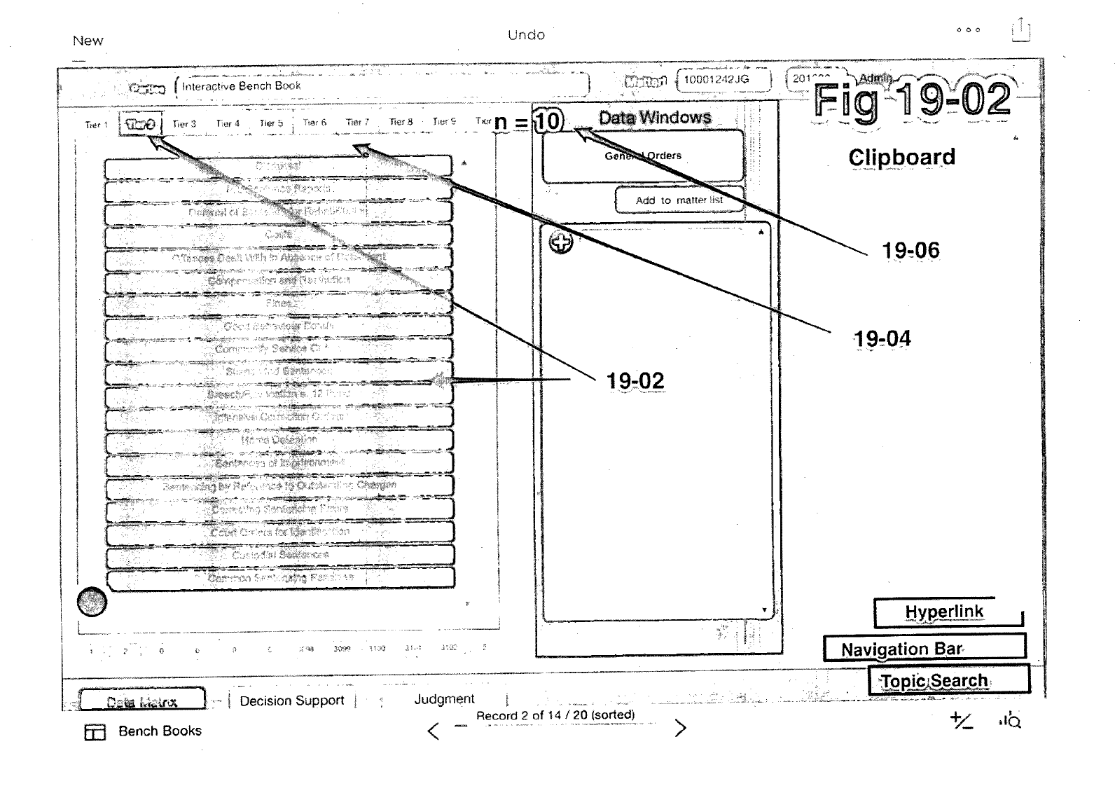

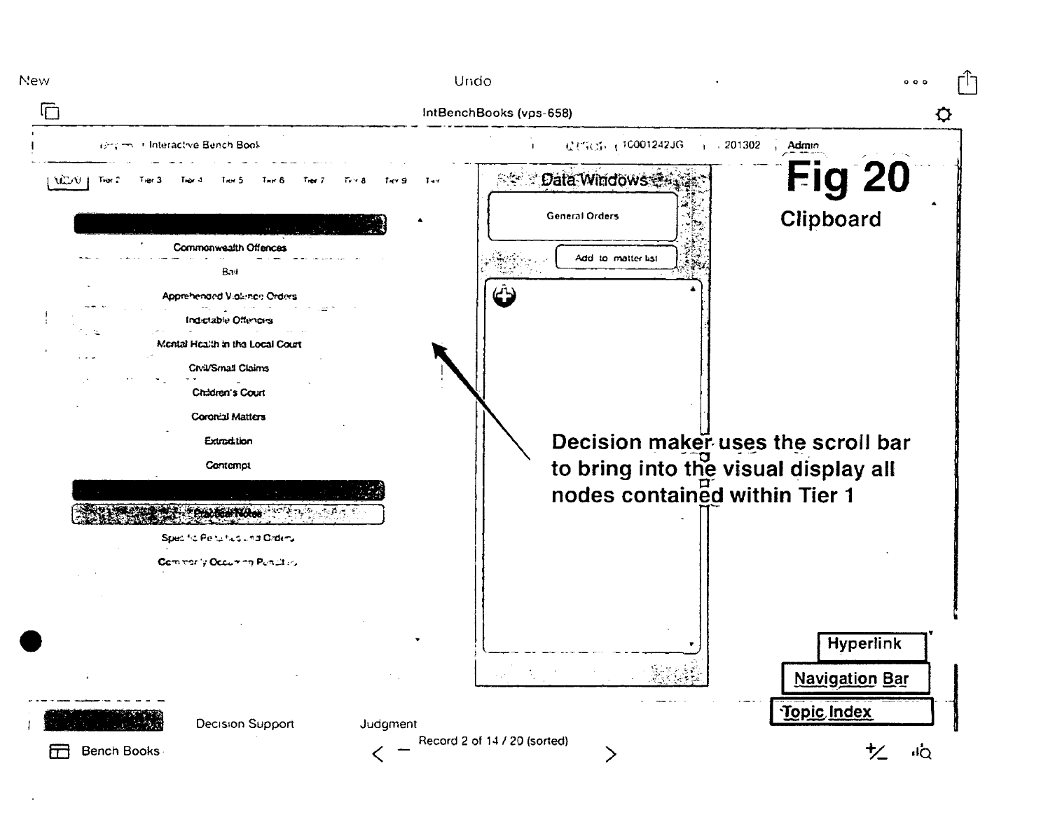

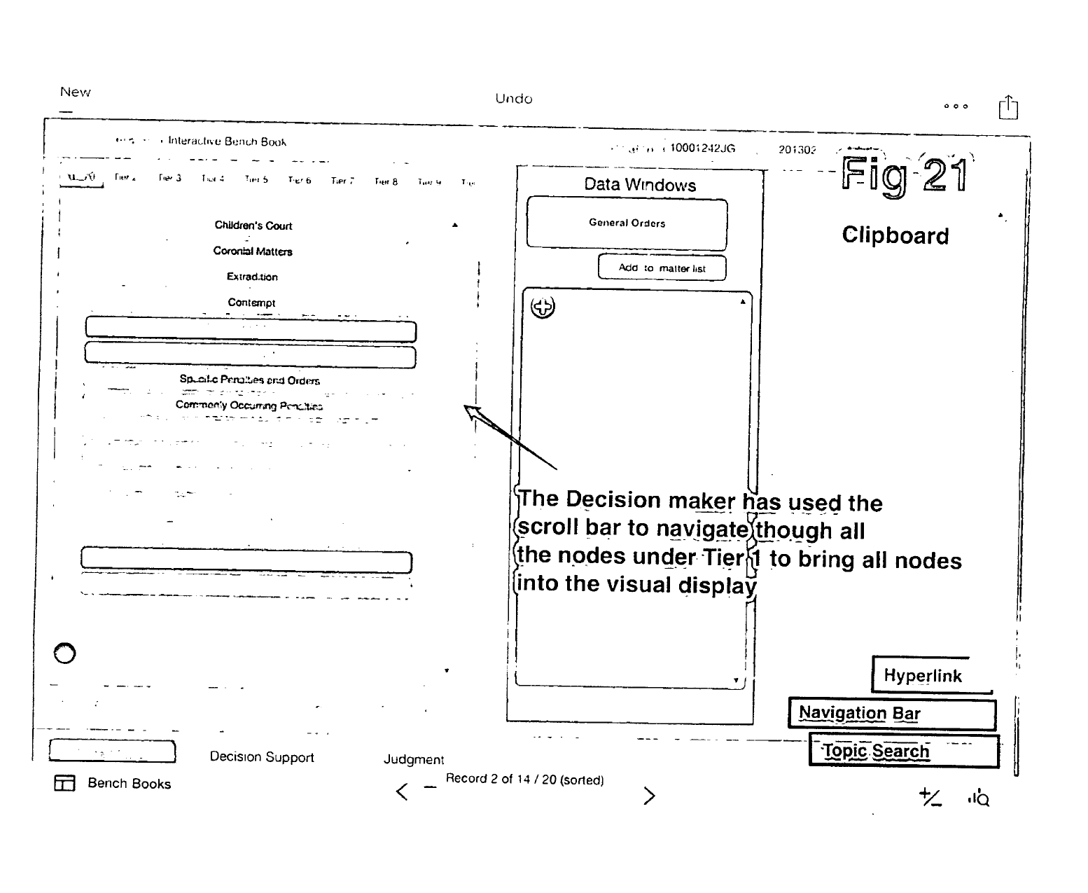

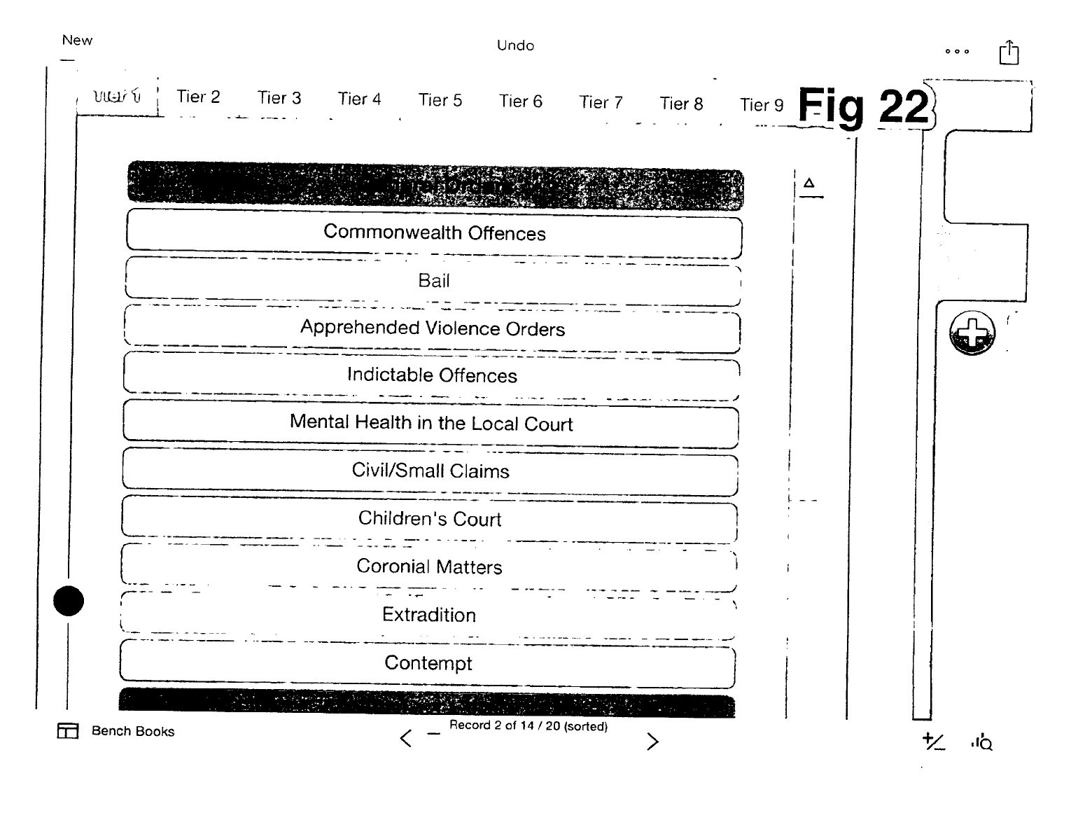

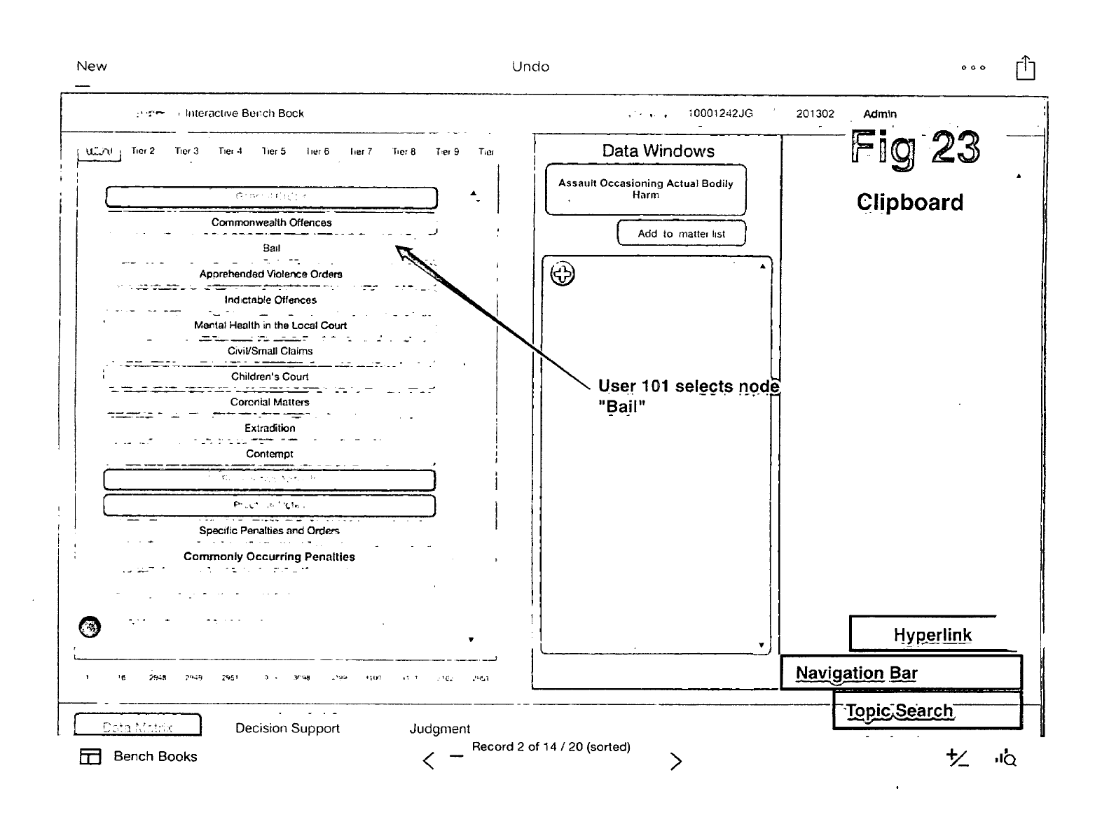

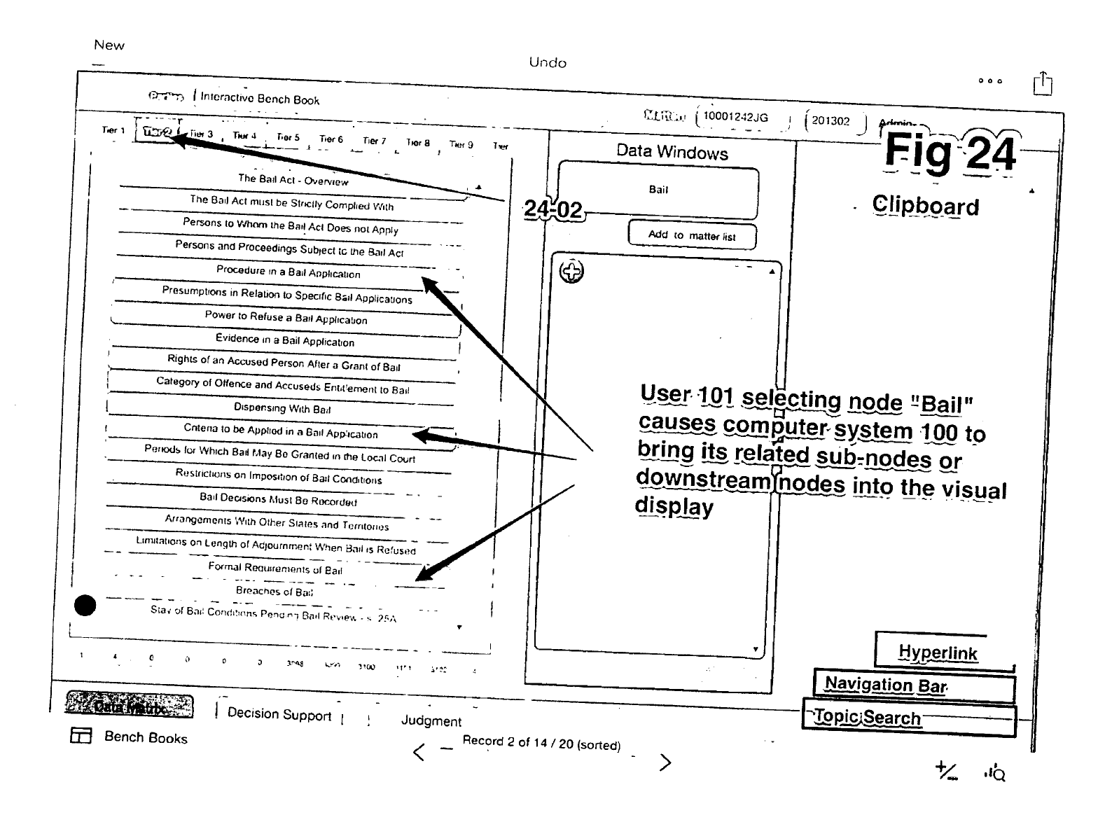

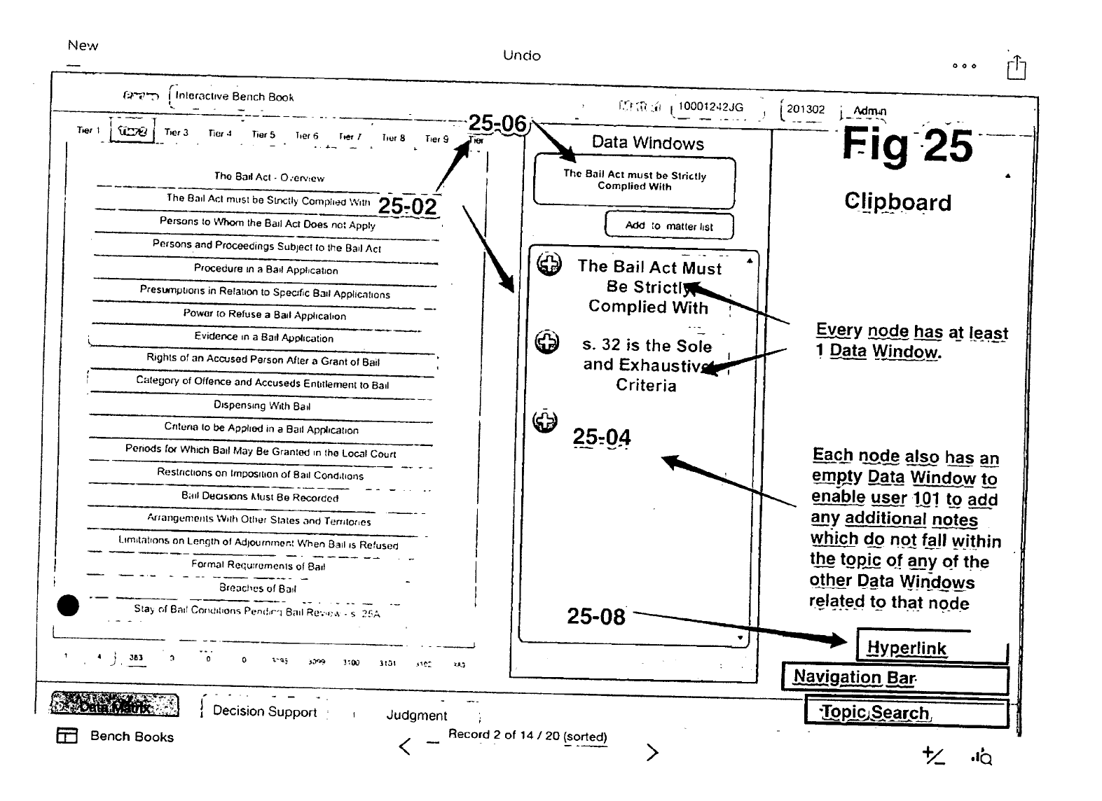

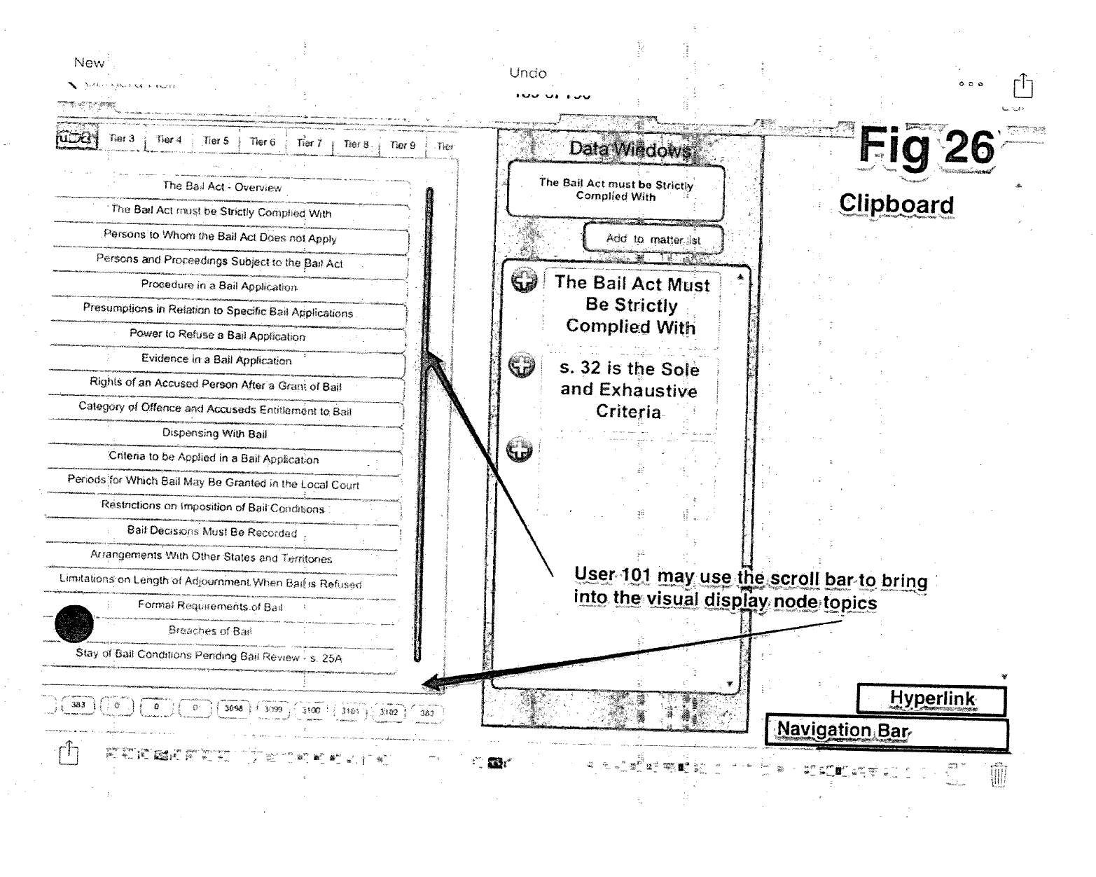

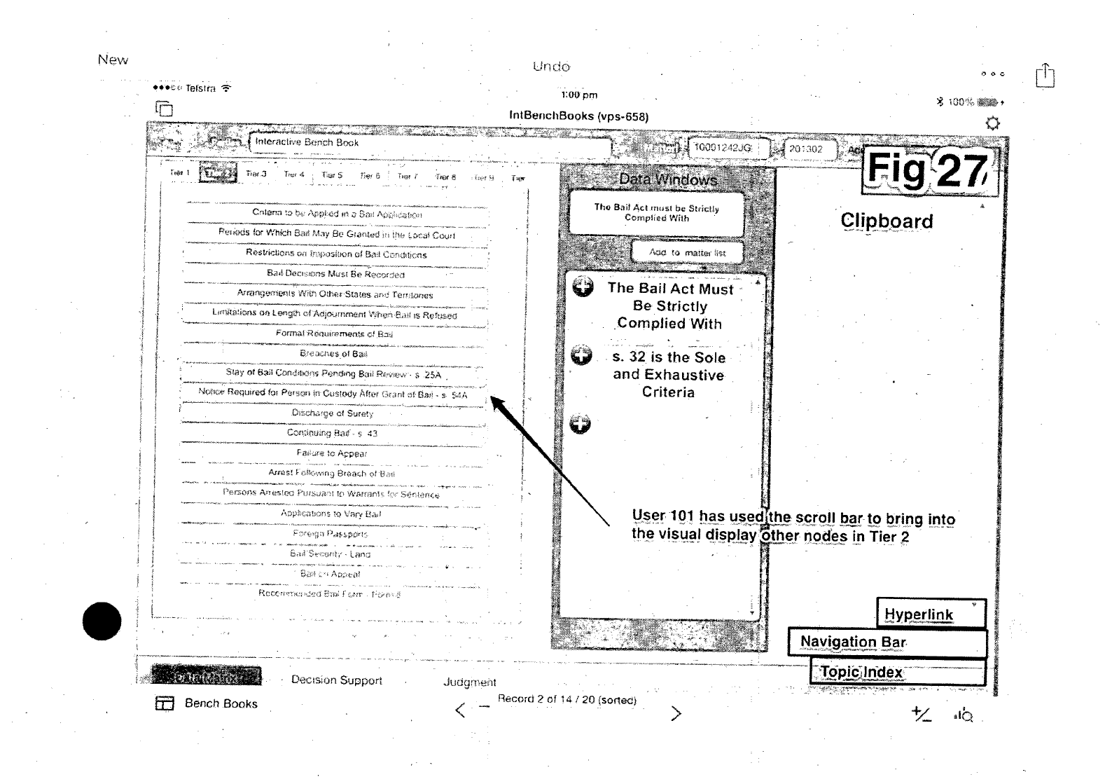

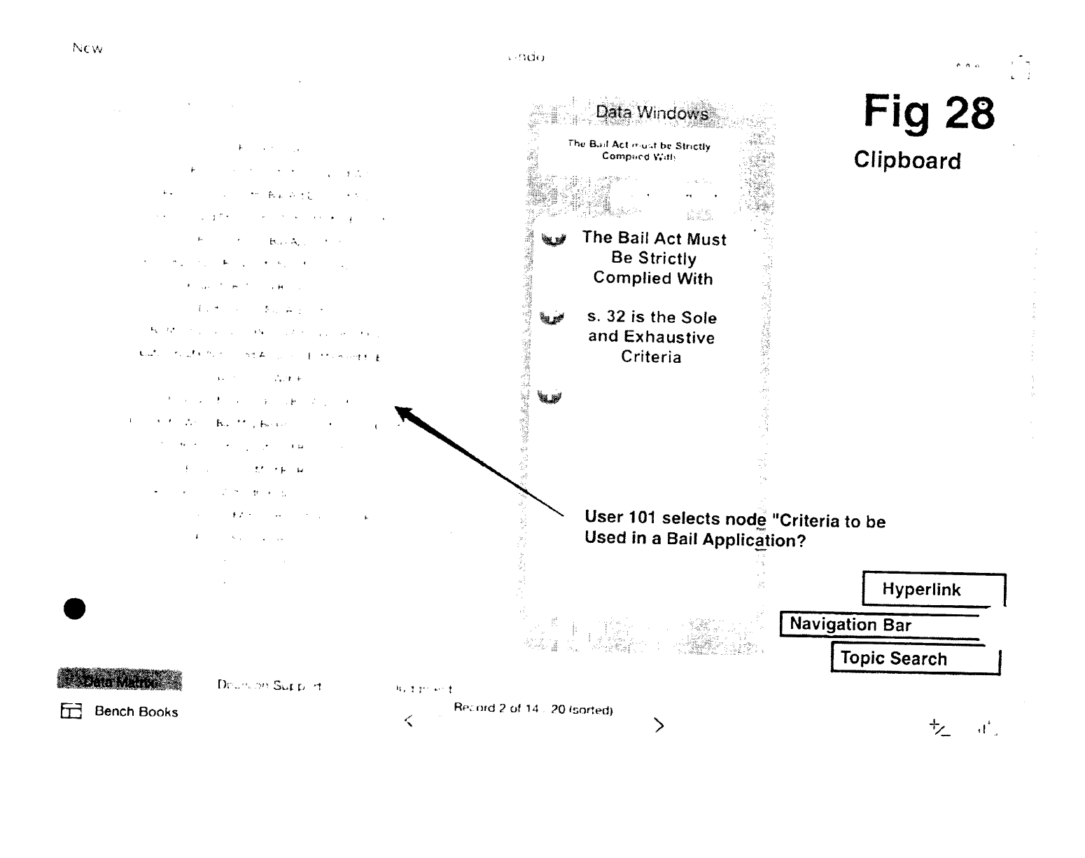

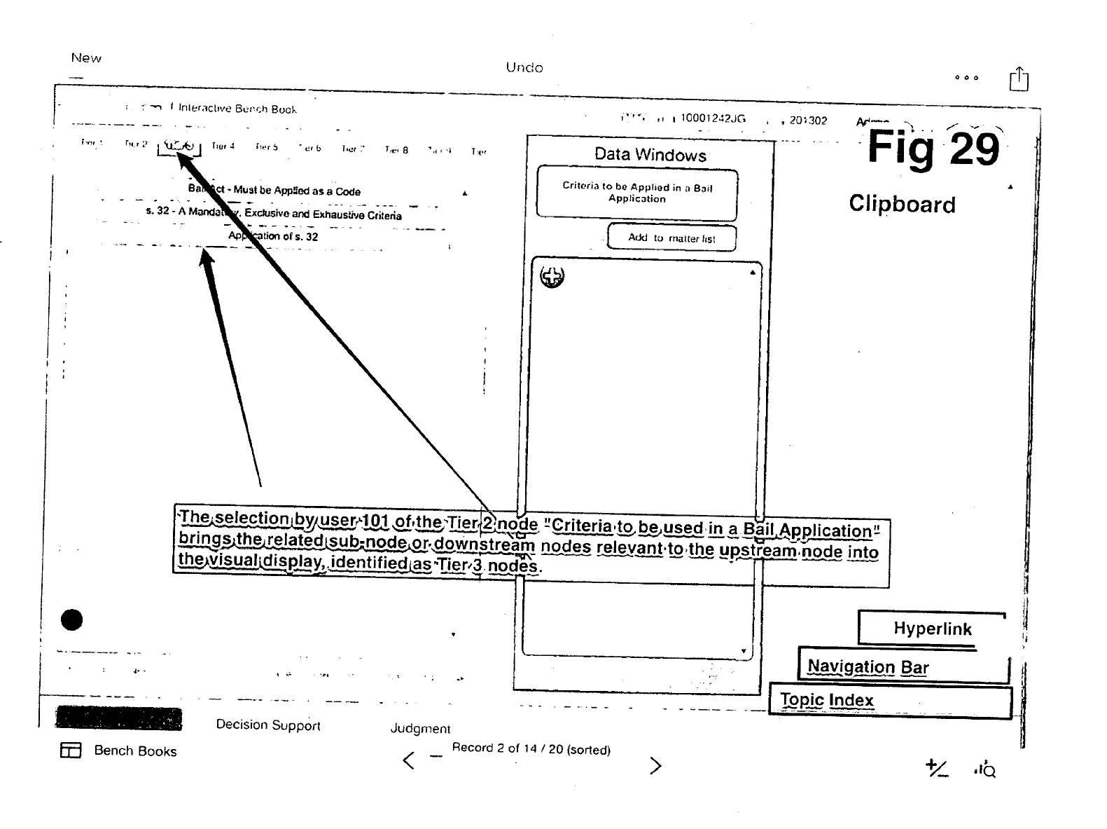

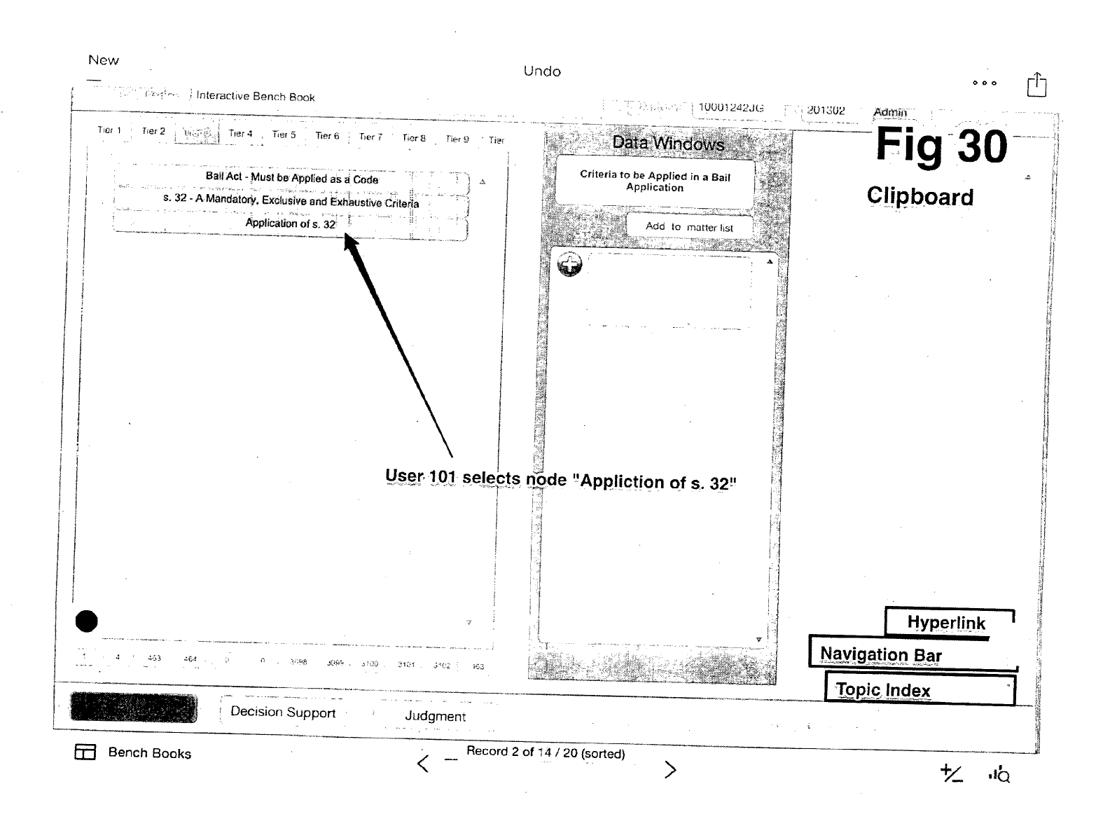

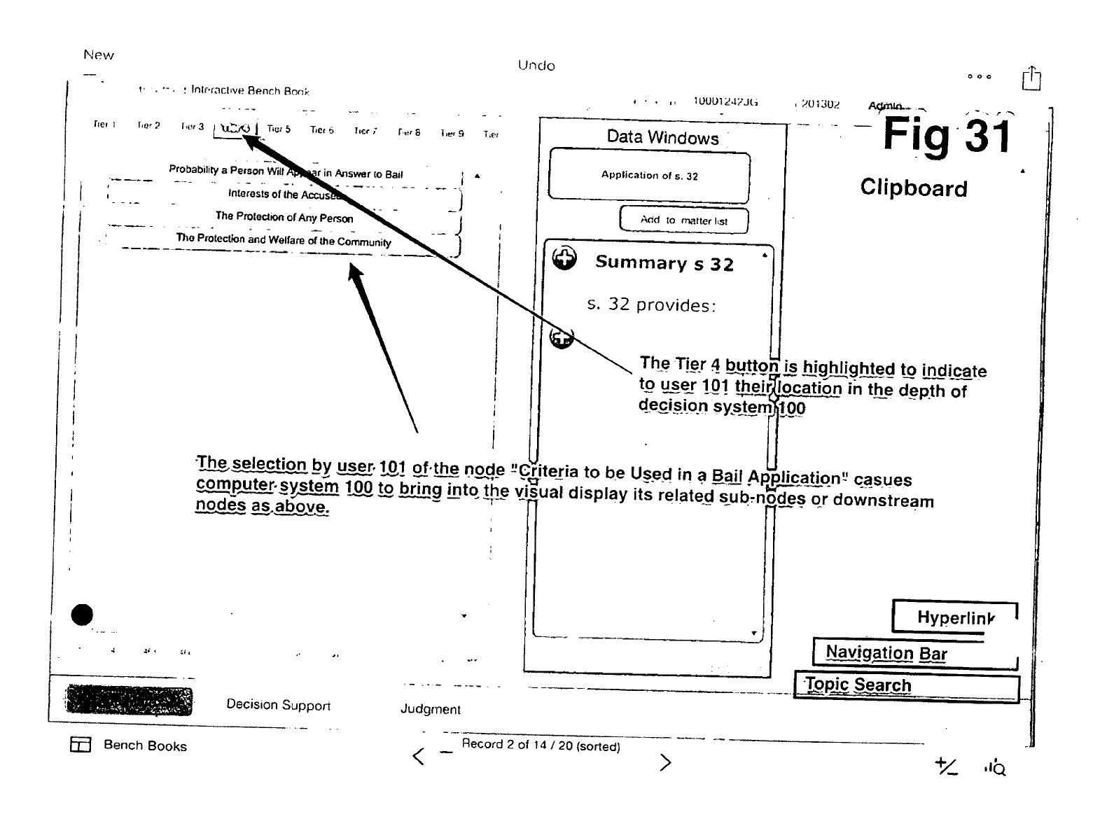

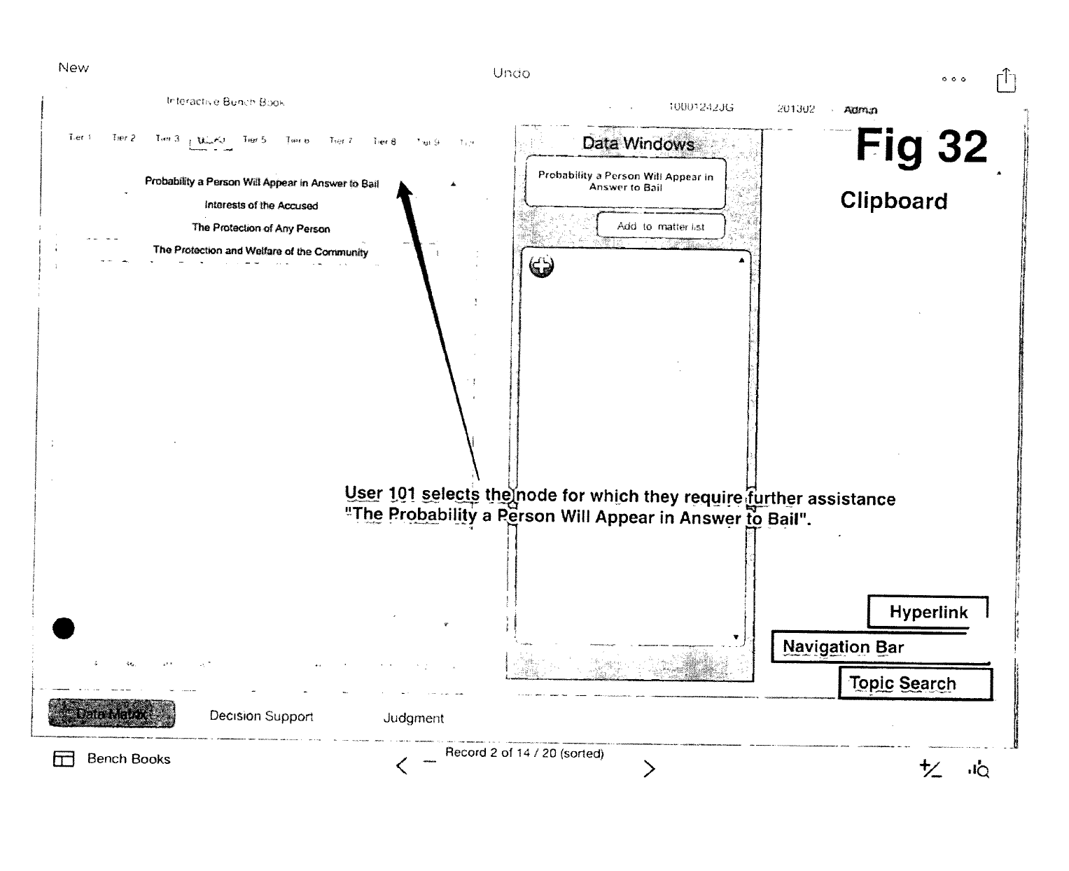

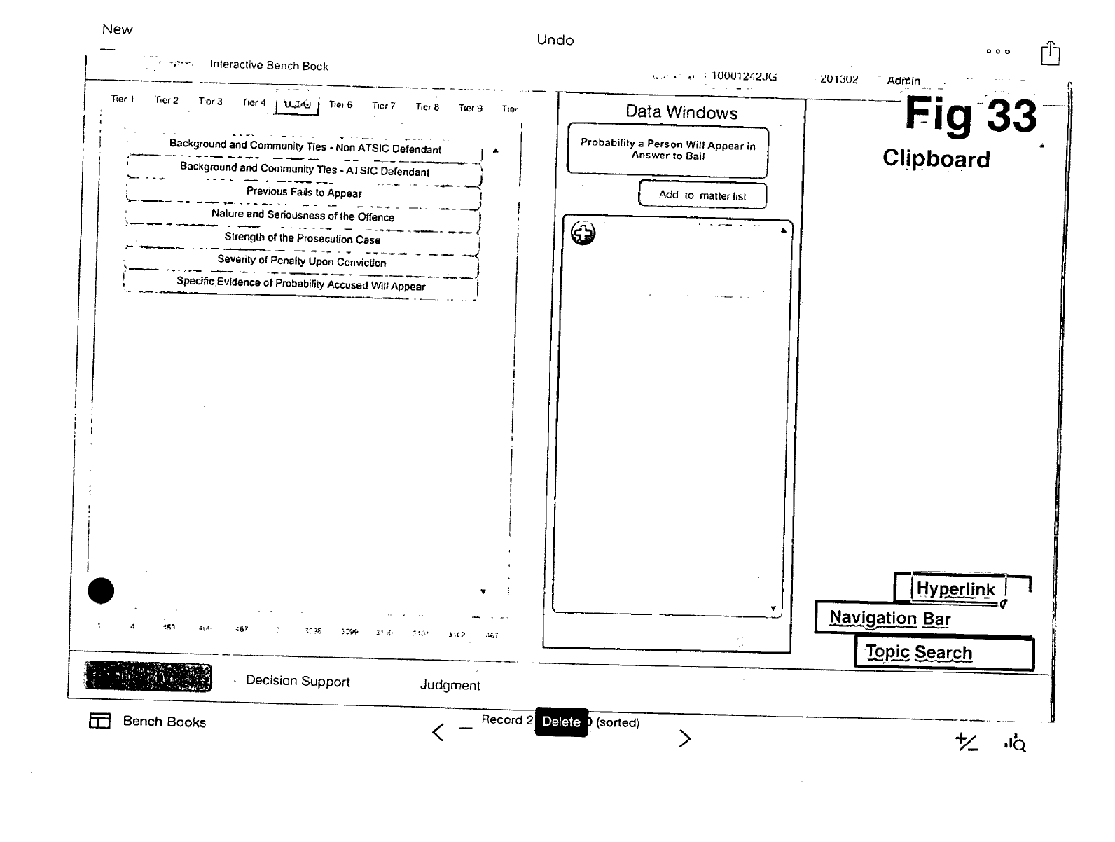

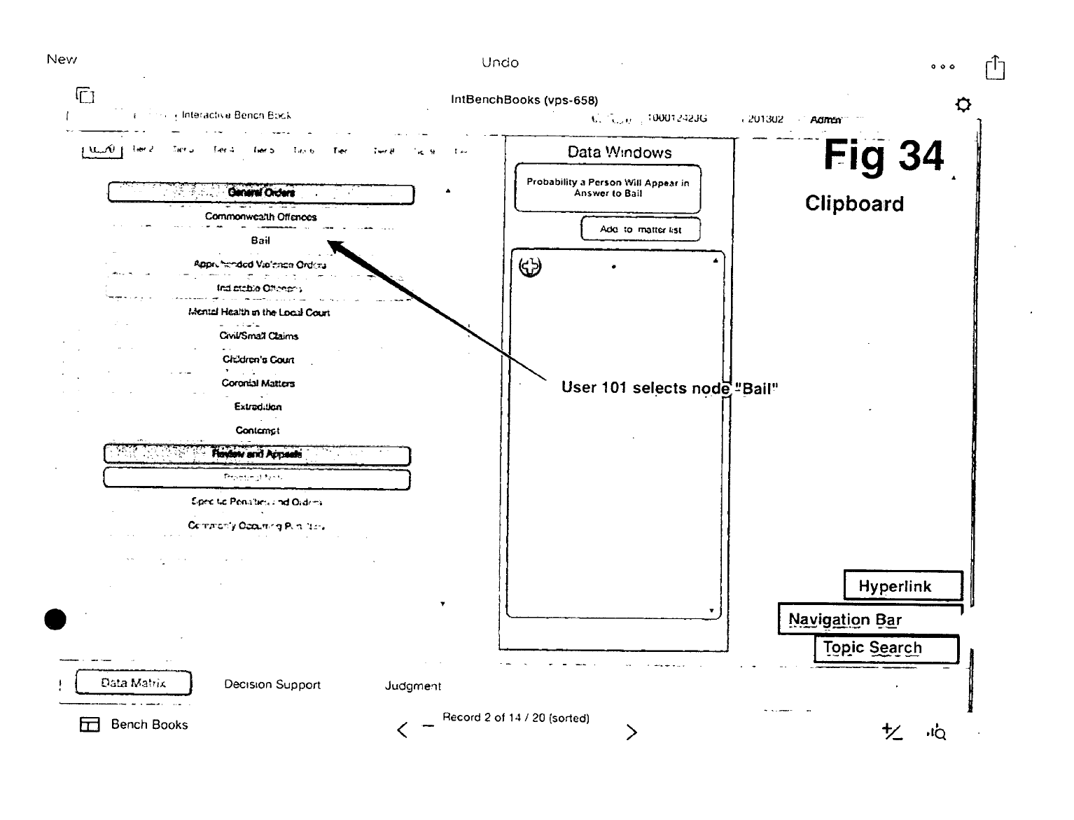

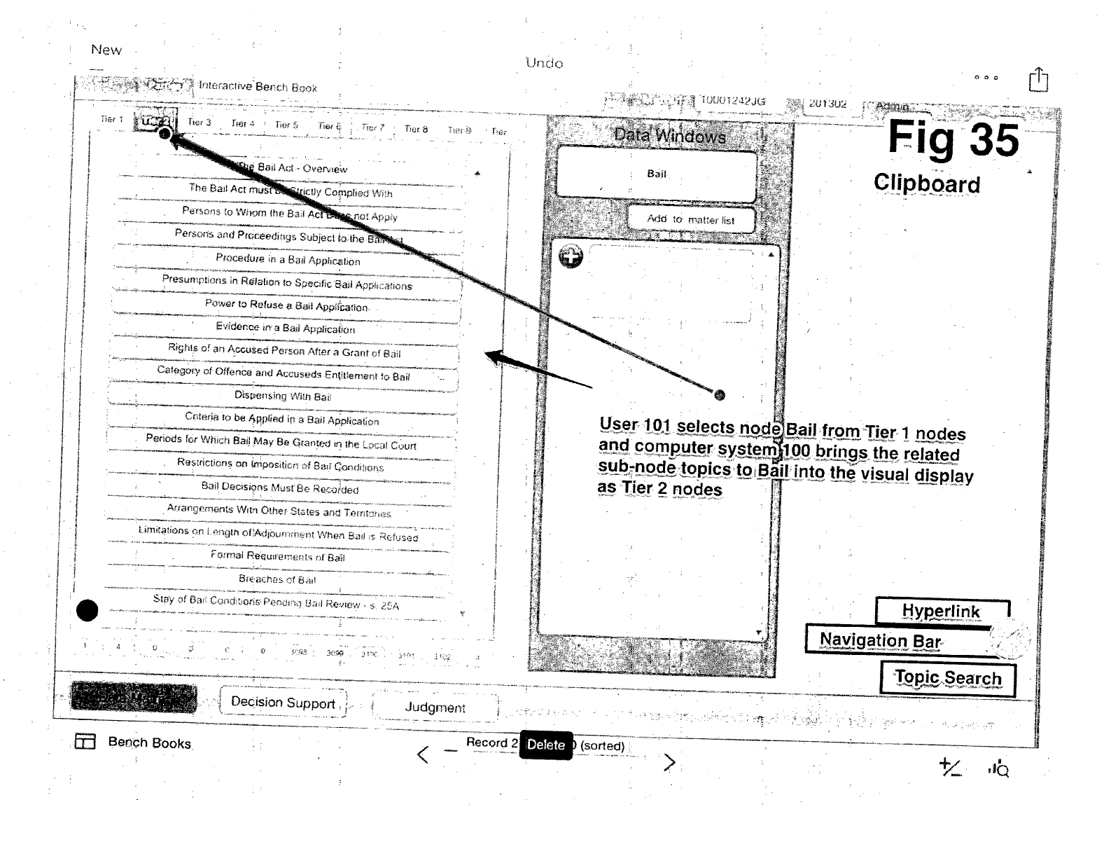

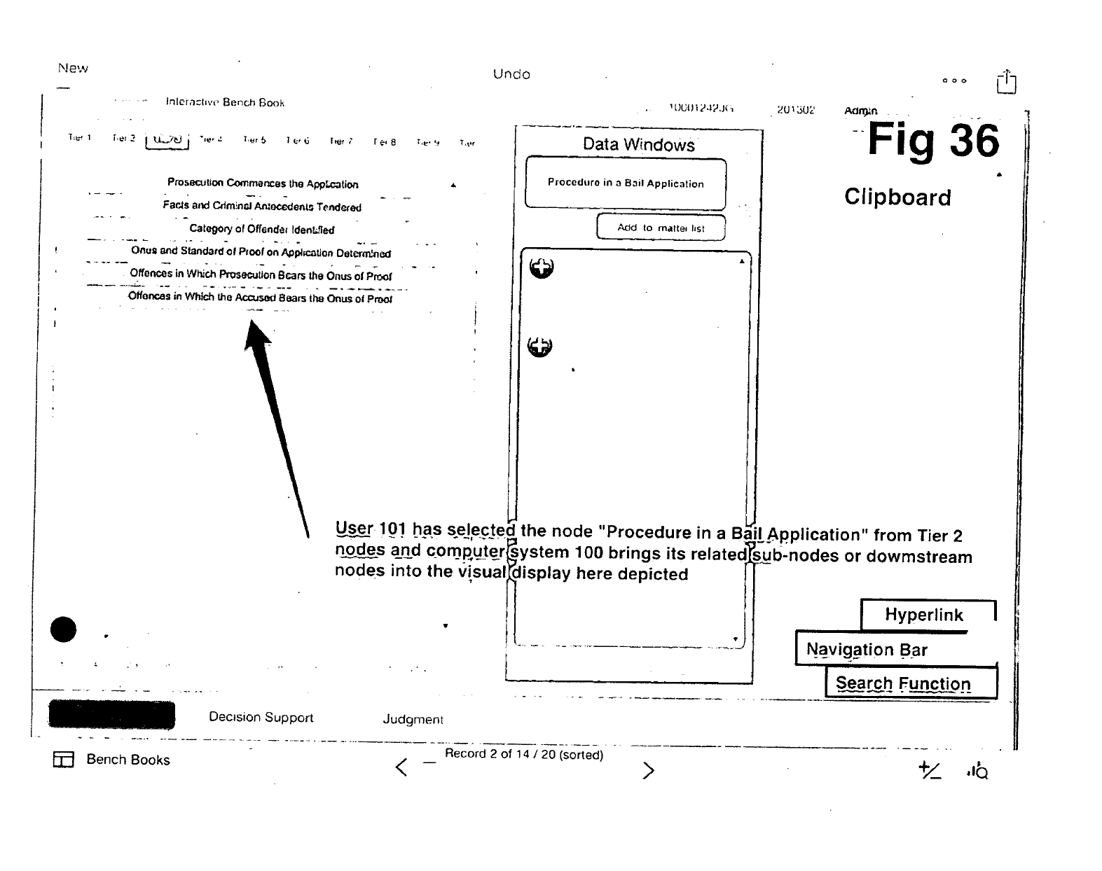

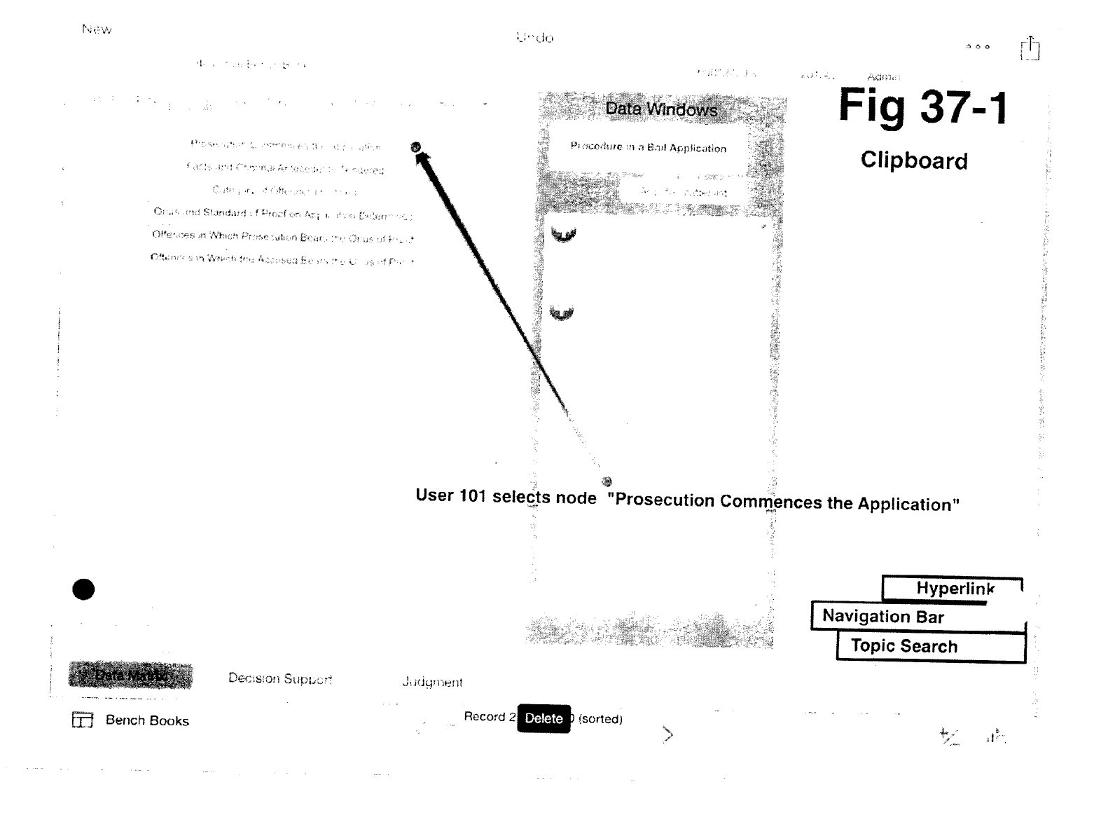

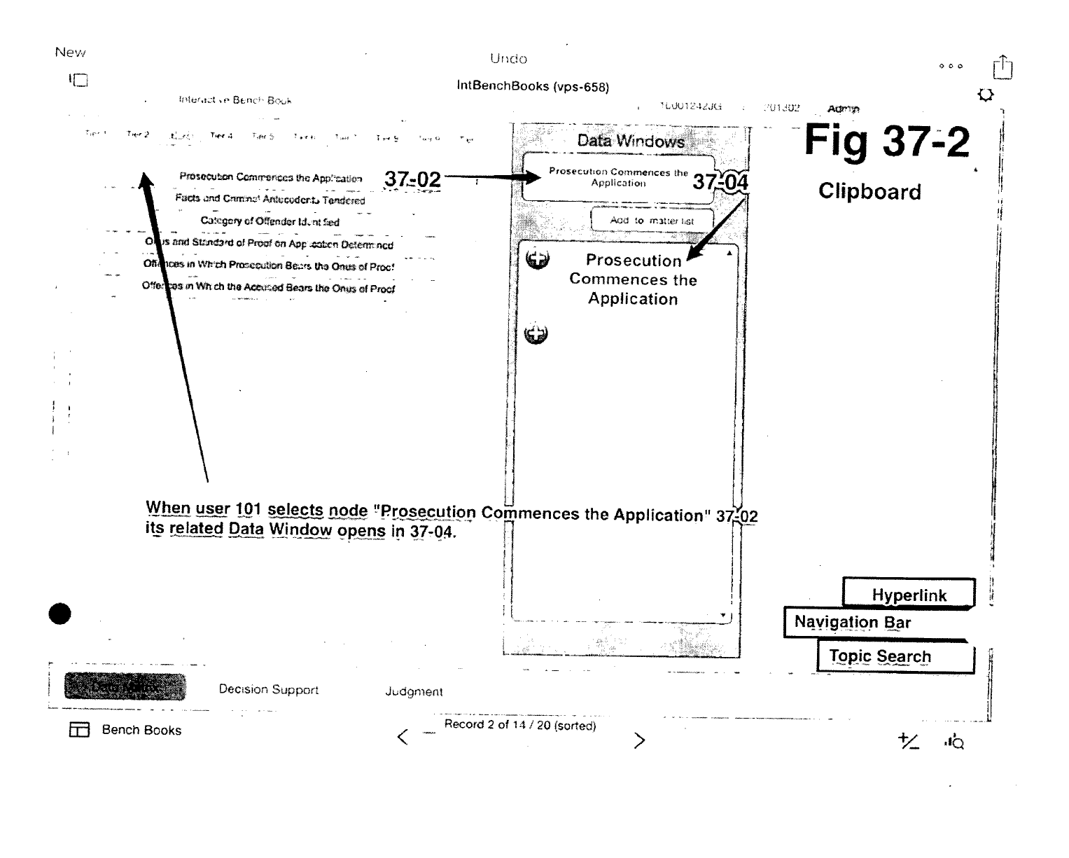

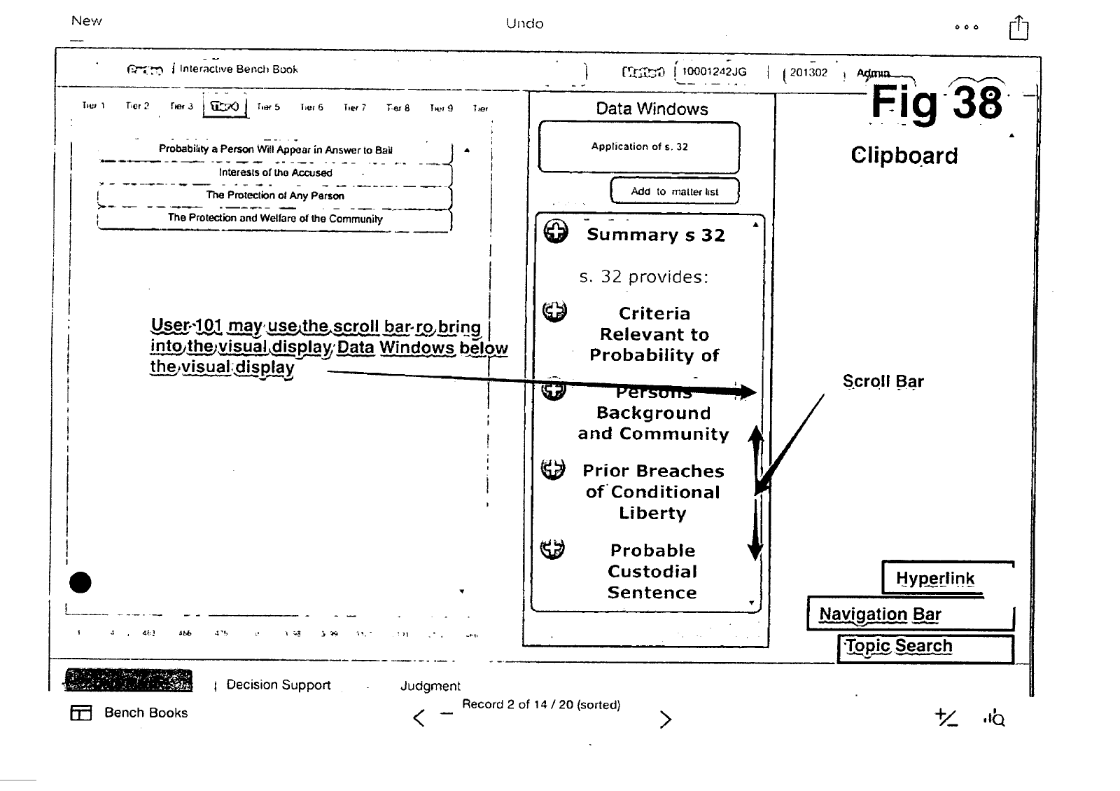

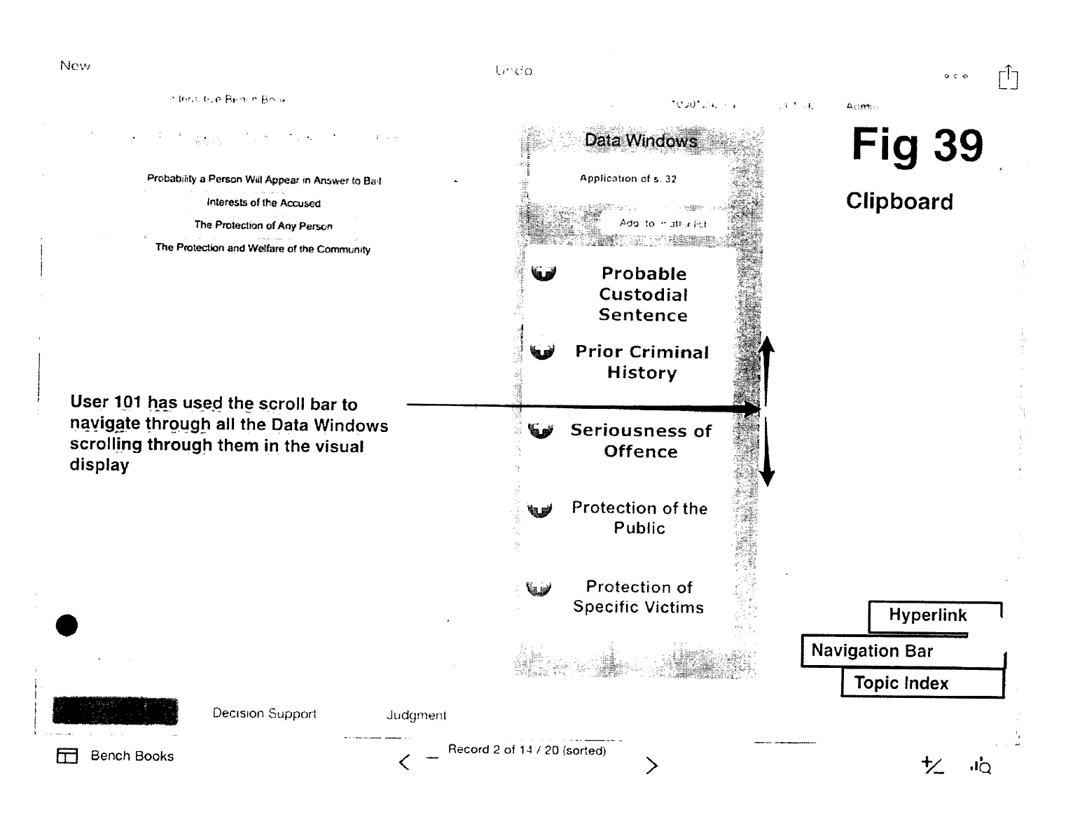

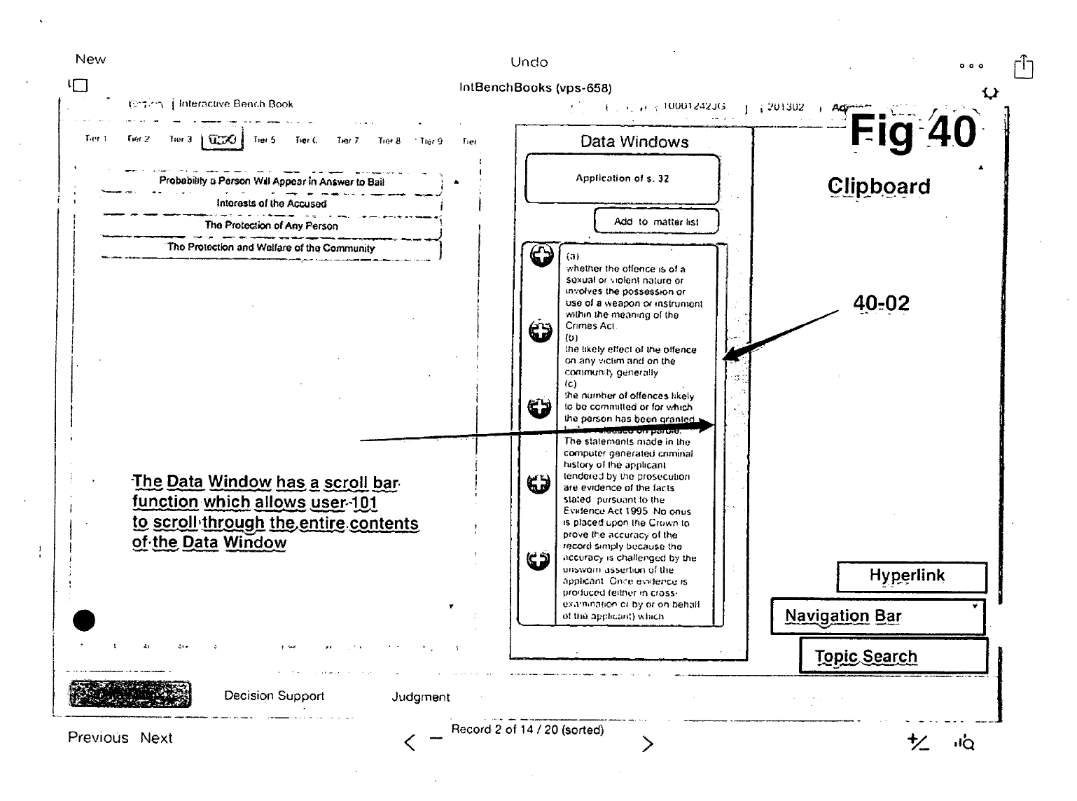

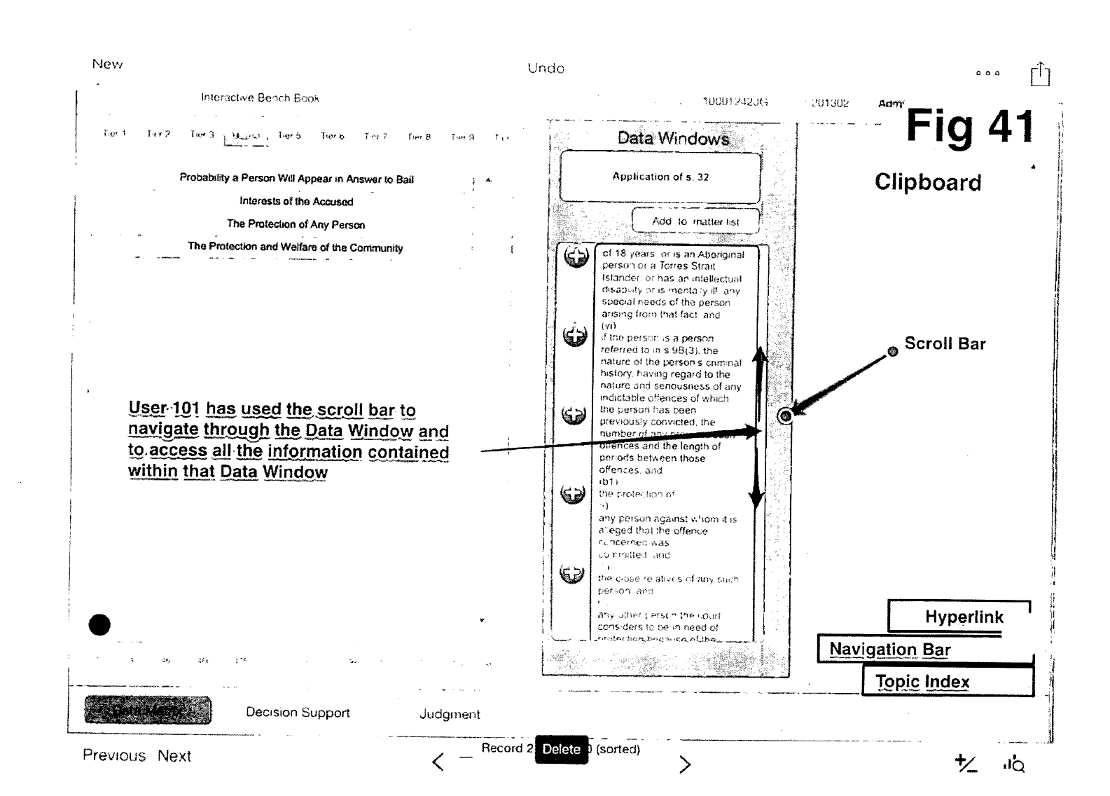

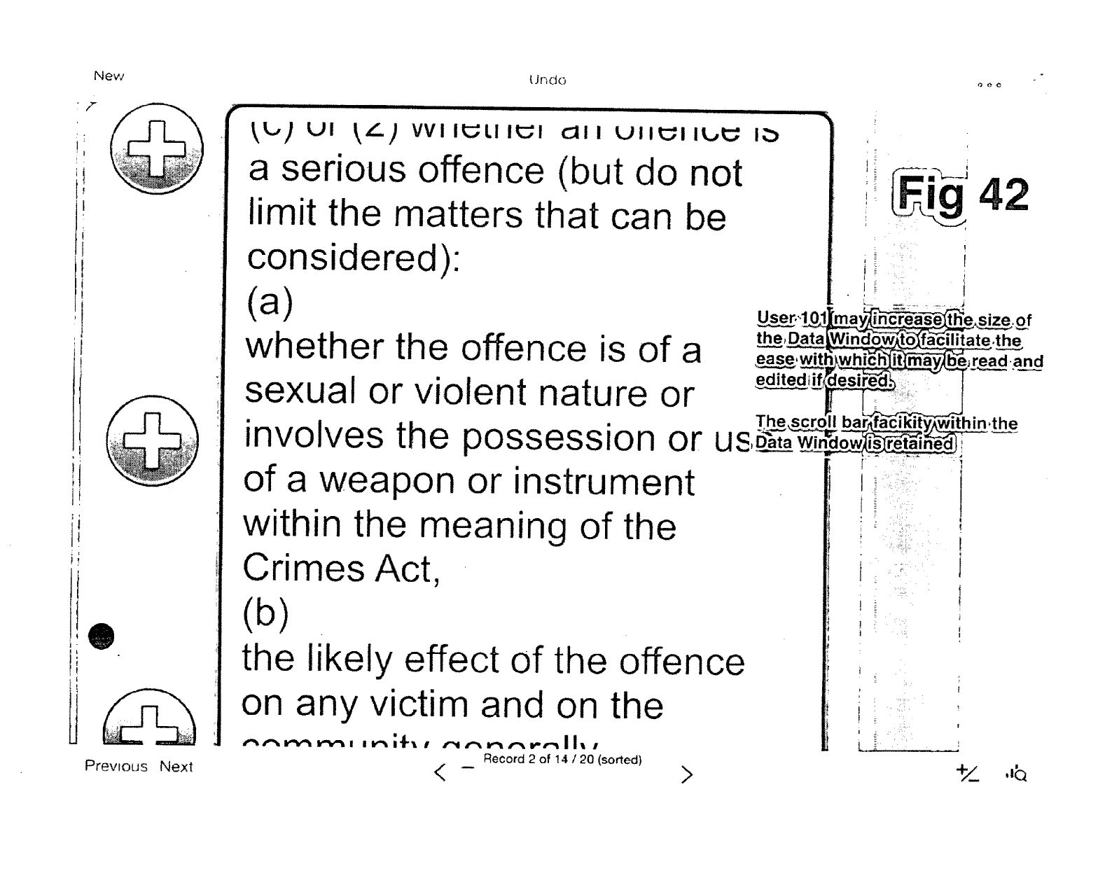

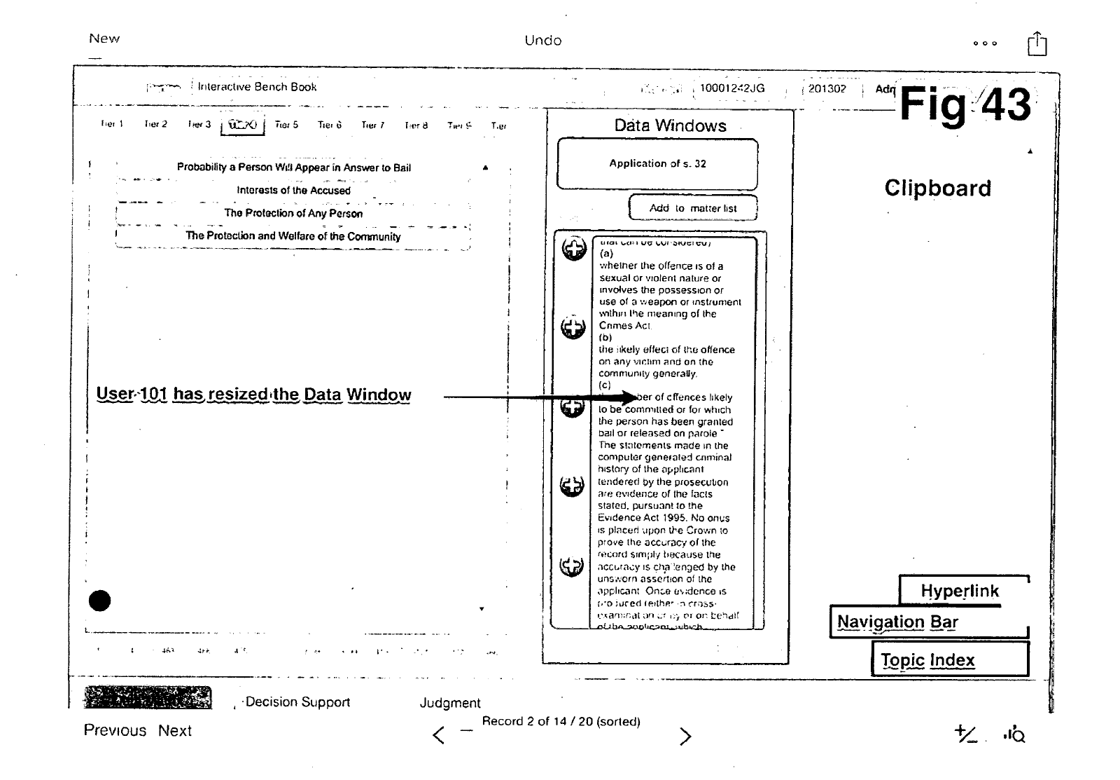

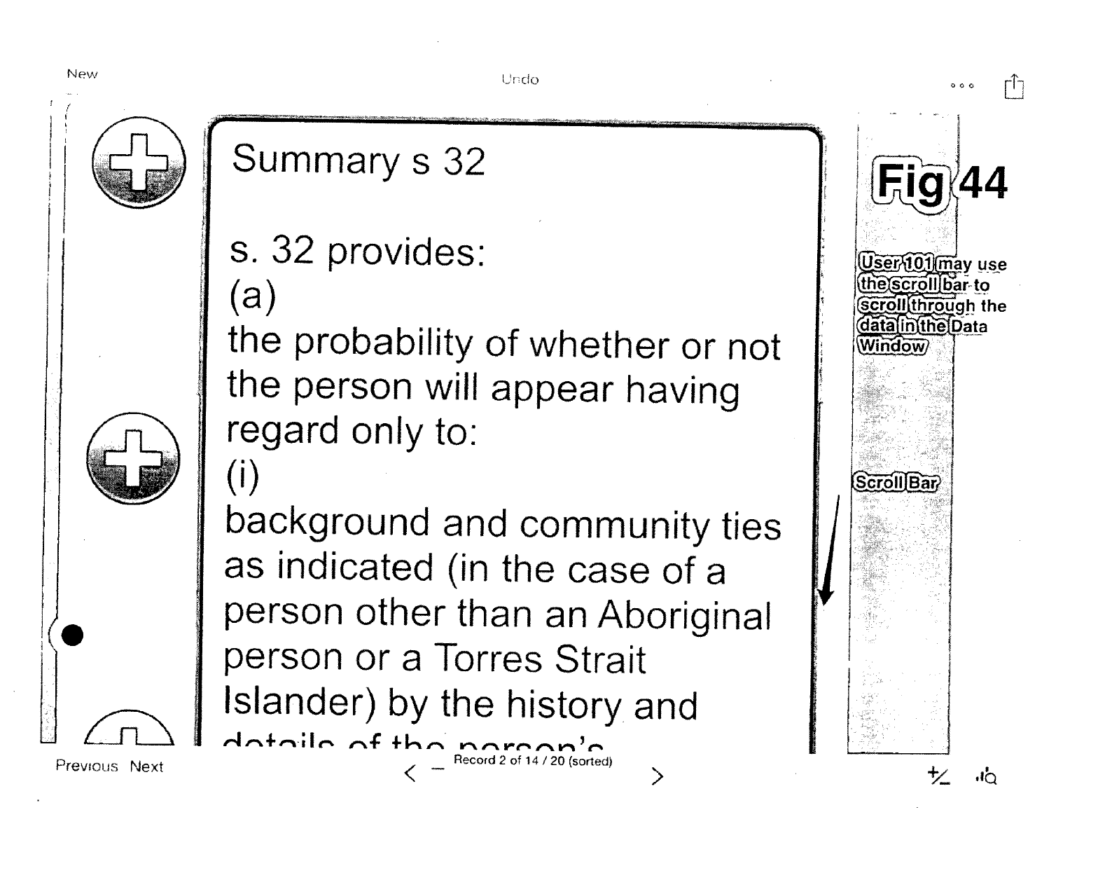

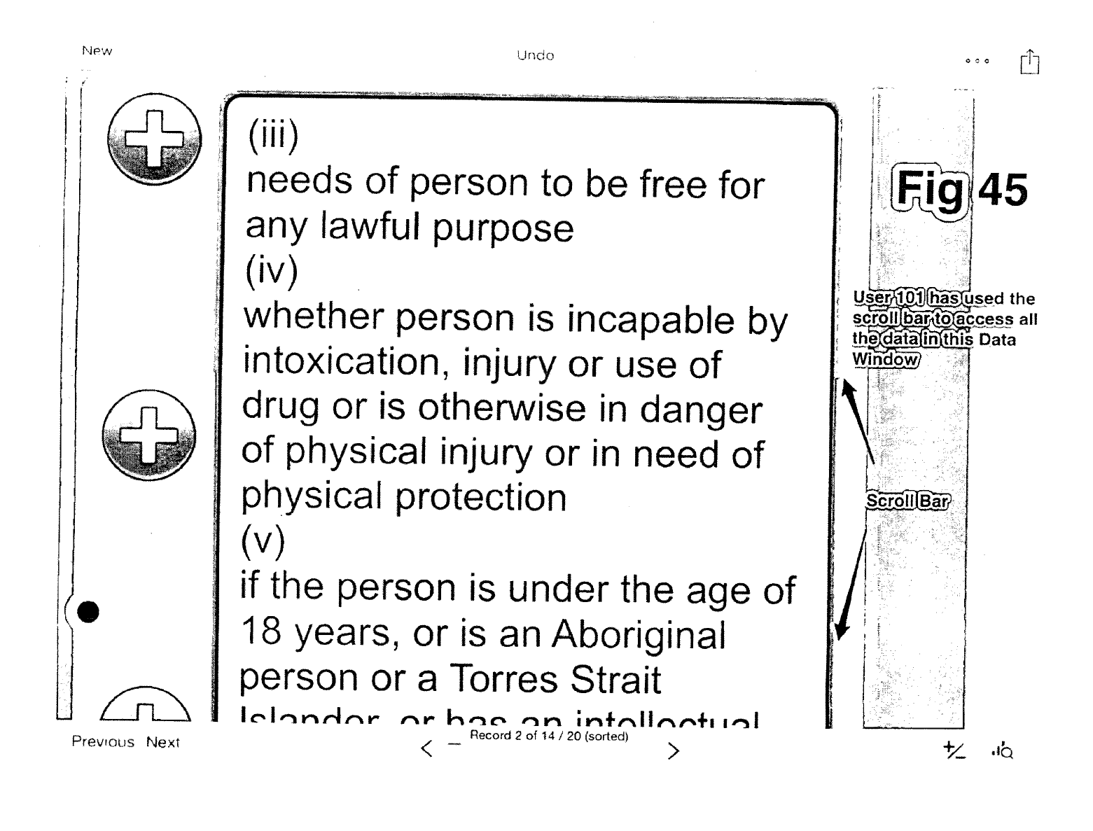

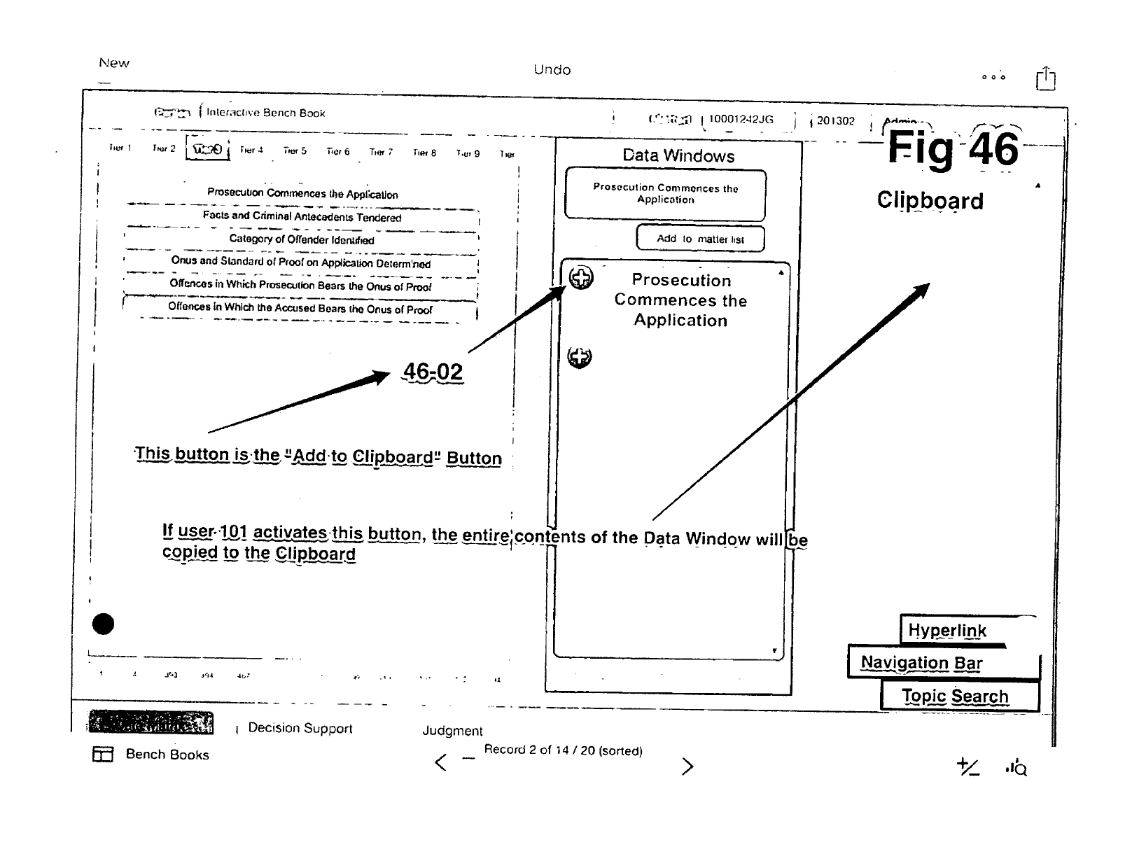

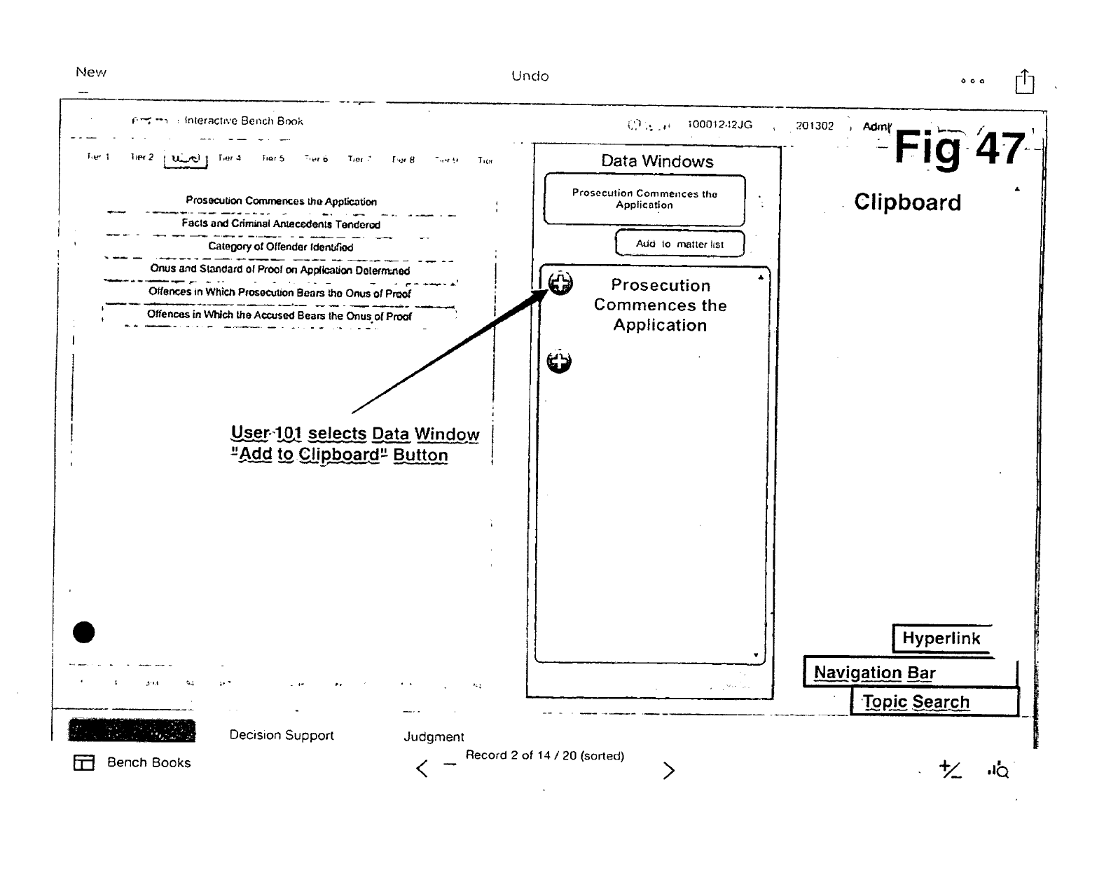

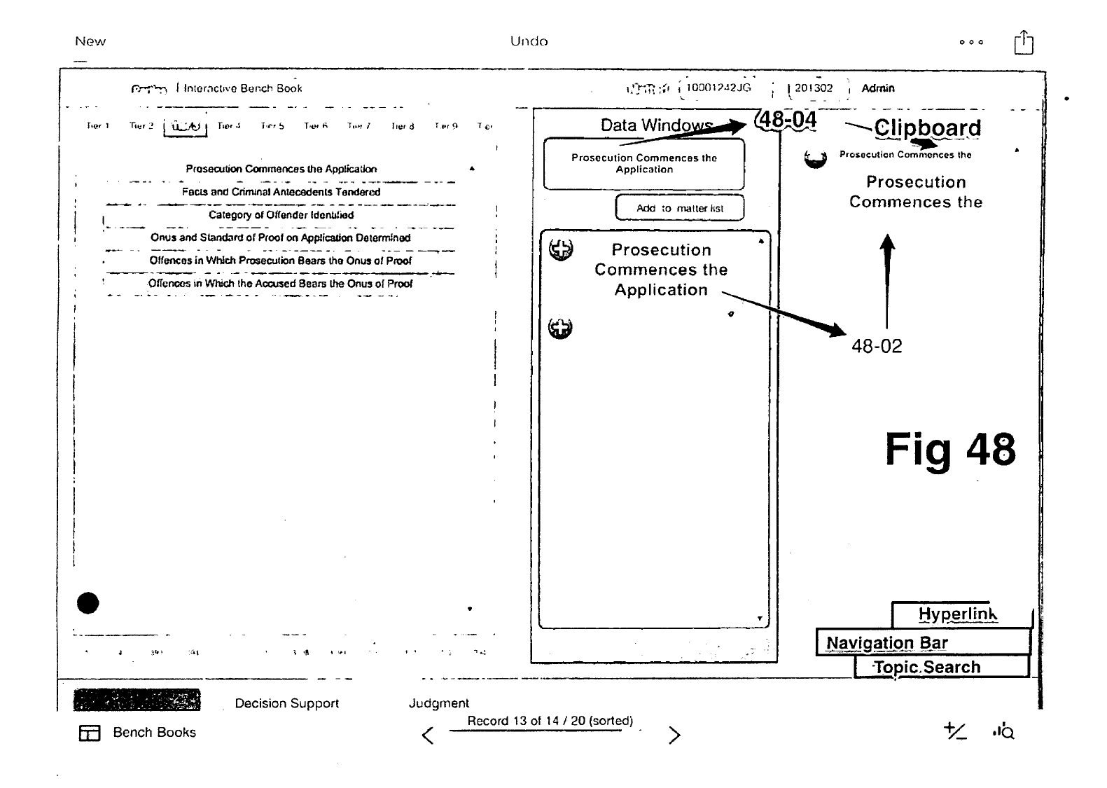

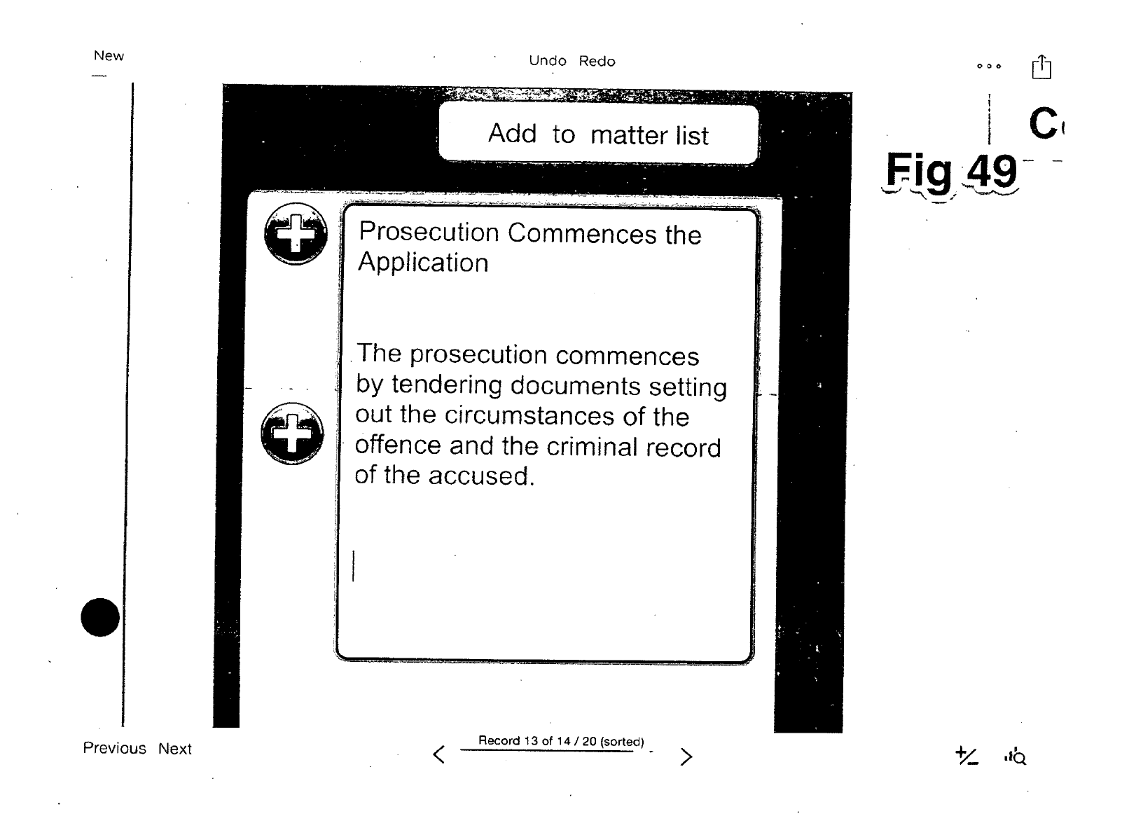

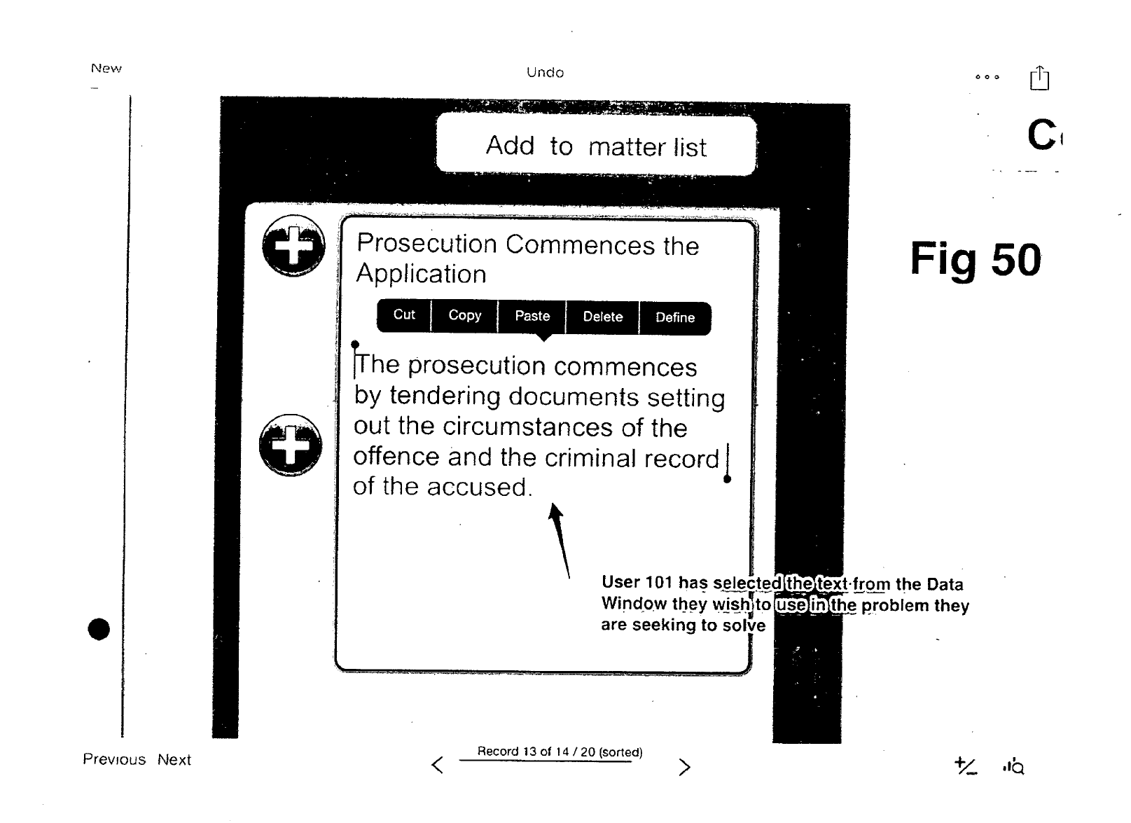

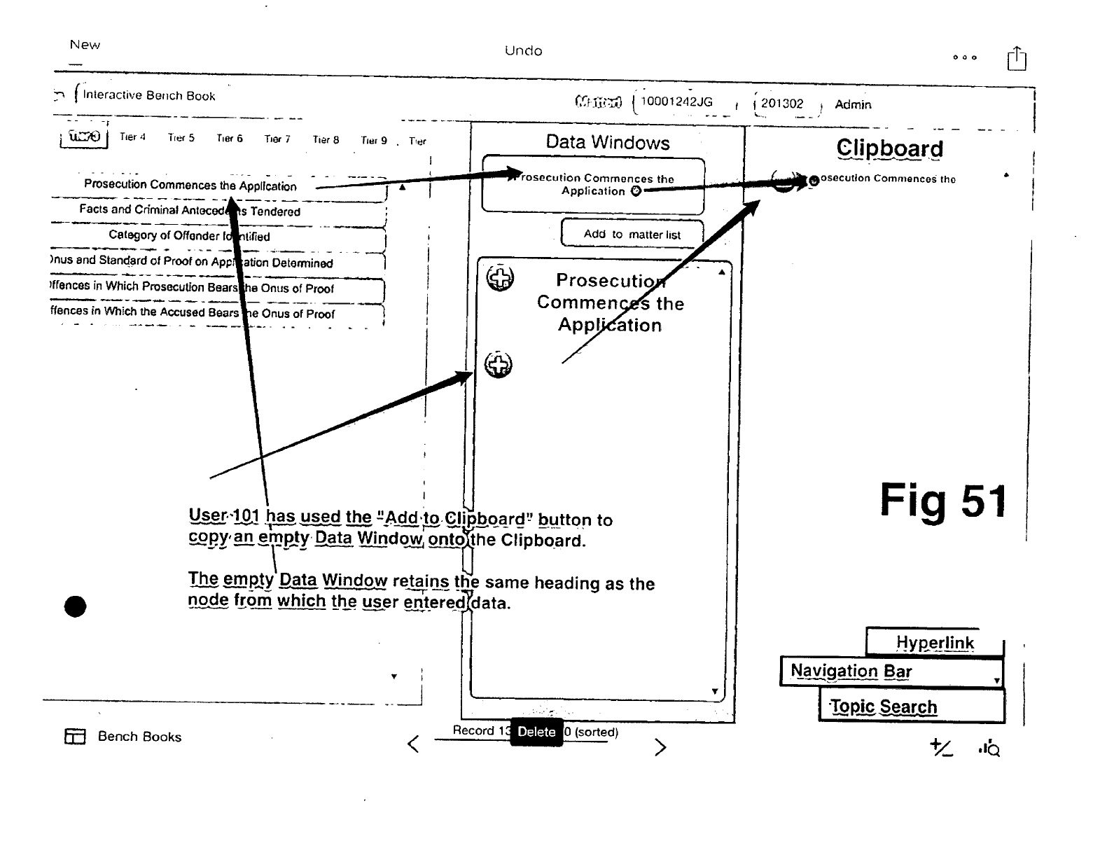

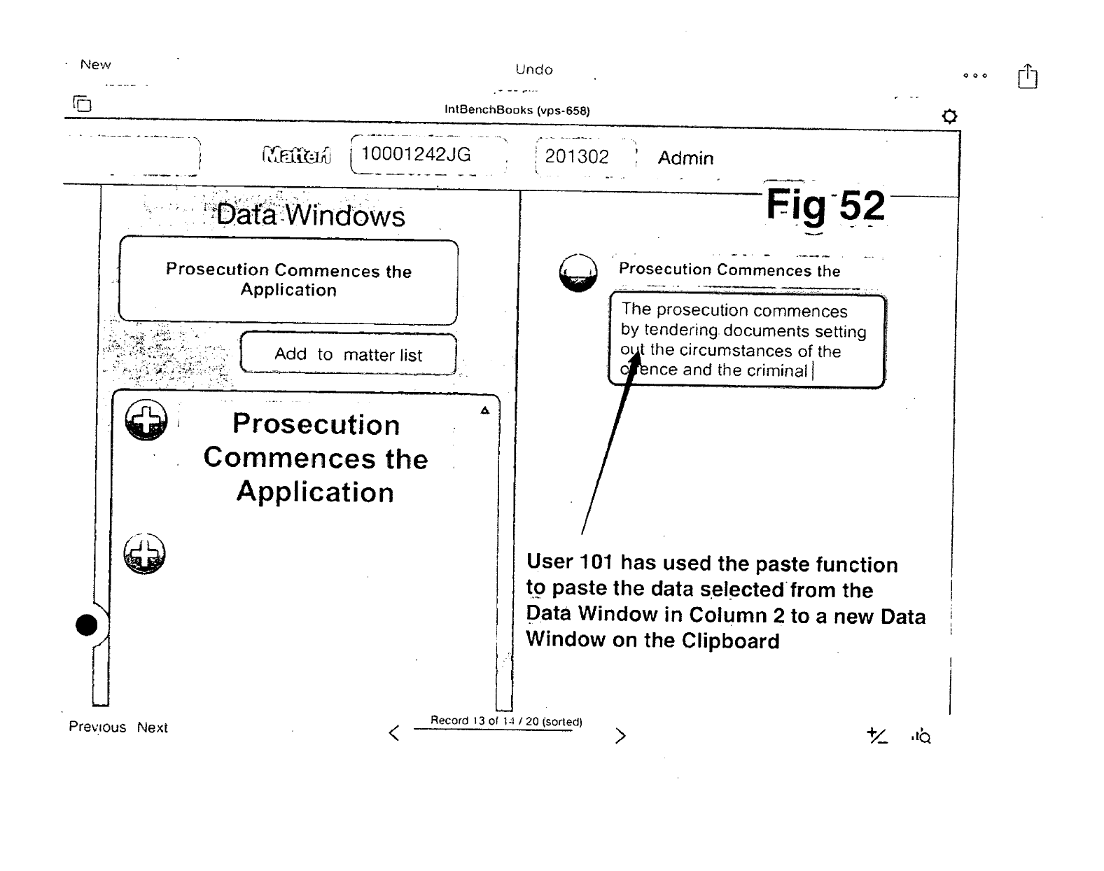

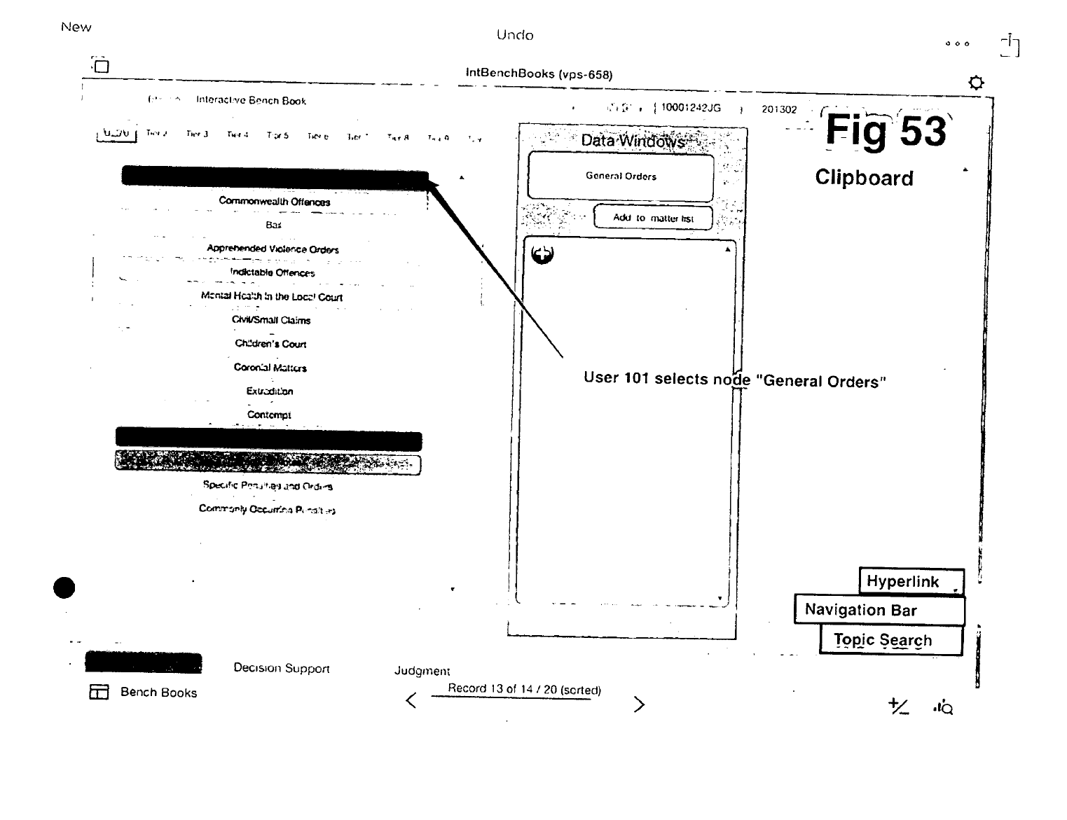

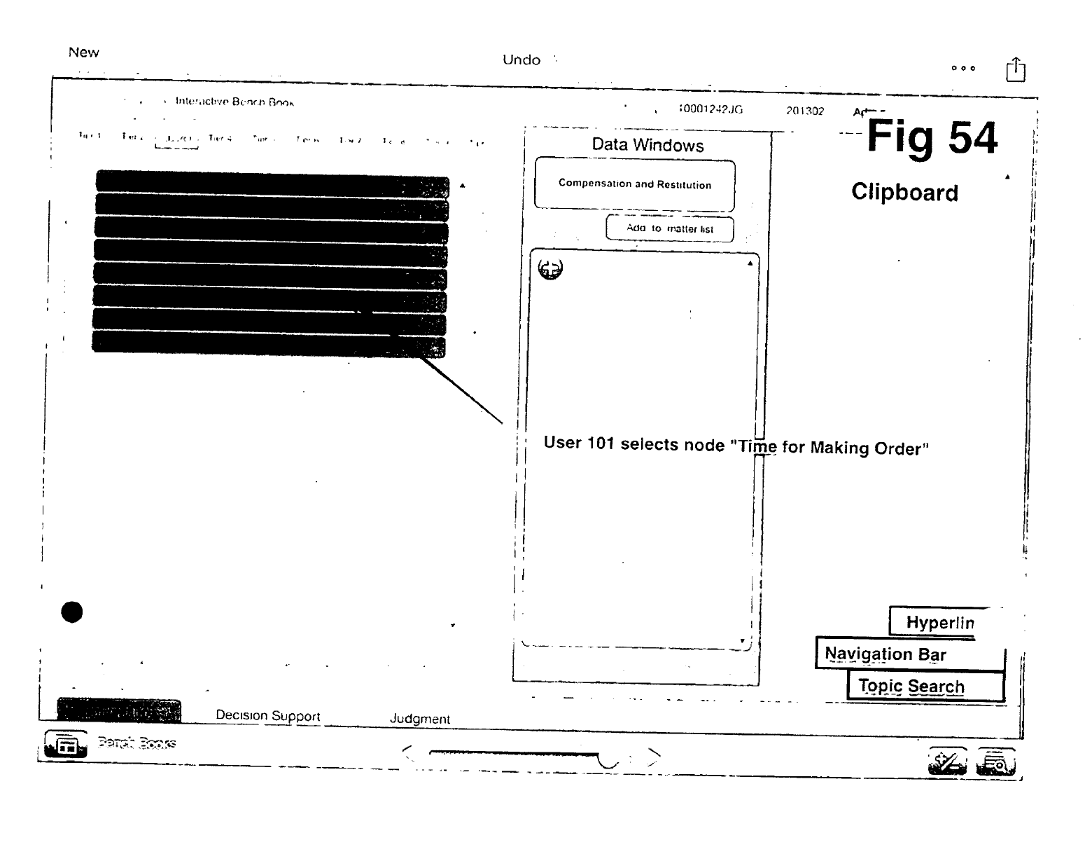

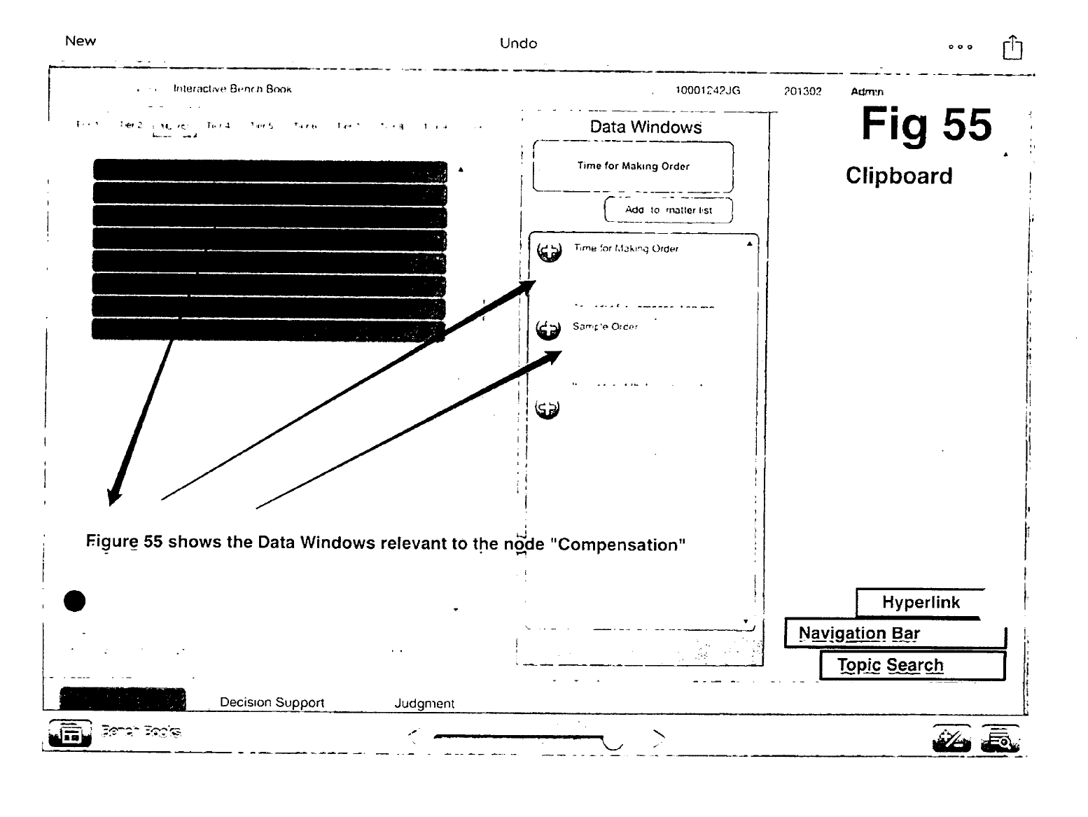

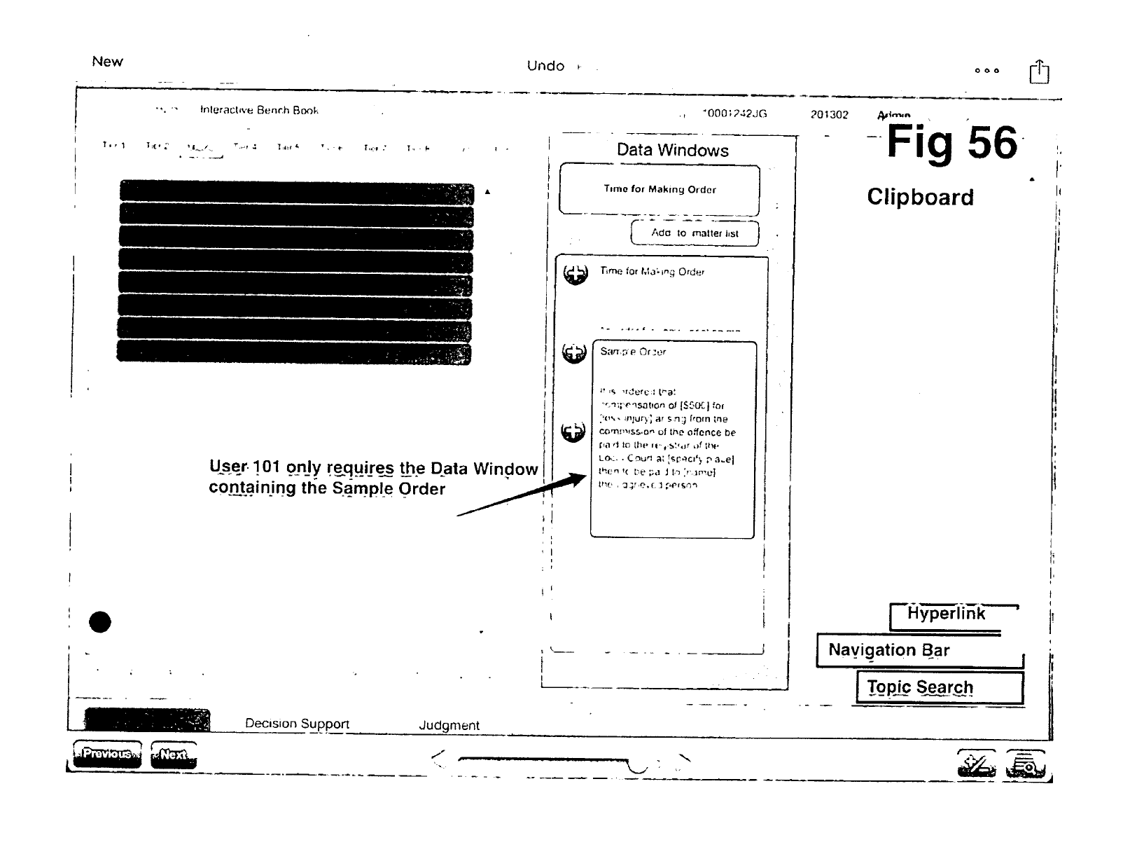

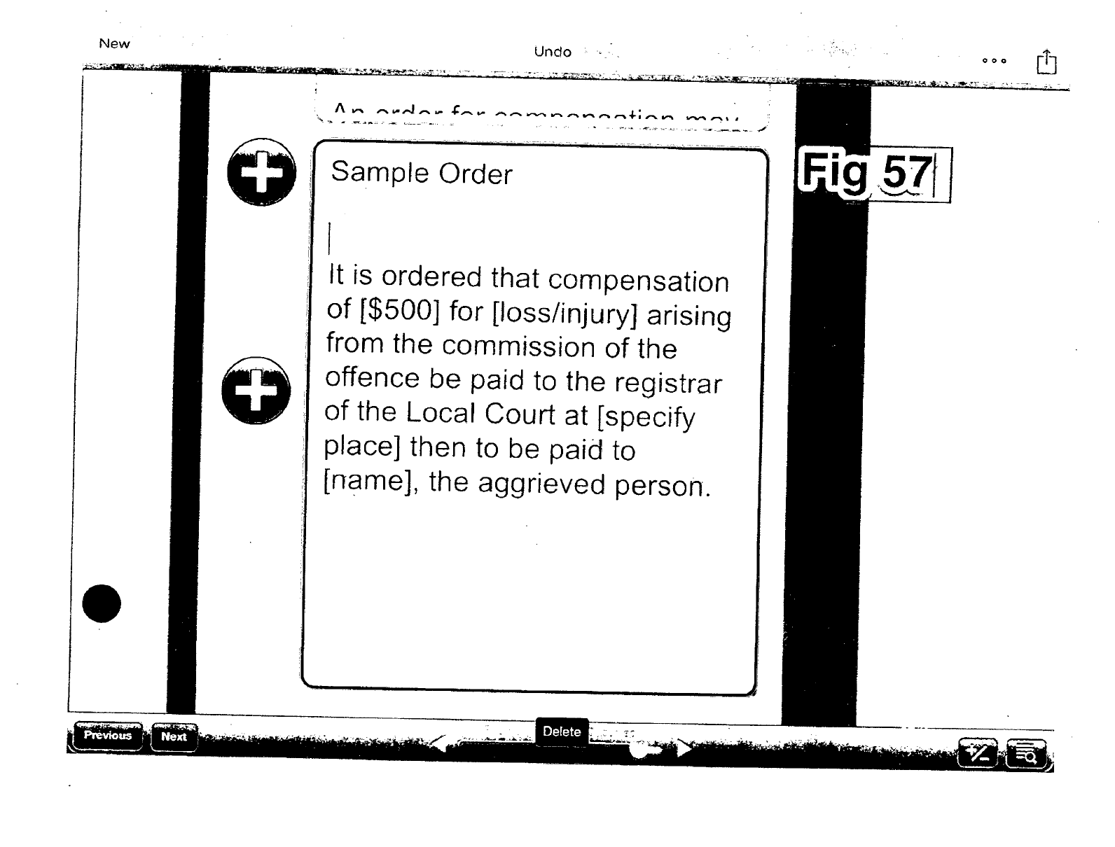

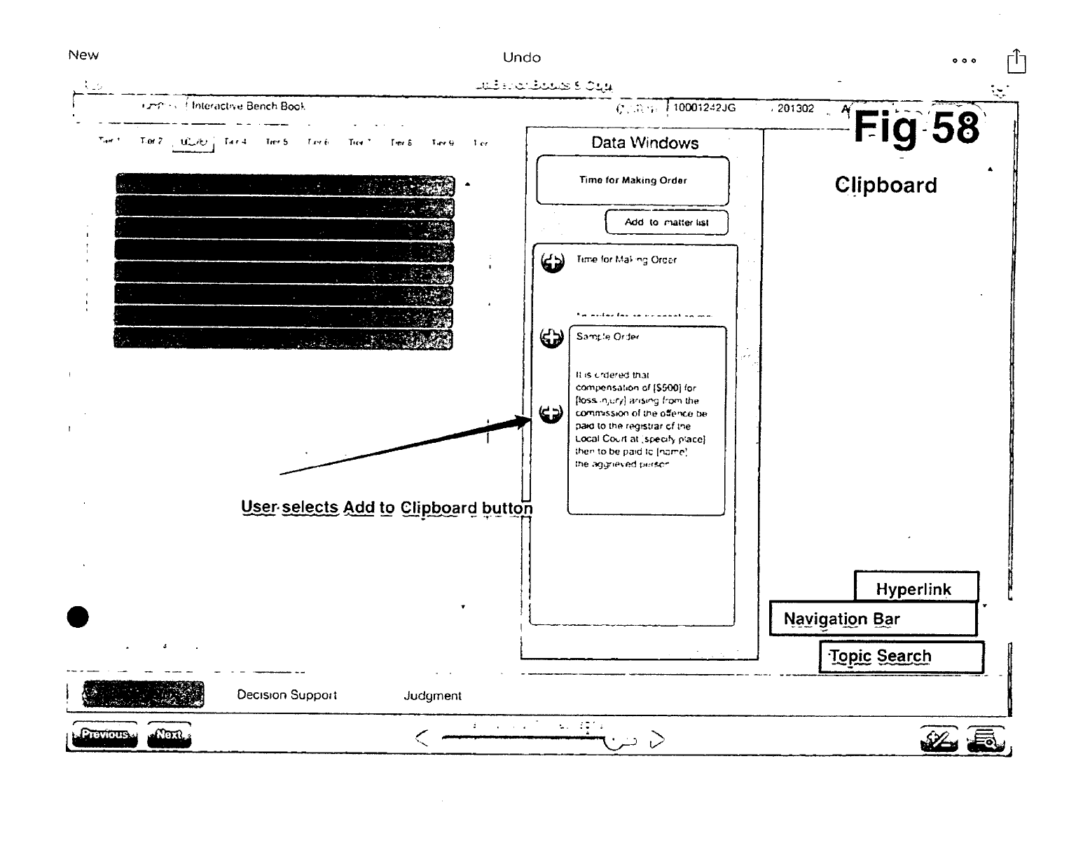

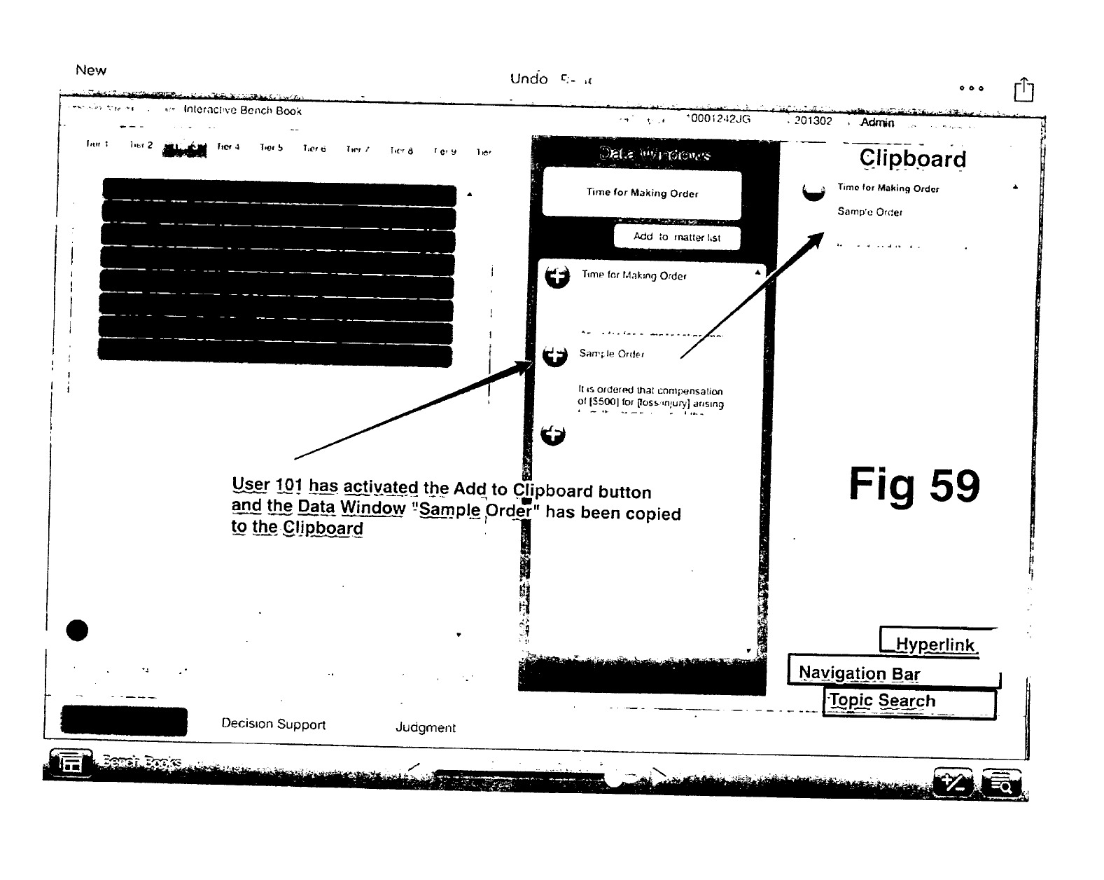

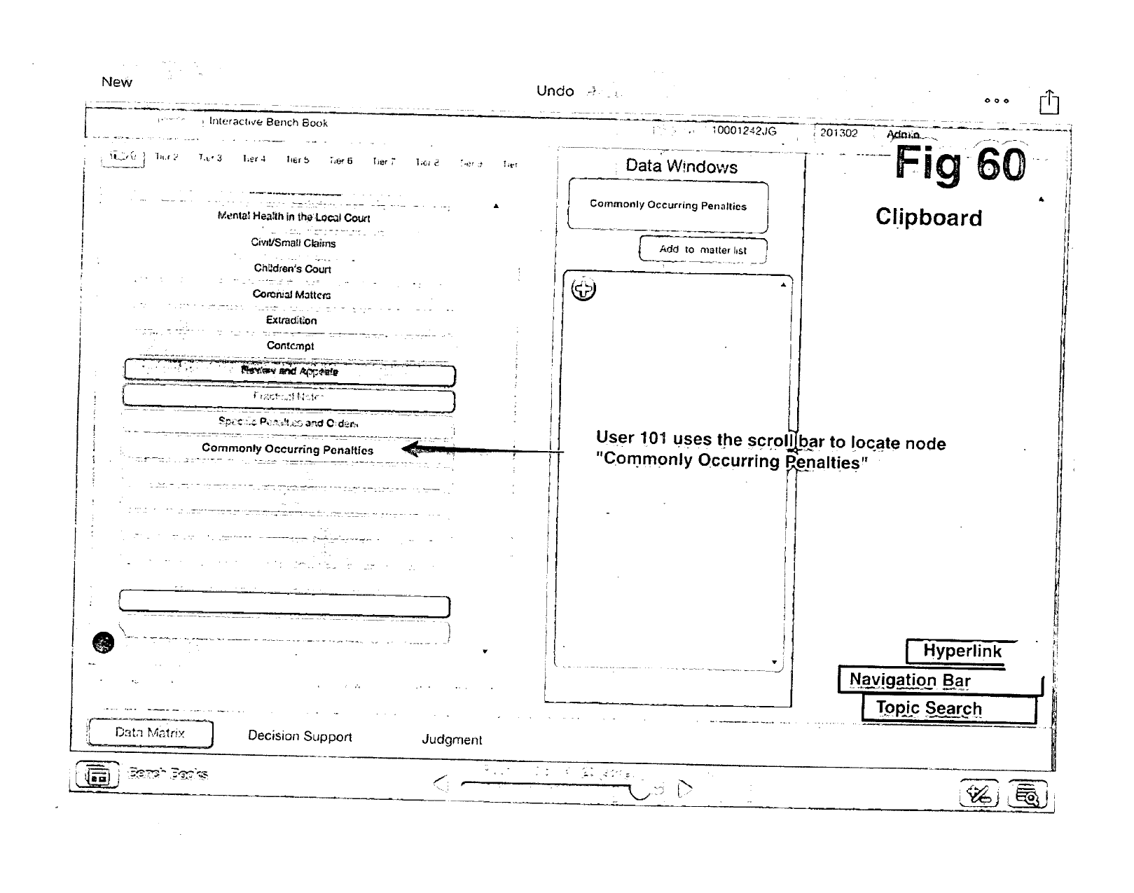

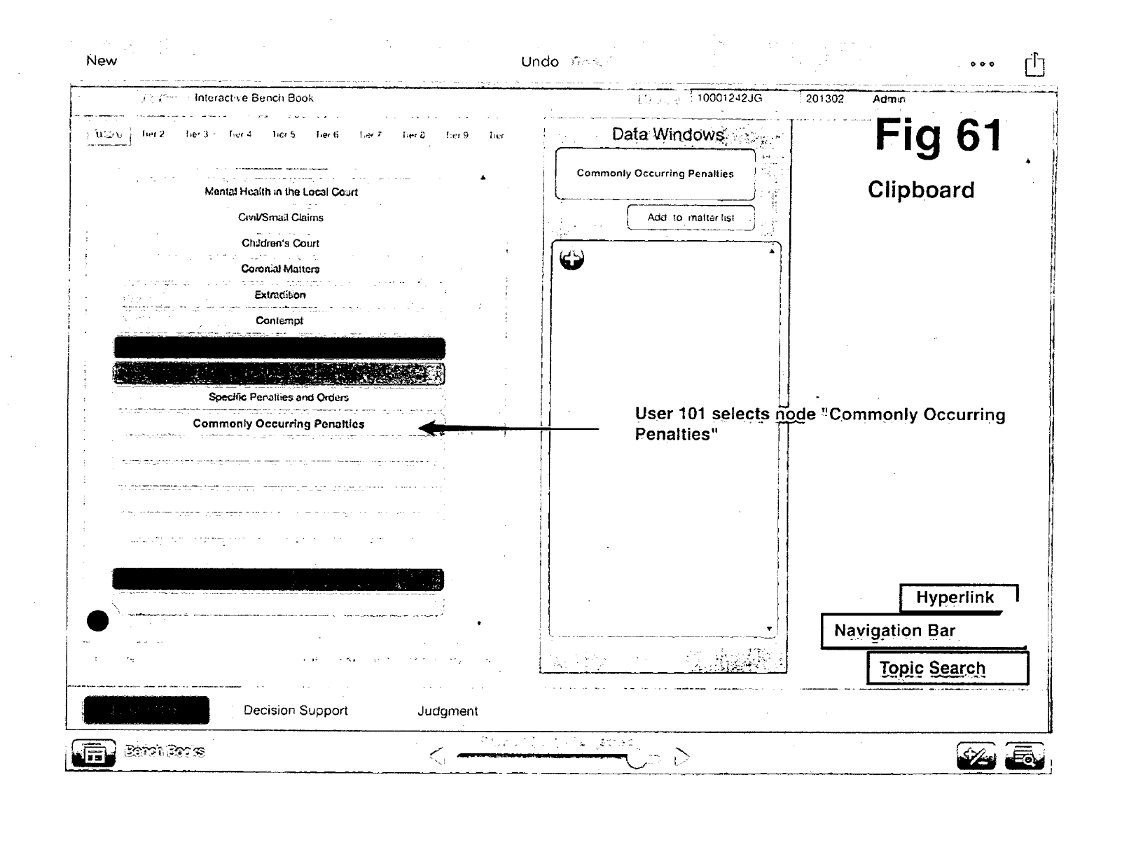

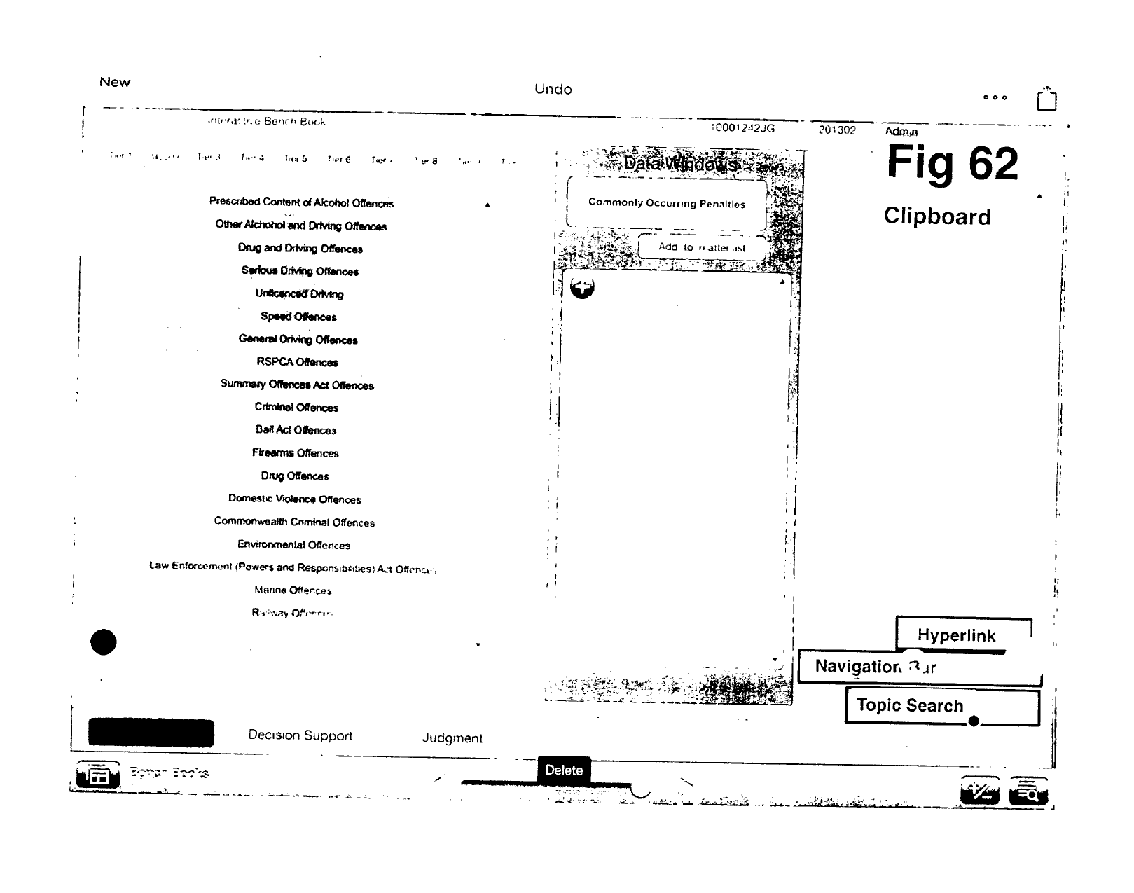

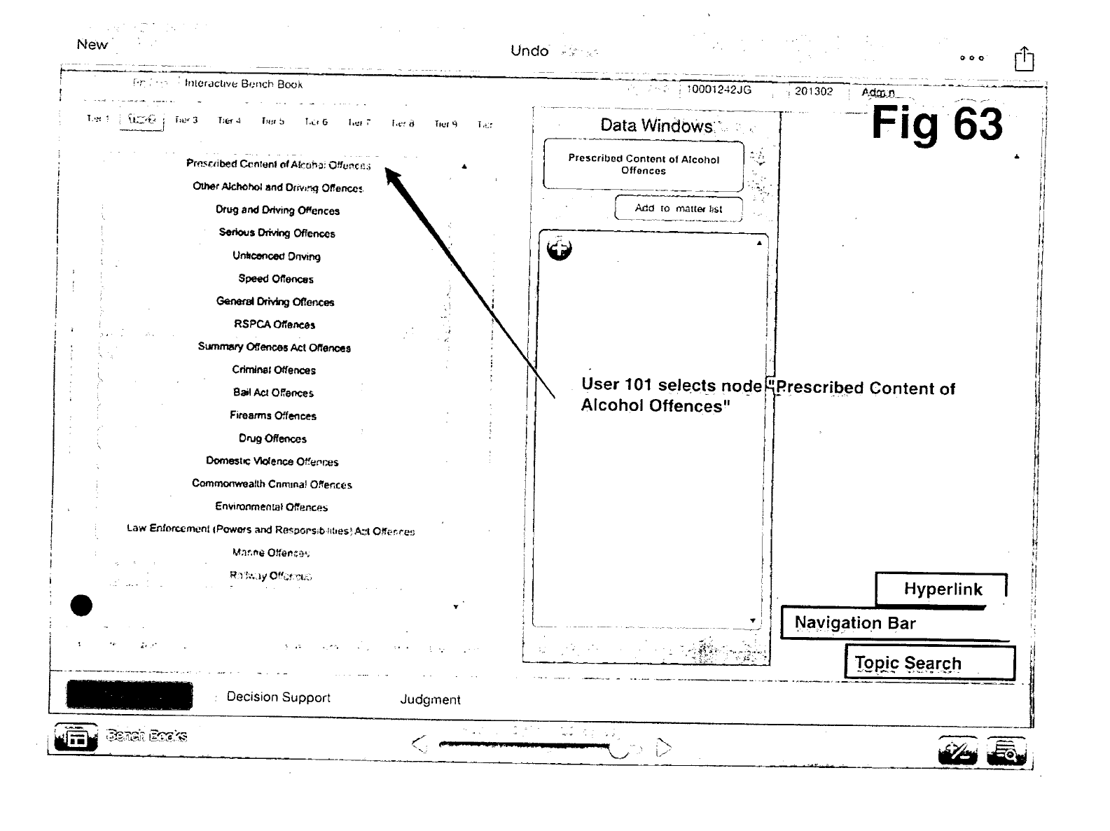

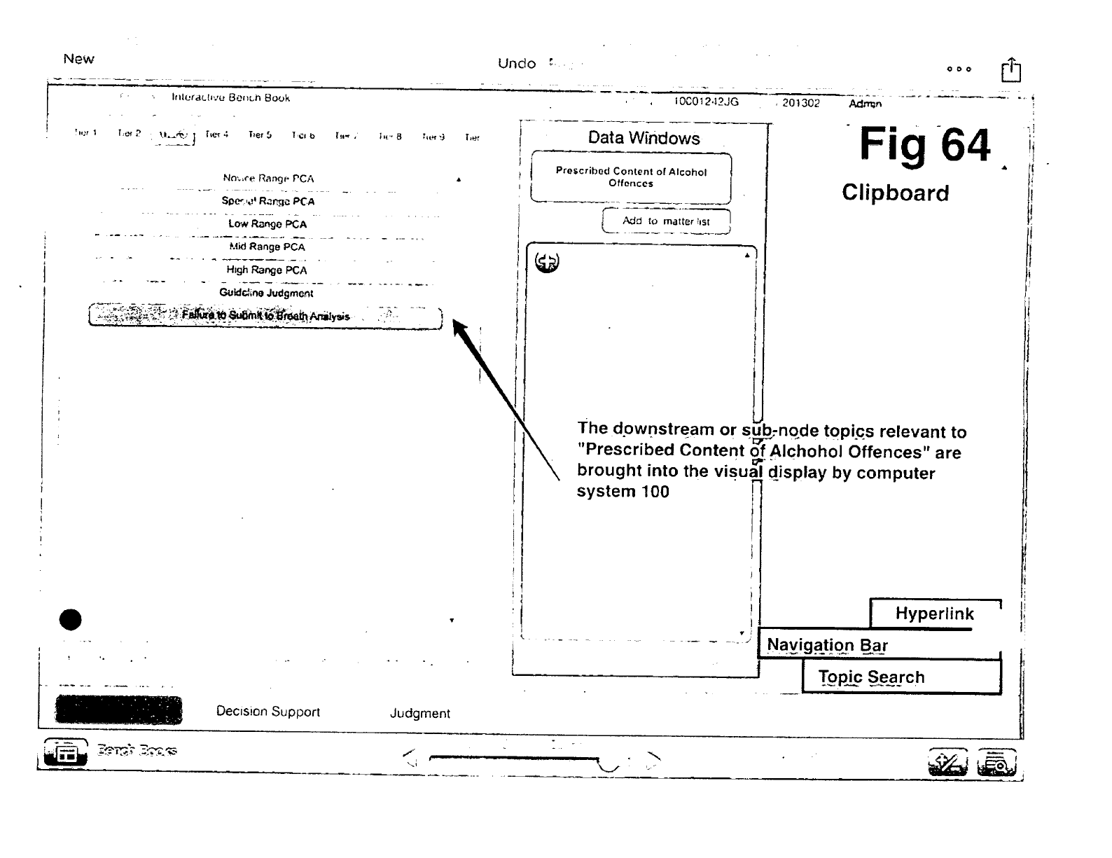

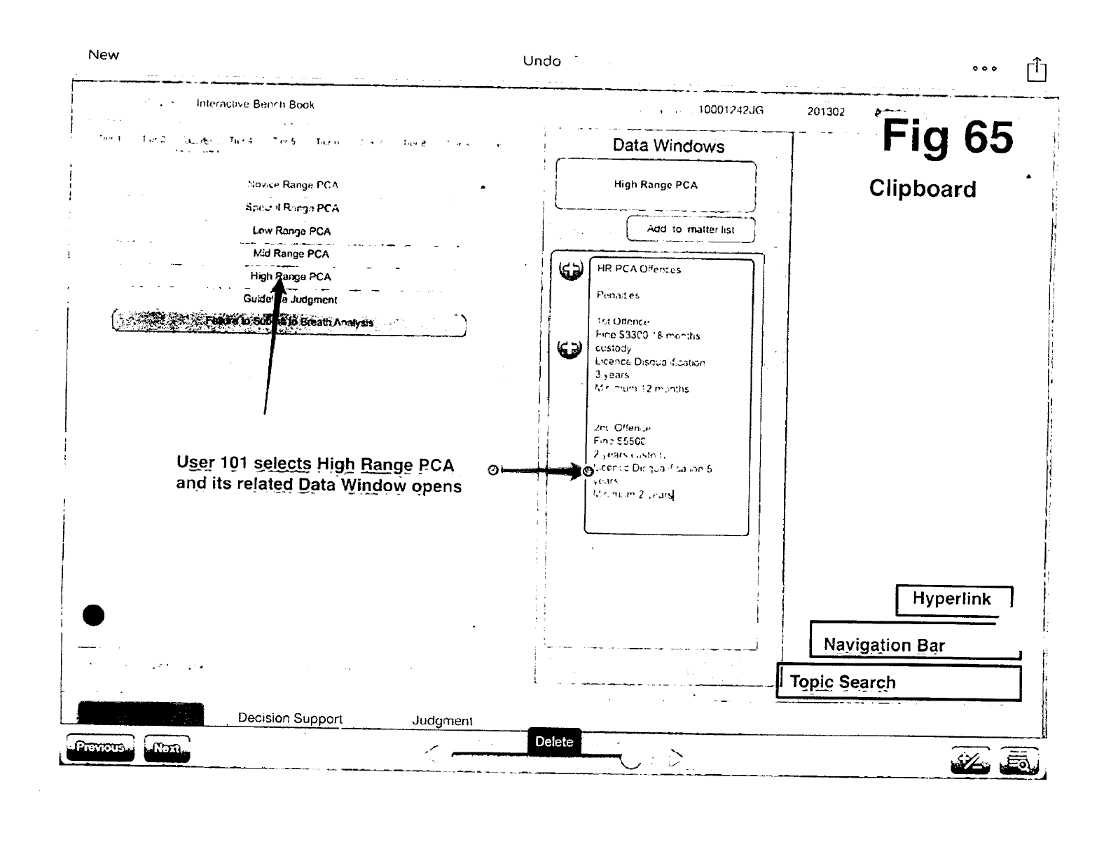

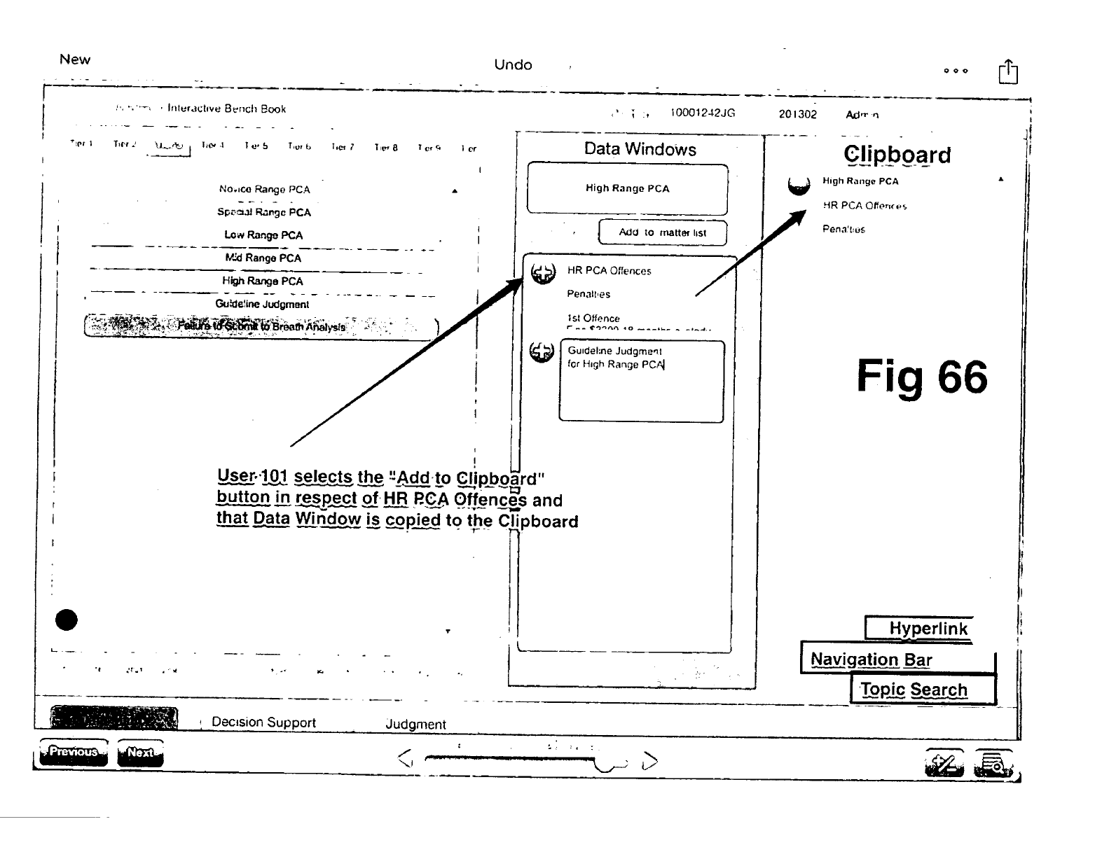

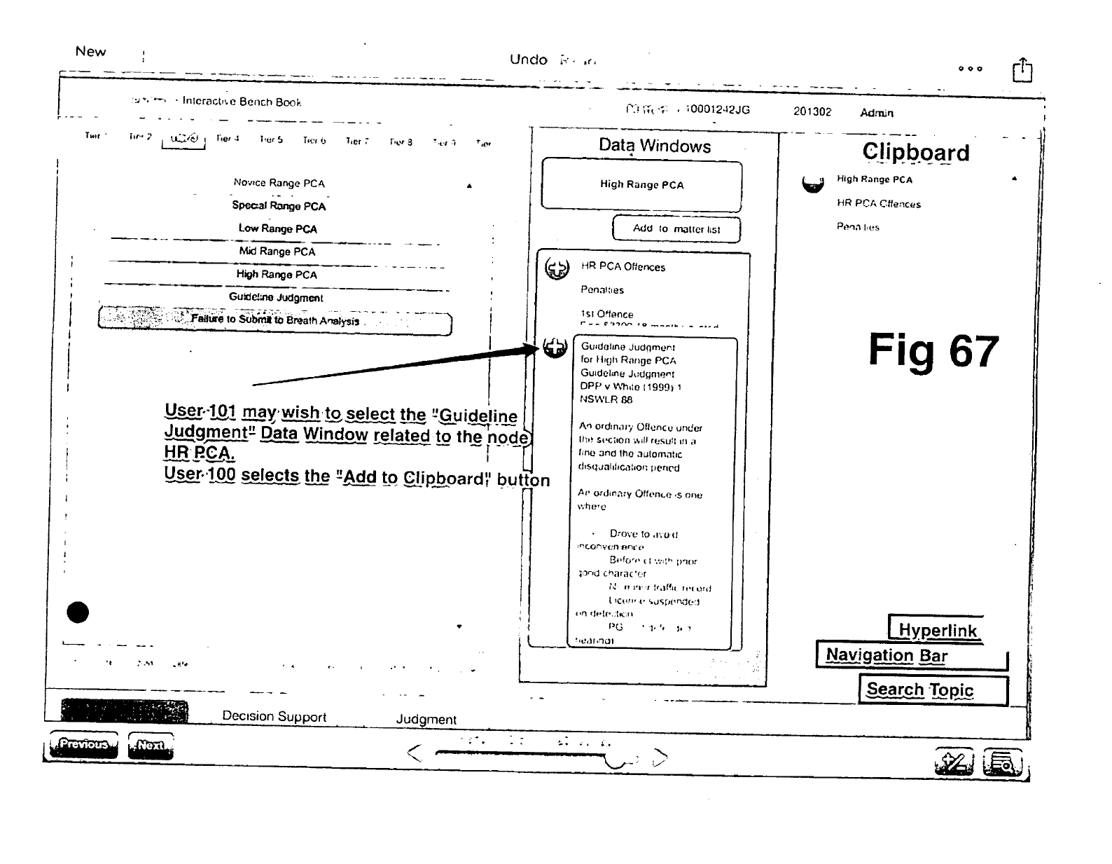

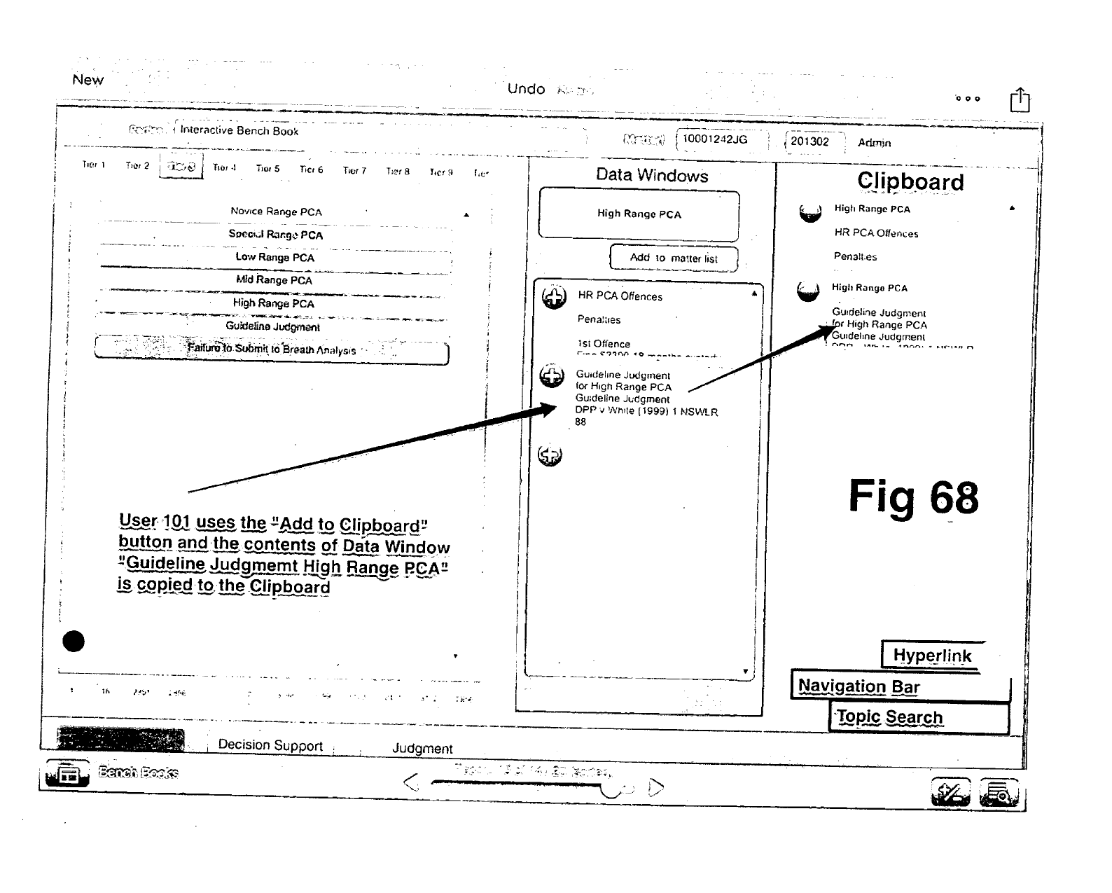

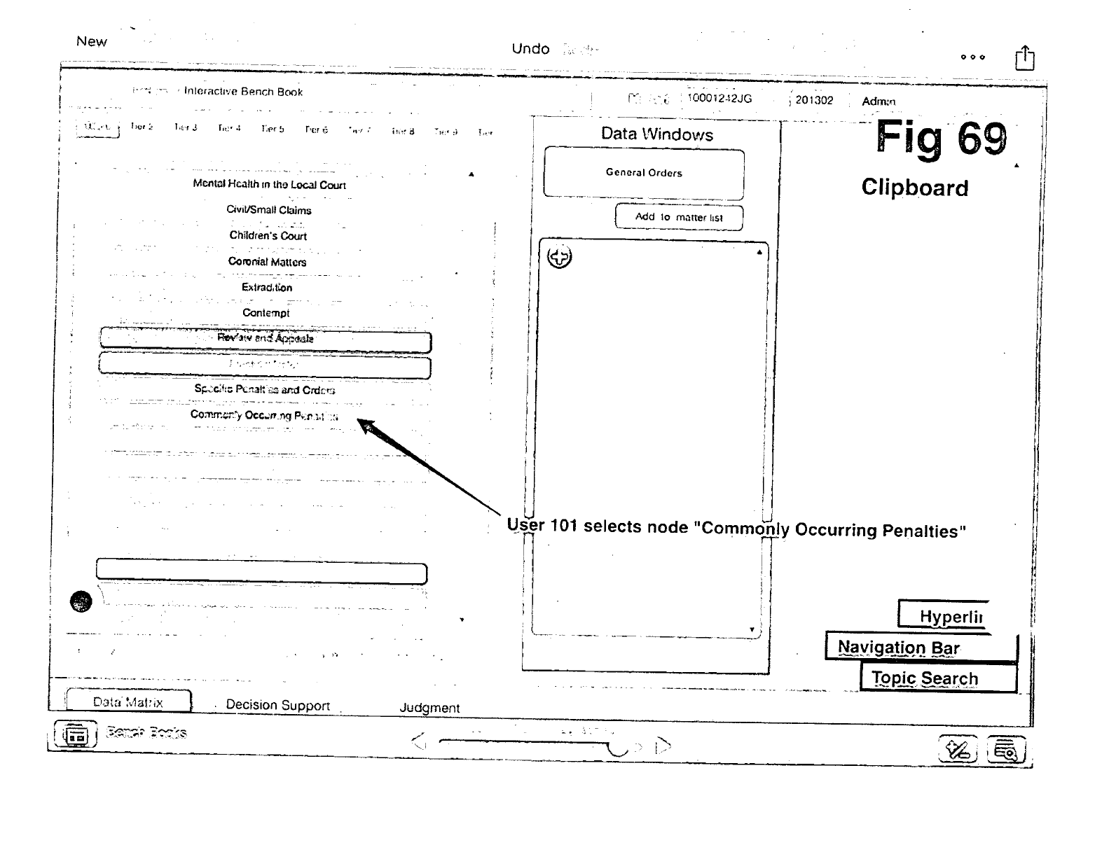

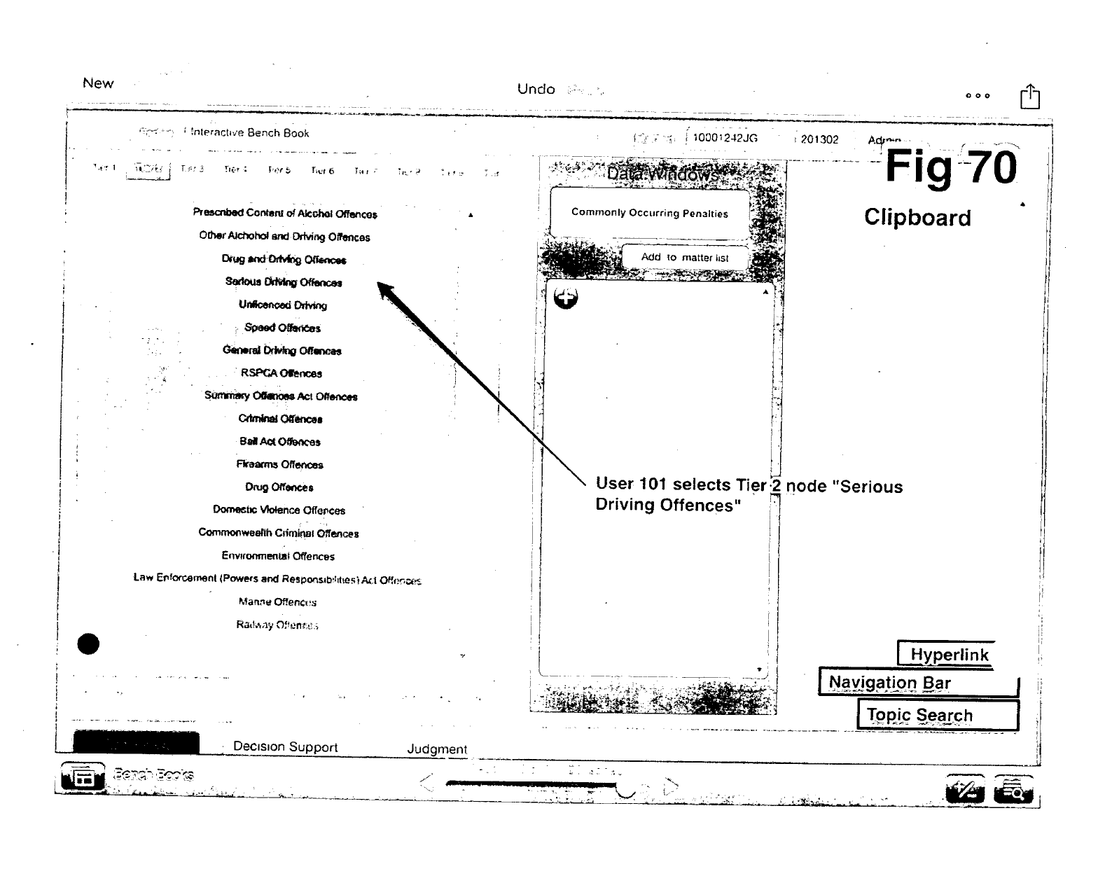

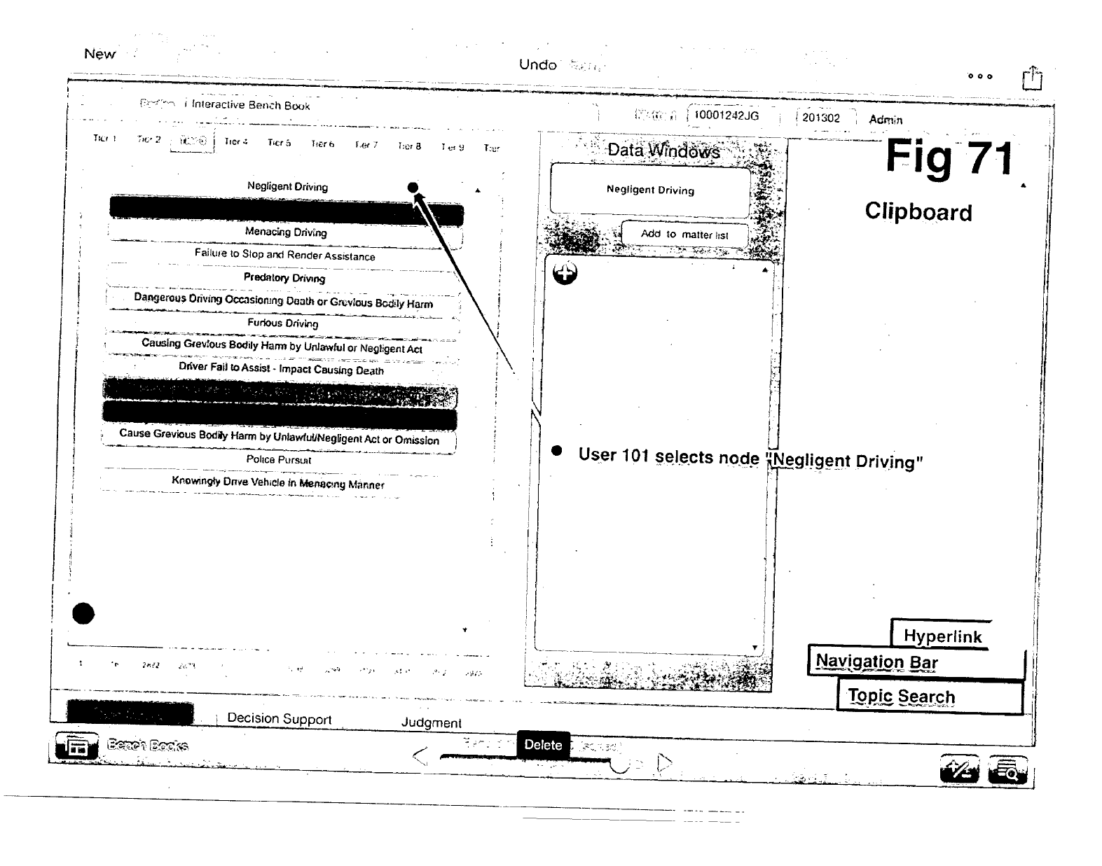

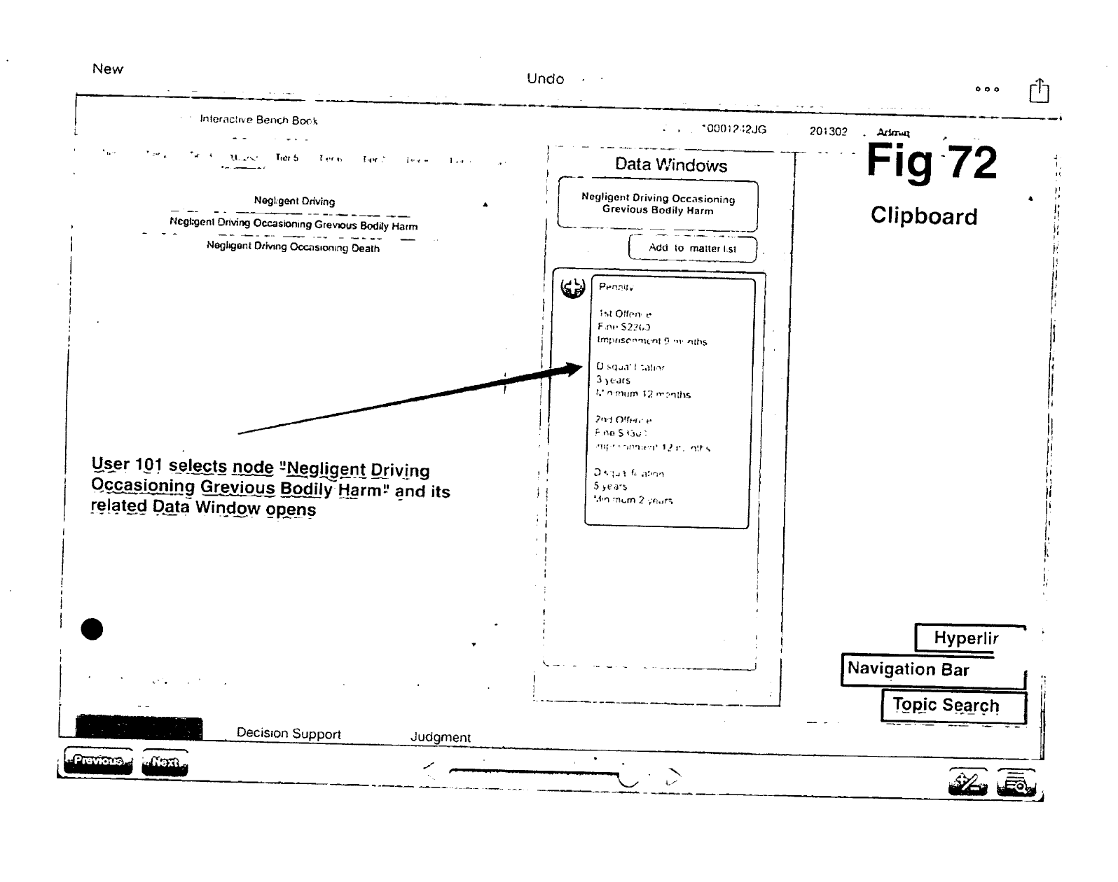

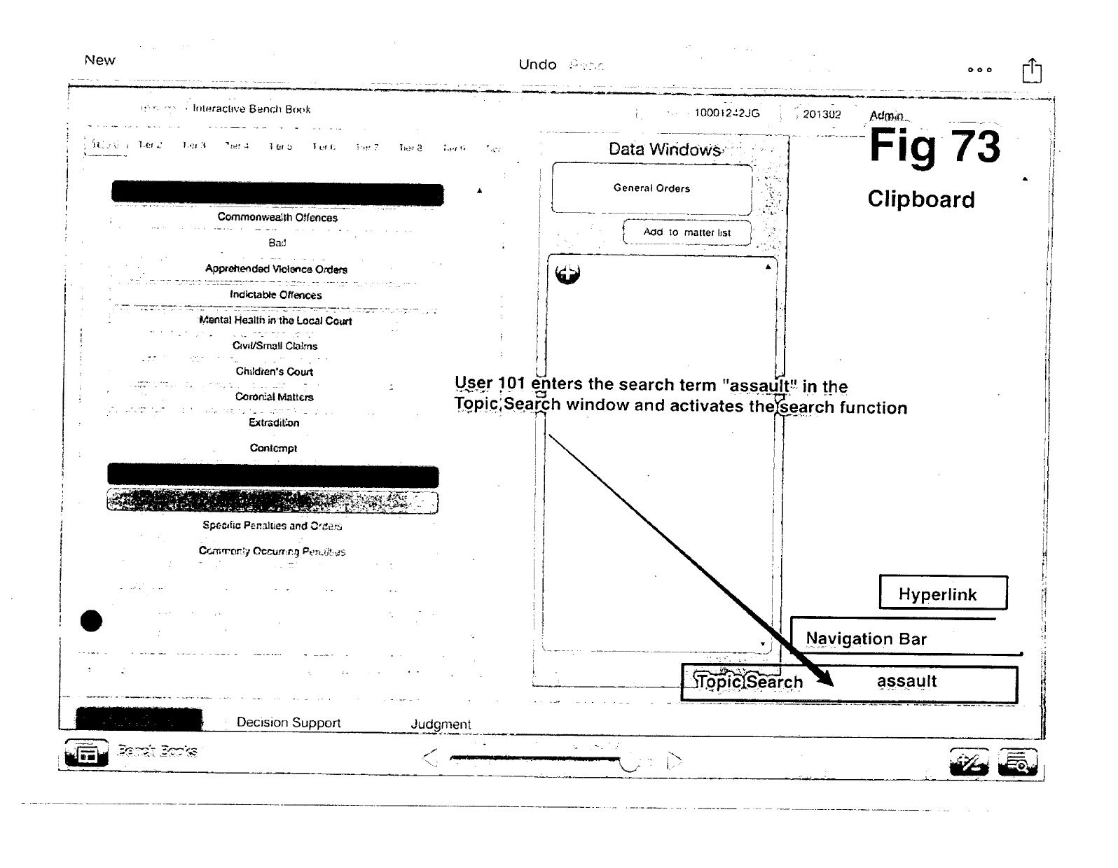

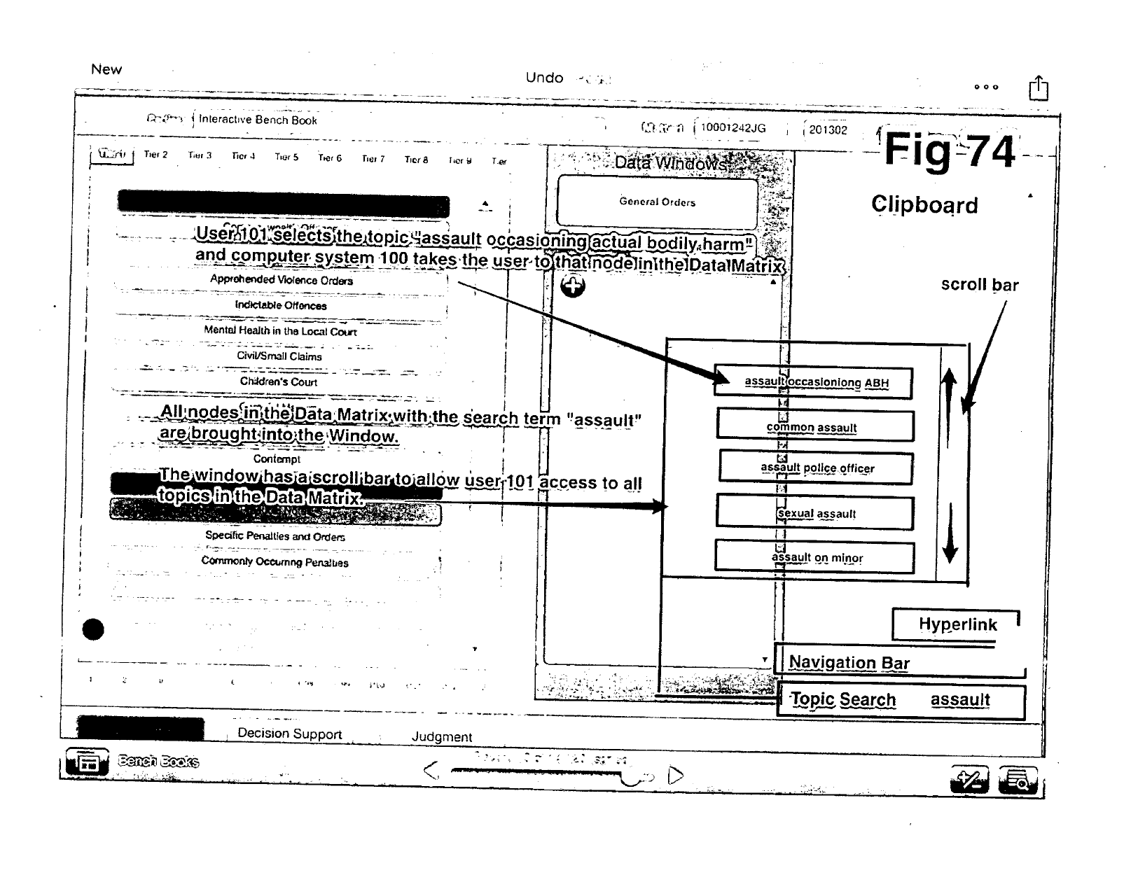

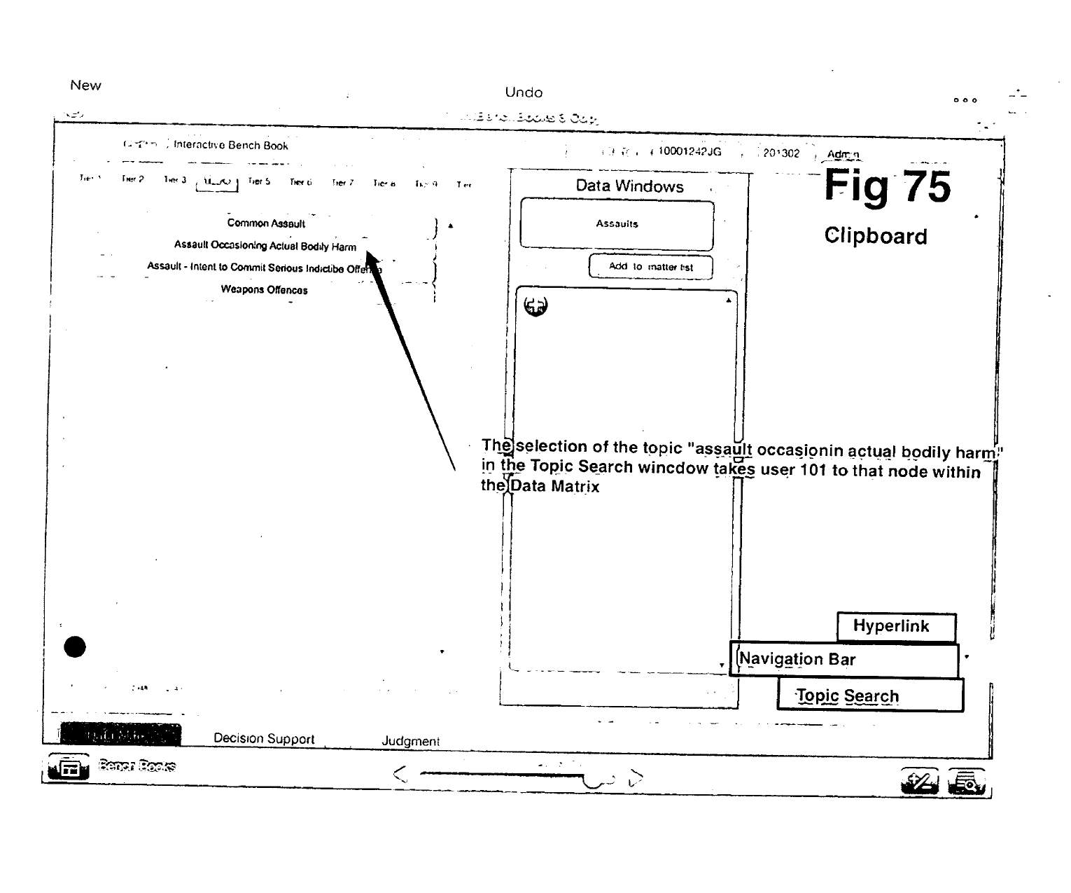

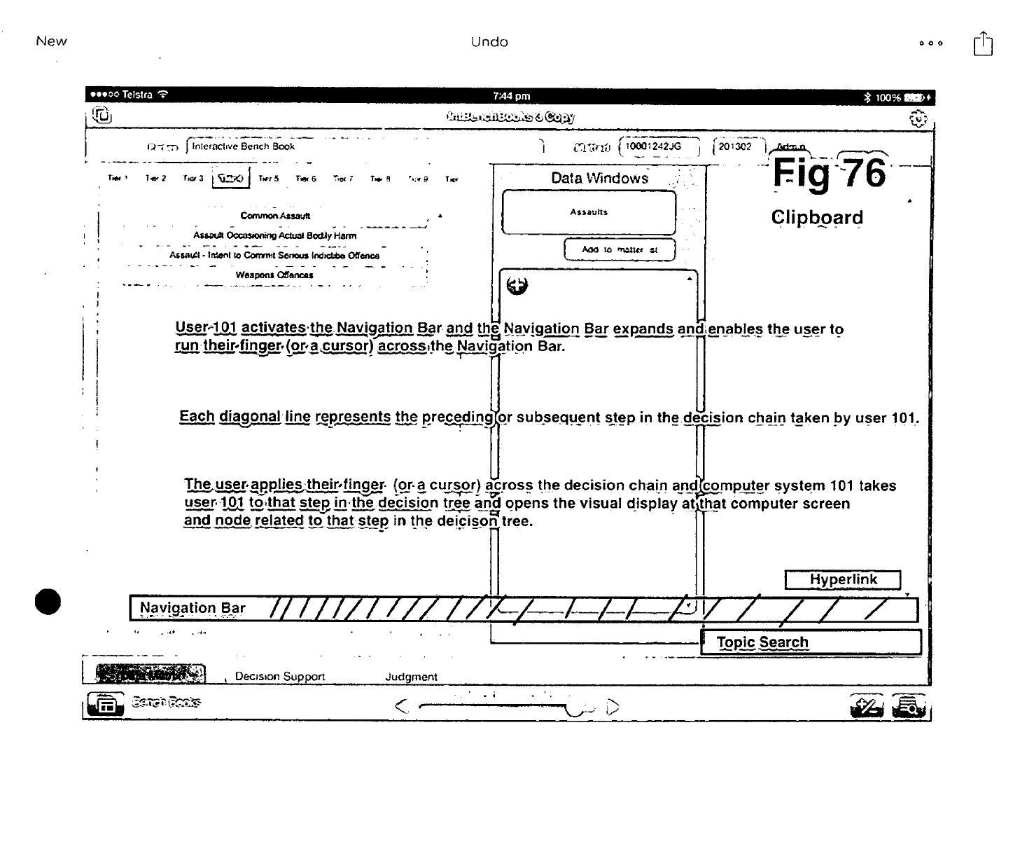

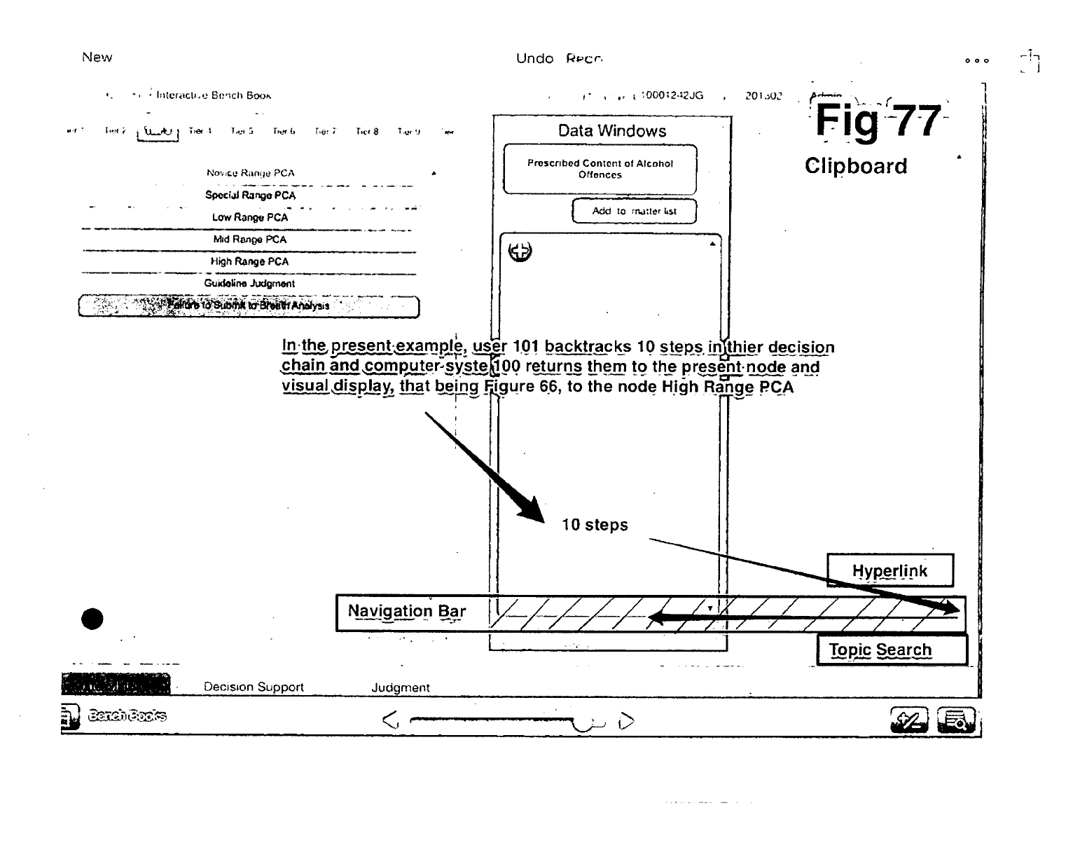

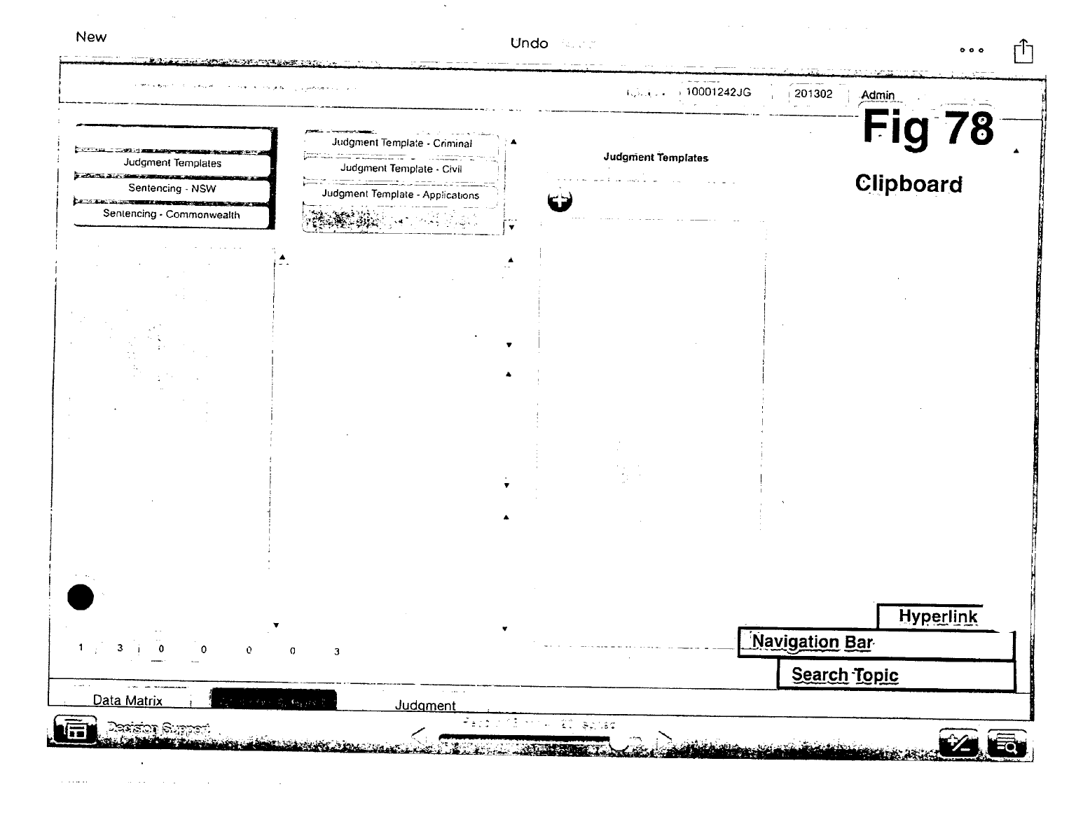

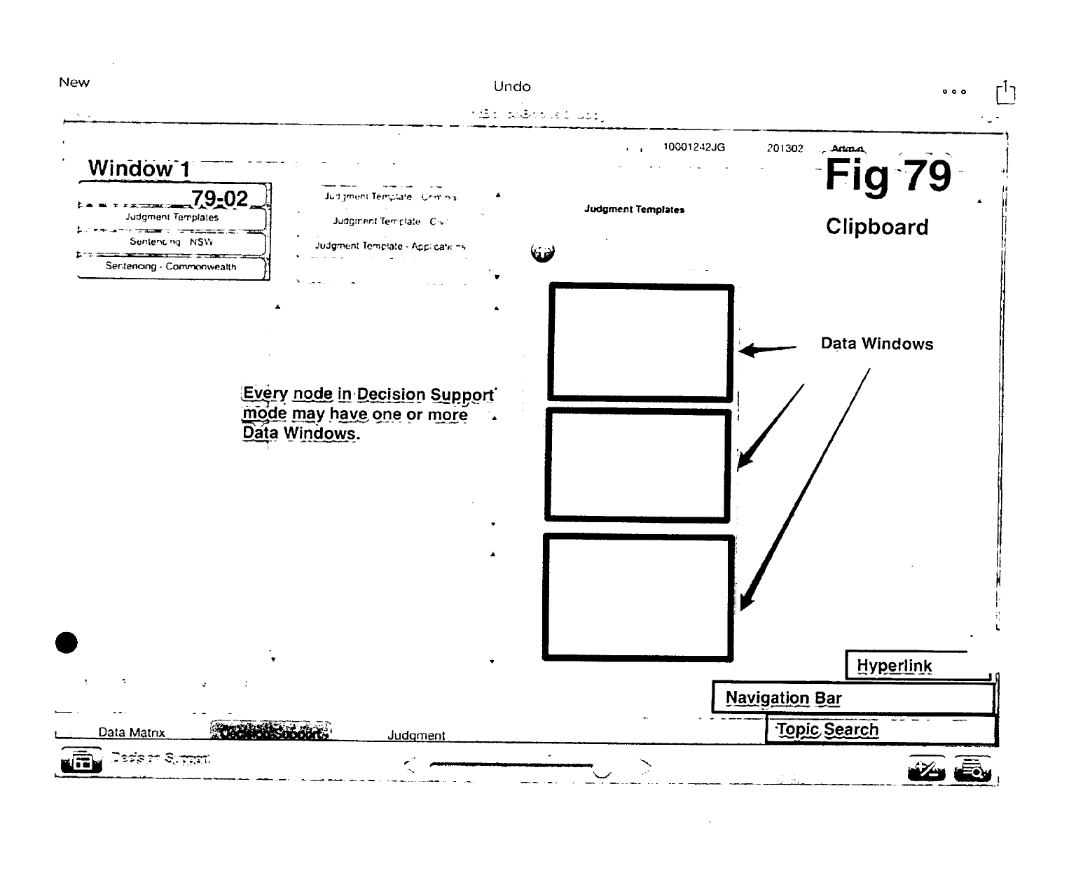

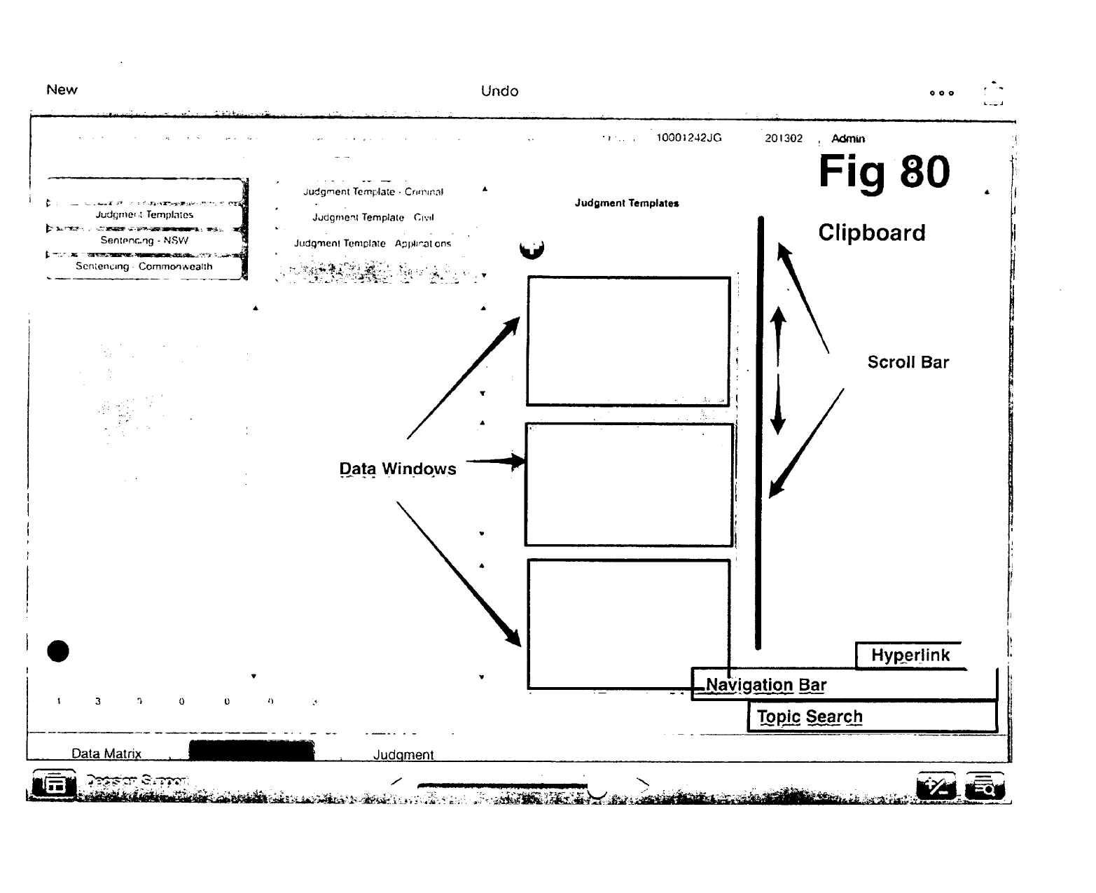

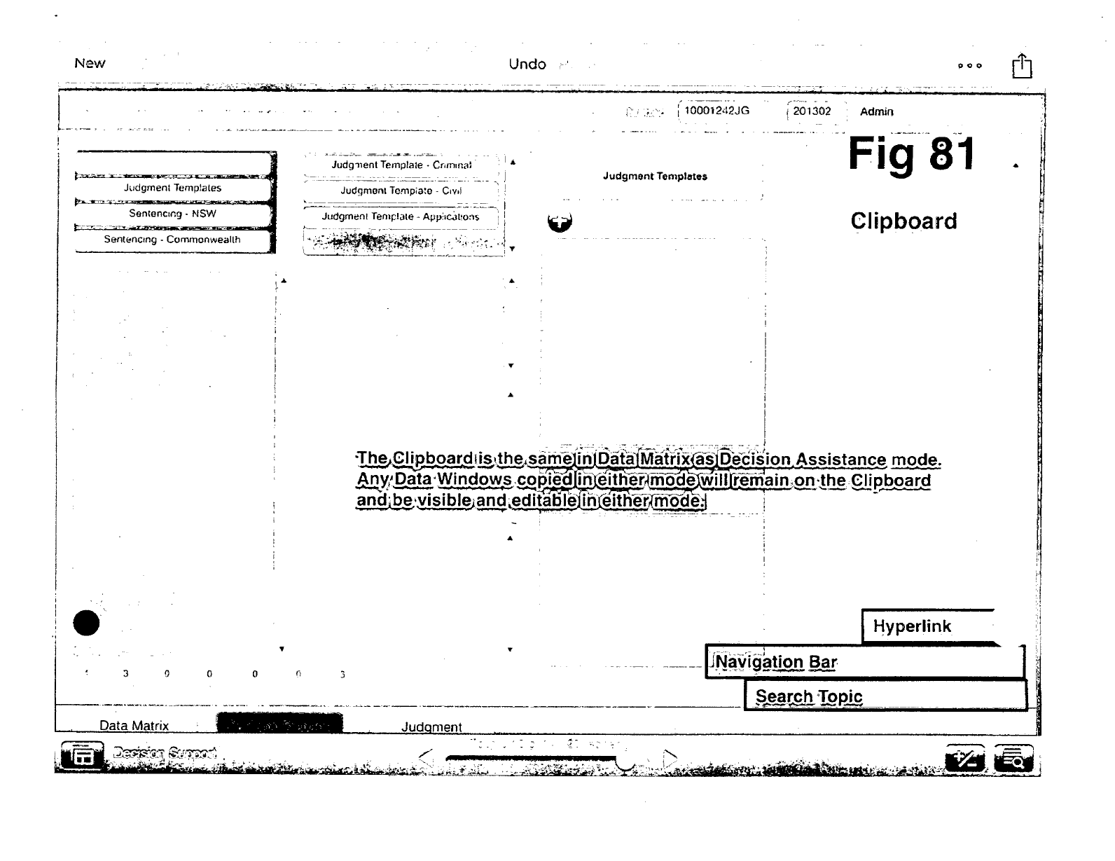

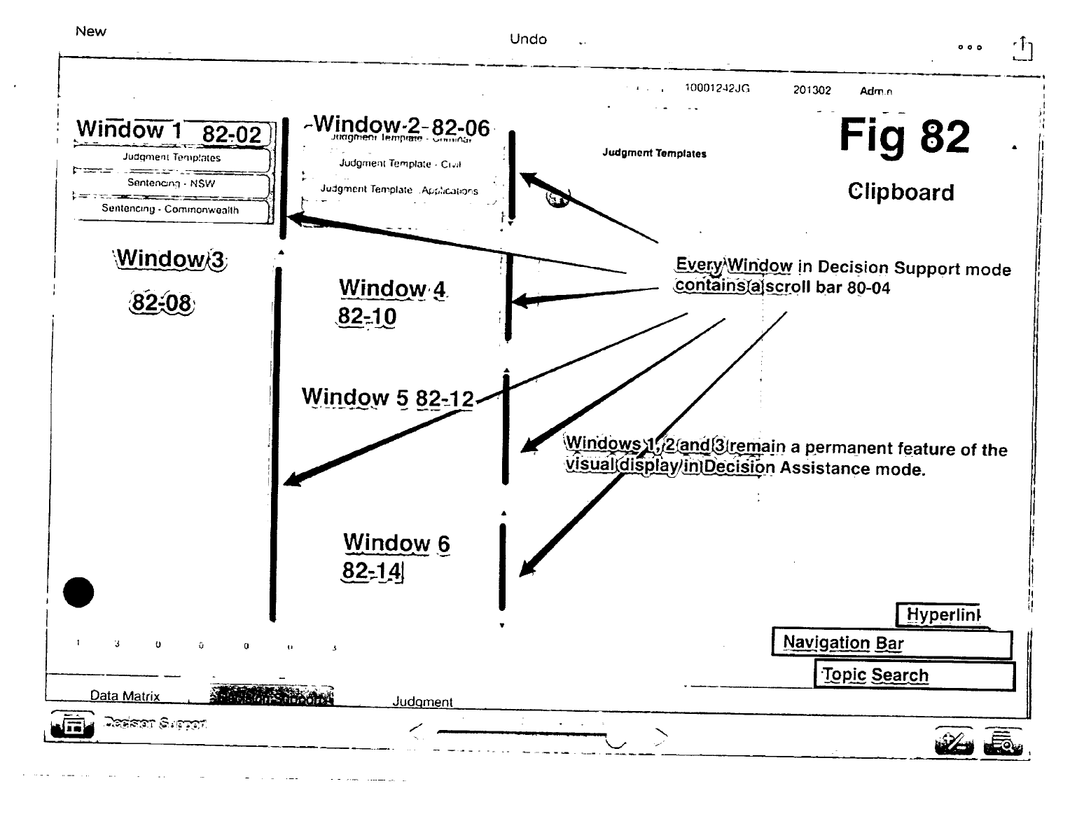

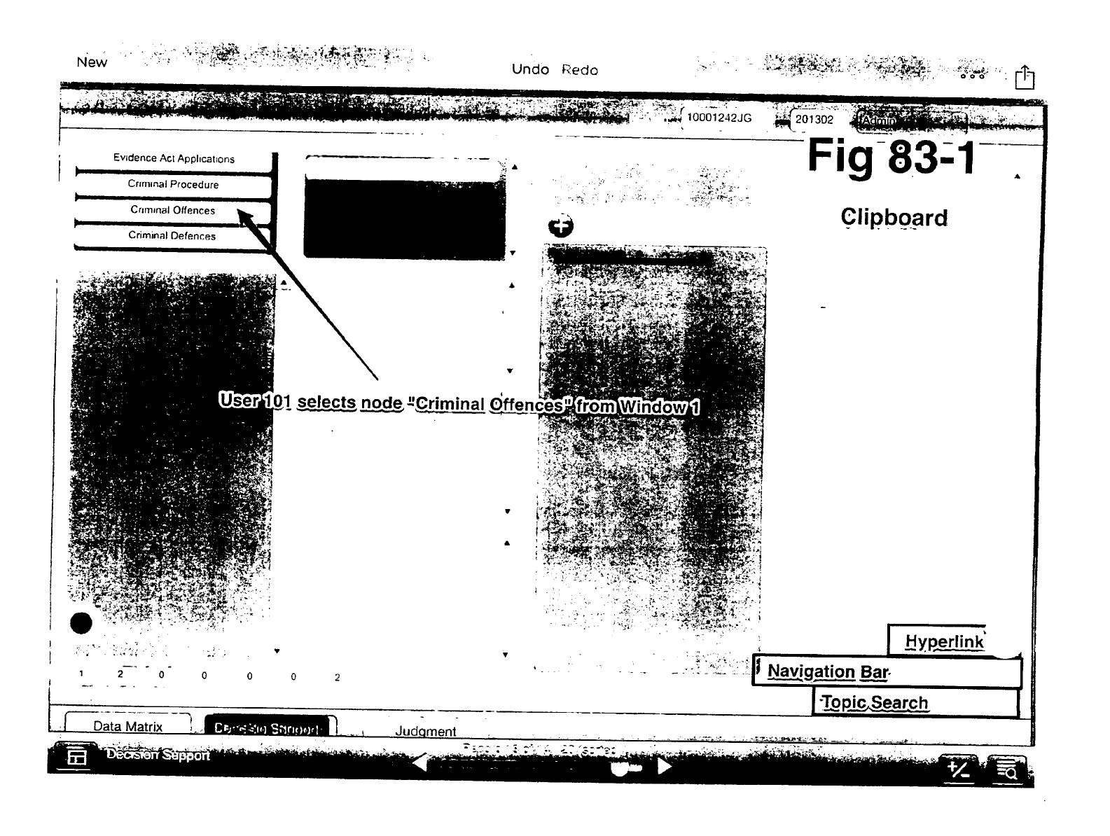

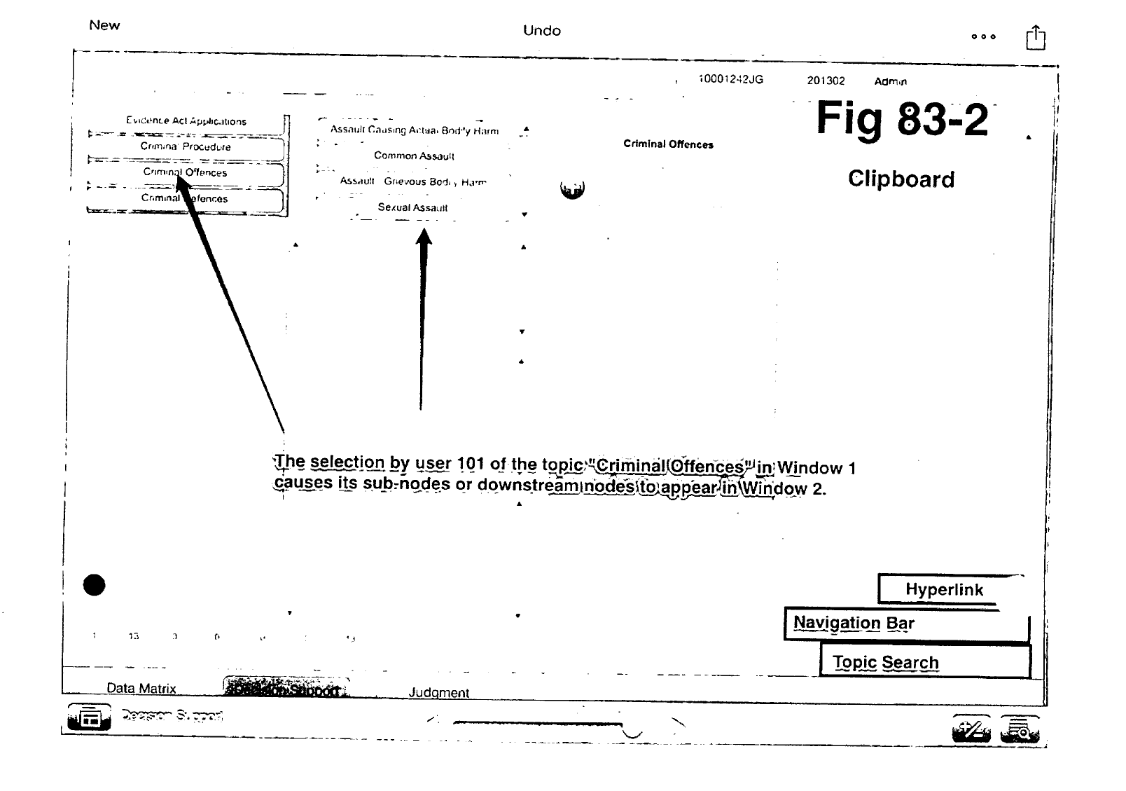

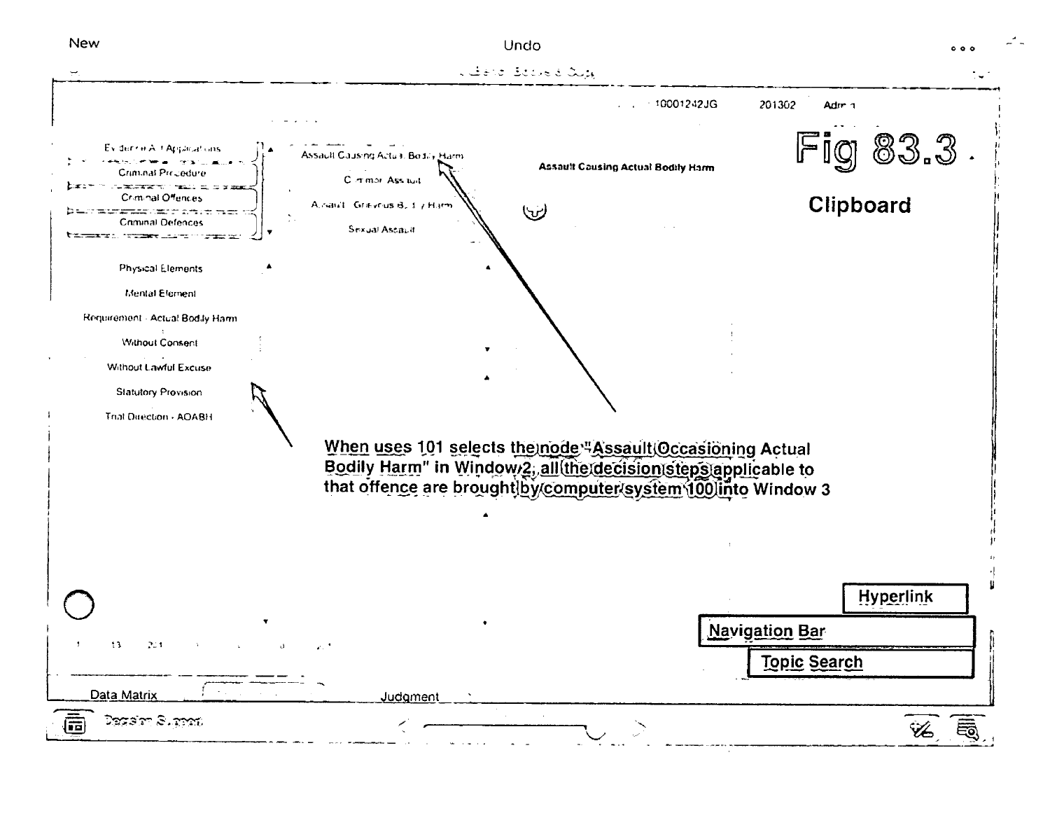

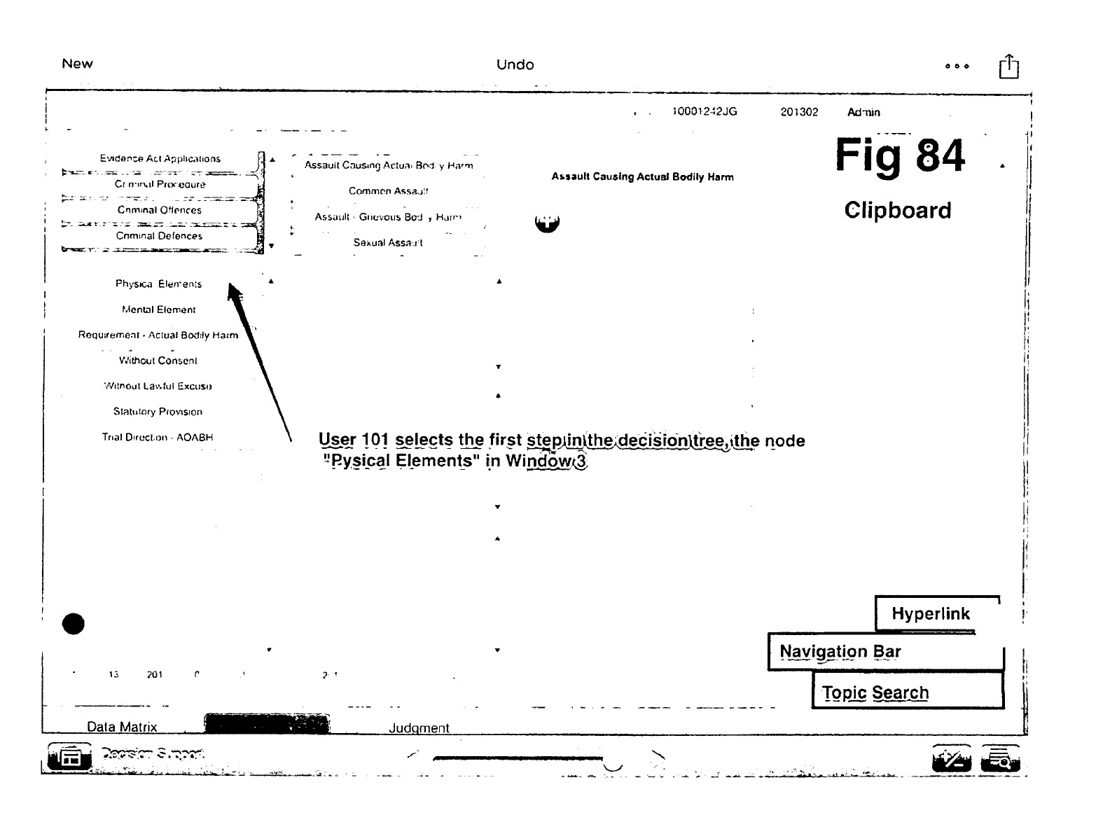

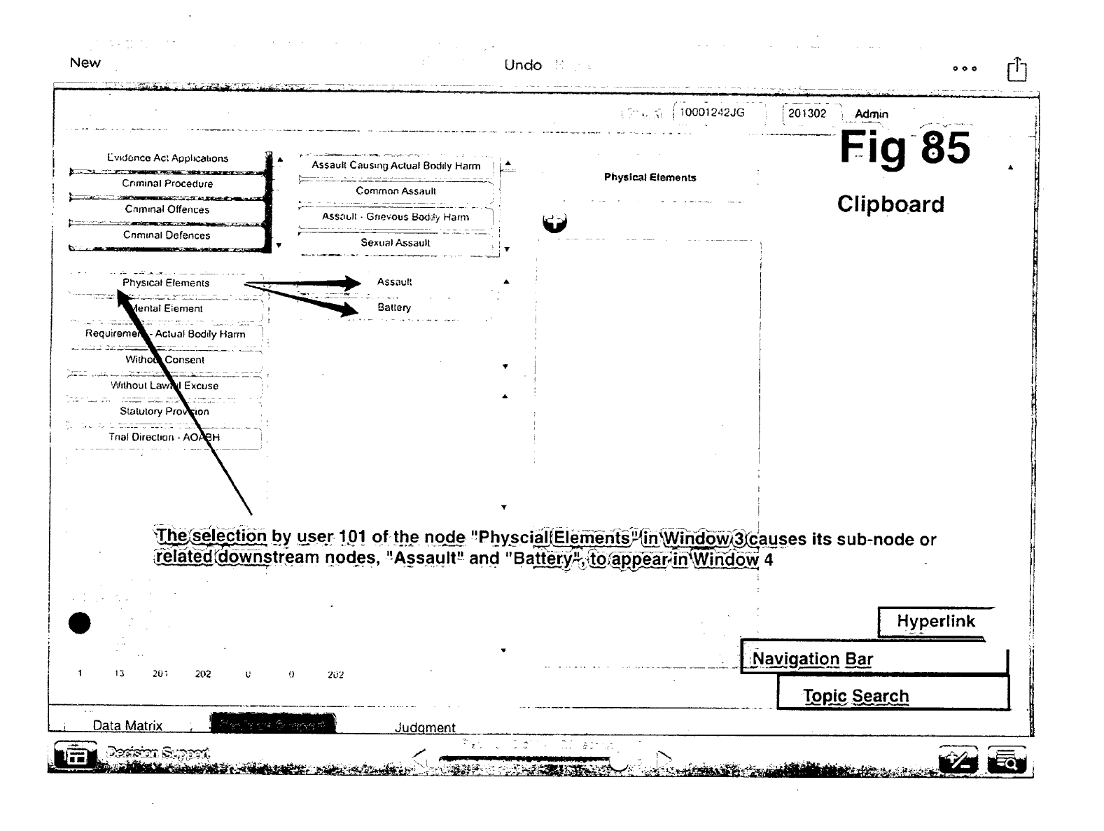

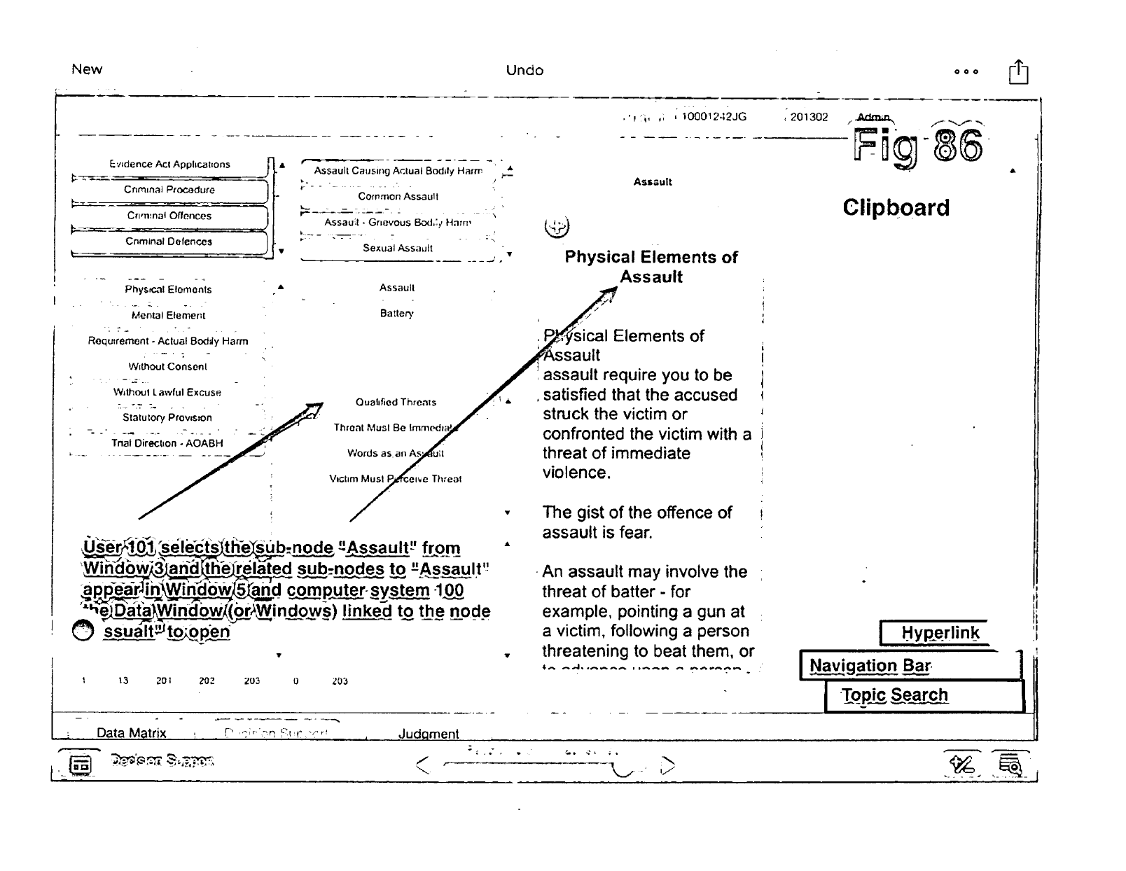

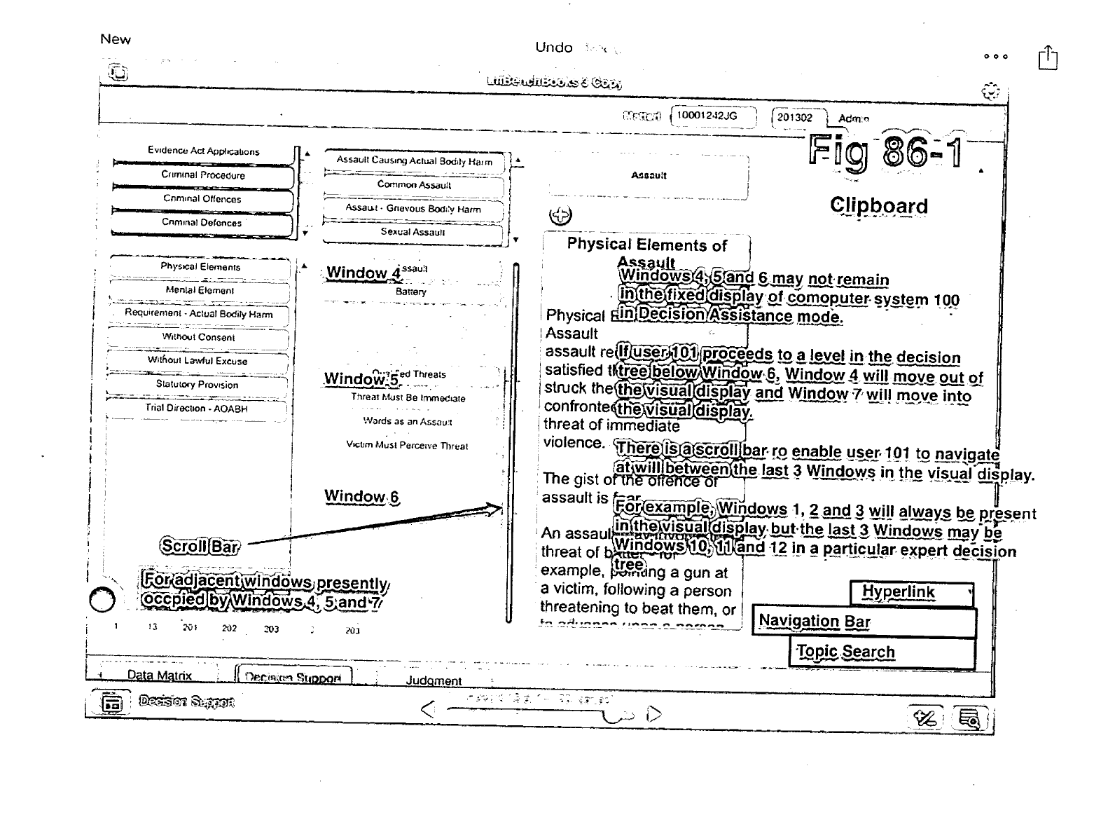

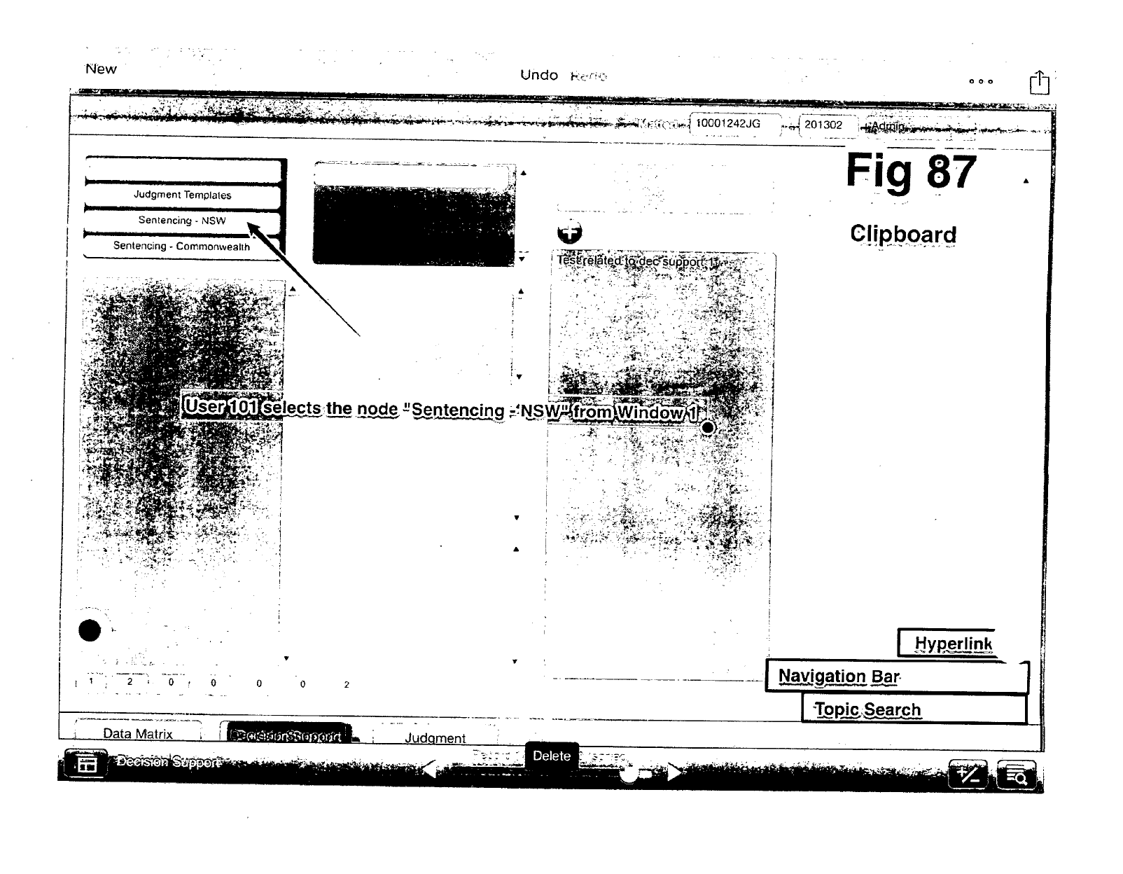

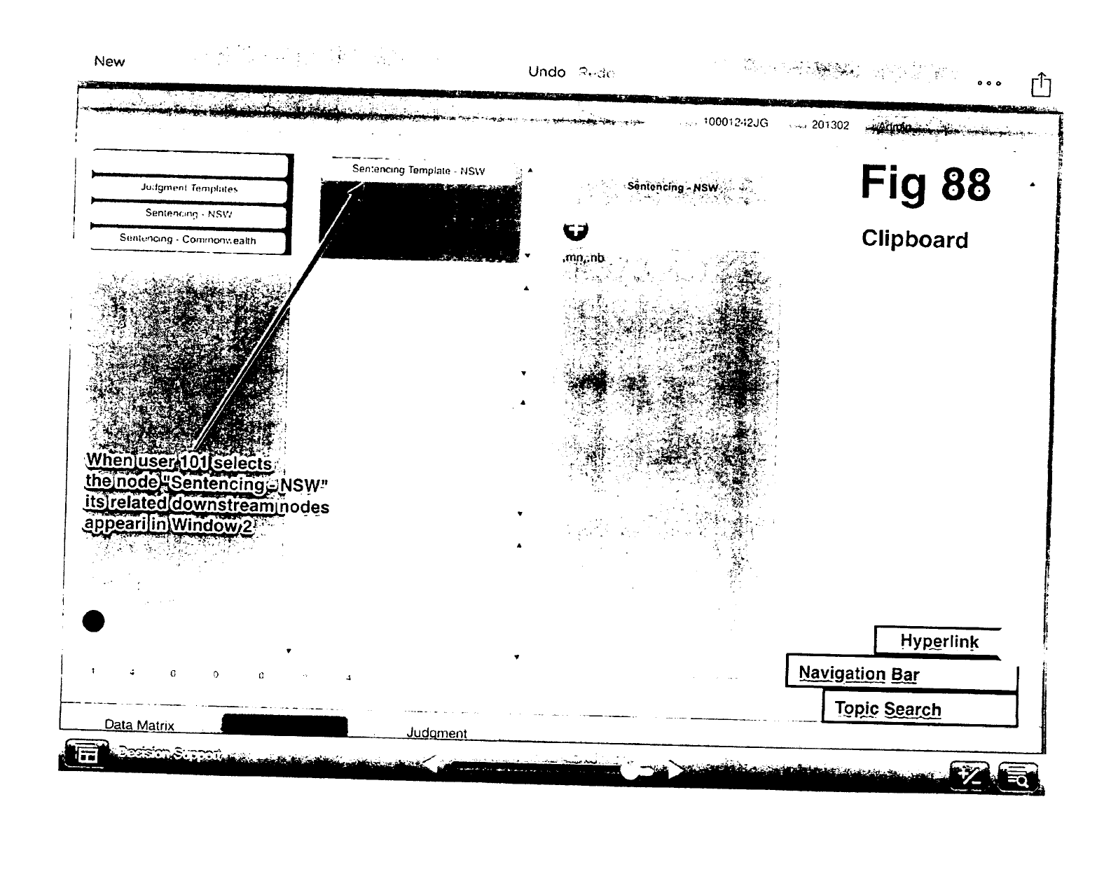

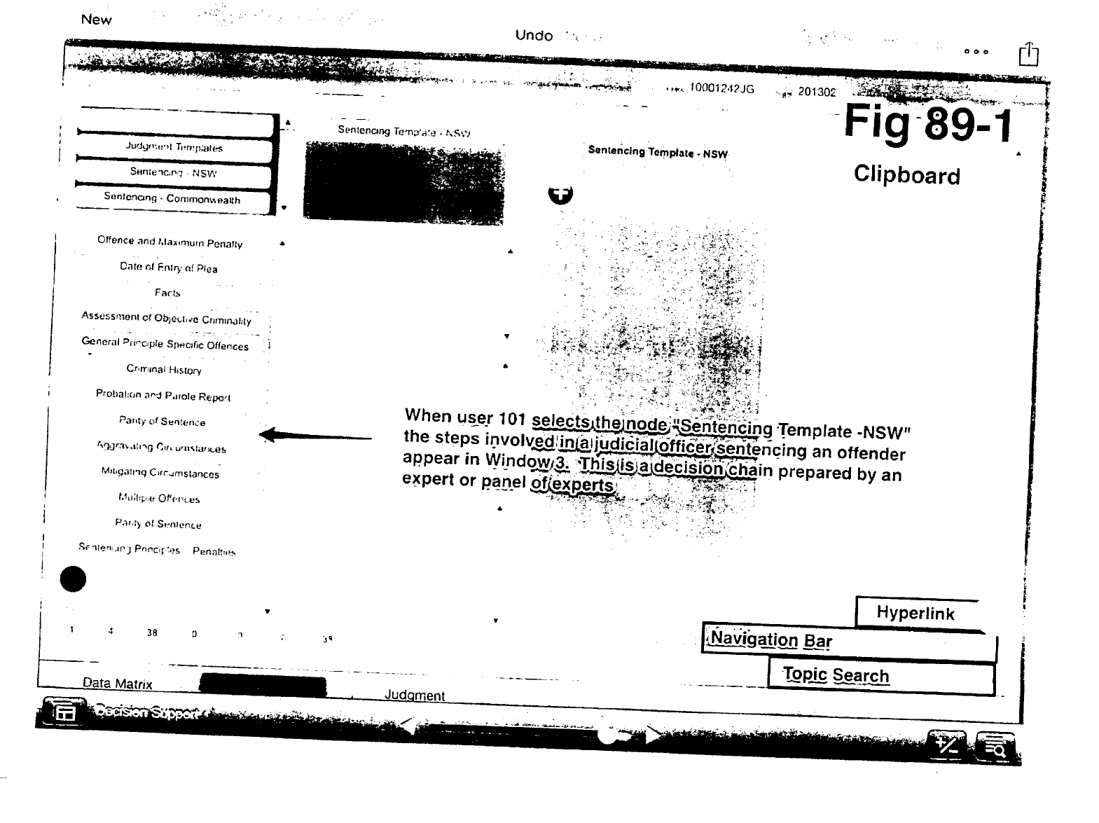

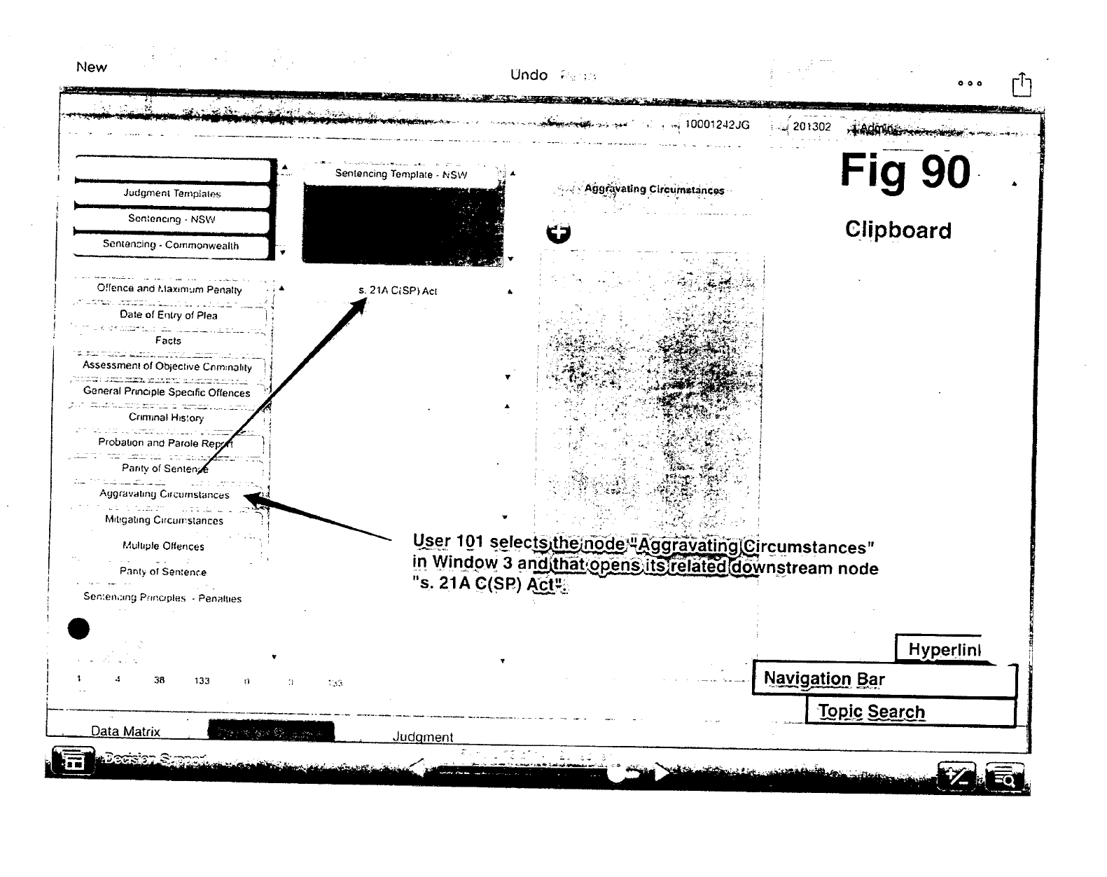

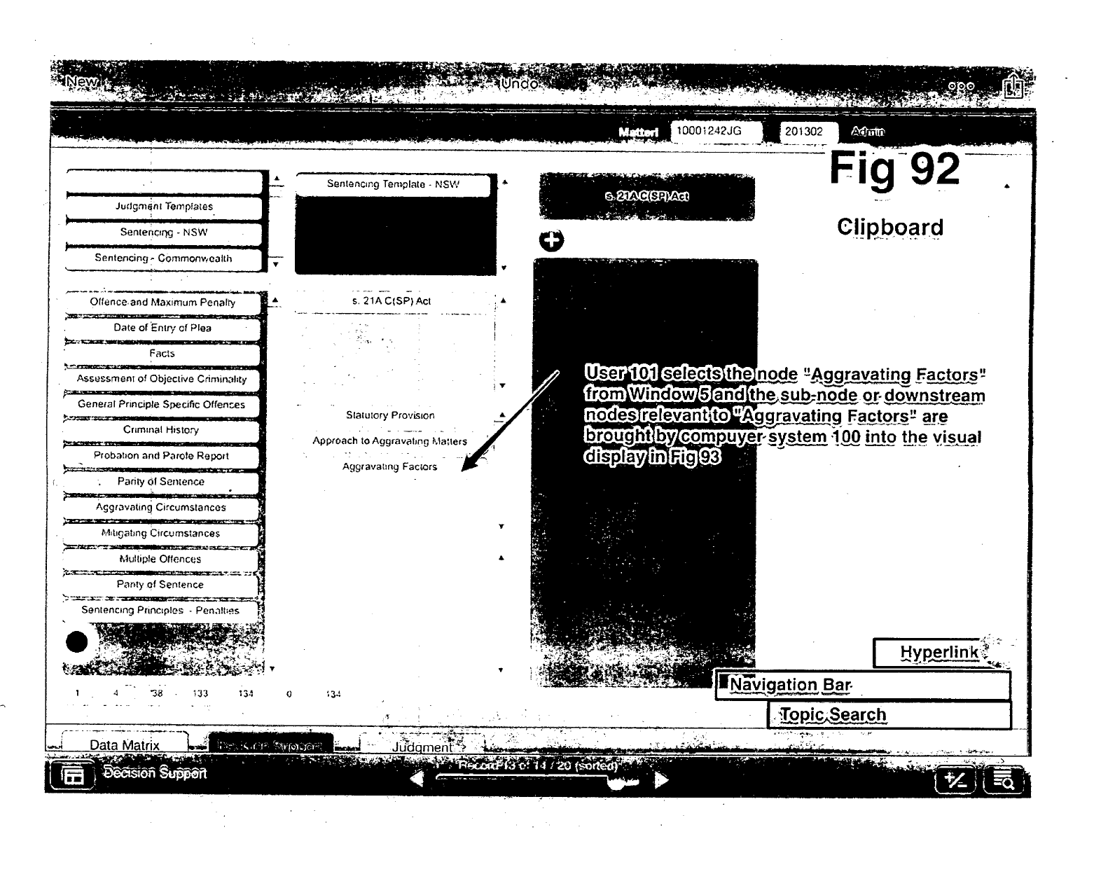

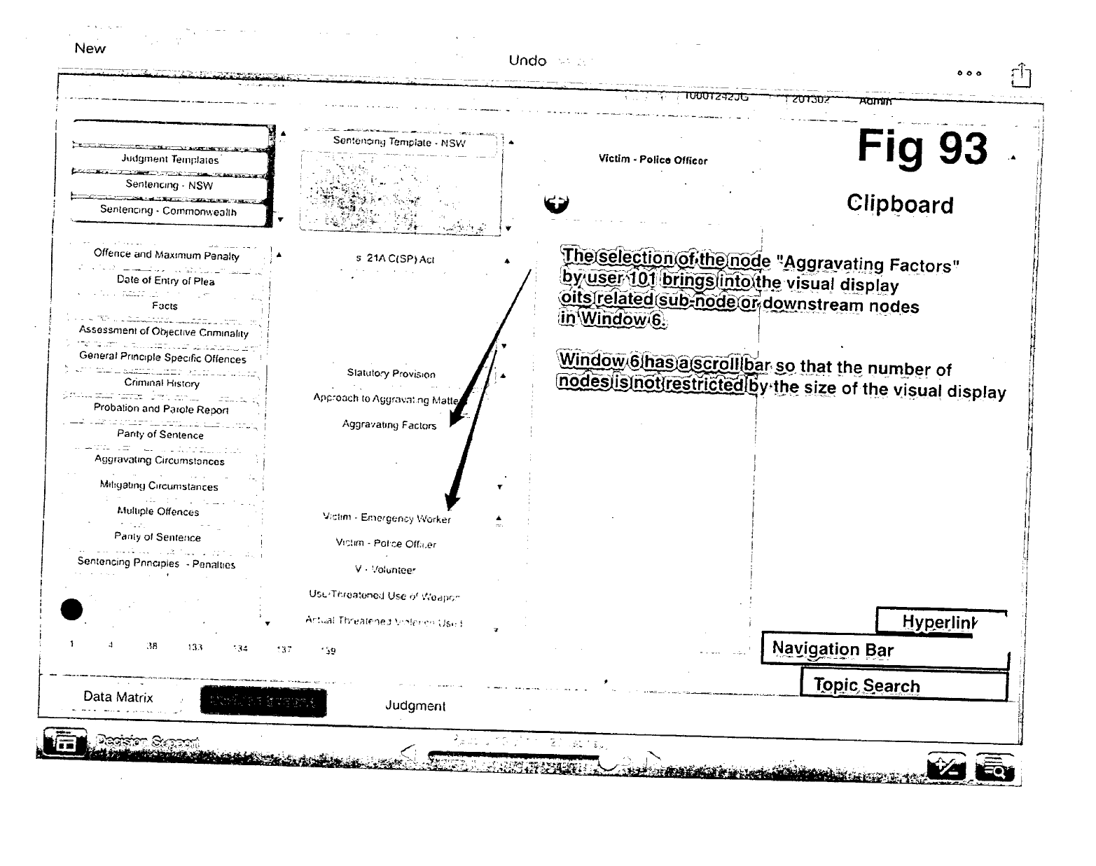

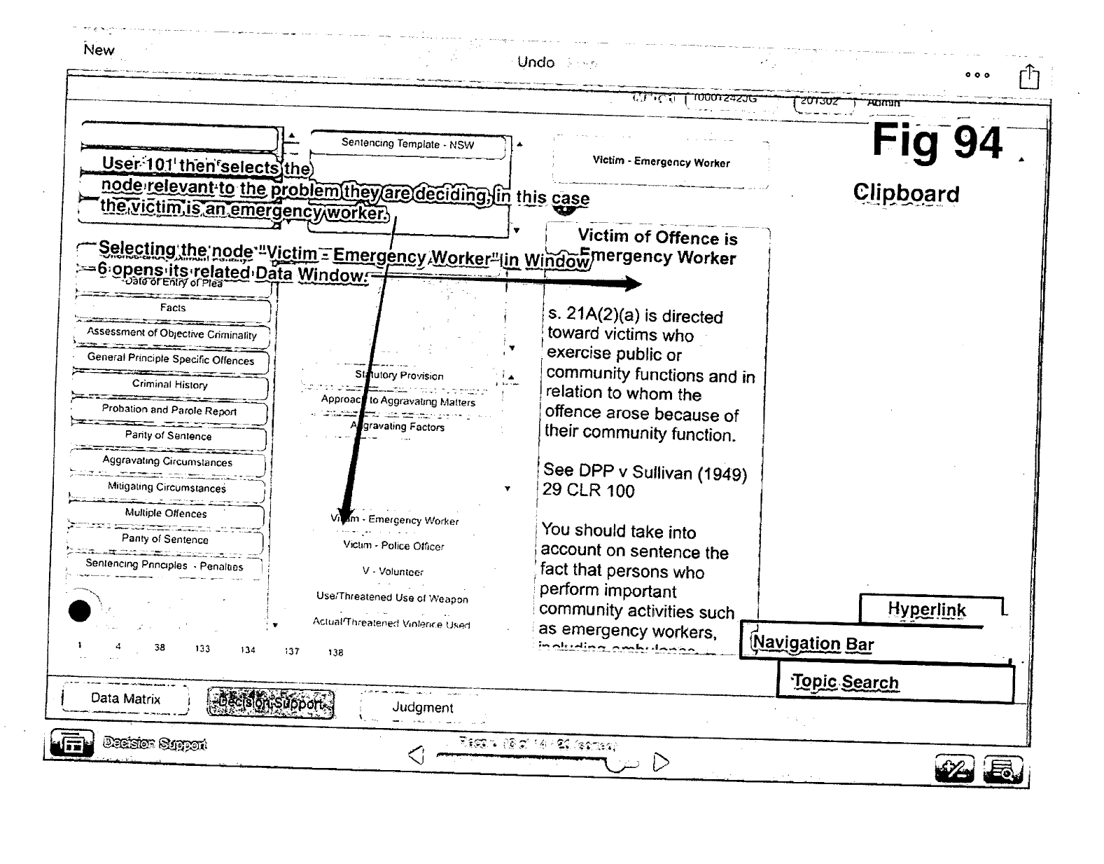

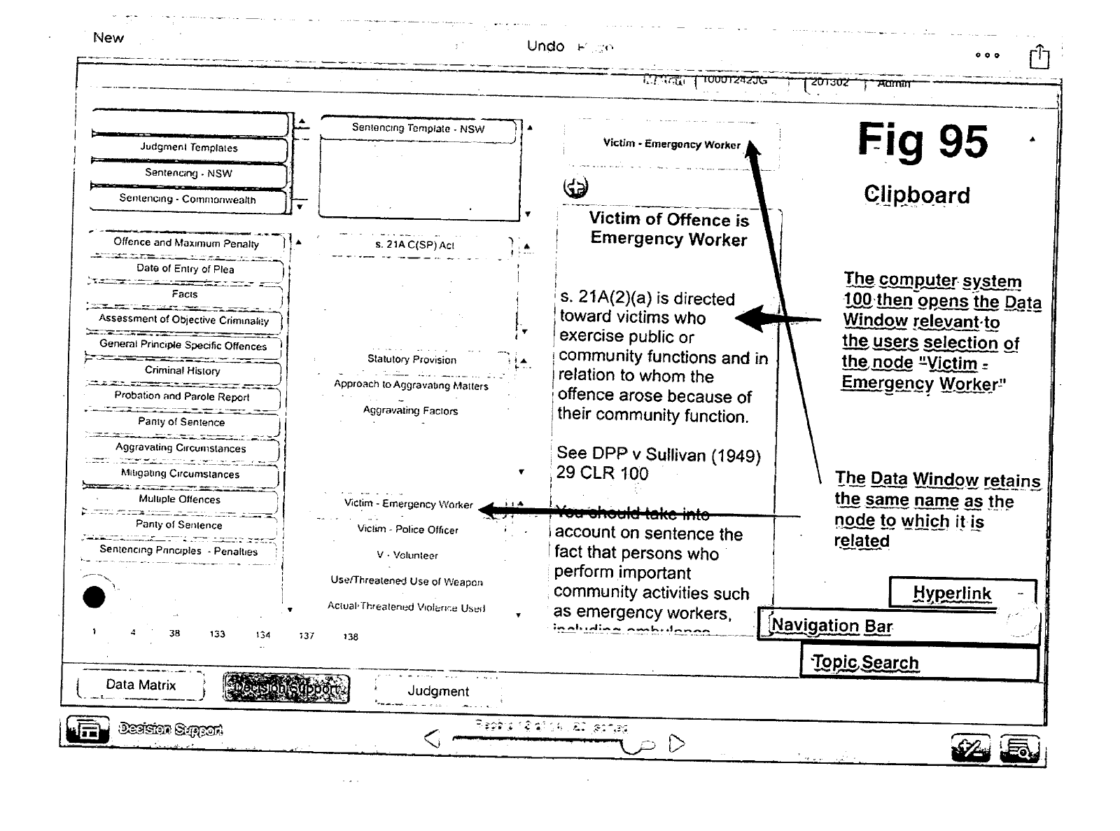

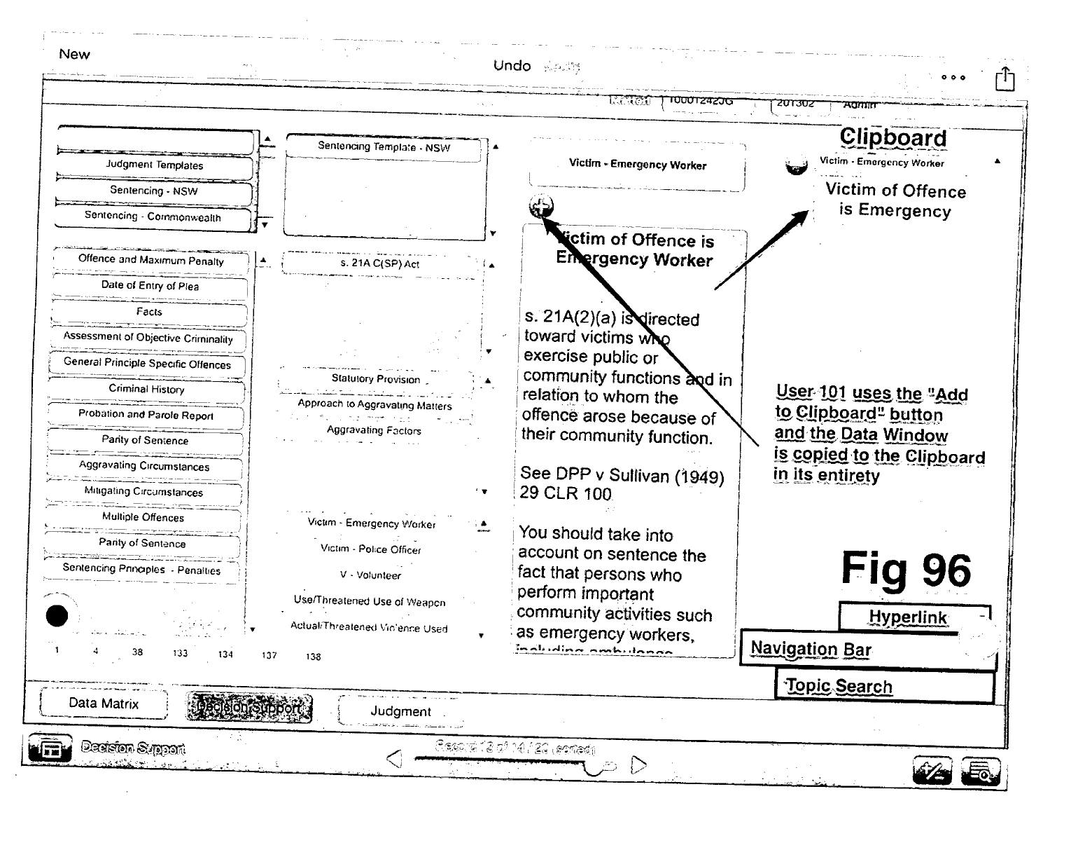

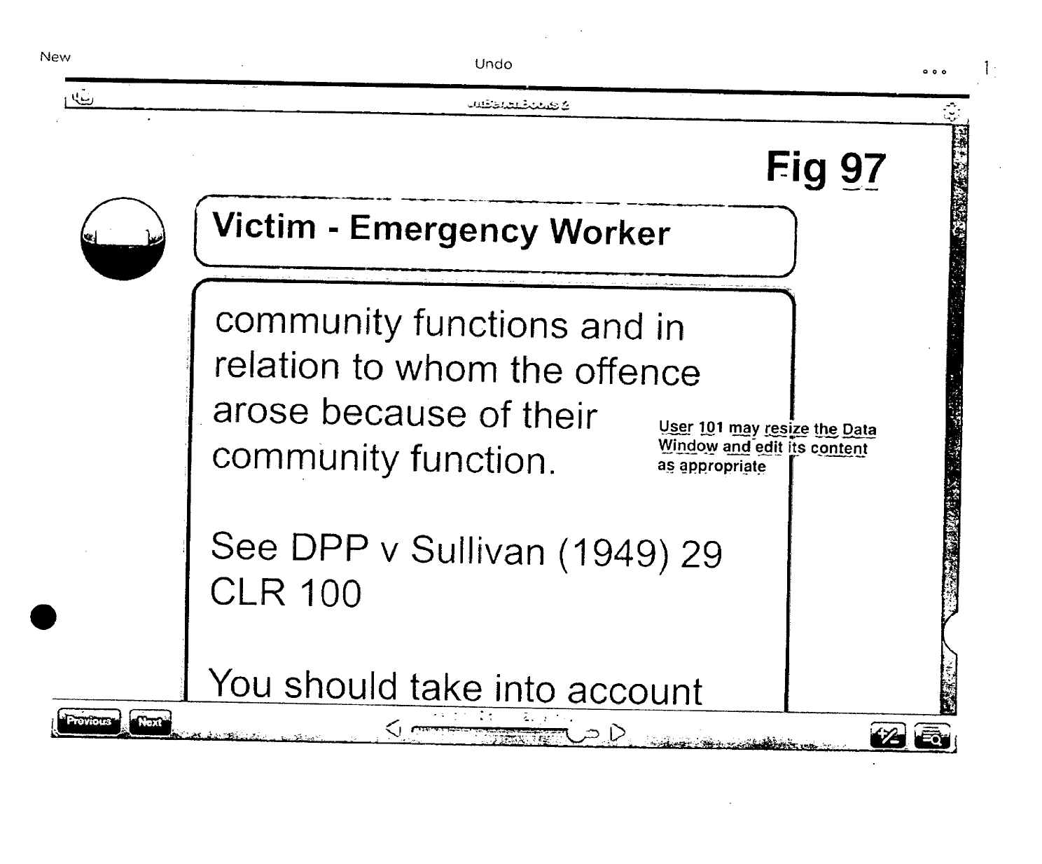

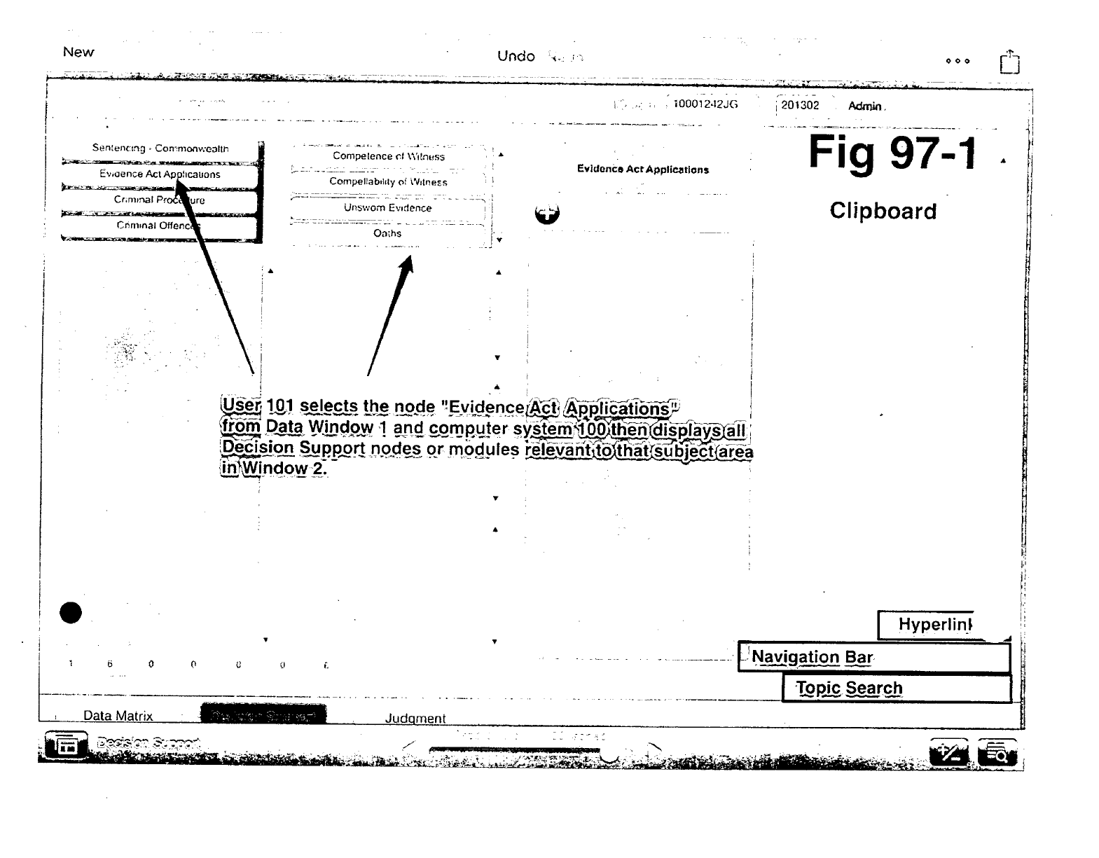

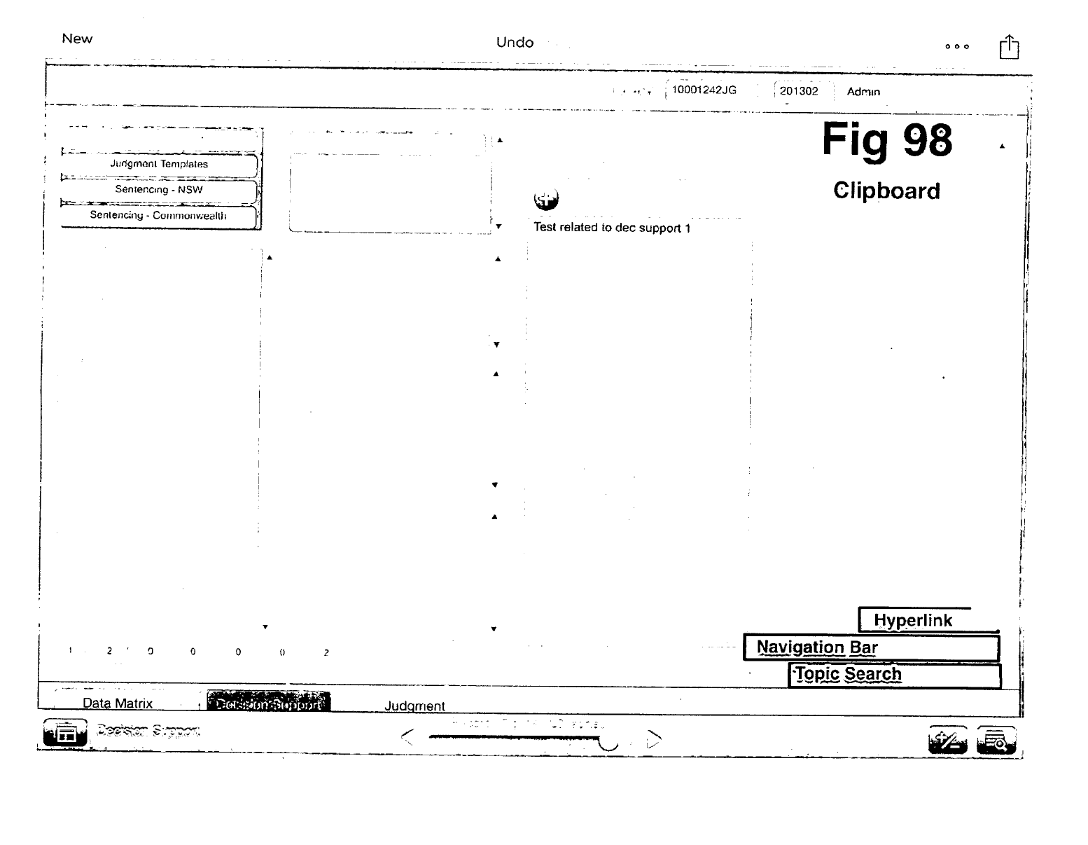

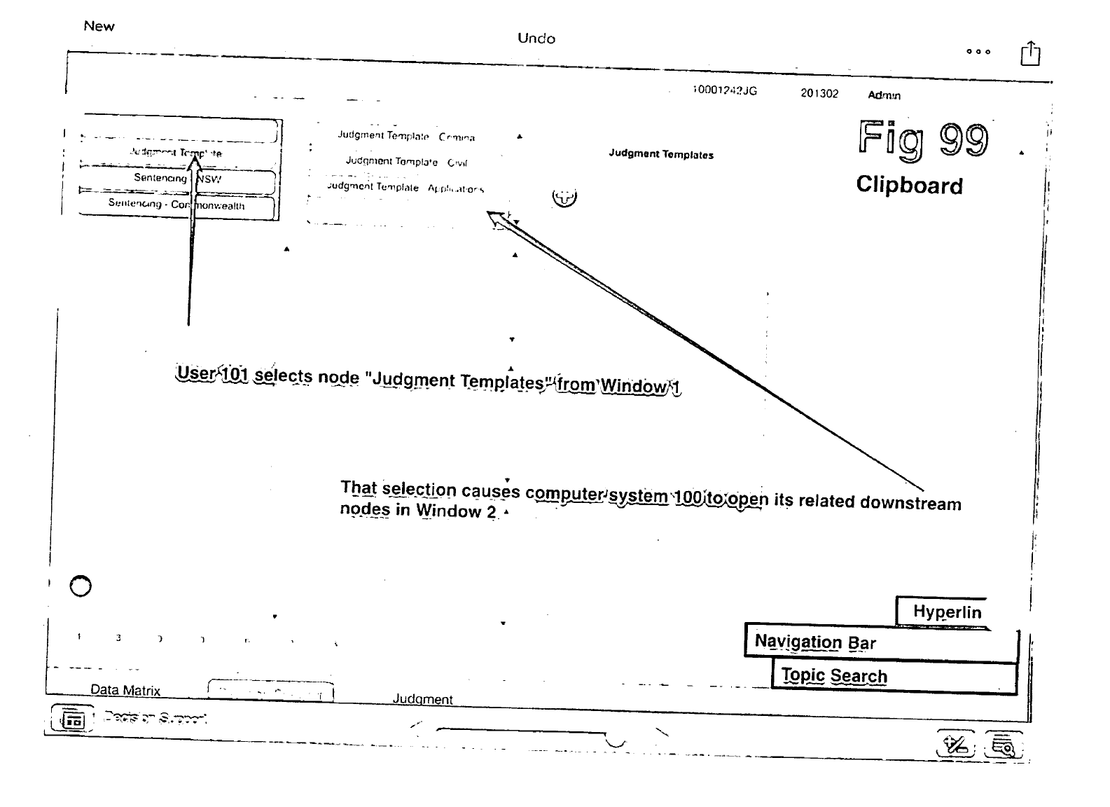

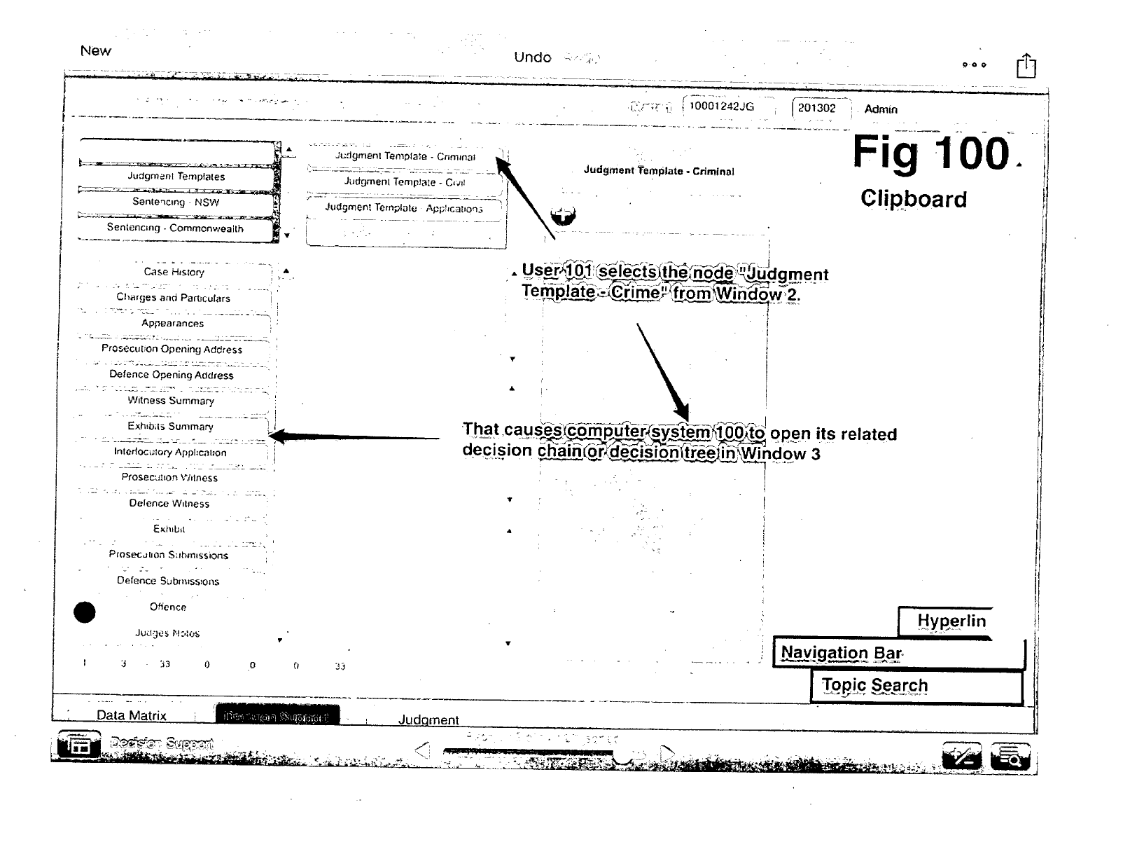

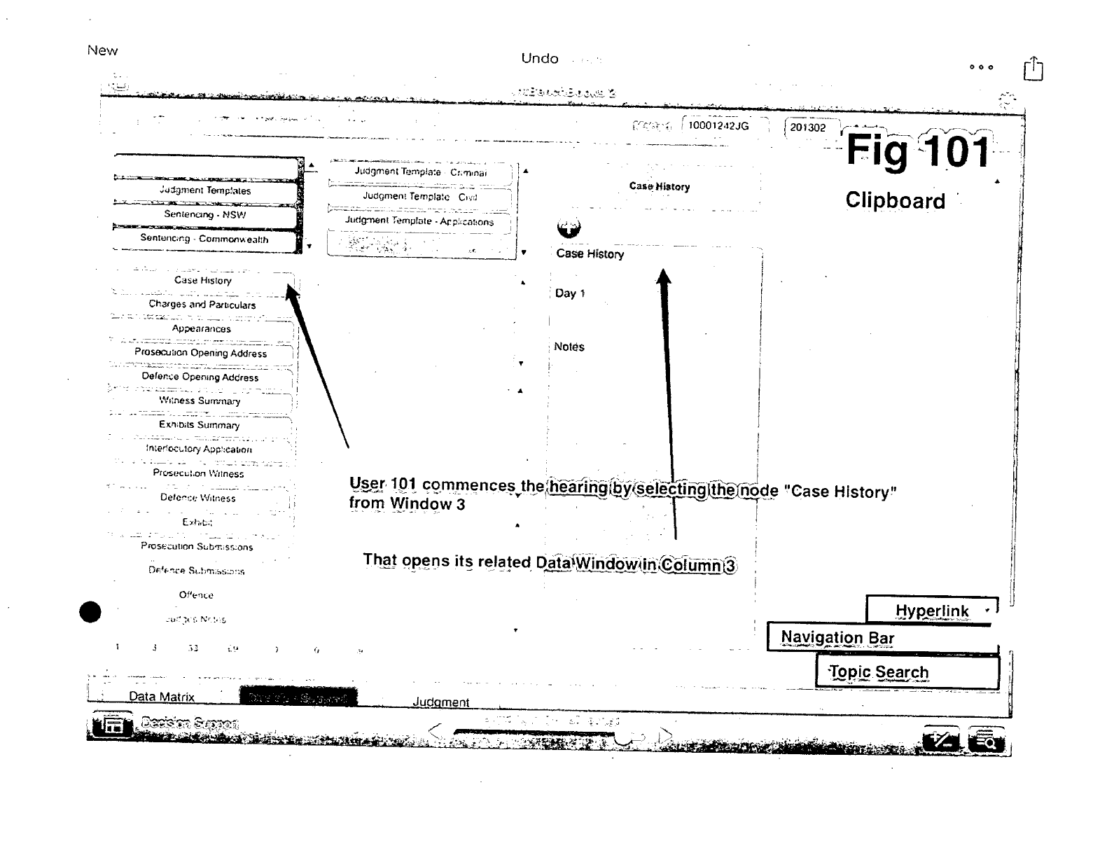

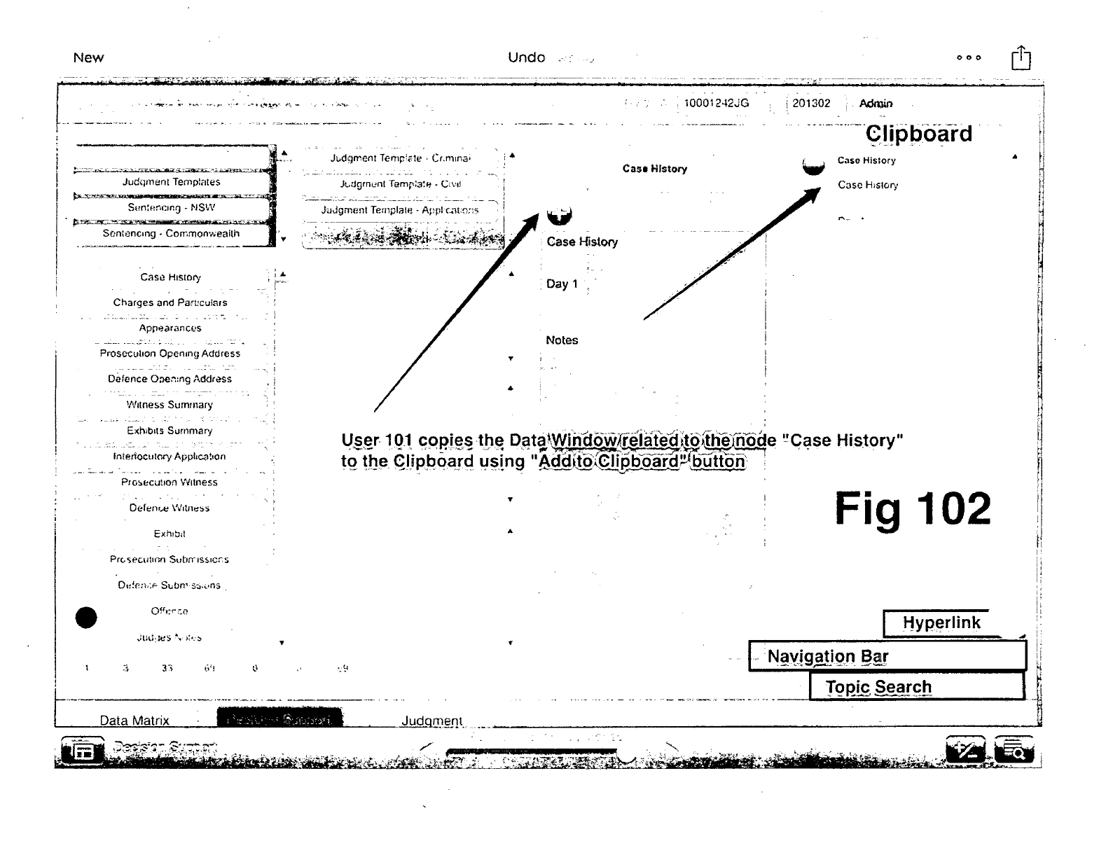

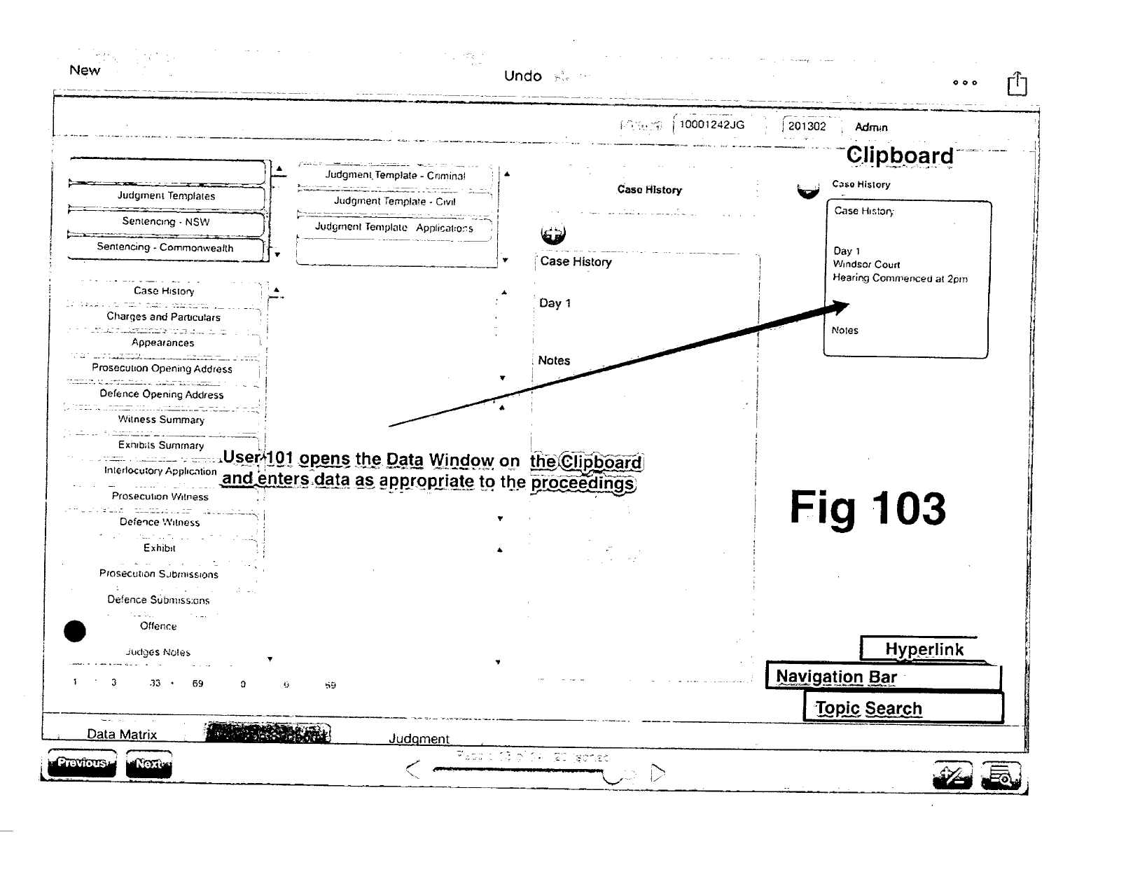

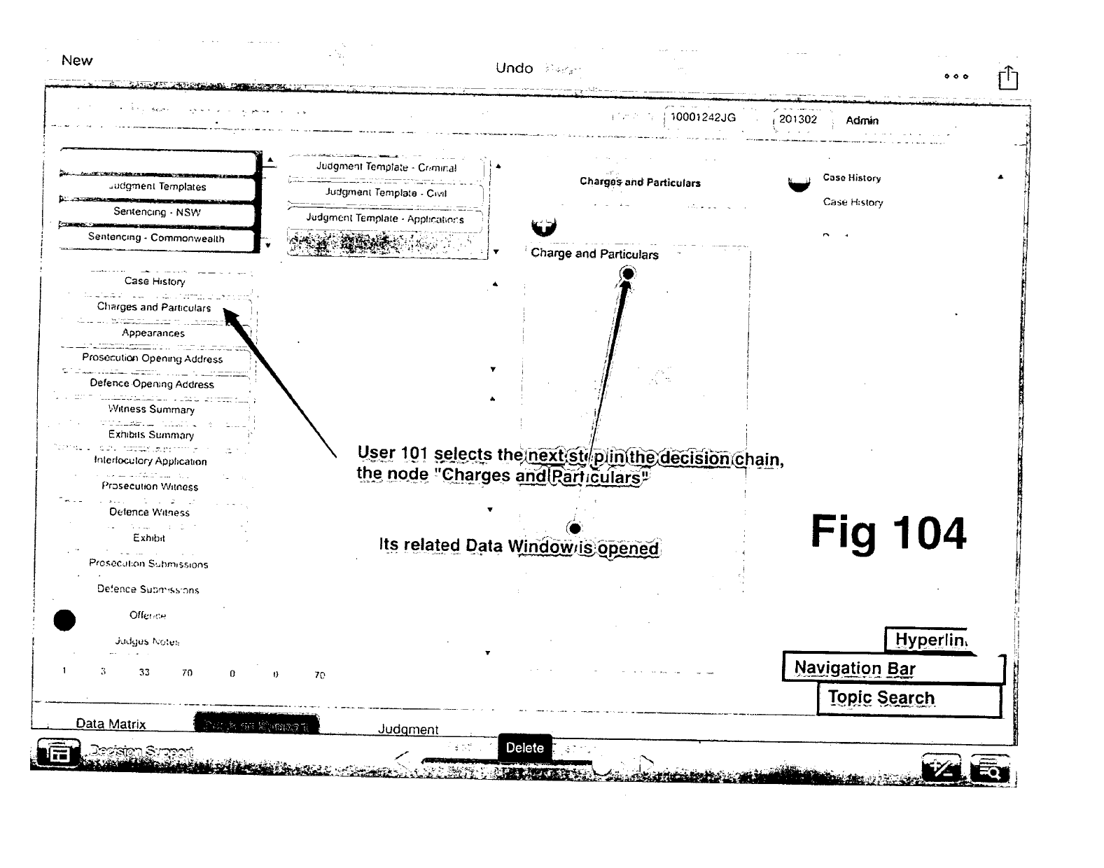

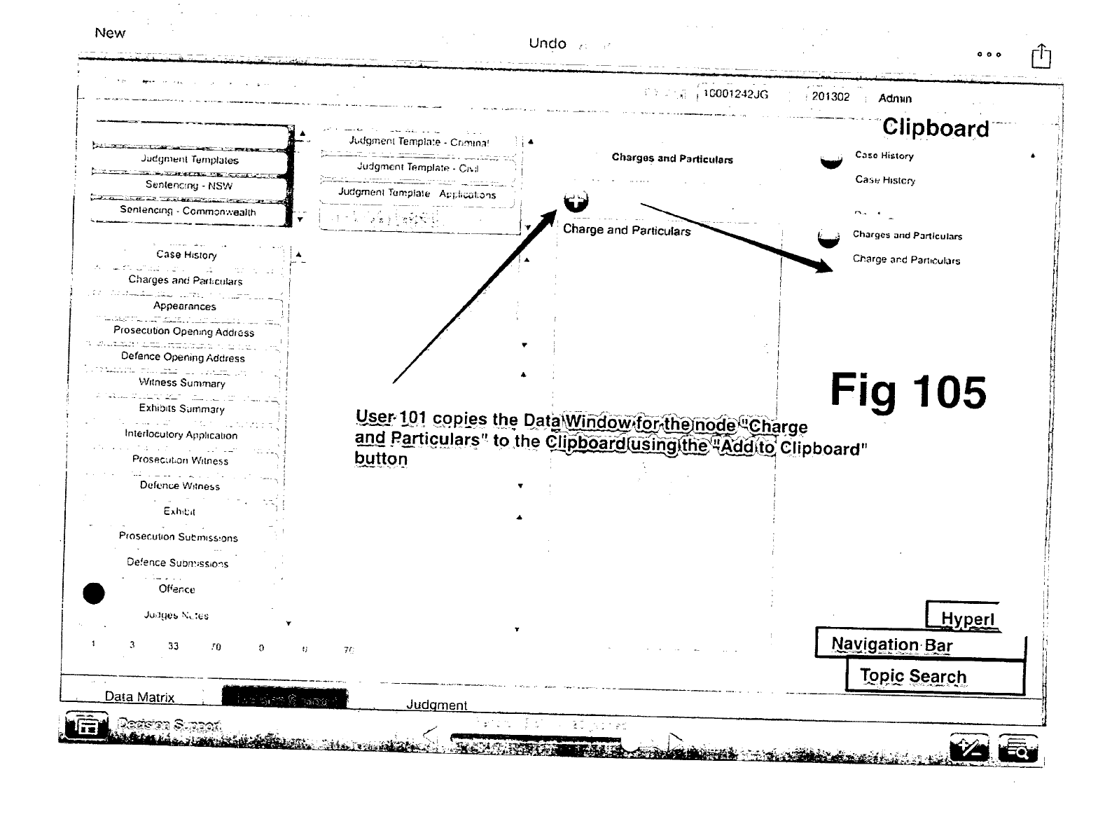

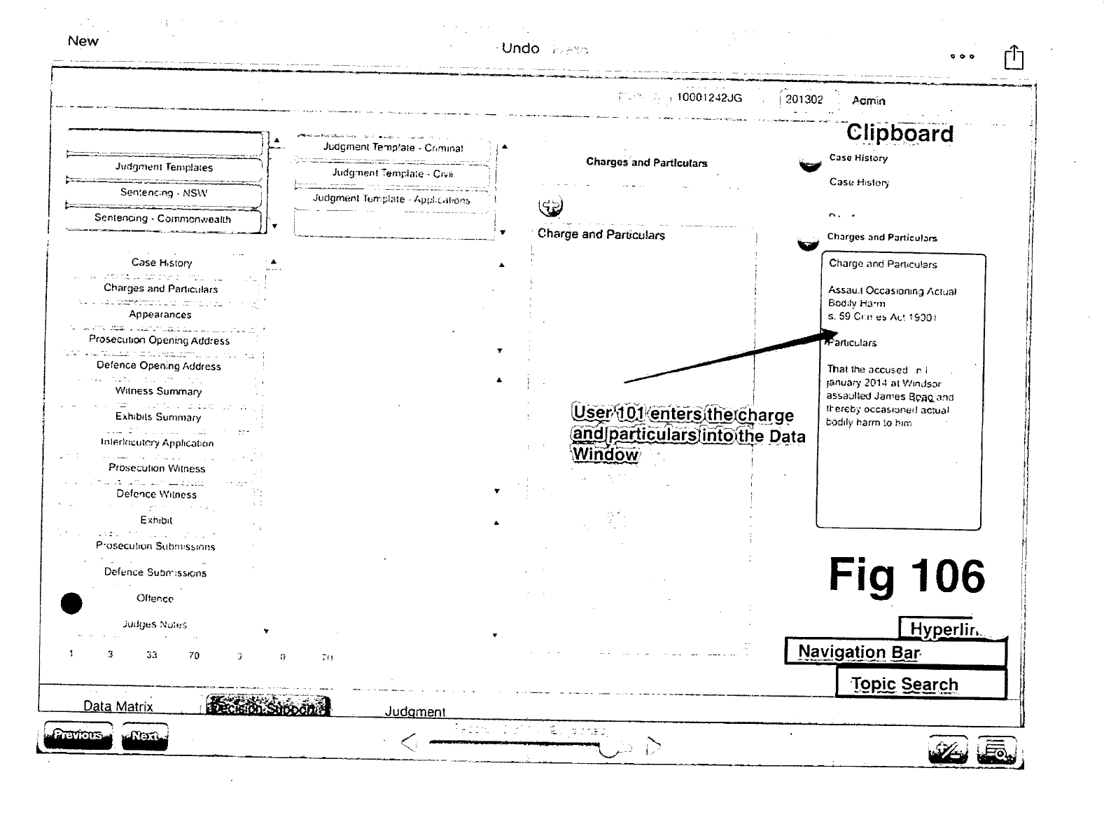

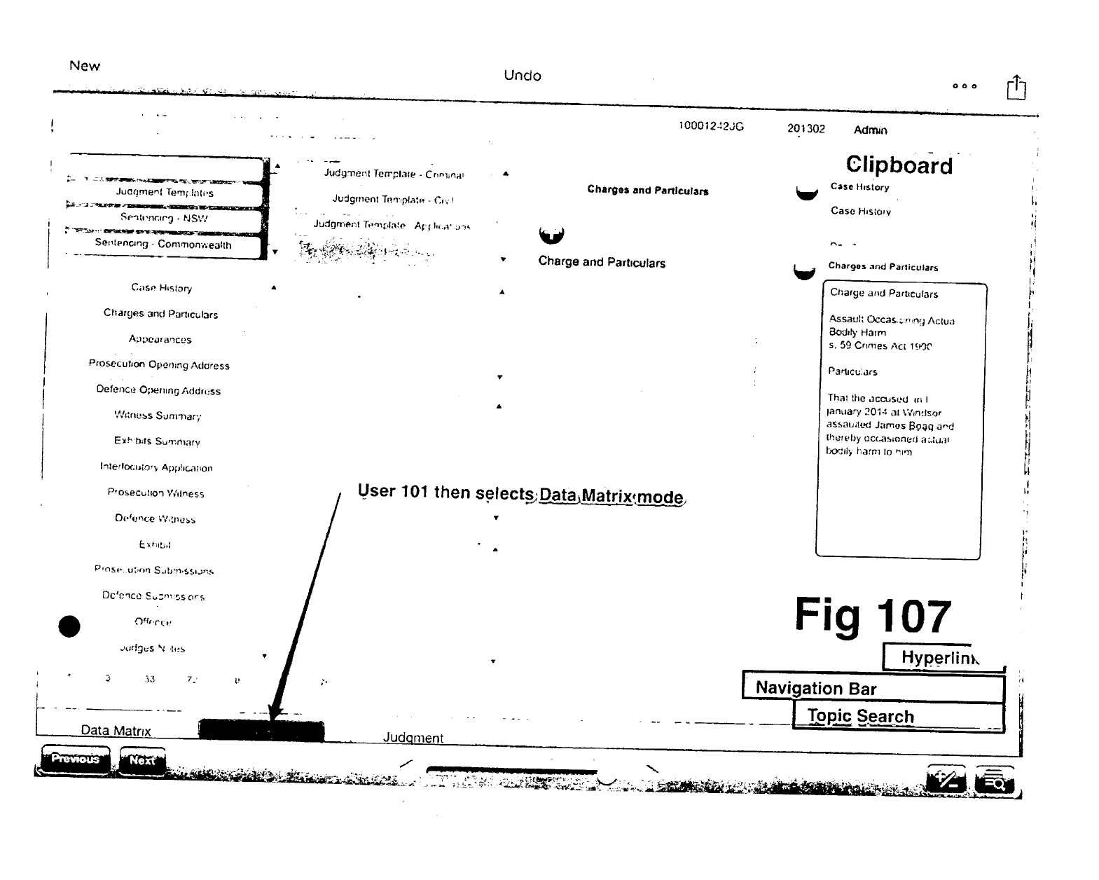

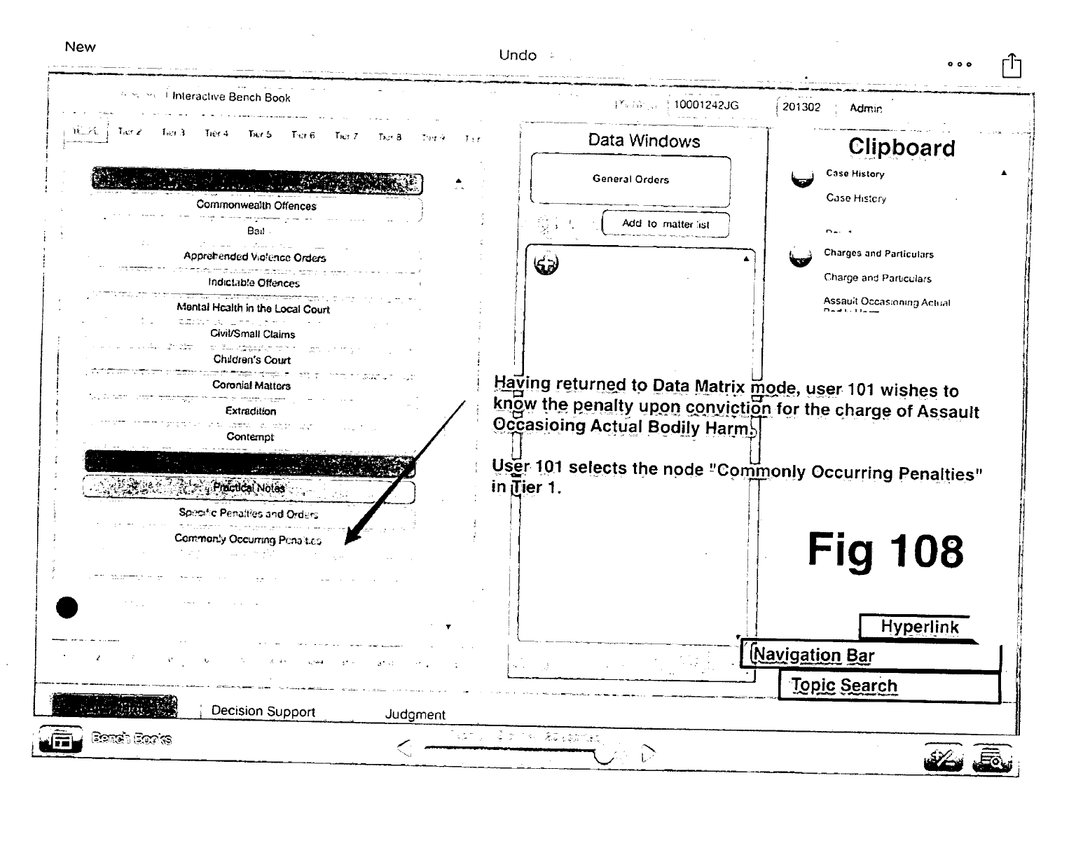

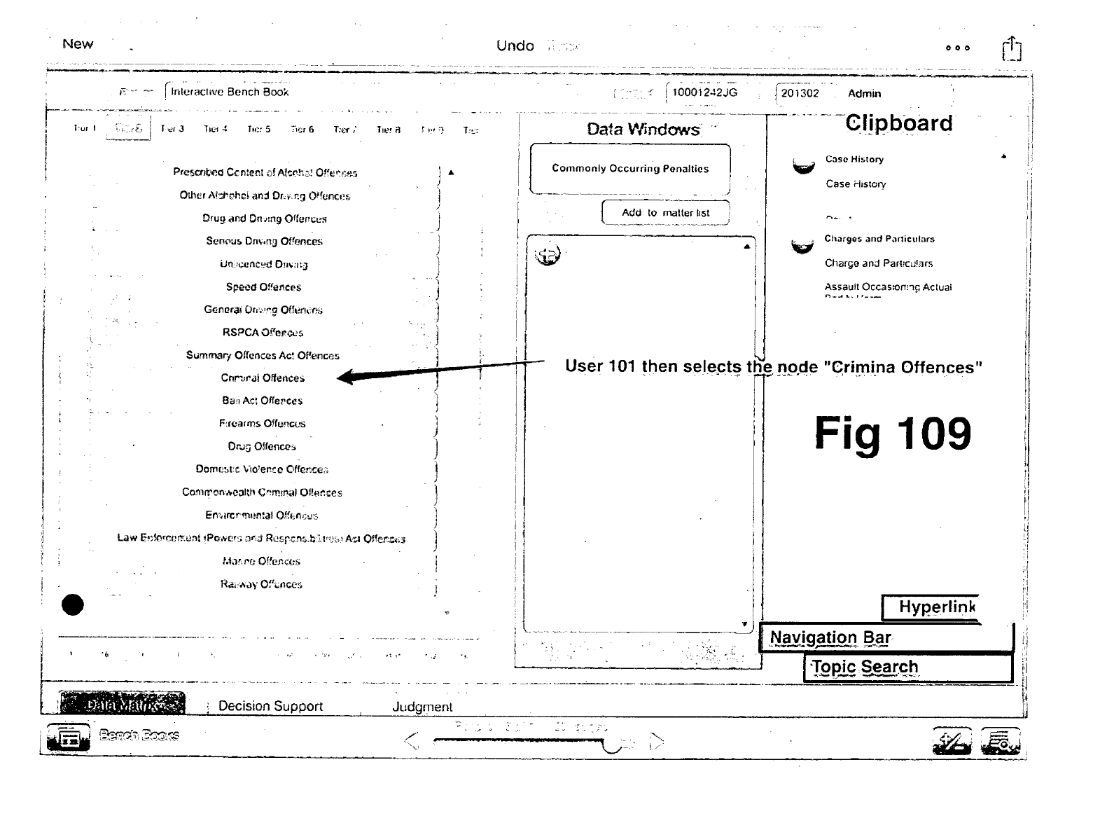

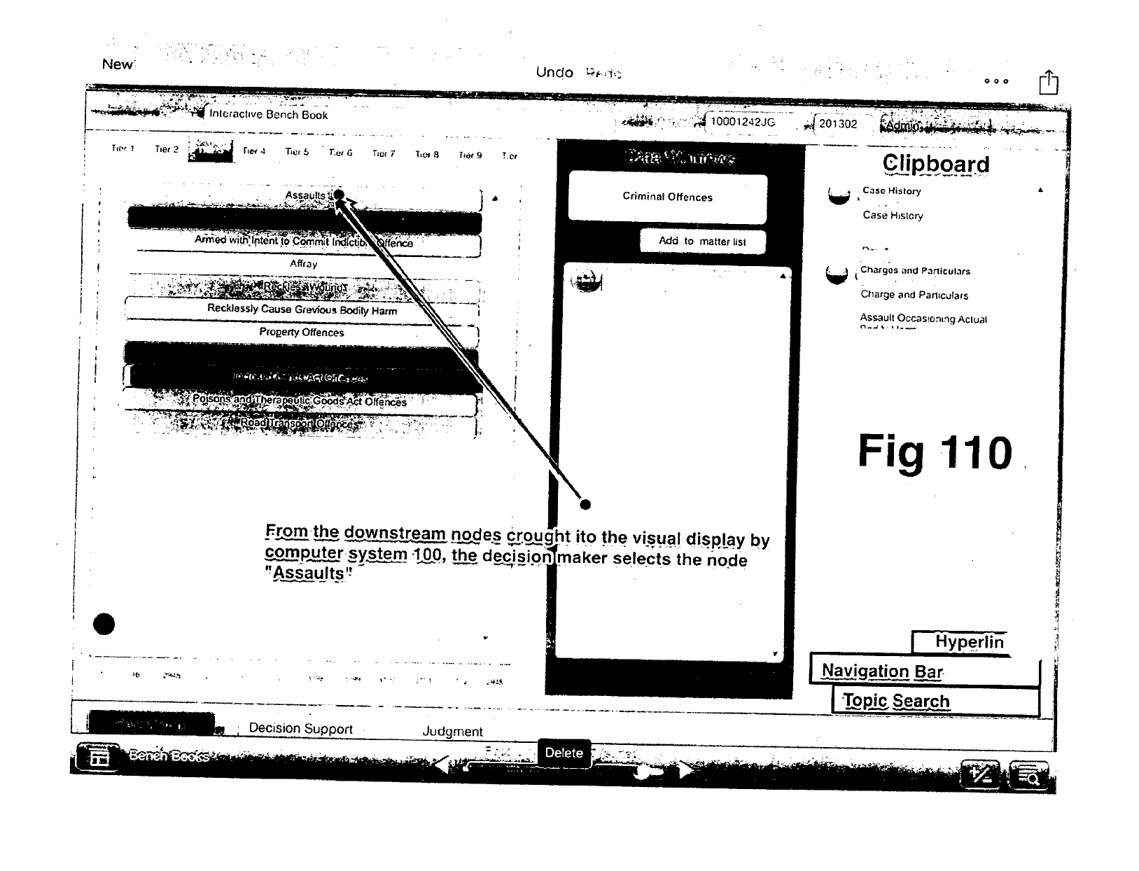

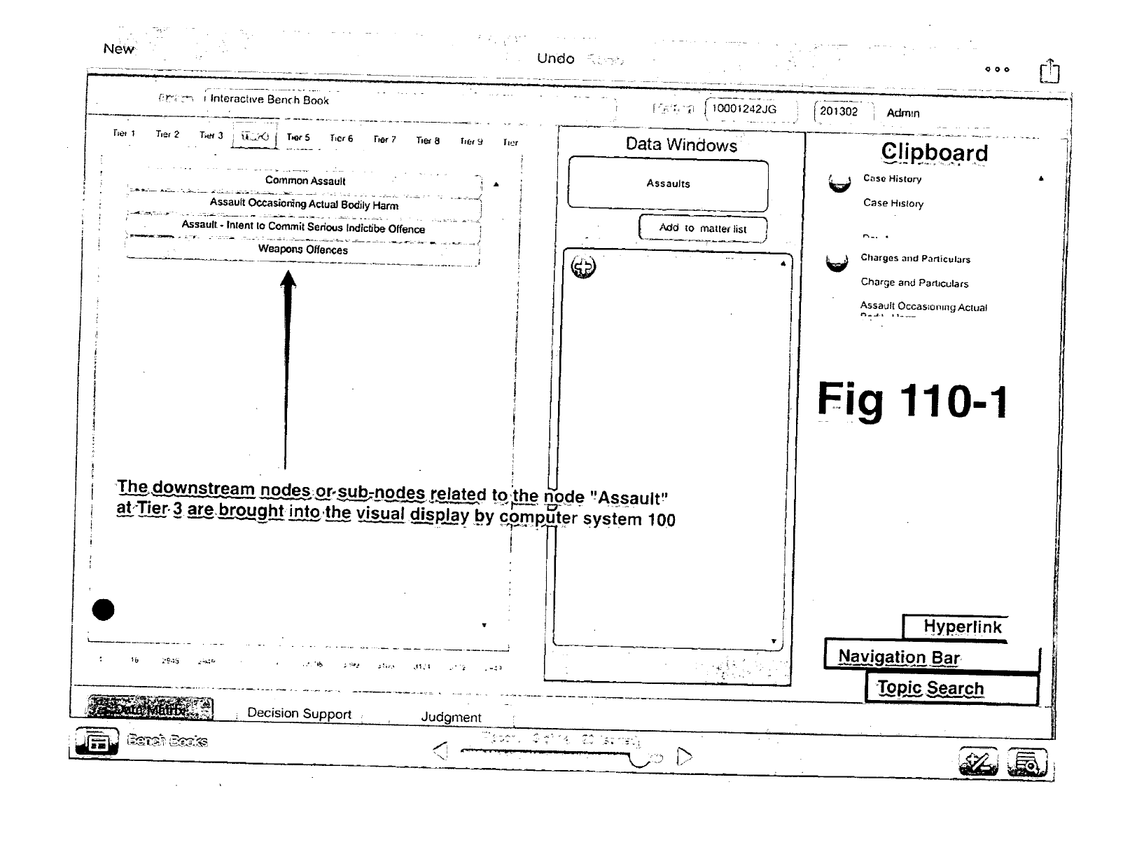

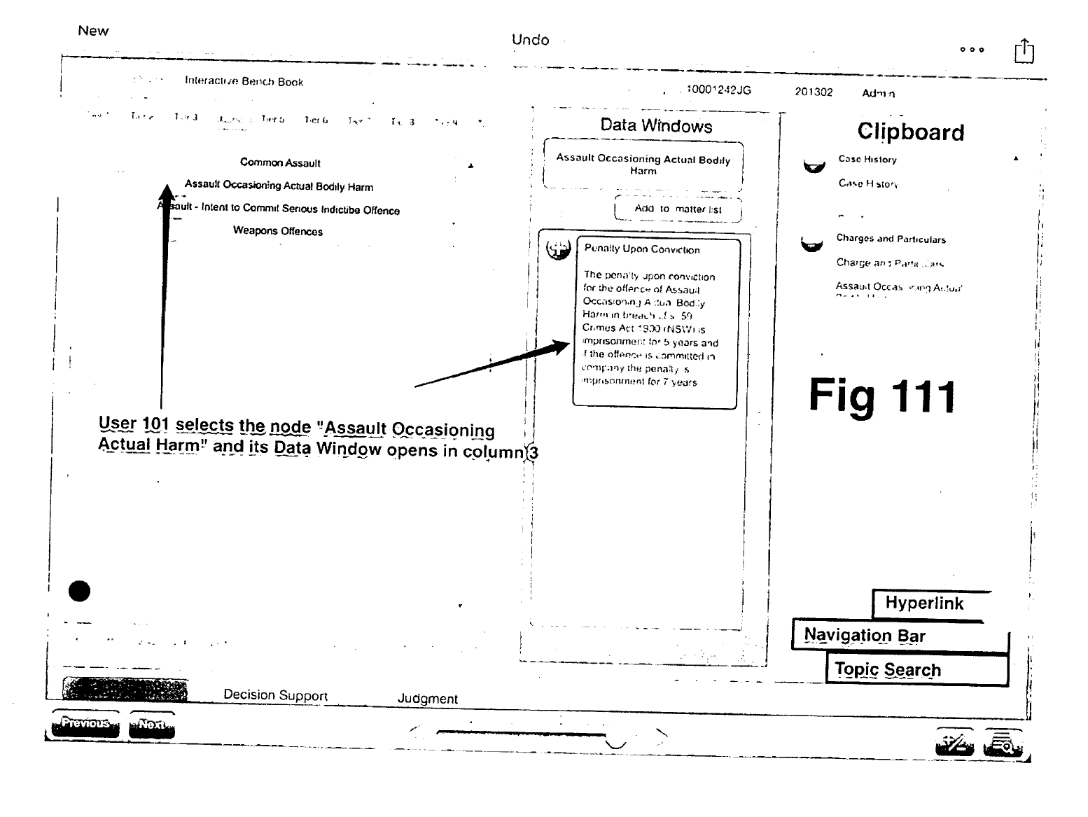

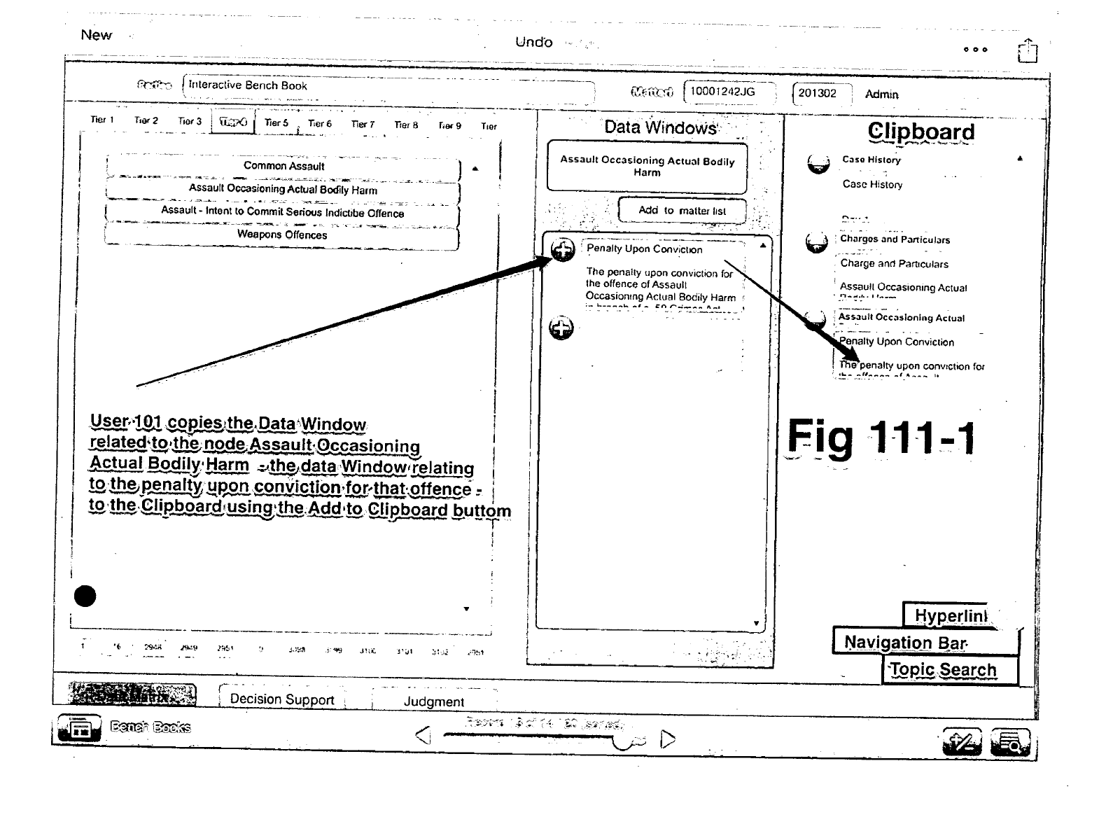

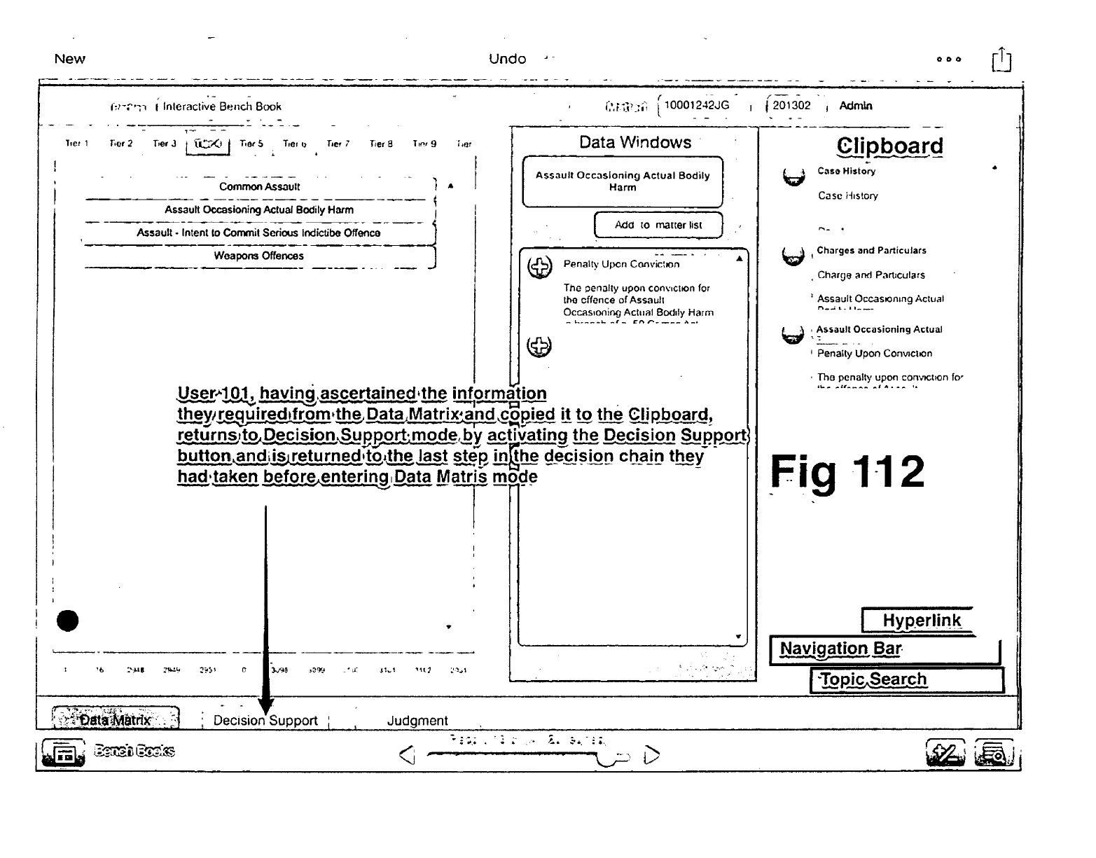

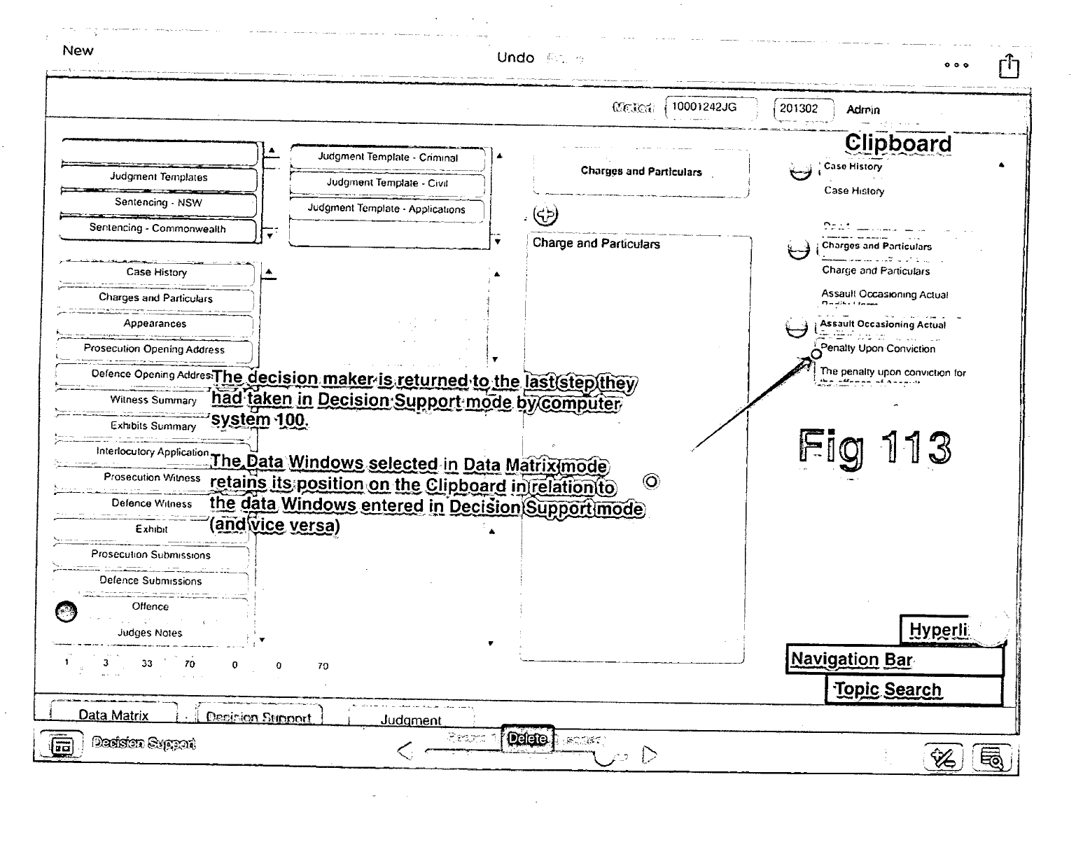

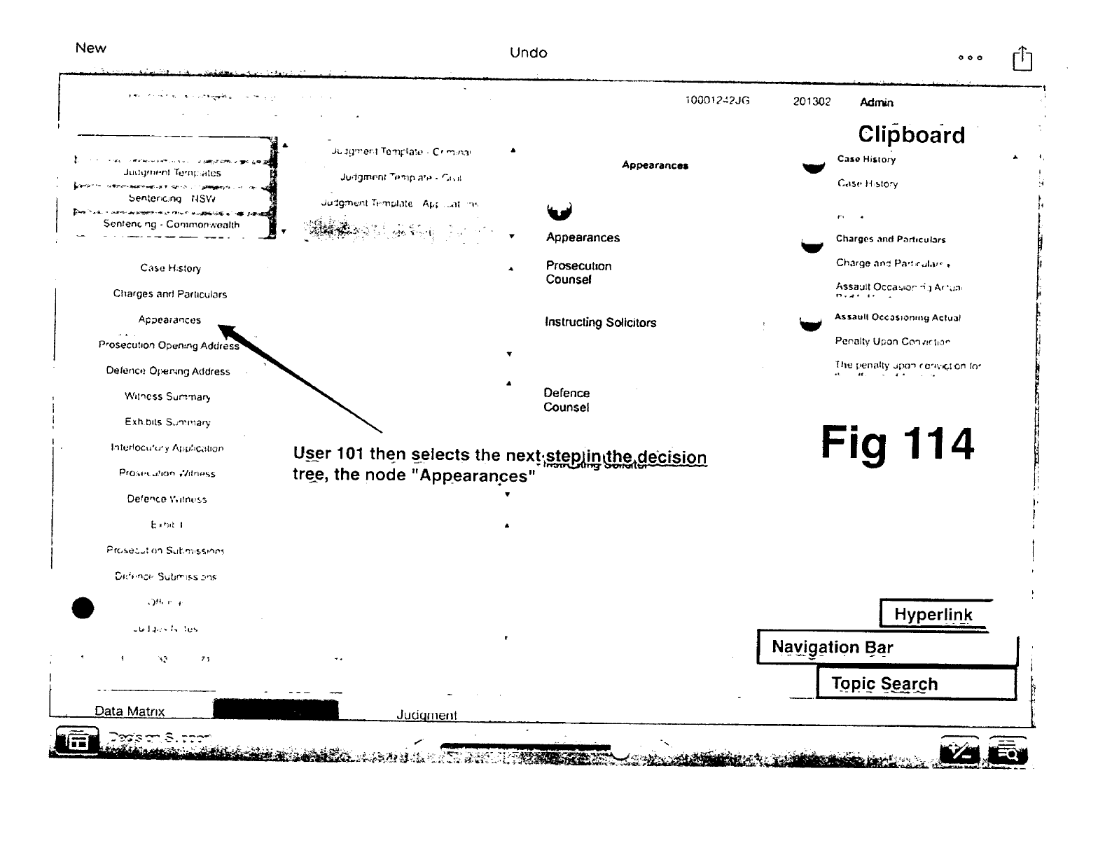

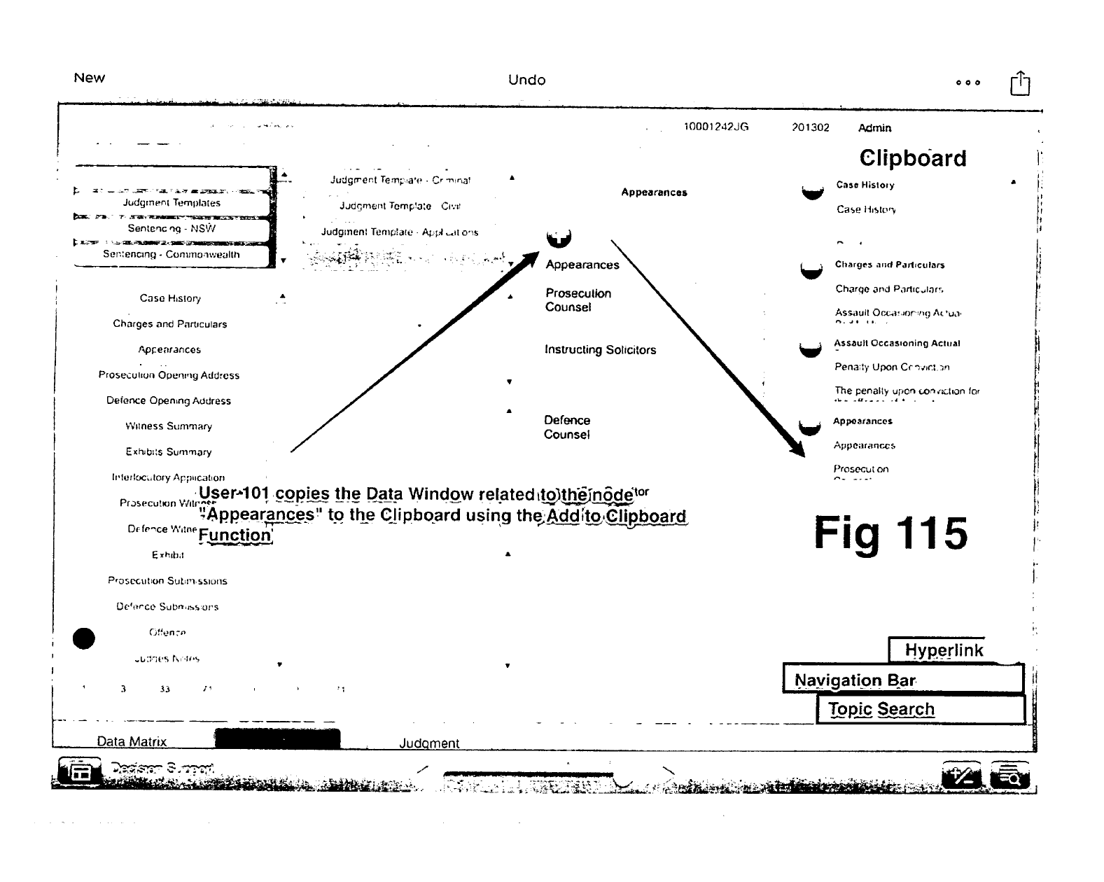

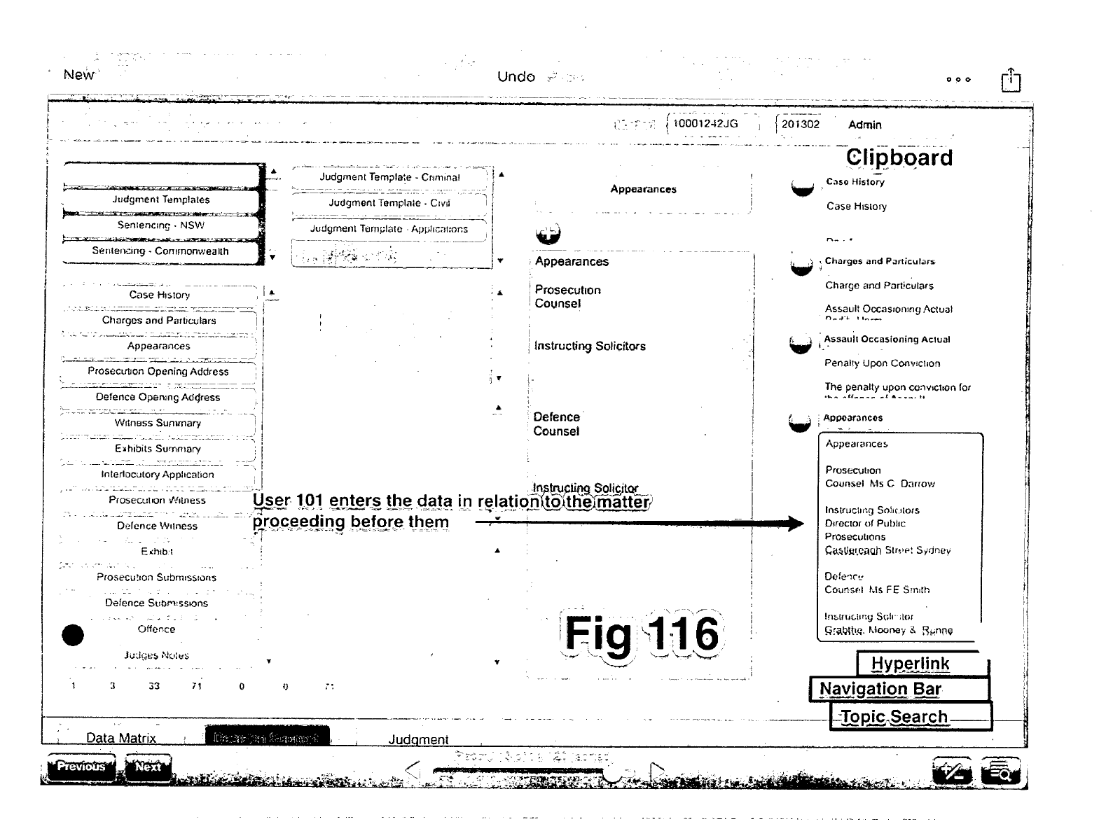

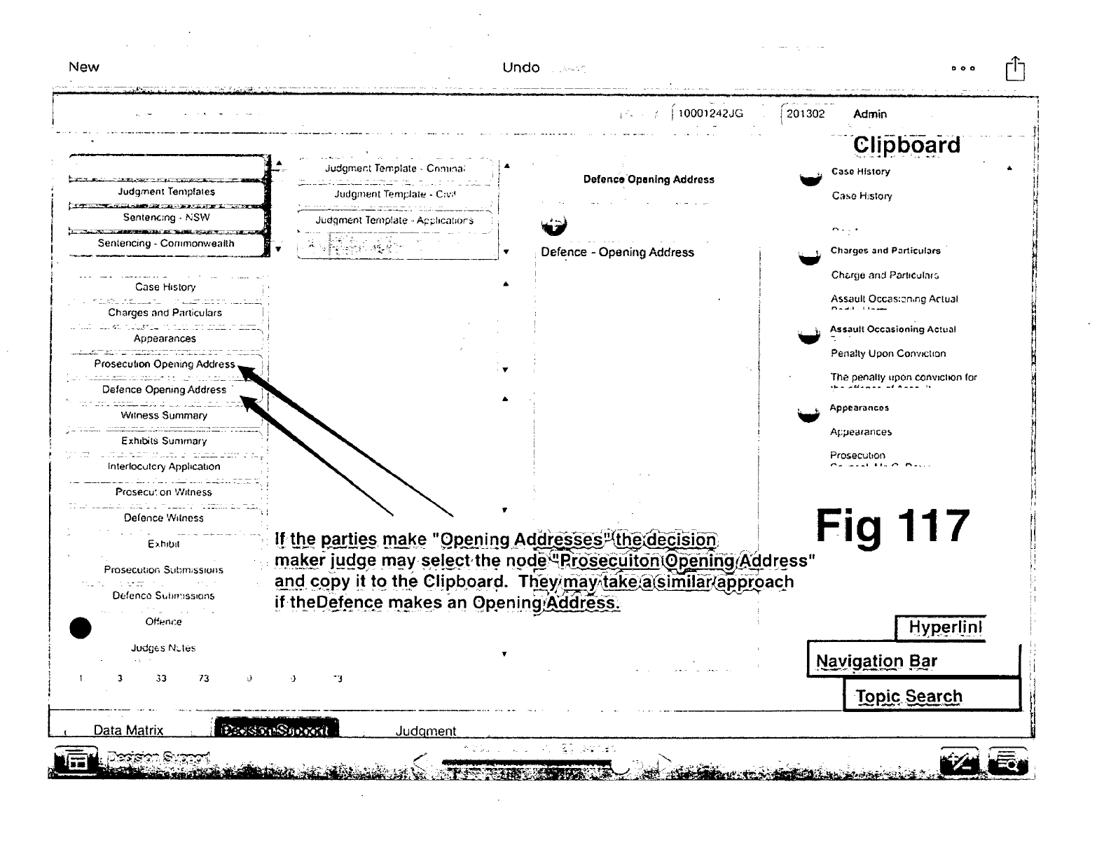

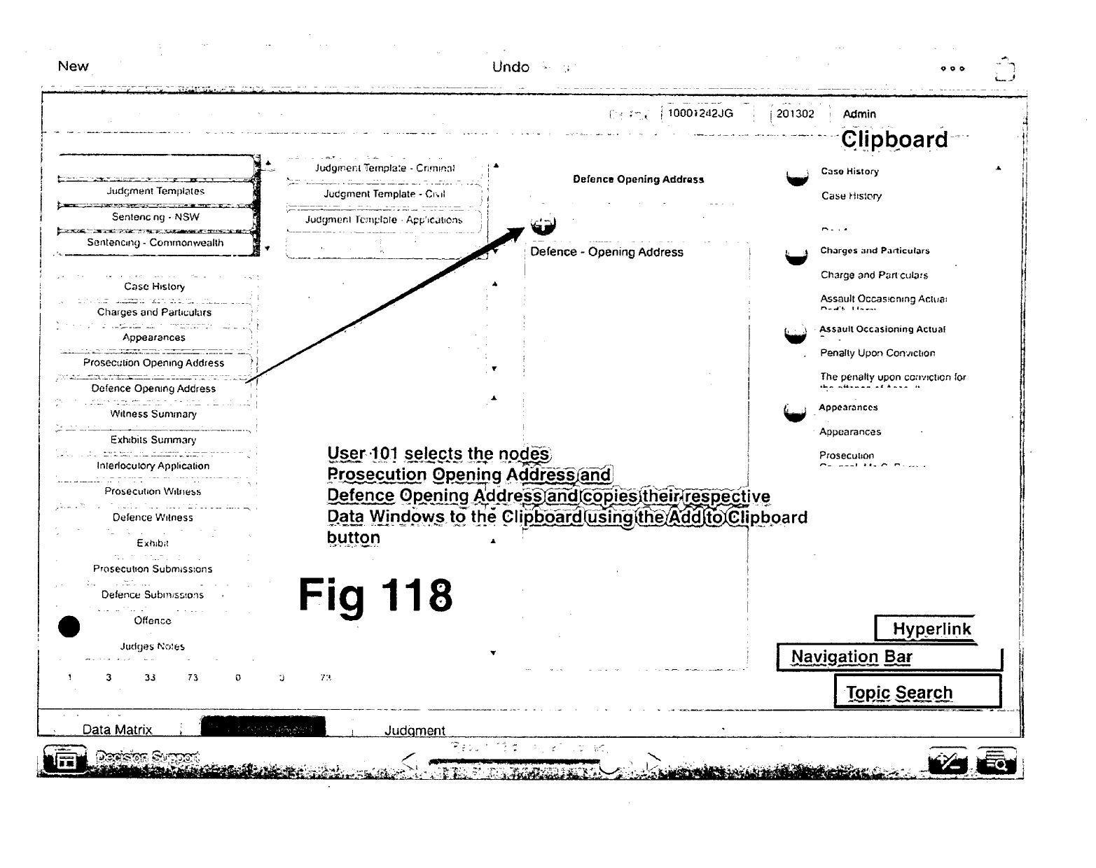

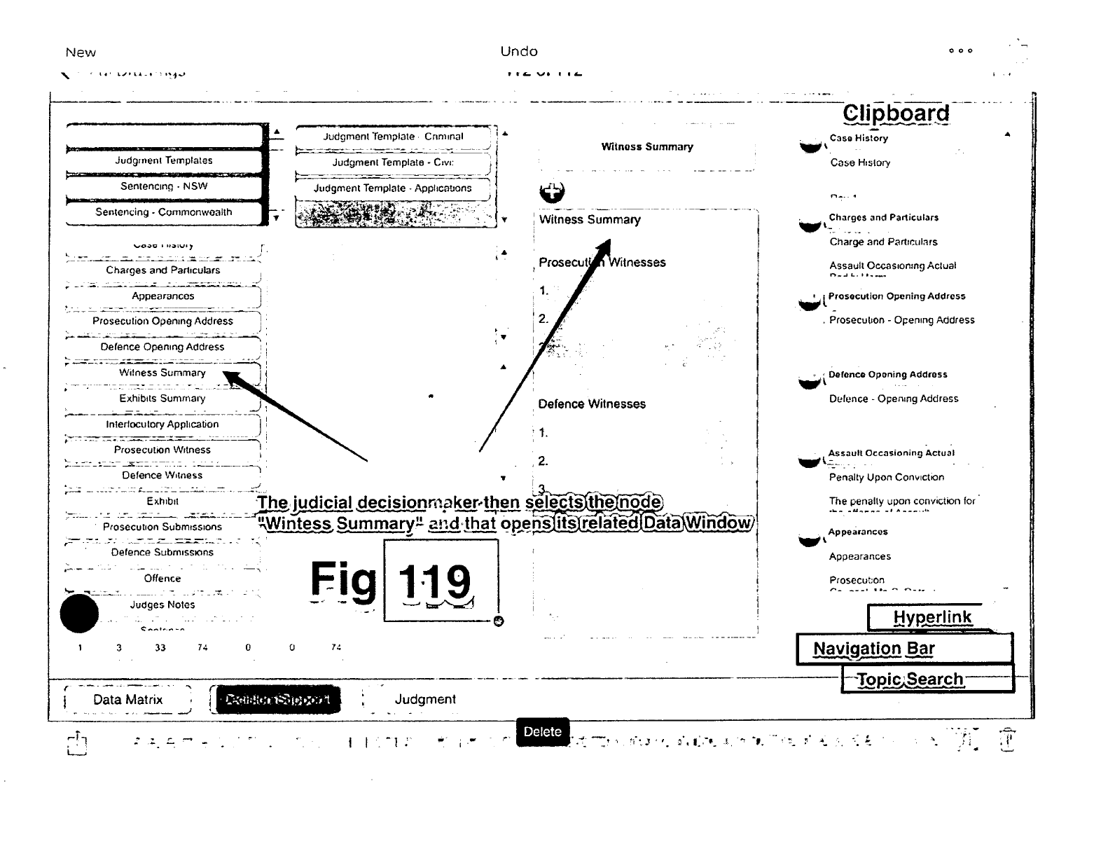

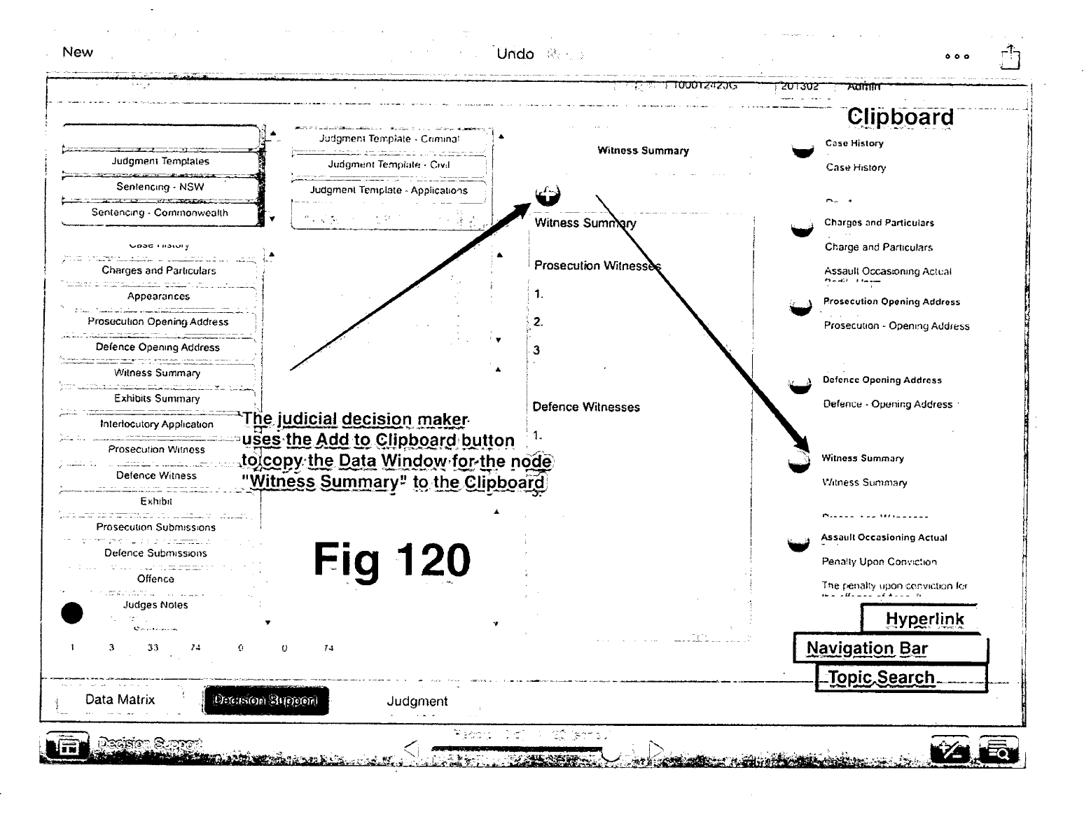

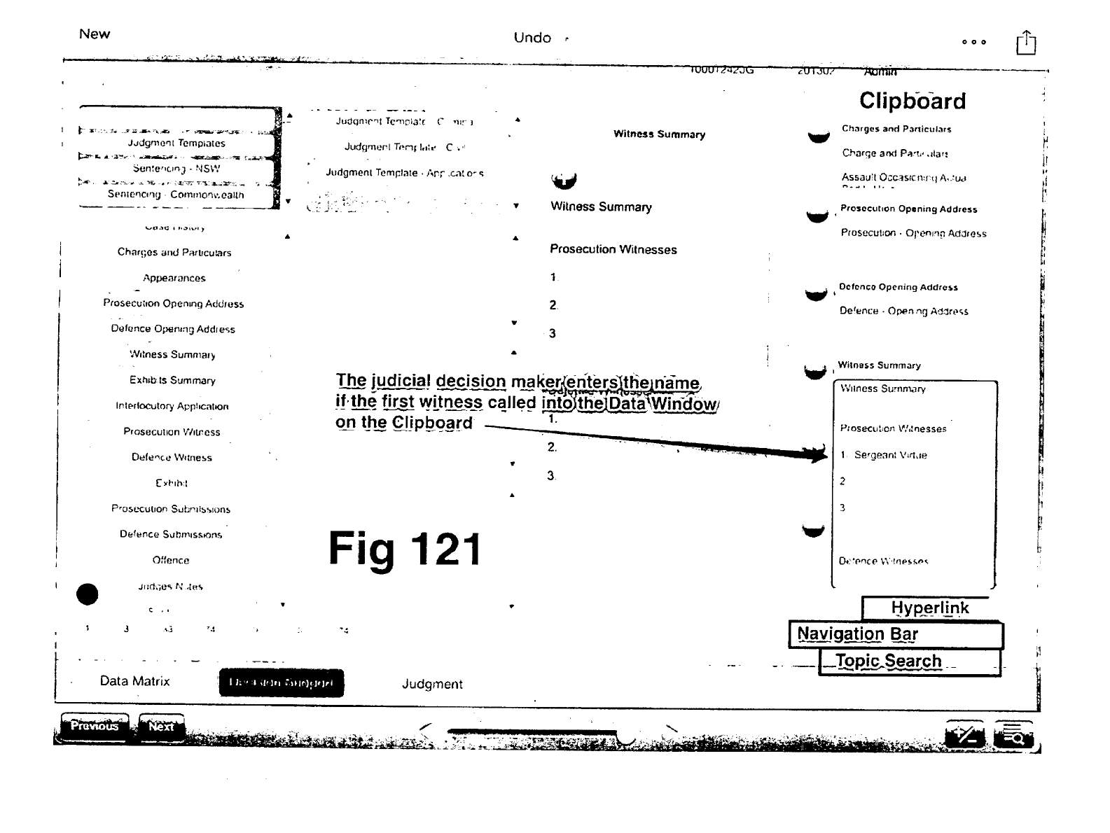

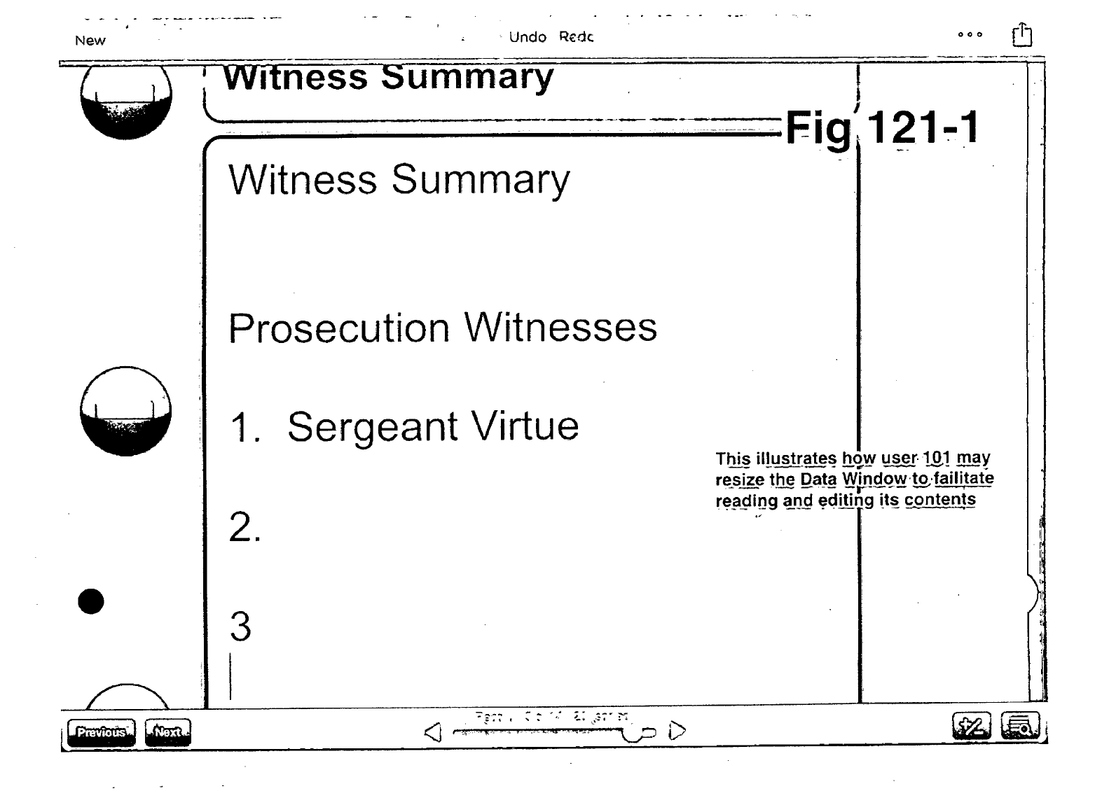

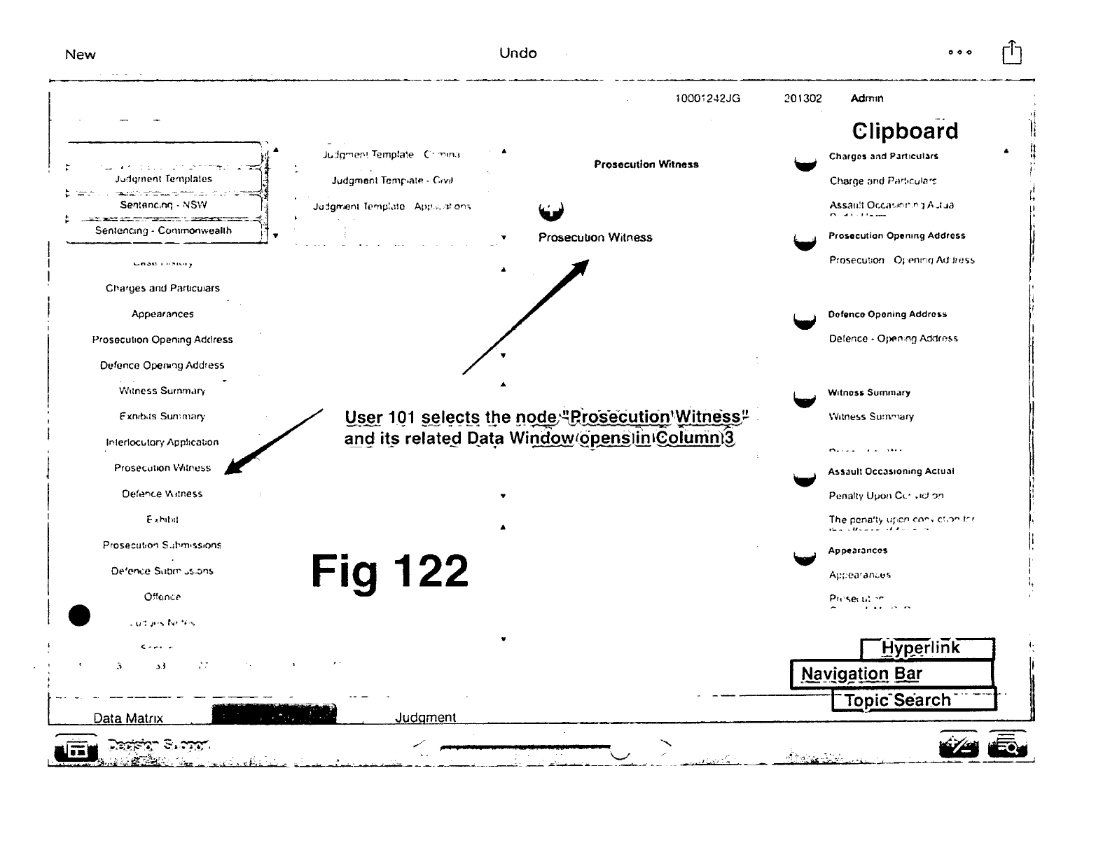

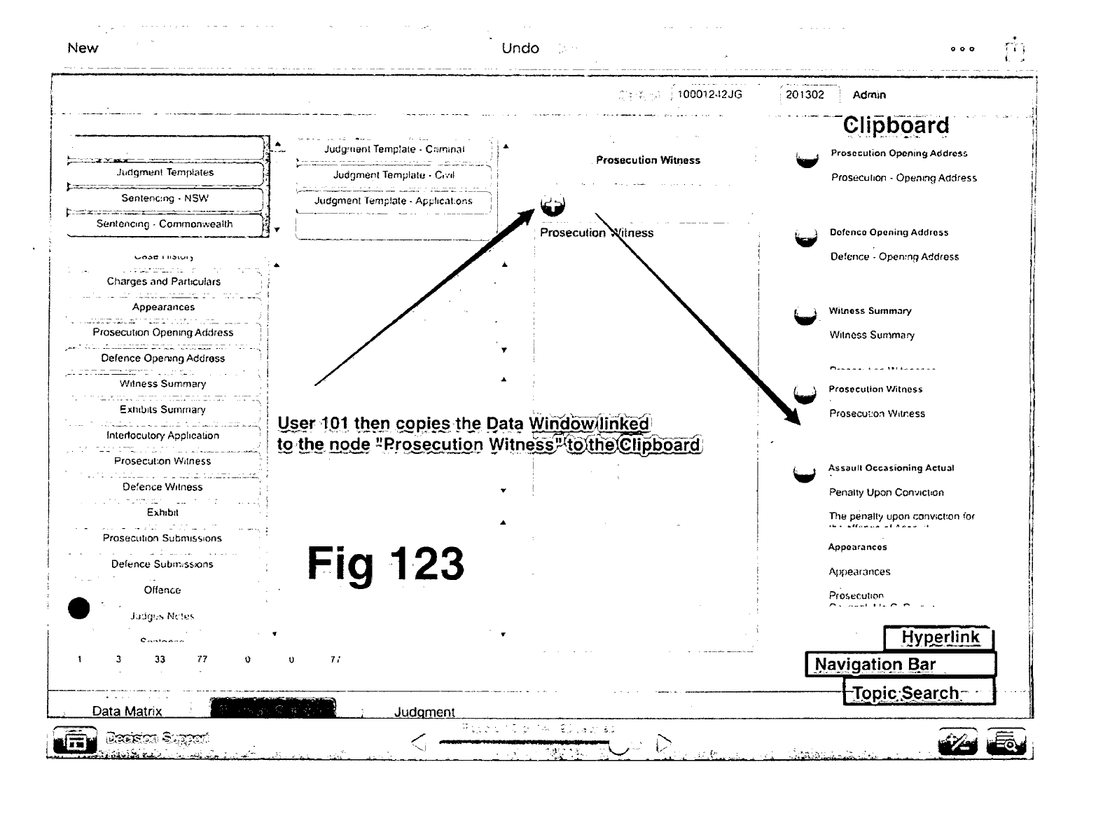

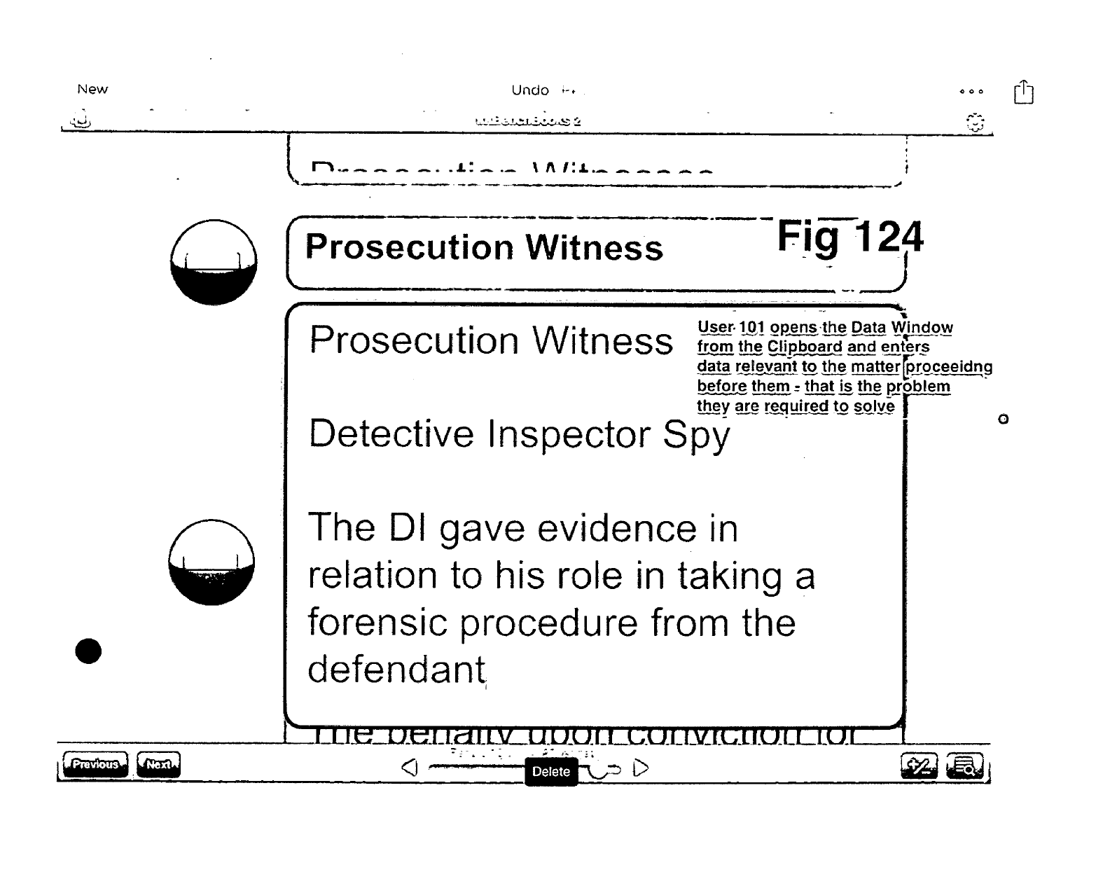

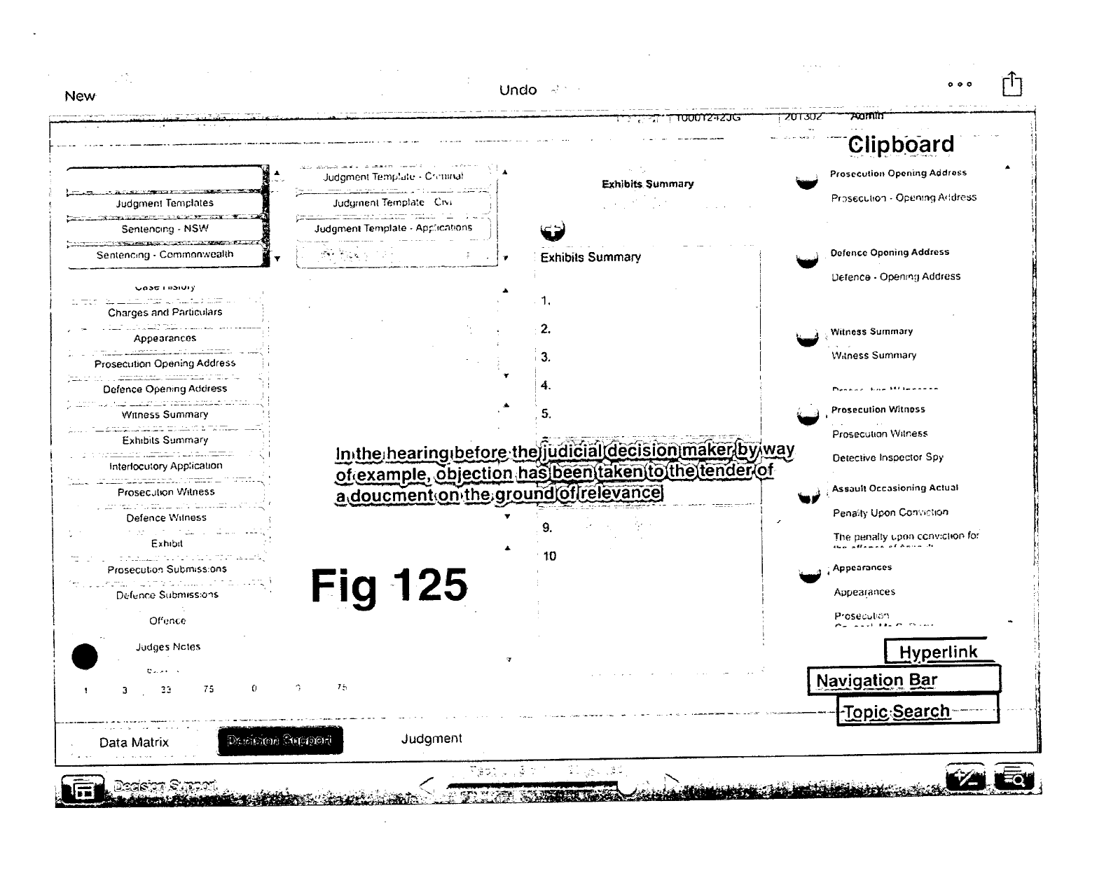

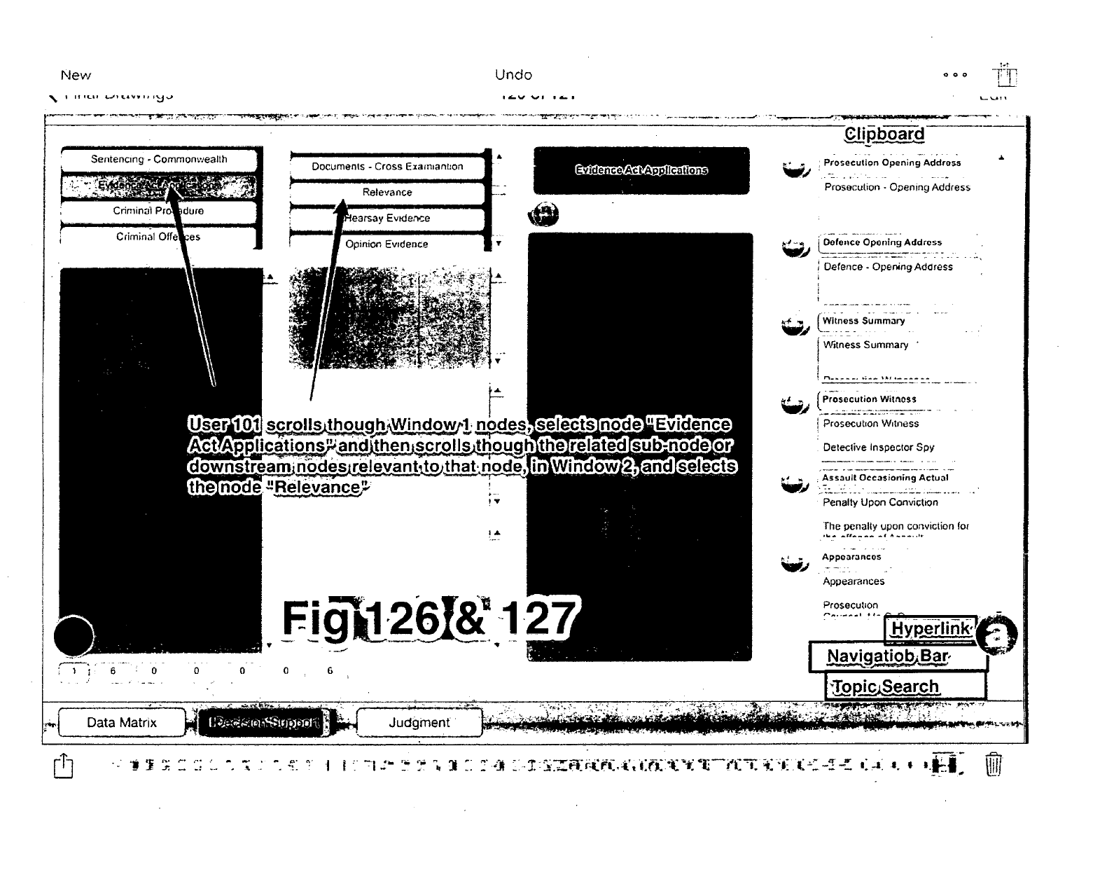

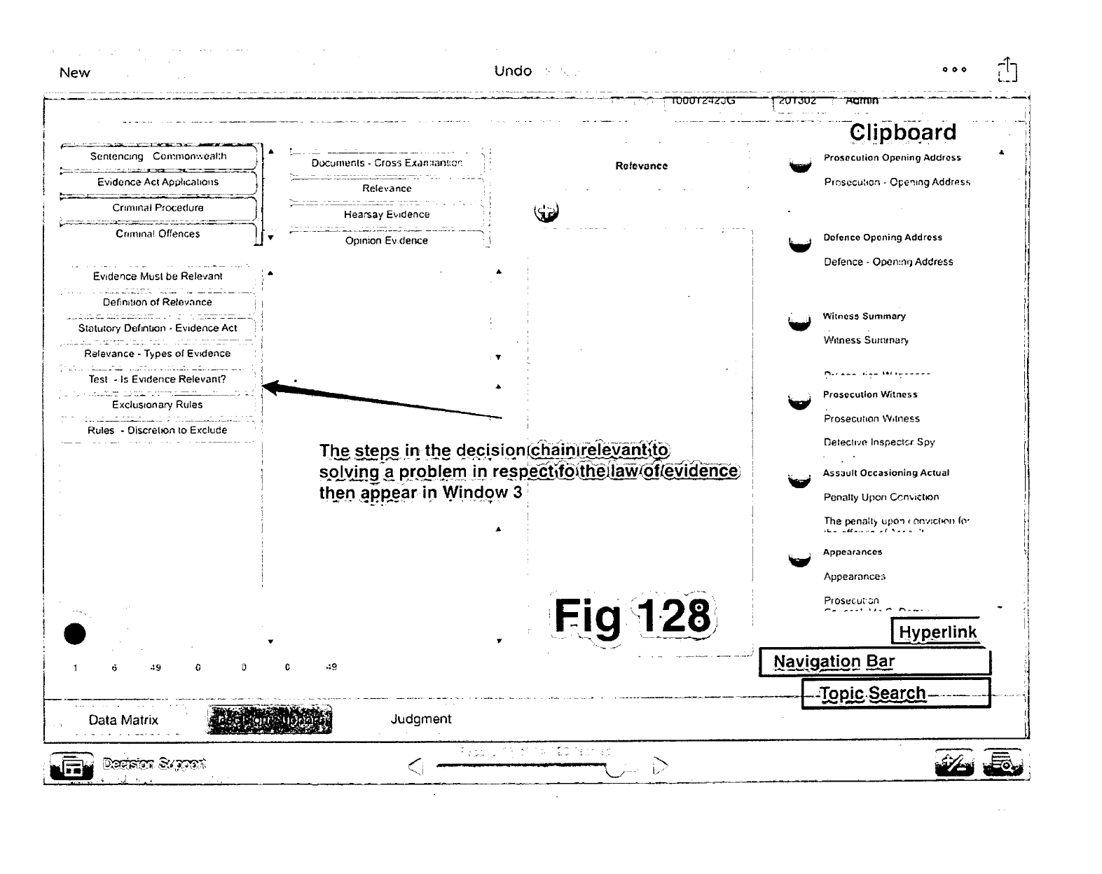

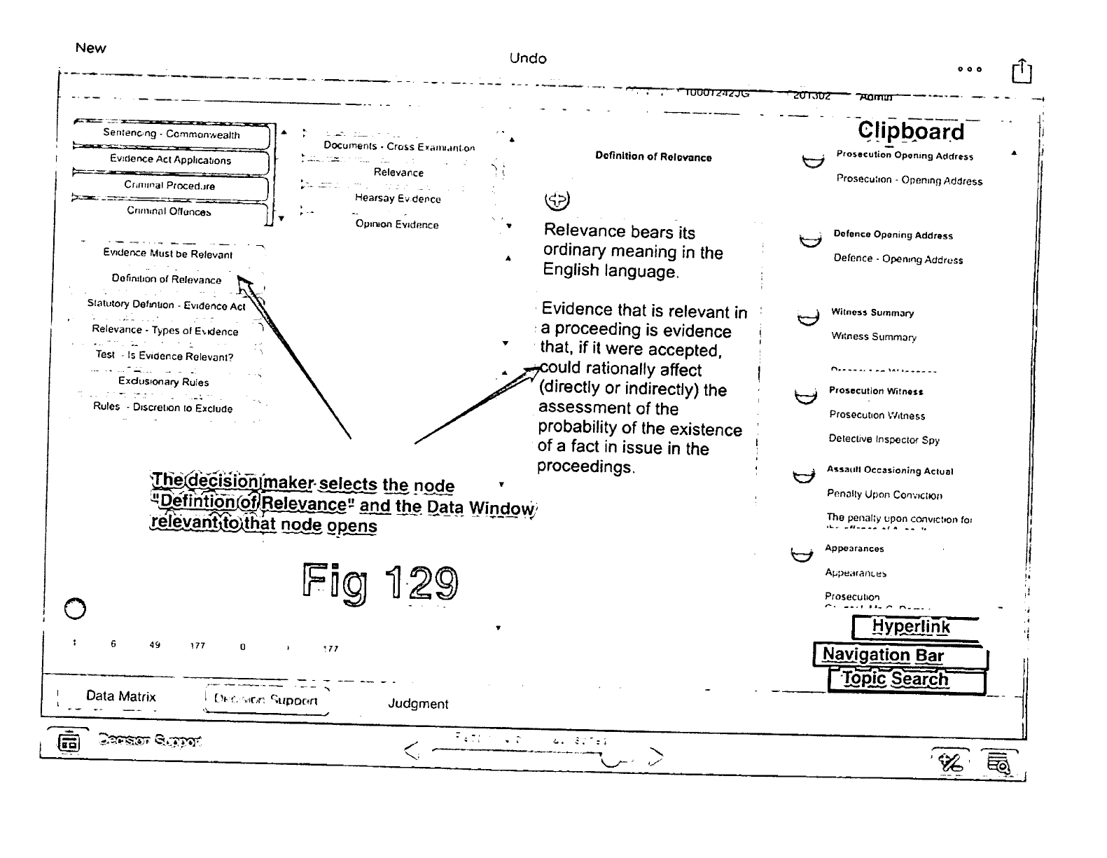

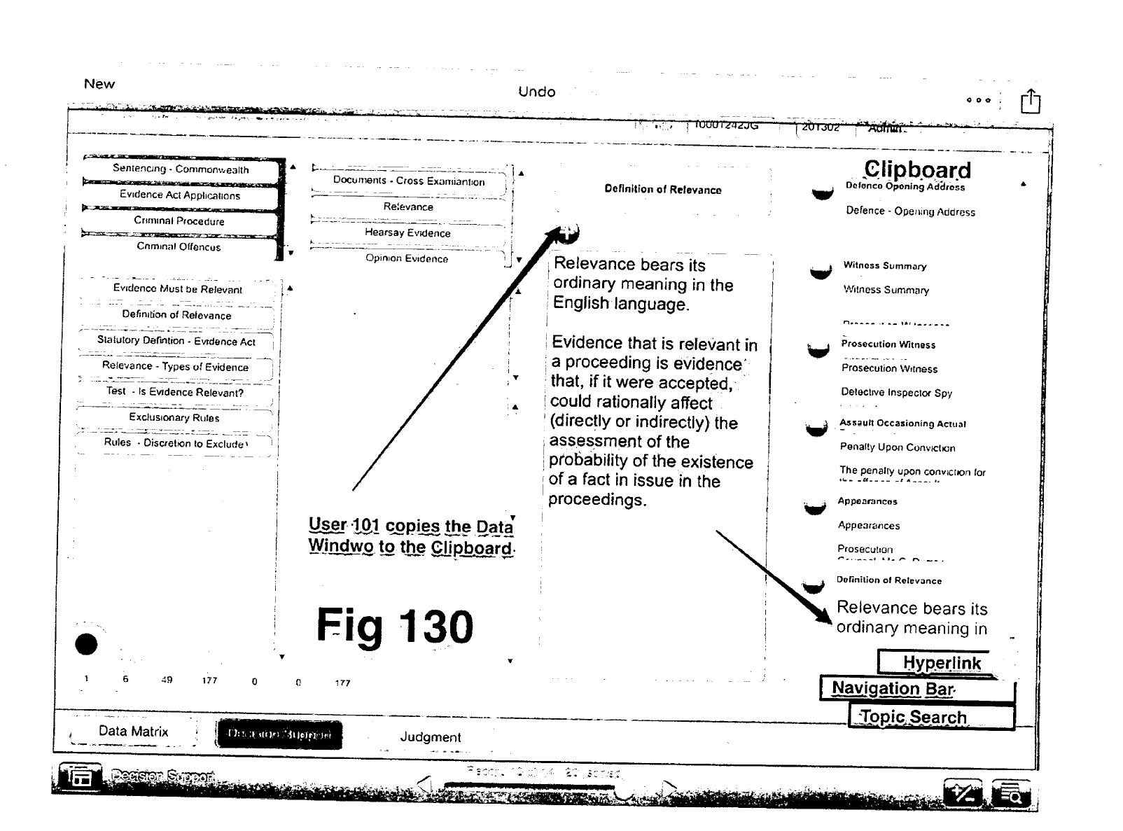

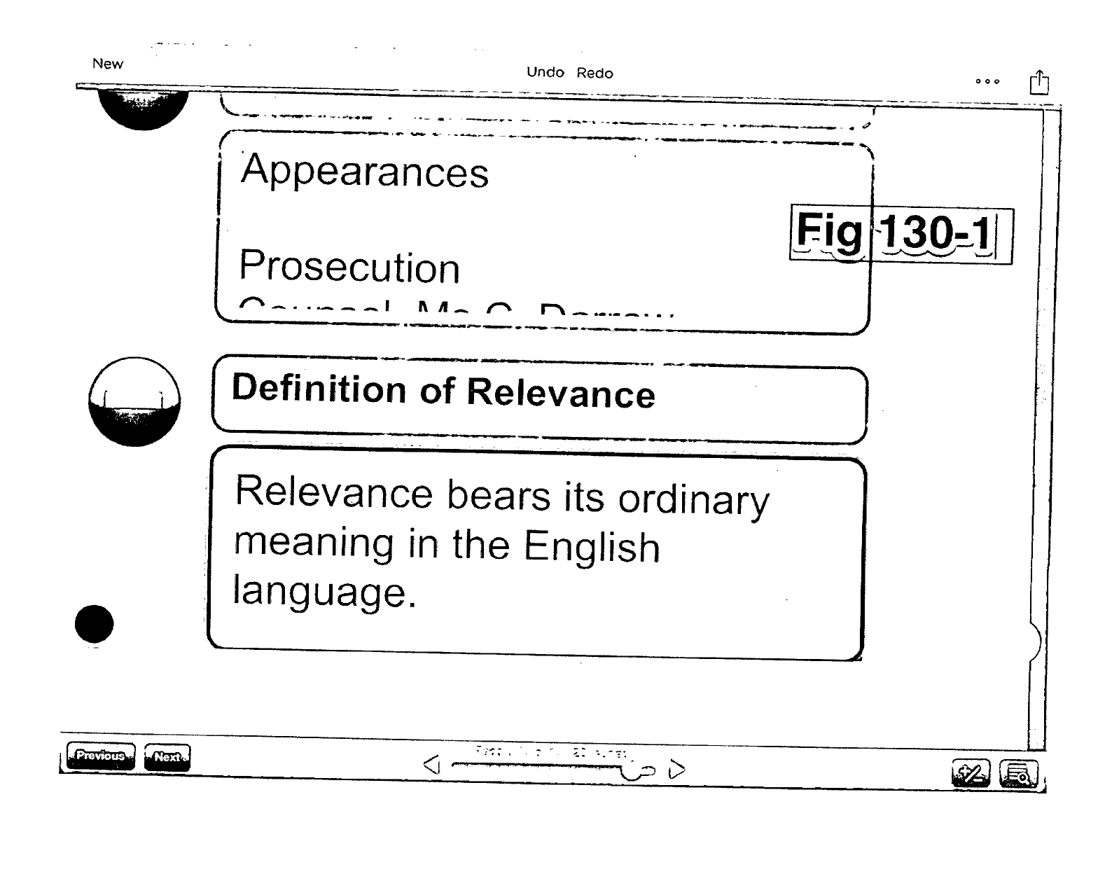

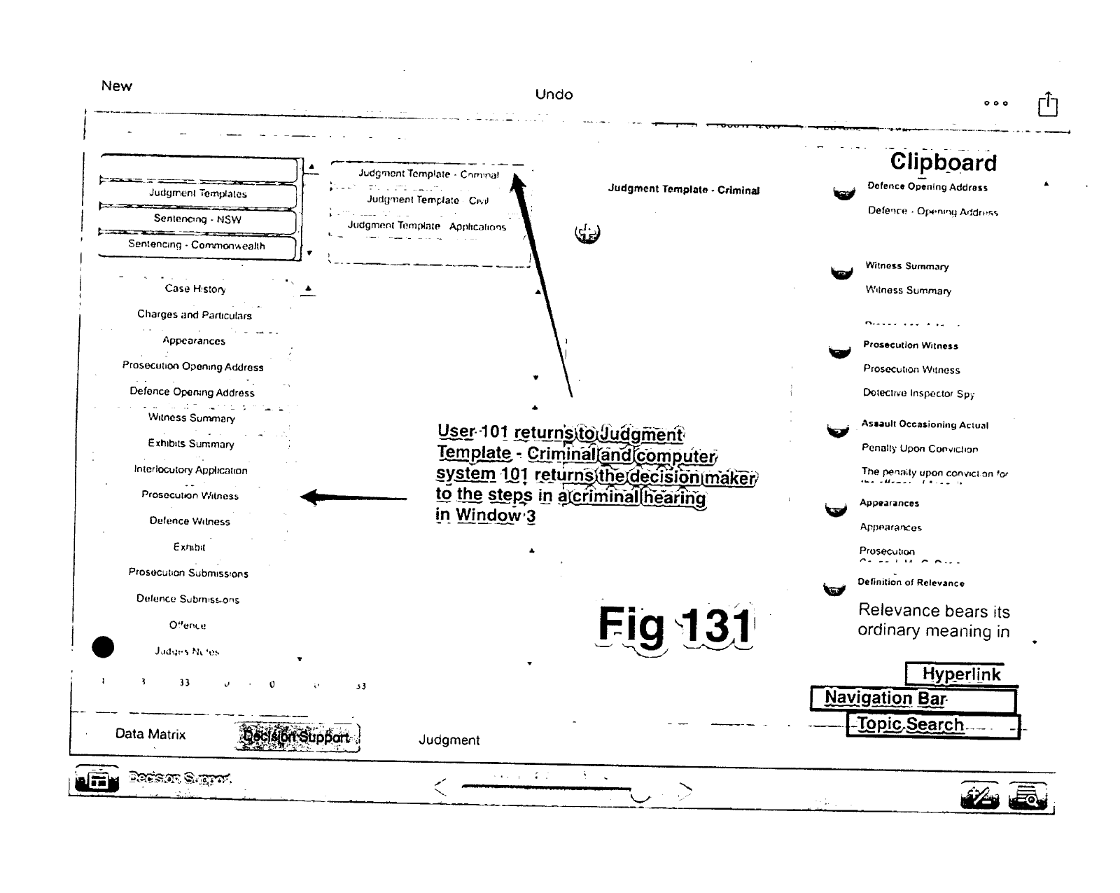

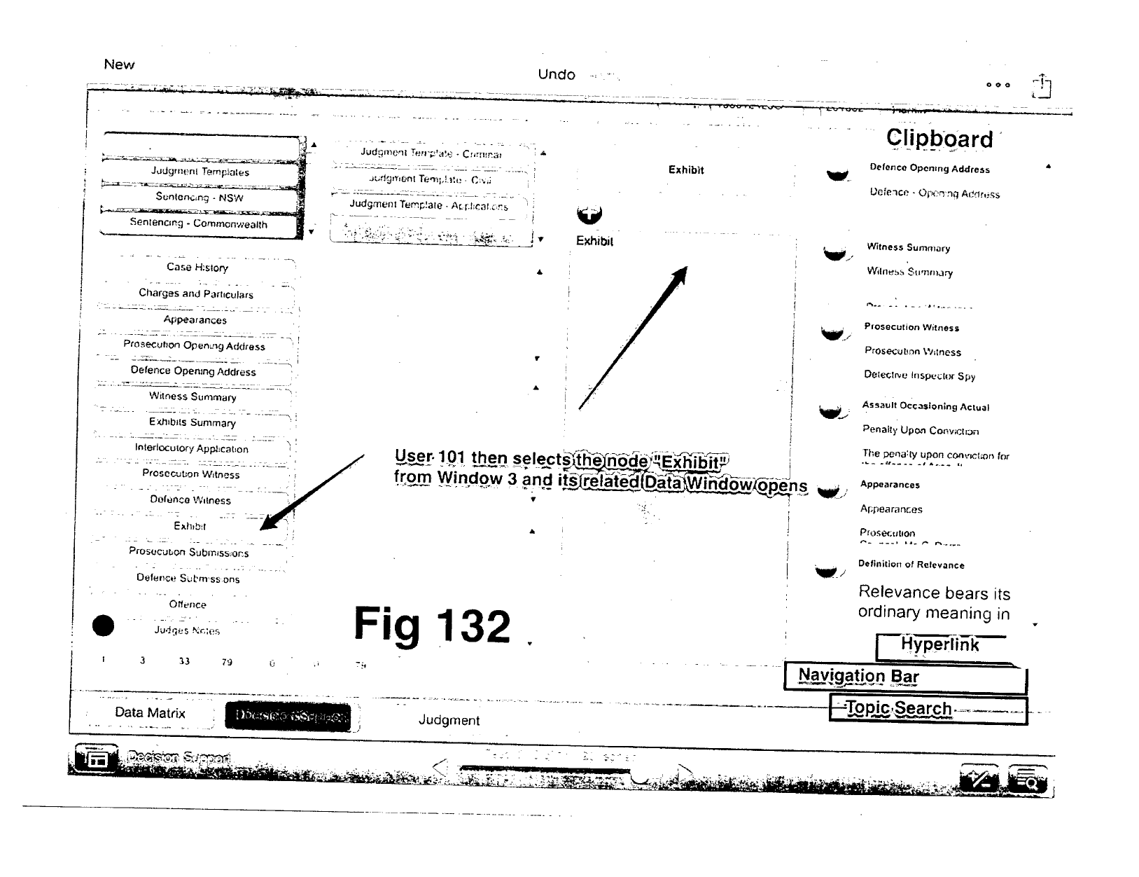

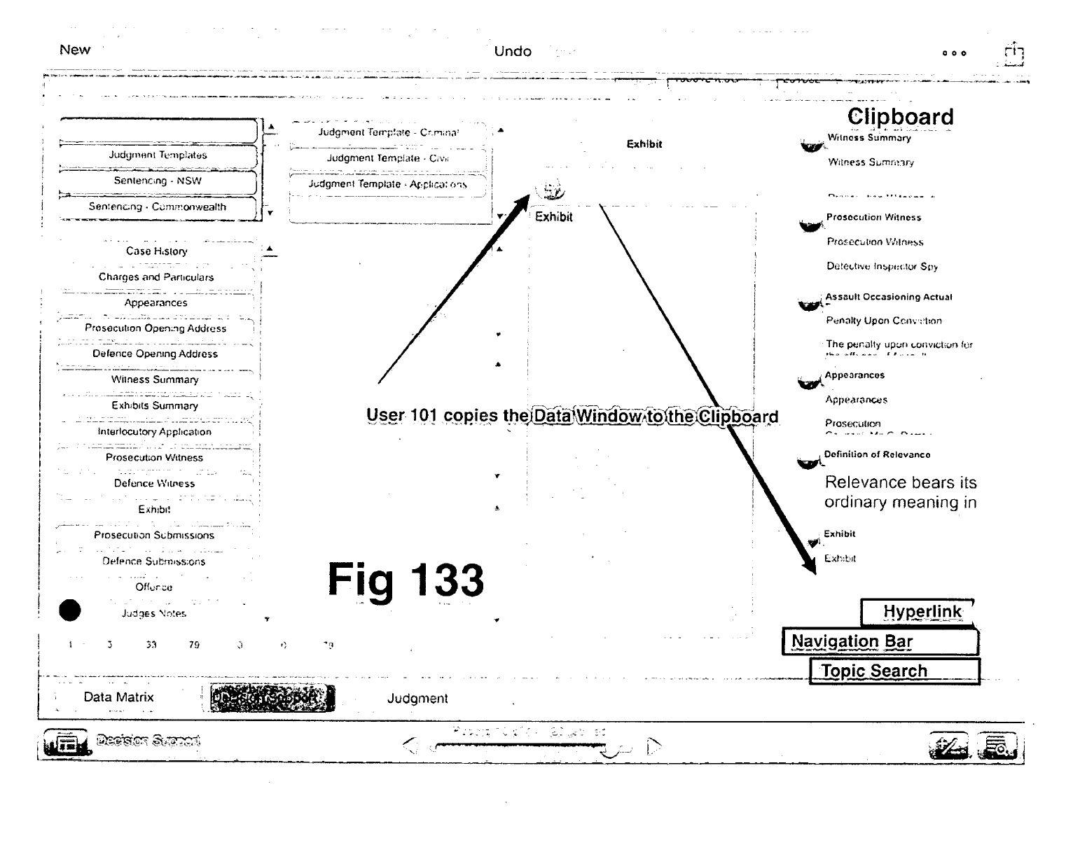

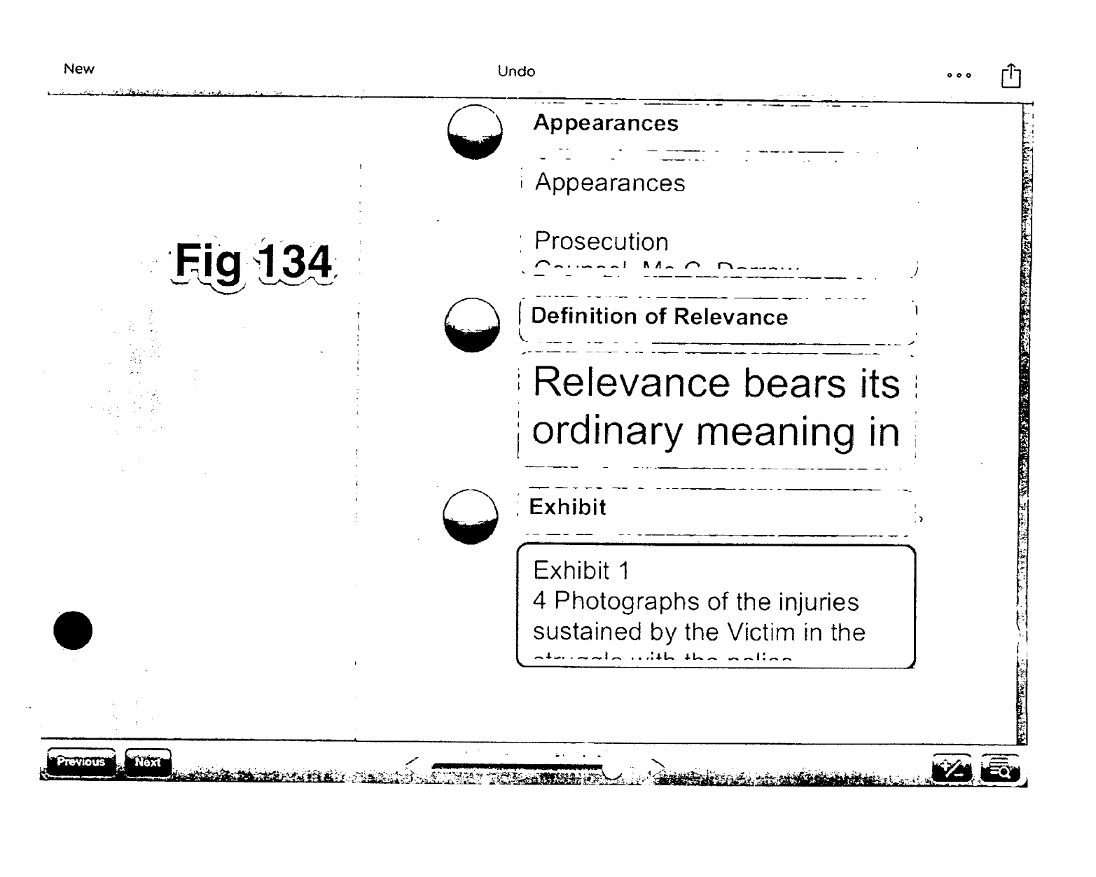

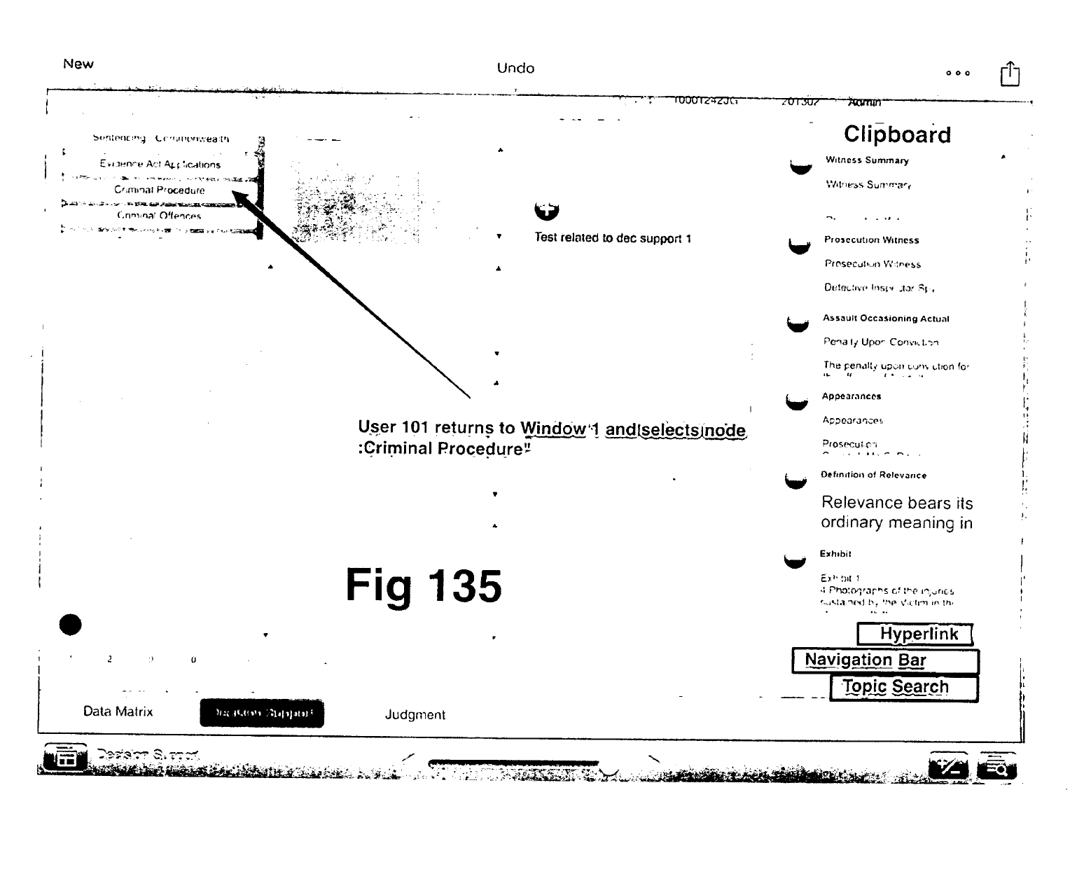

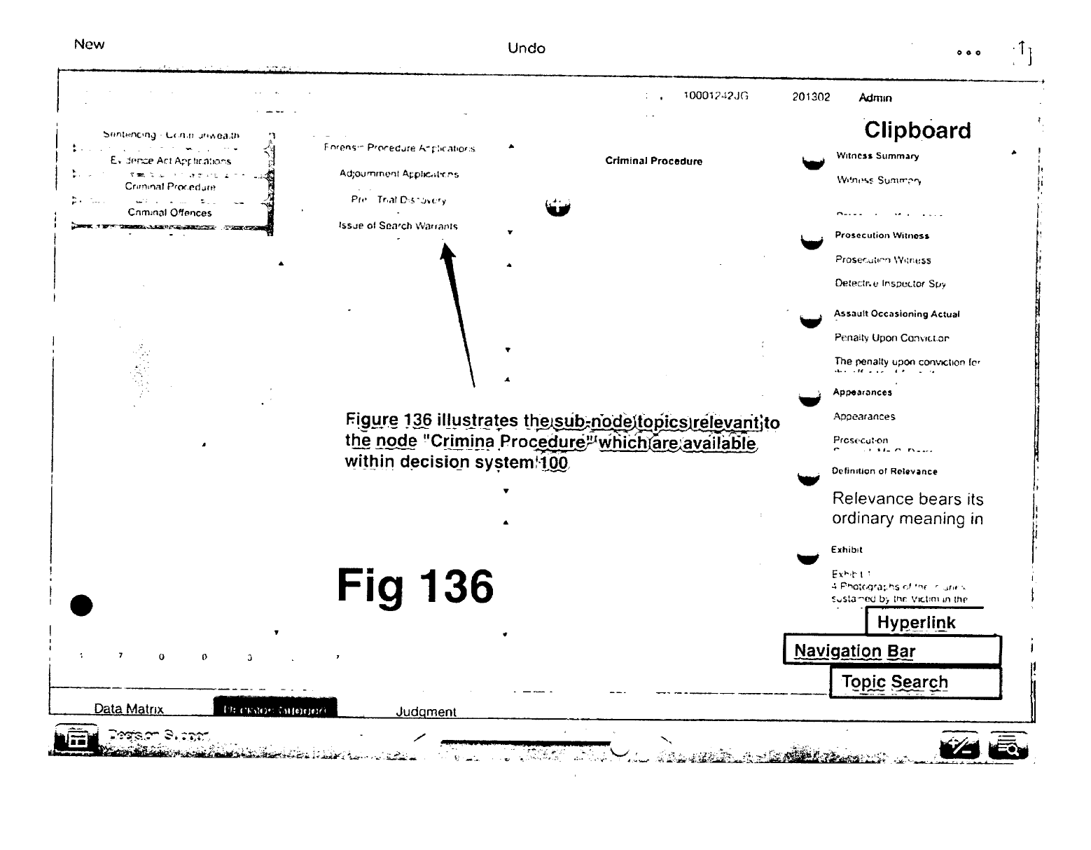

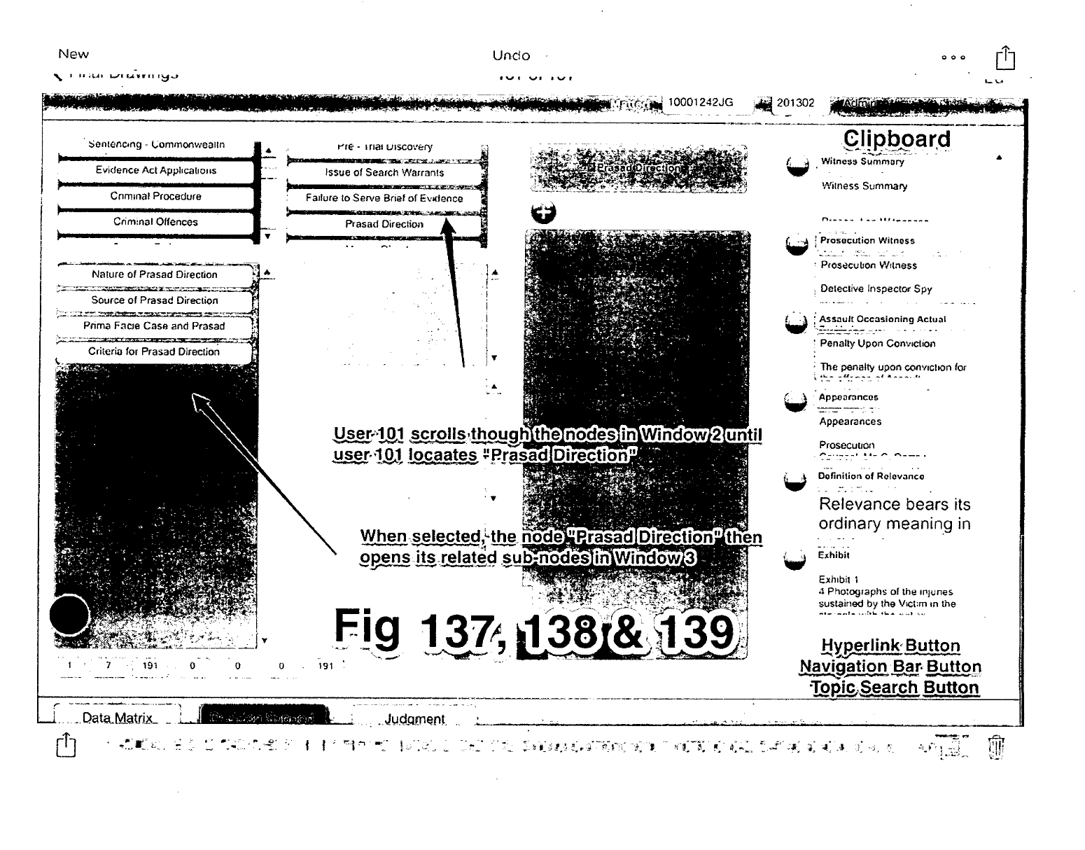

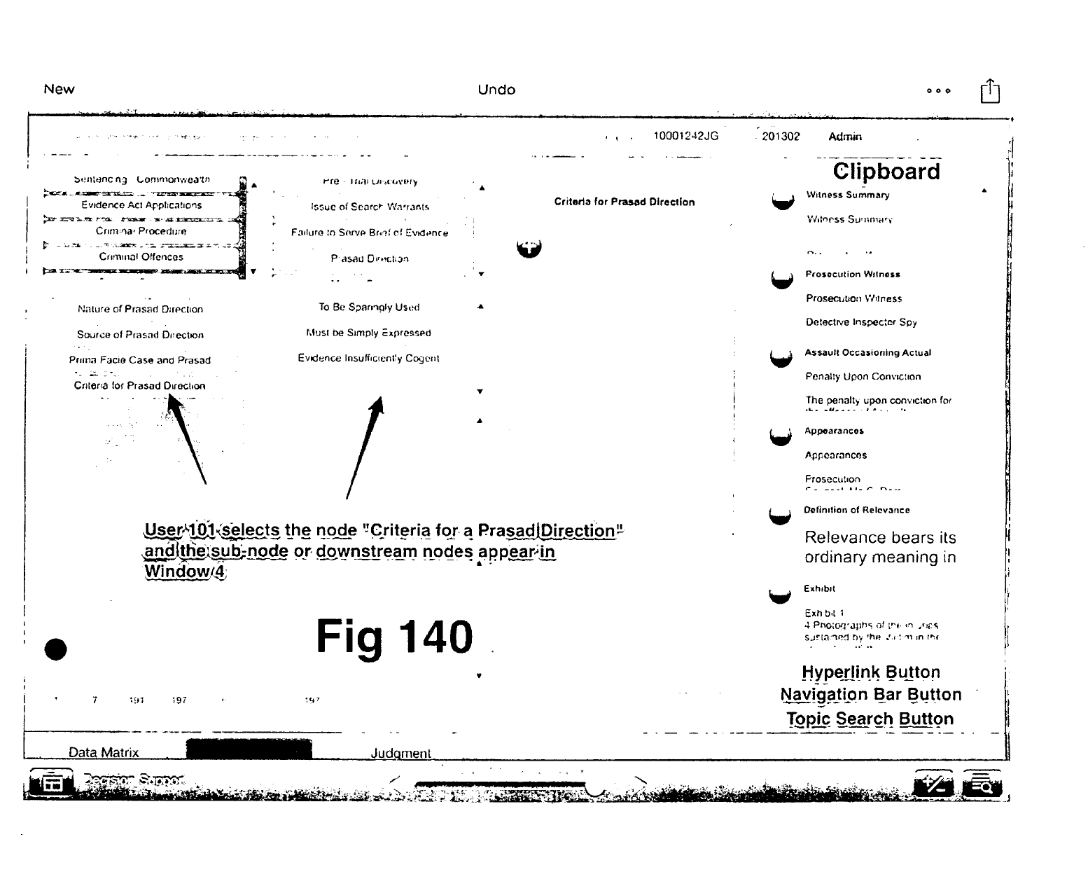

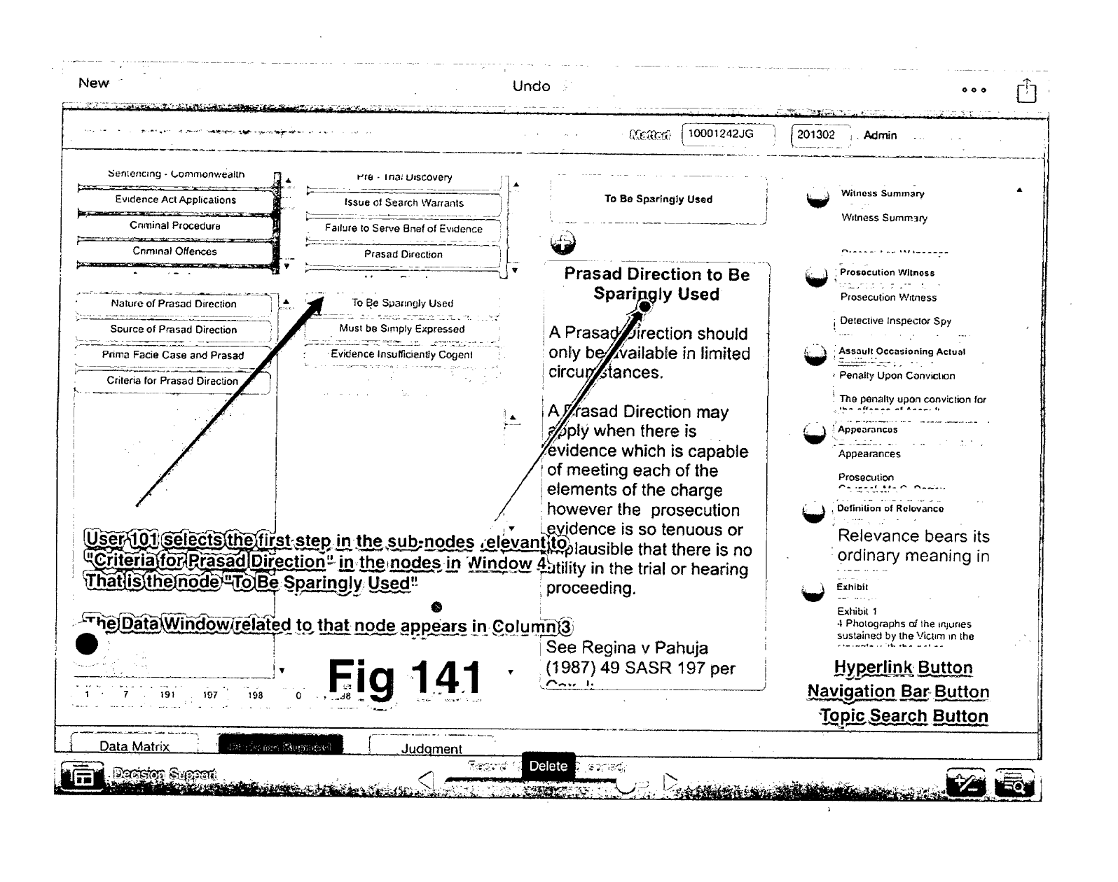

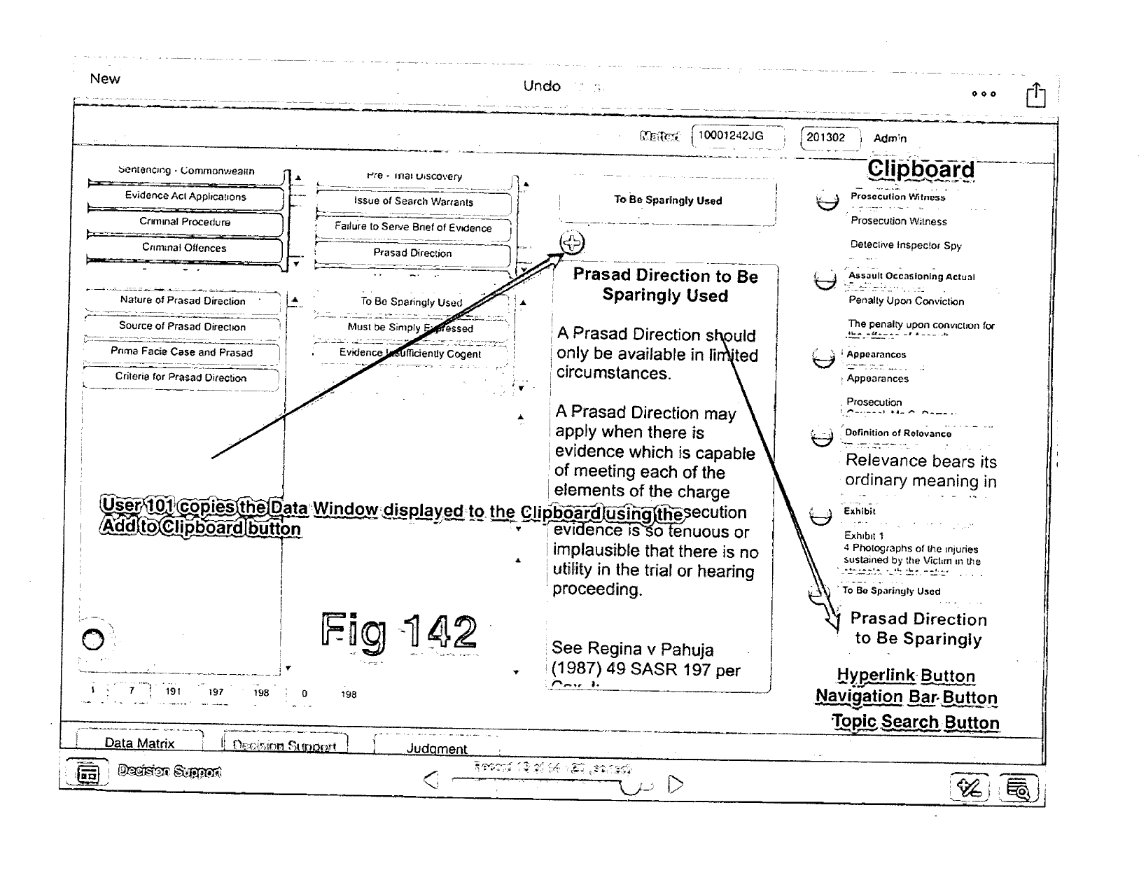

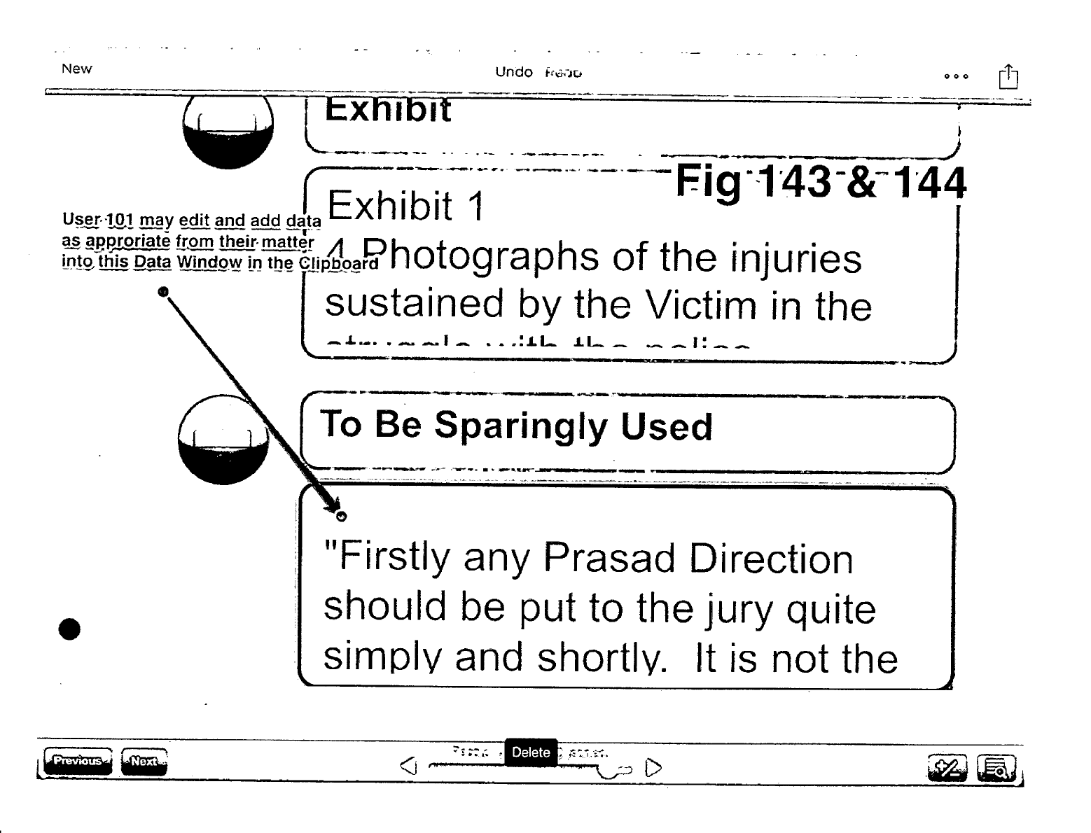

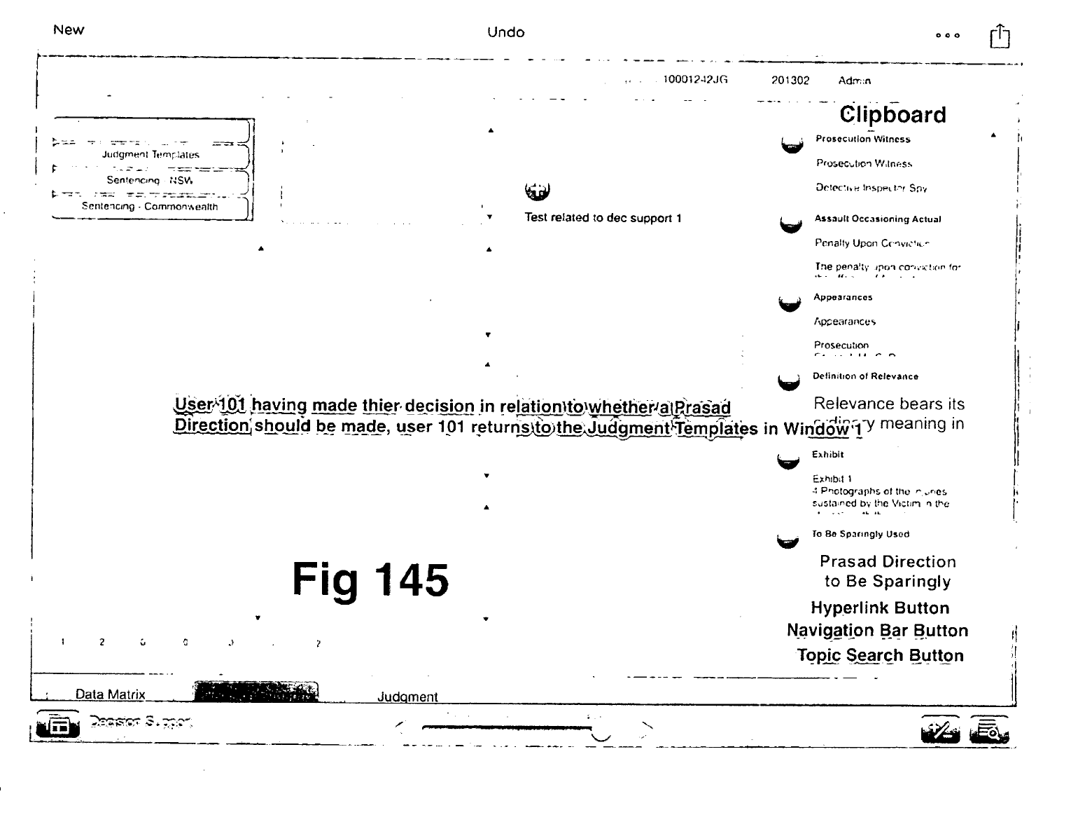

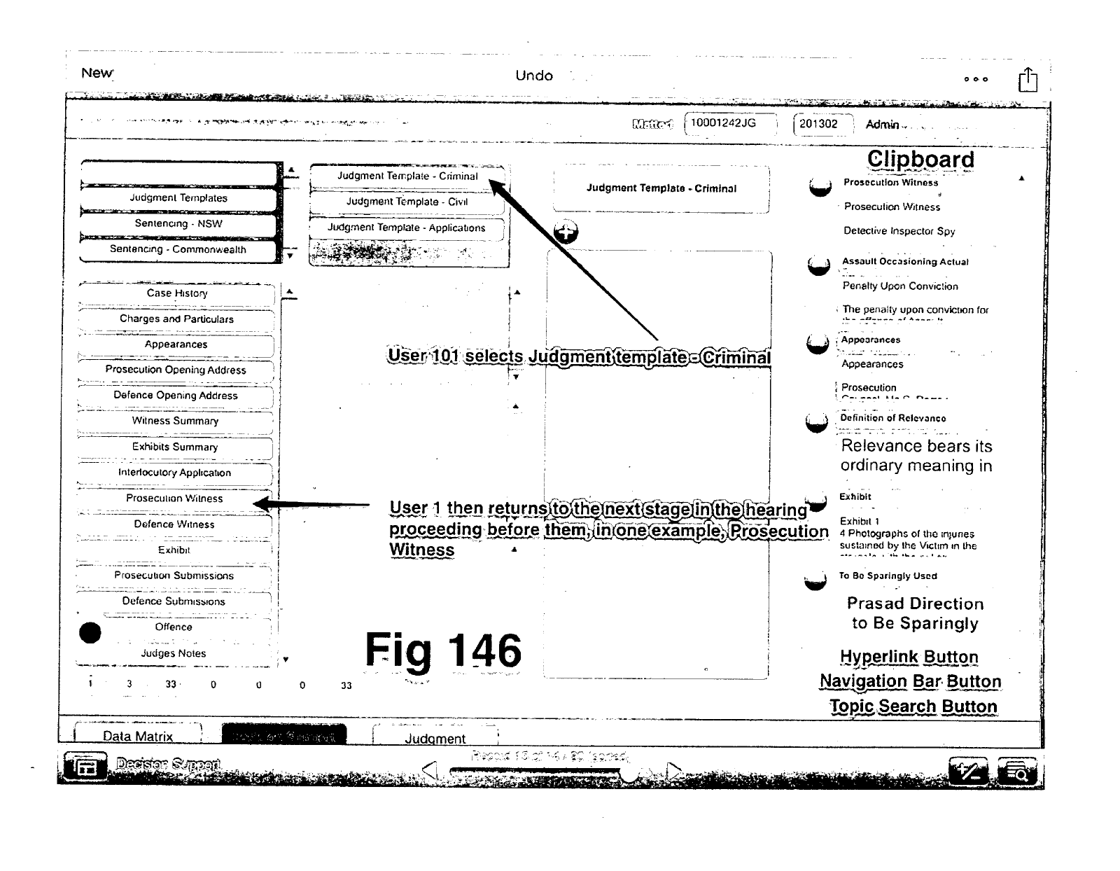

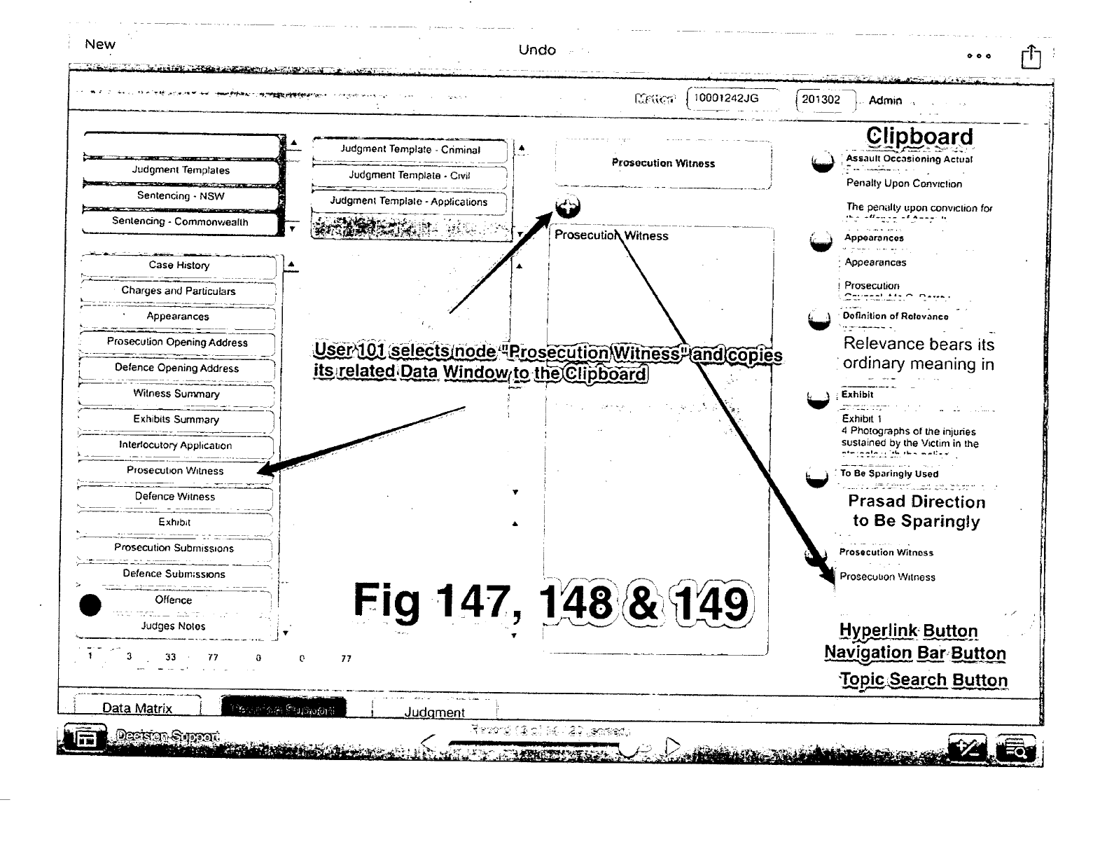

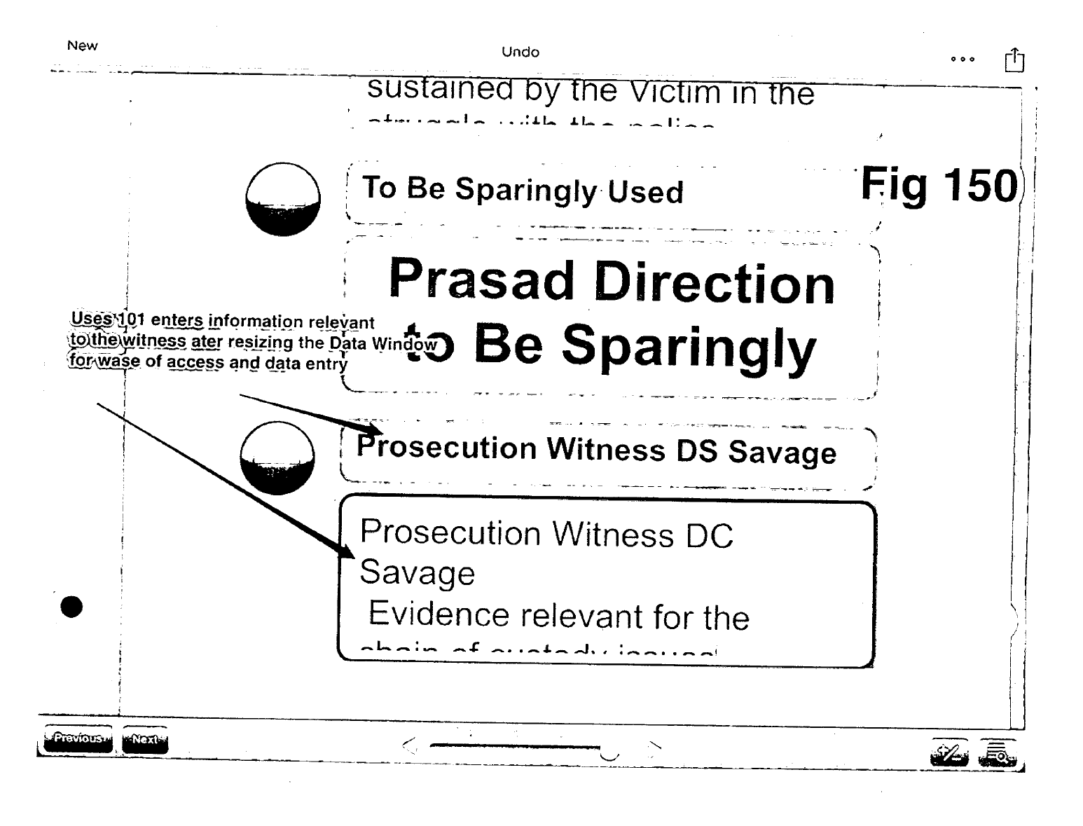

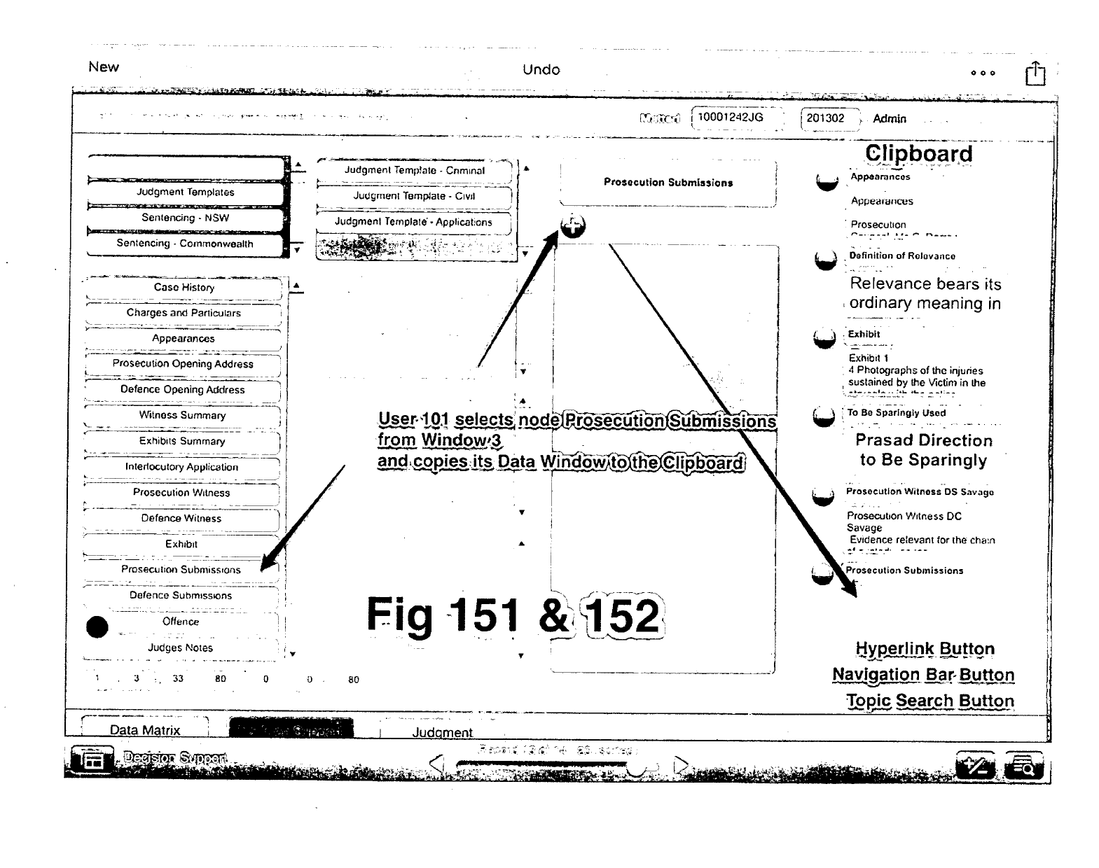

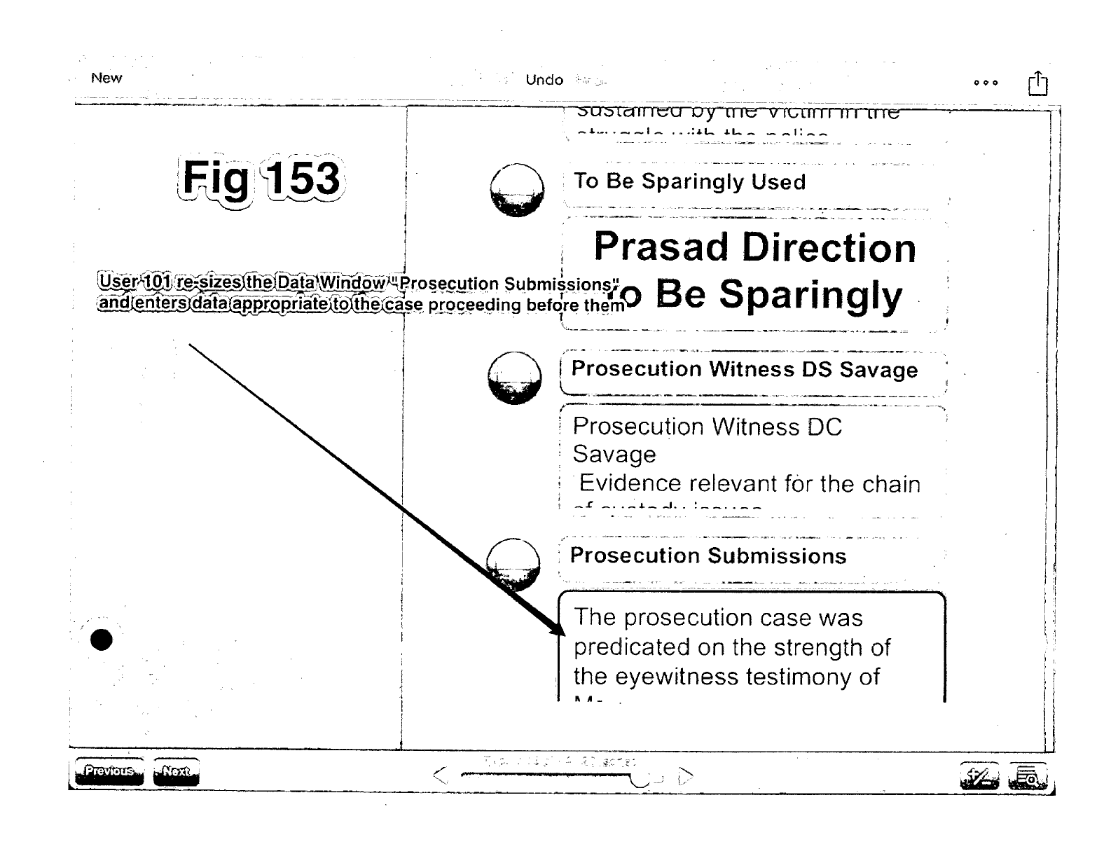

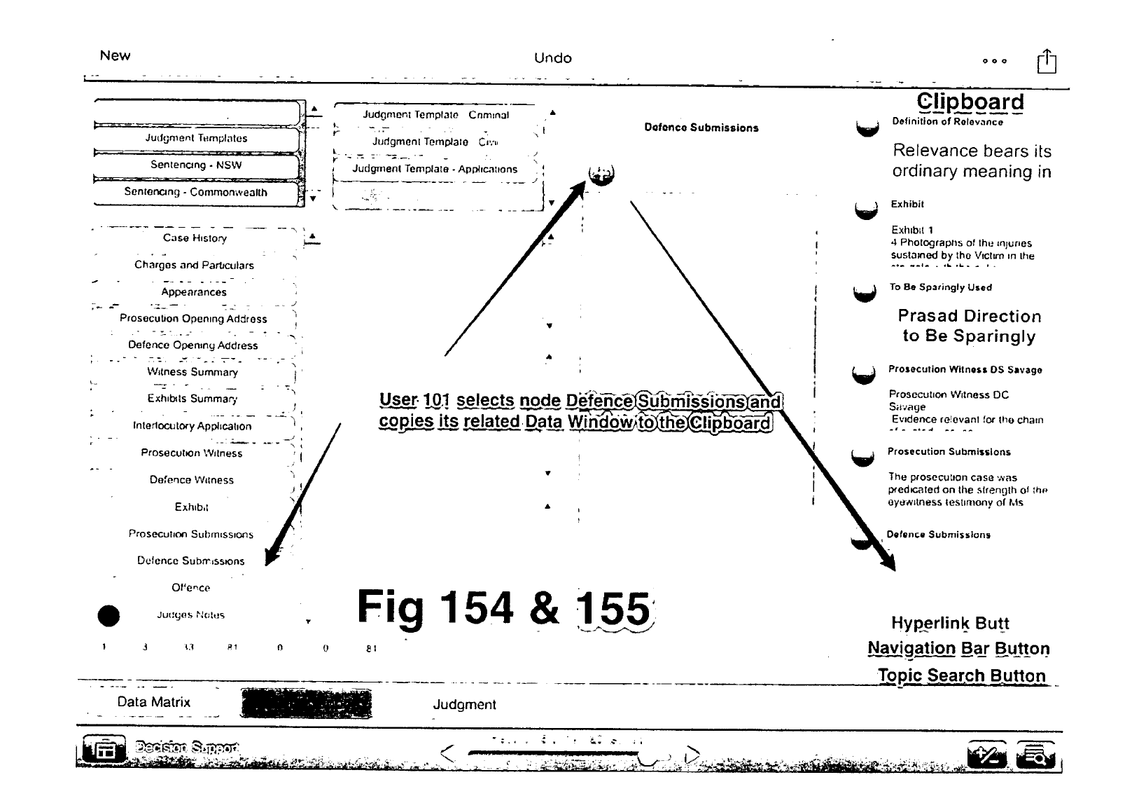

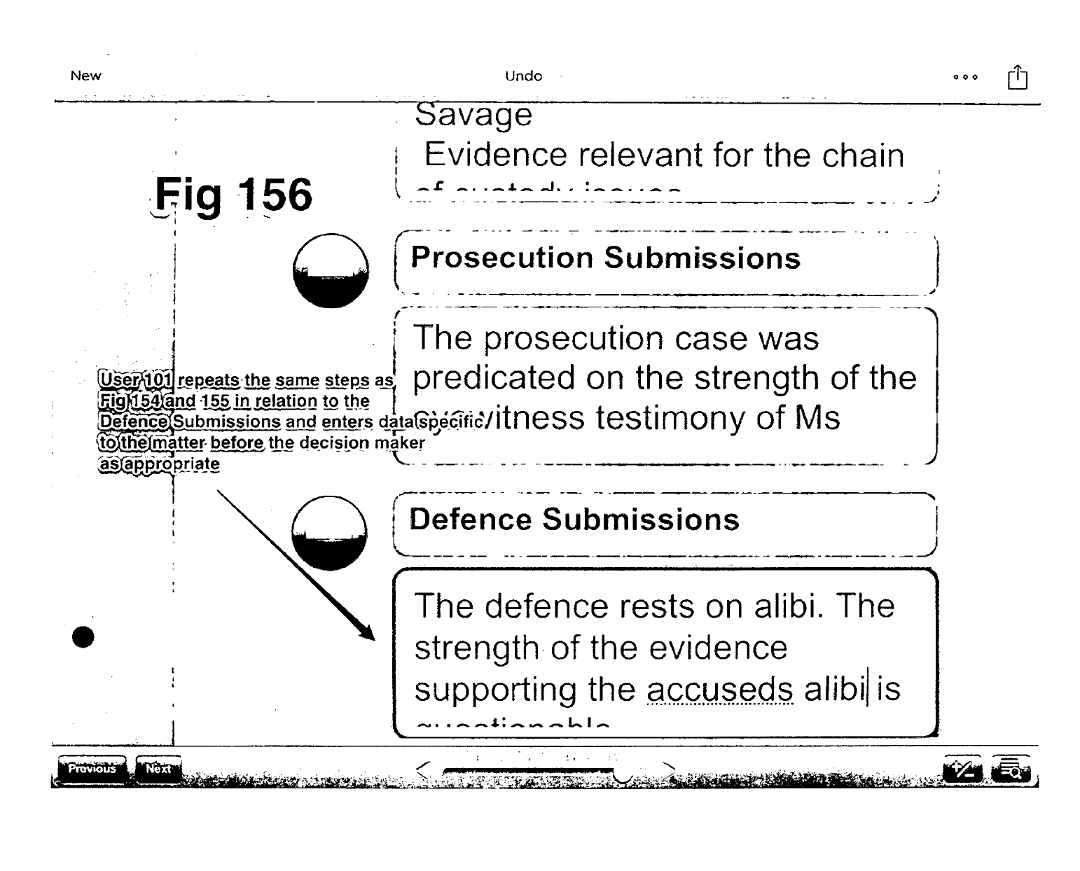

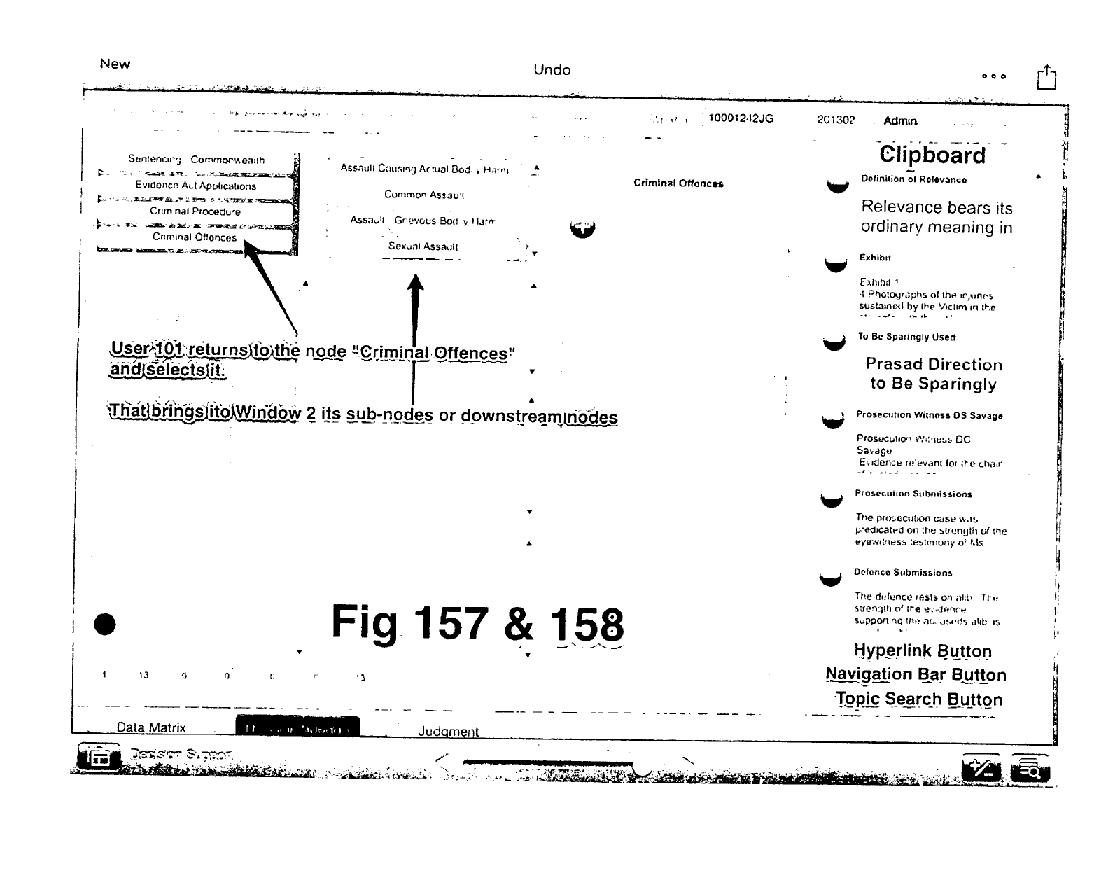

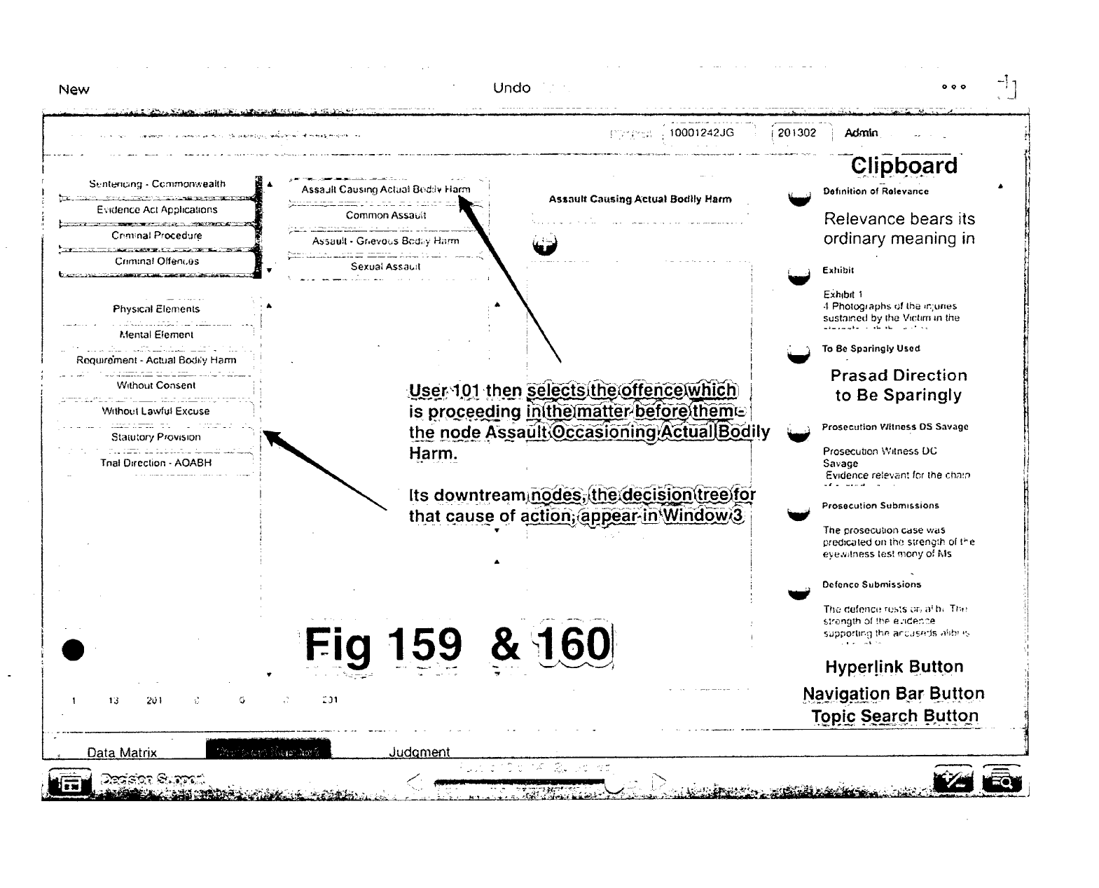

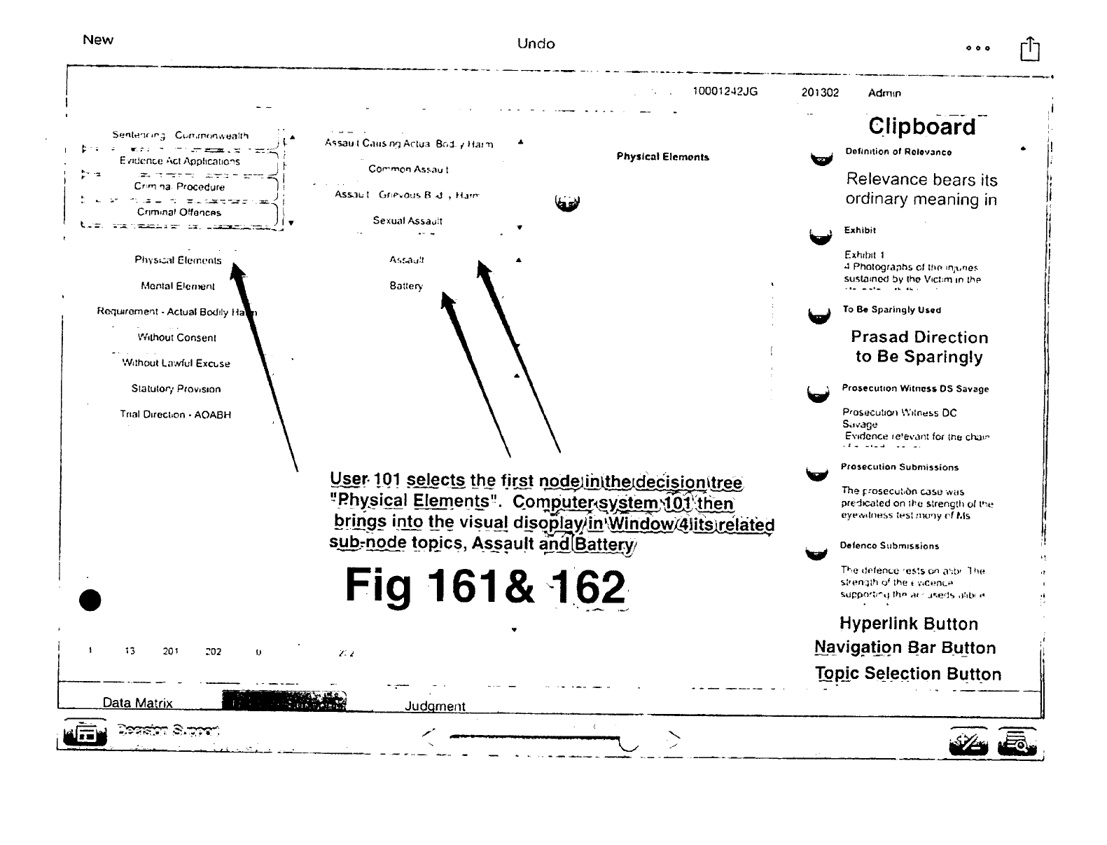

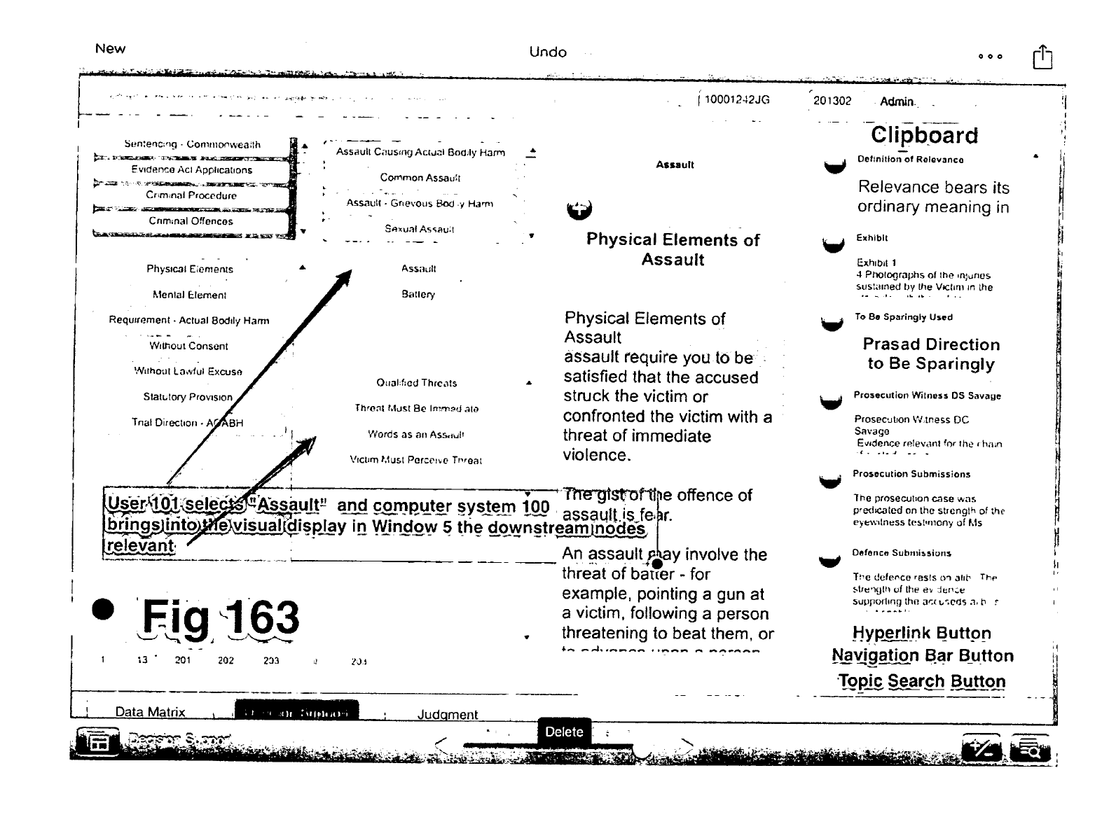

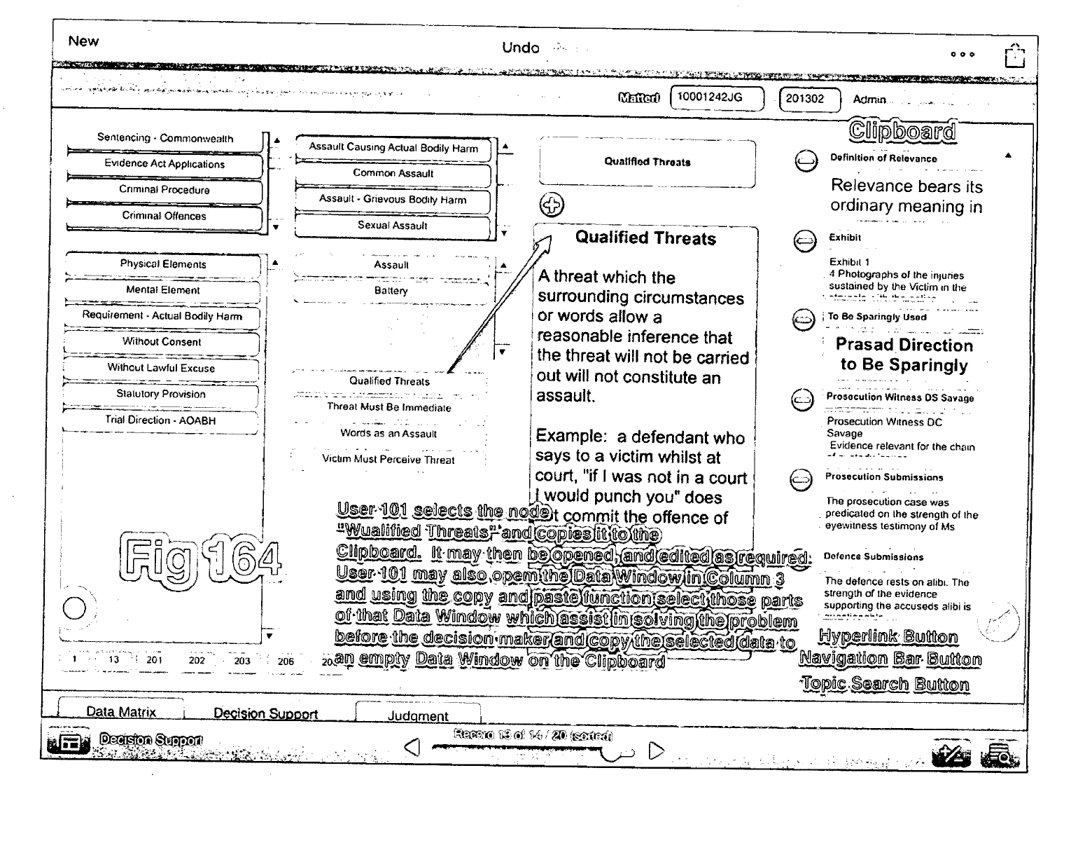

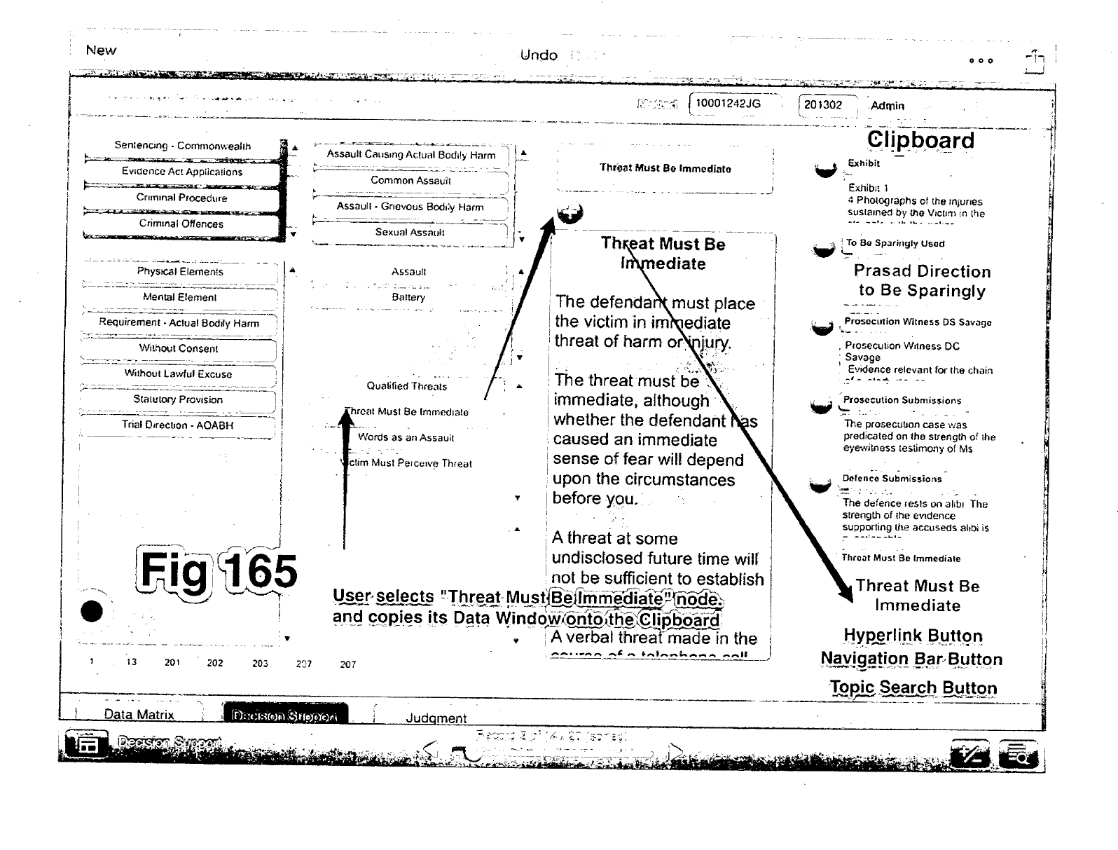

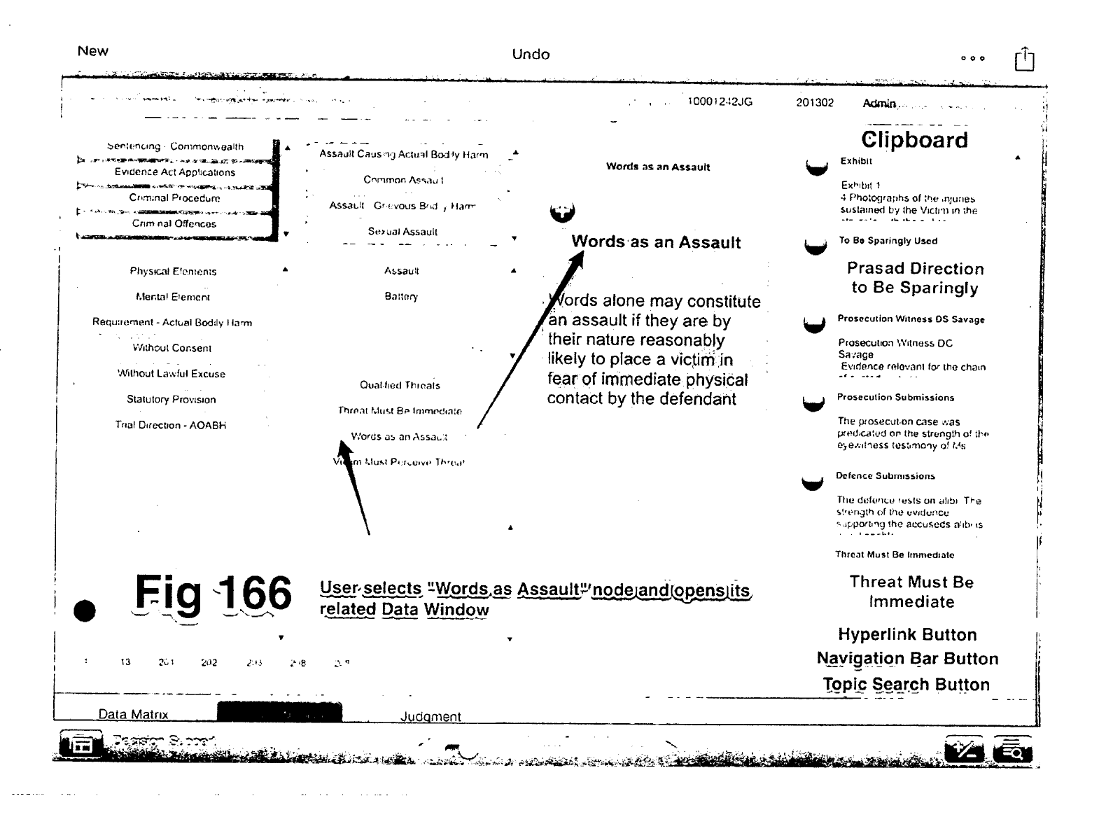

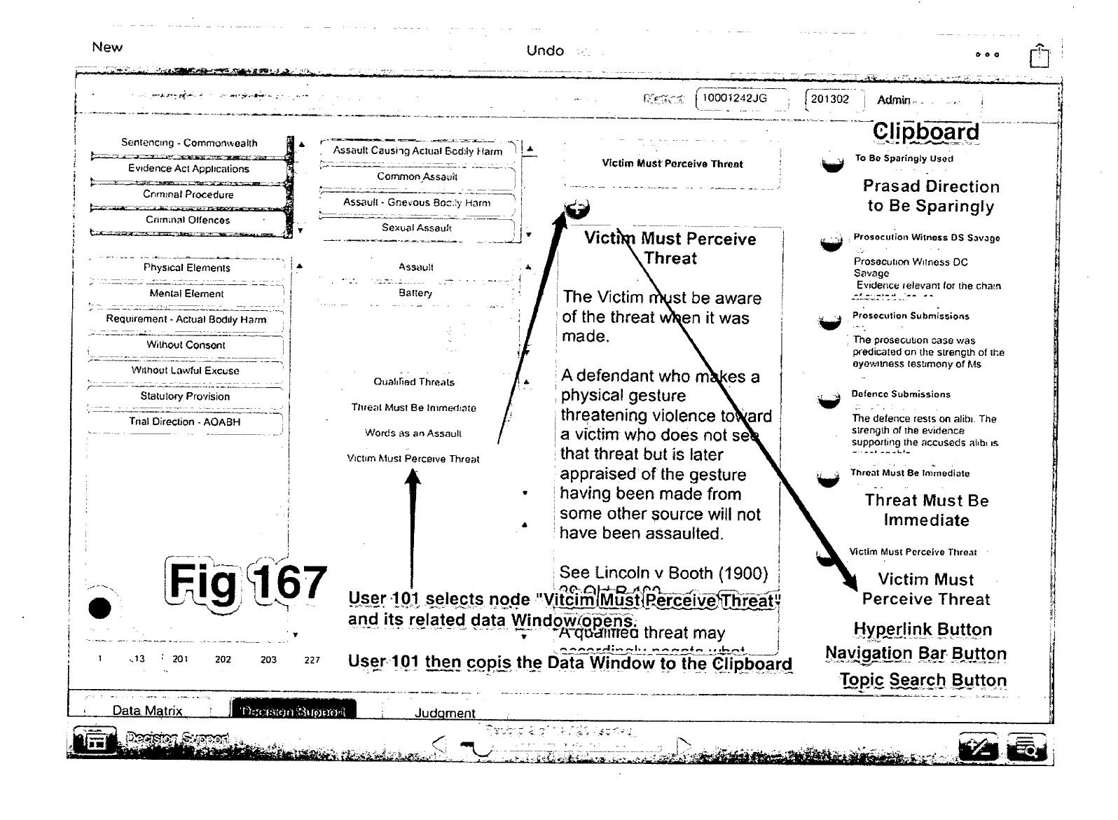

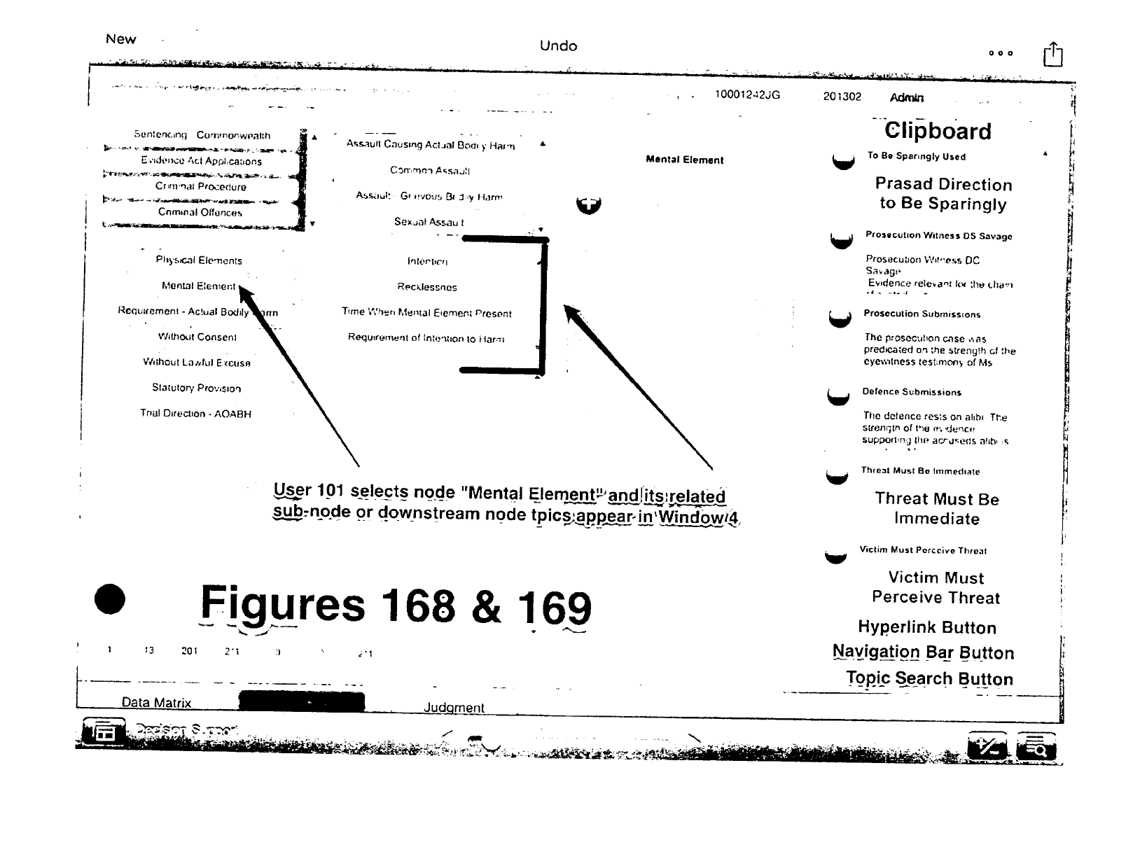

FIG. 13 illustrates another user interface 1300 where the decision maker selects the primary node topic, “how does the Court proceeds to find the facts relevant to sentence” 1206 at the NNDS SDA Screen. The topics that inform the decision maker how they should answer that question appear in the sub node. Note that the Sub-Node window 1302 has a scrollbar 1304 so that the topics which are able to be displayed are not limited by the size of the visual display.

Referring back to FIG. 2, the next step of method 200 is to display 212 a user interface including at least part of the decision tree including the selected node and at least one generation of downstream nodes. This can best be seen in FIGS. 6 and 7 where the node 602 “Application of the Evidence Act” is selected and one generation of downstream nodes, in this case node 604 “Onus of Proof on Sentencing”, is displayed.

The user interface further includes a persistent menu as explained with reference to FIG. 4.

The Decision Maker may sequentially work their way through each topic in the Sub-Node window 1302, or go straight to the topic in relation to which they have a specific query. In the illustrated example, the decision maker may wish to know whether the onus of proving a particular fact relevant to sentence lies on the prosecution or the defence (ie whether the defendant has some mental infirmity at the time of the commission of the offence).

The decision maker opens the Sub-Node topic, “The Onus and Standard of Proof” and its related Data Window opens. The link between the SDA and the Data Matrix is maintained through the Header Topic in the Data Window.

If the information or summary of the applicable legal principle contained in the data window in SDA mode is not sufficiently precise all detailed for the decision makers purposes, the decision maker may activate the link in the data window in SDA mode and be taken directly to that same topic in the Data Matrix mode.

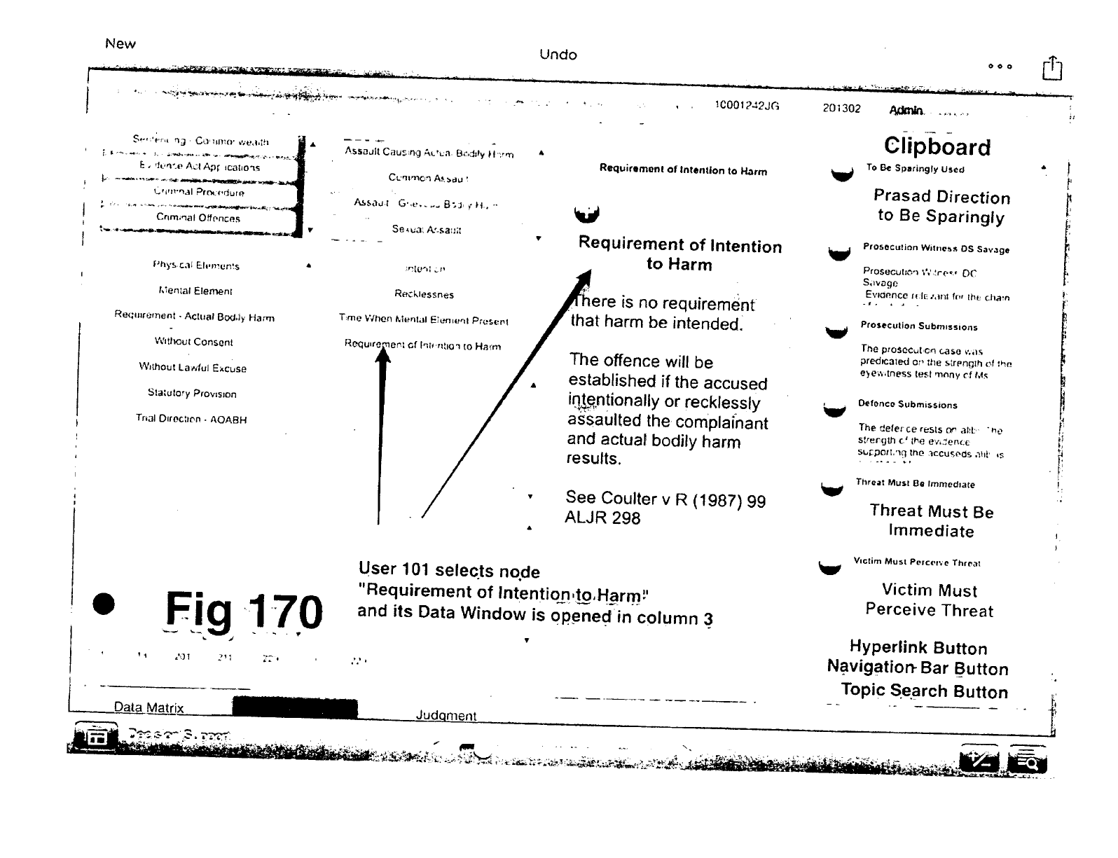

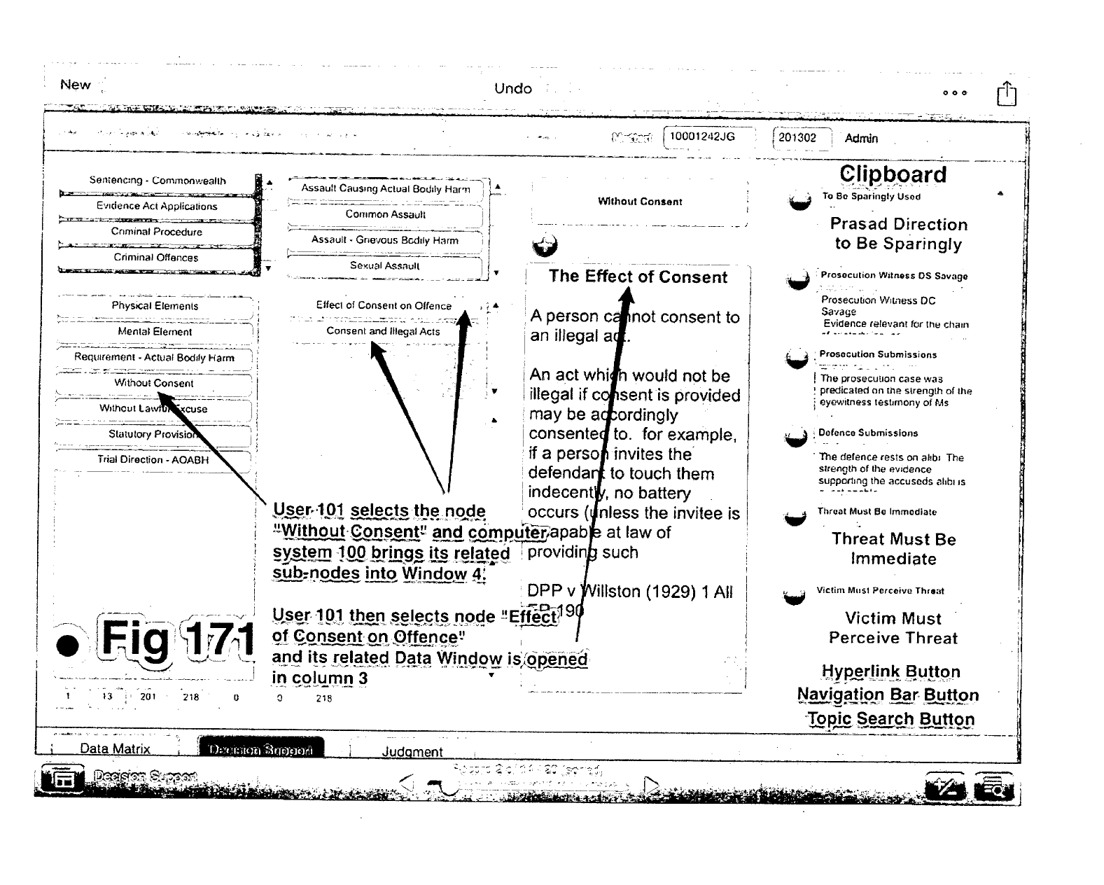

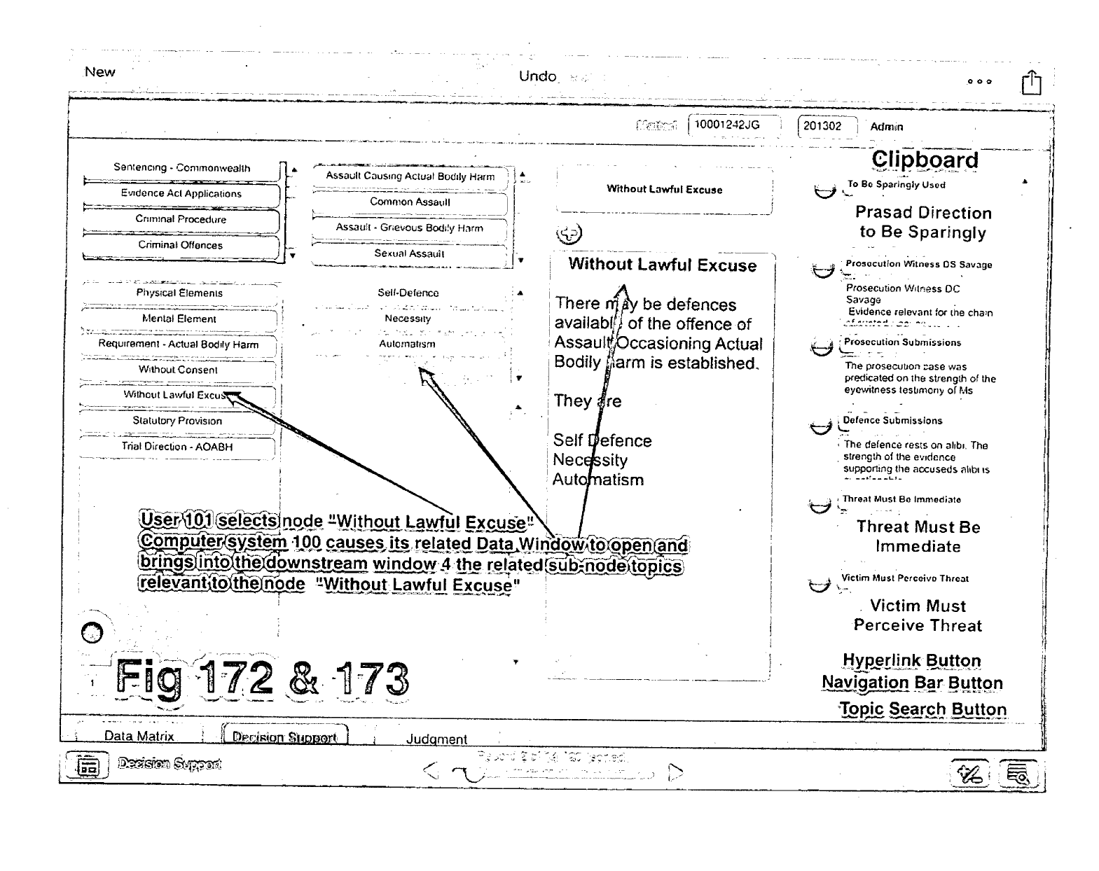

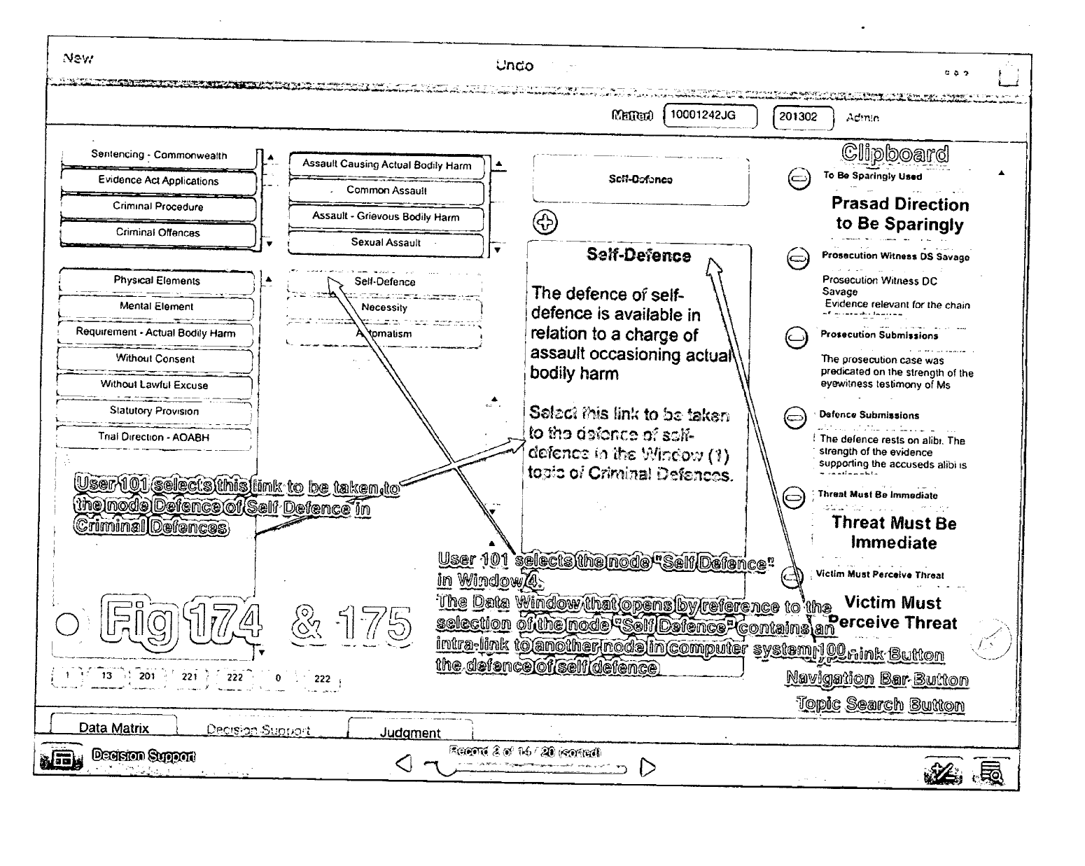

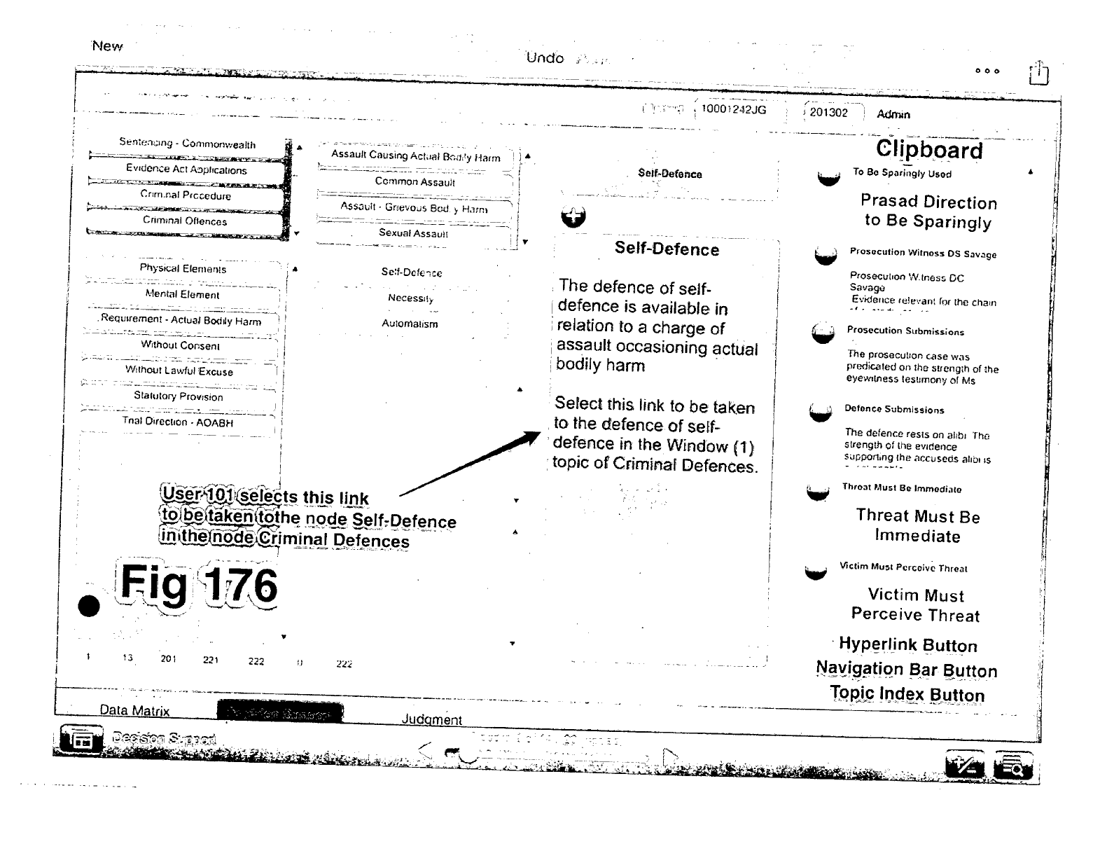

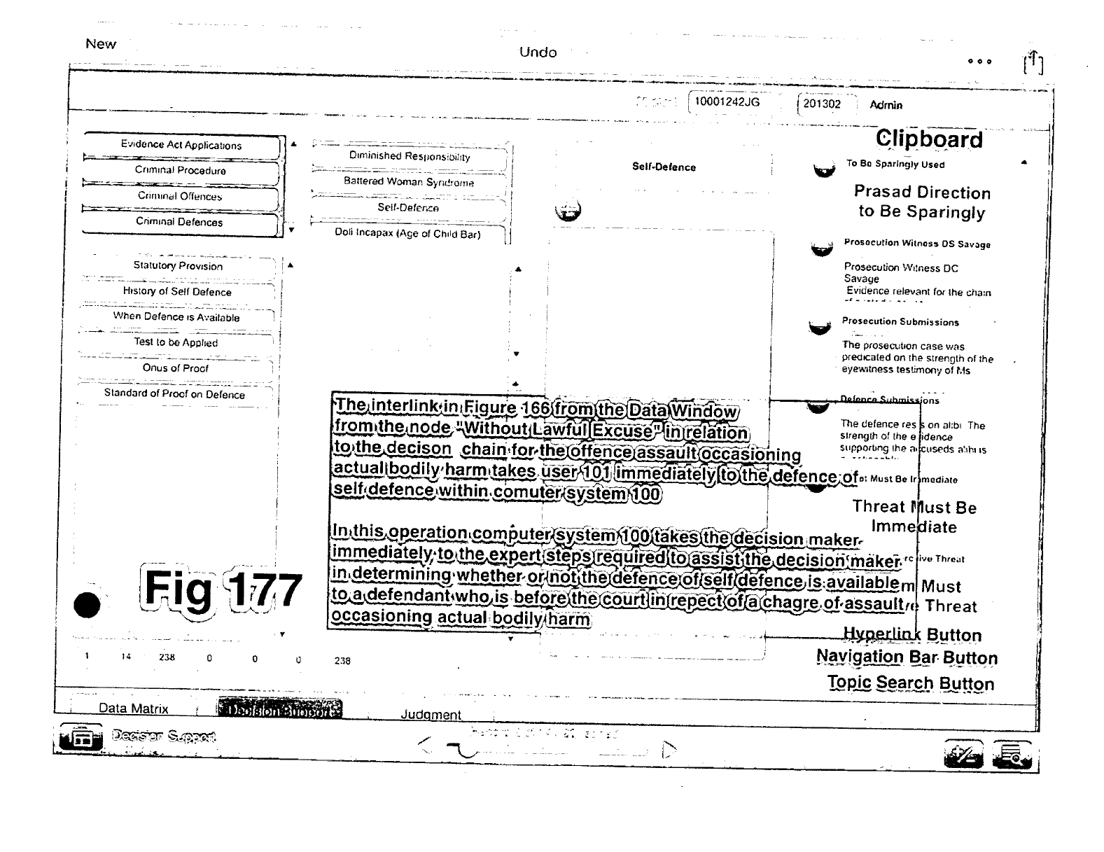

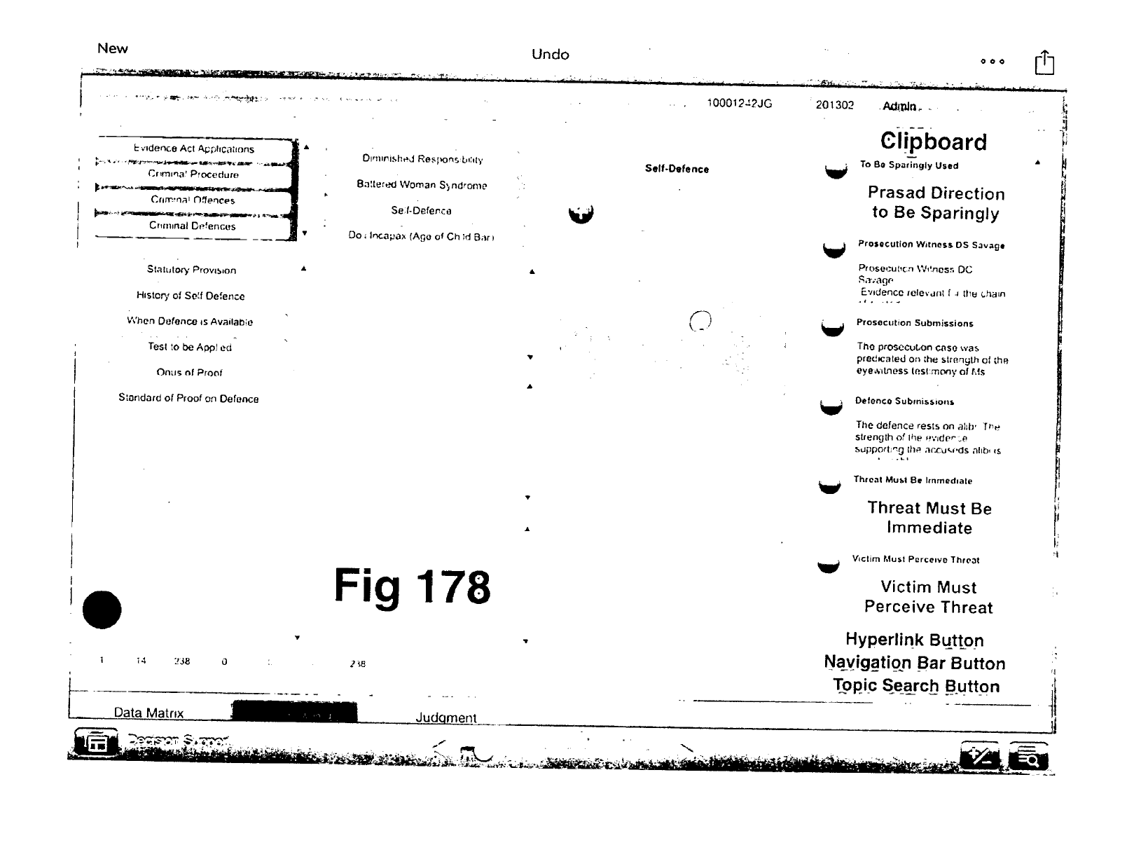

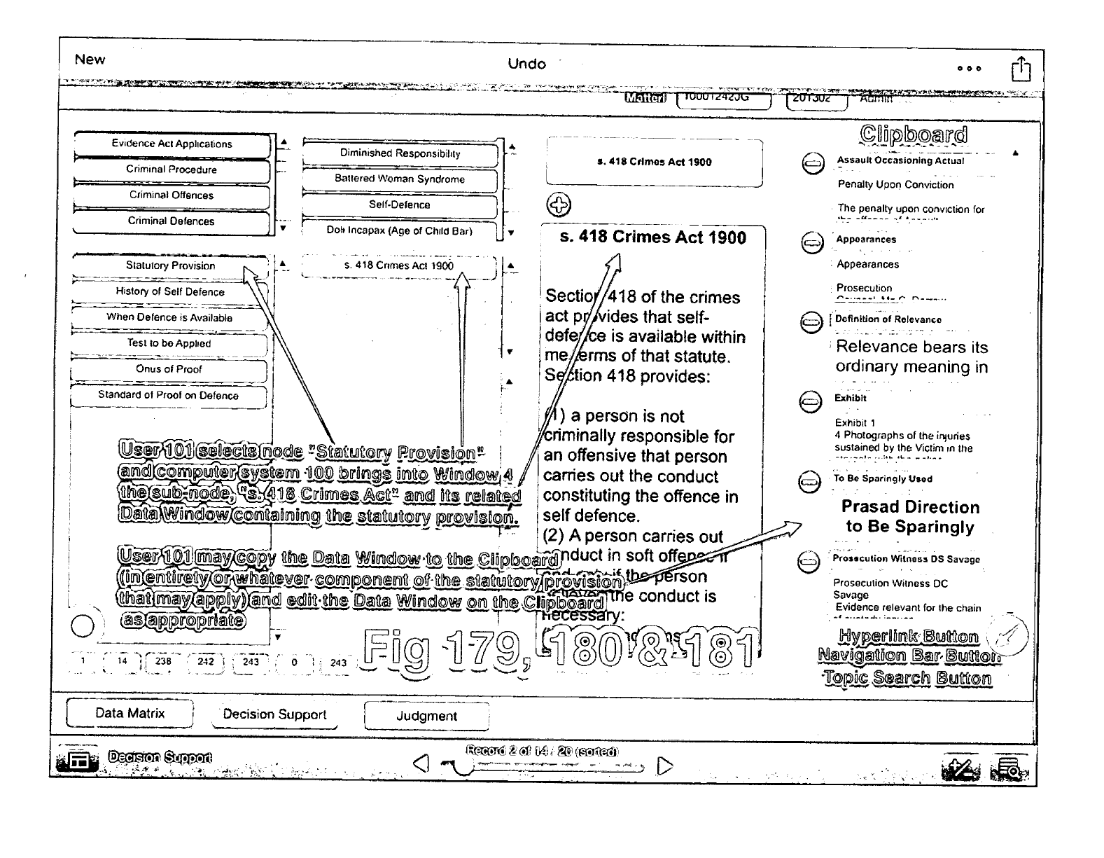

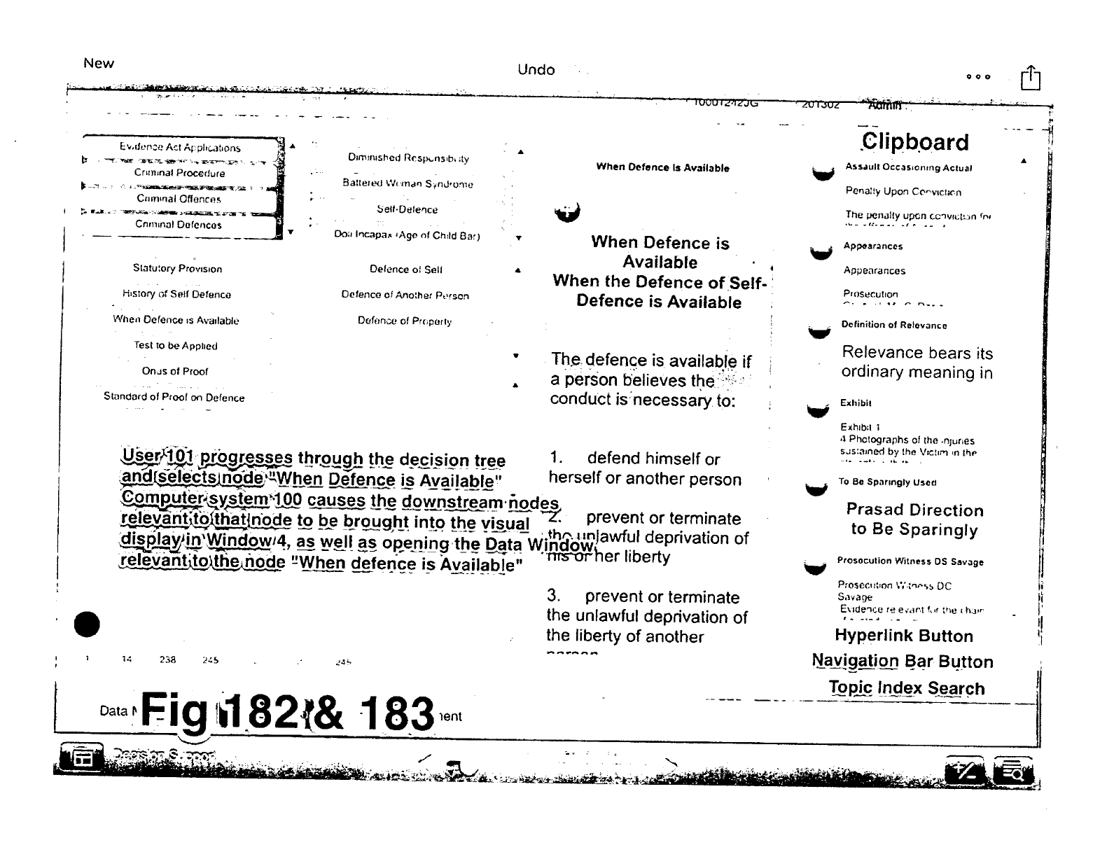

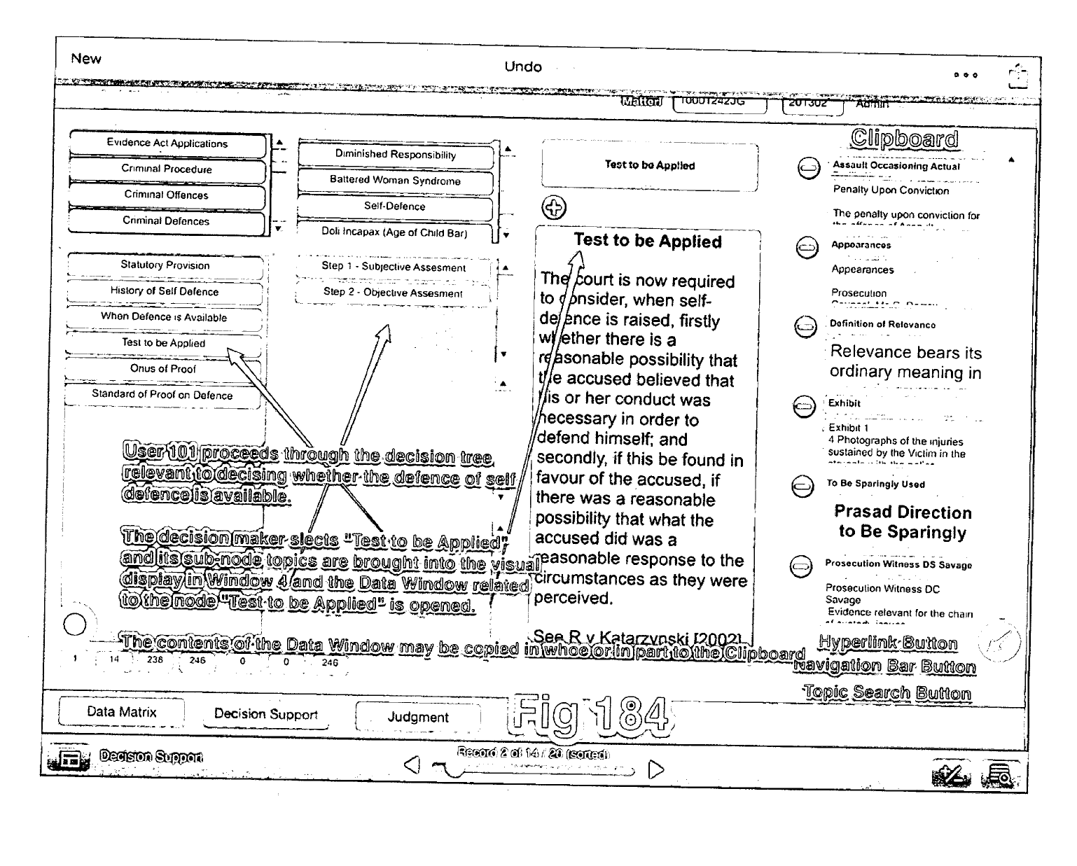

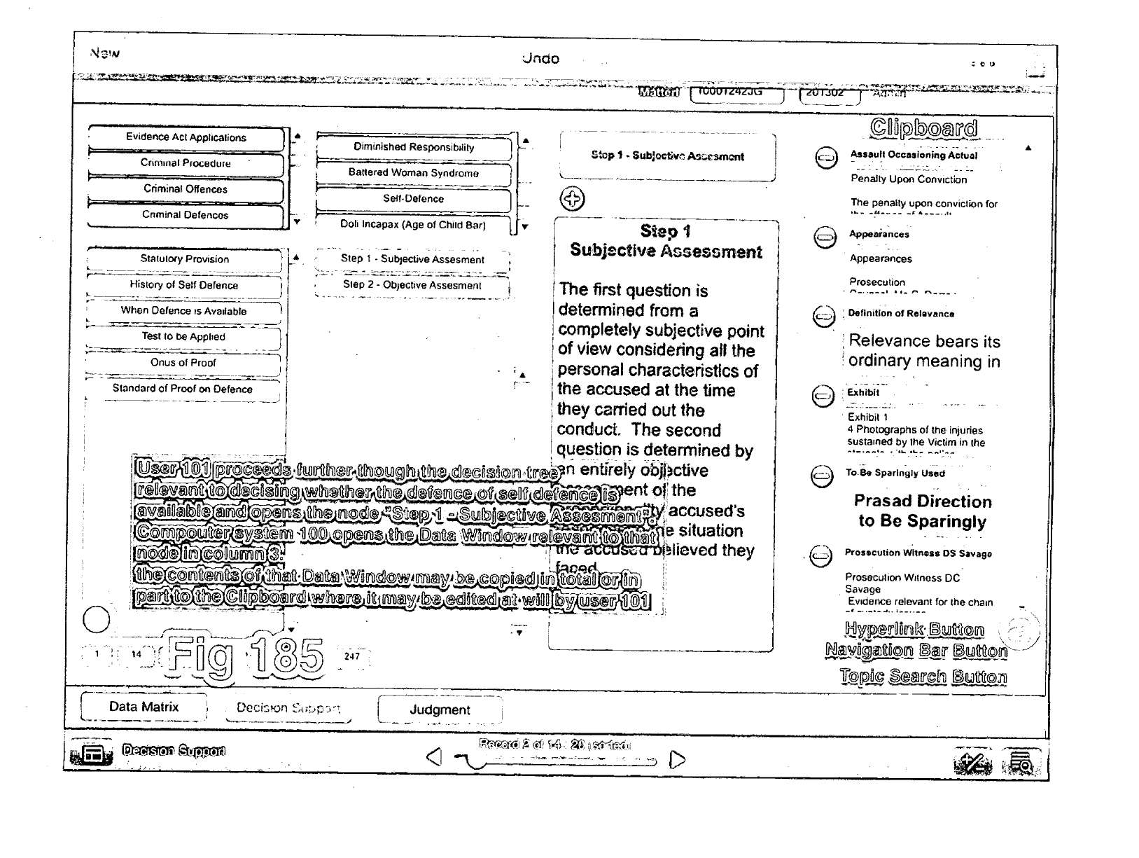

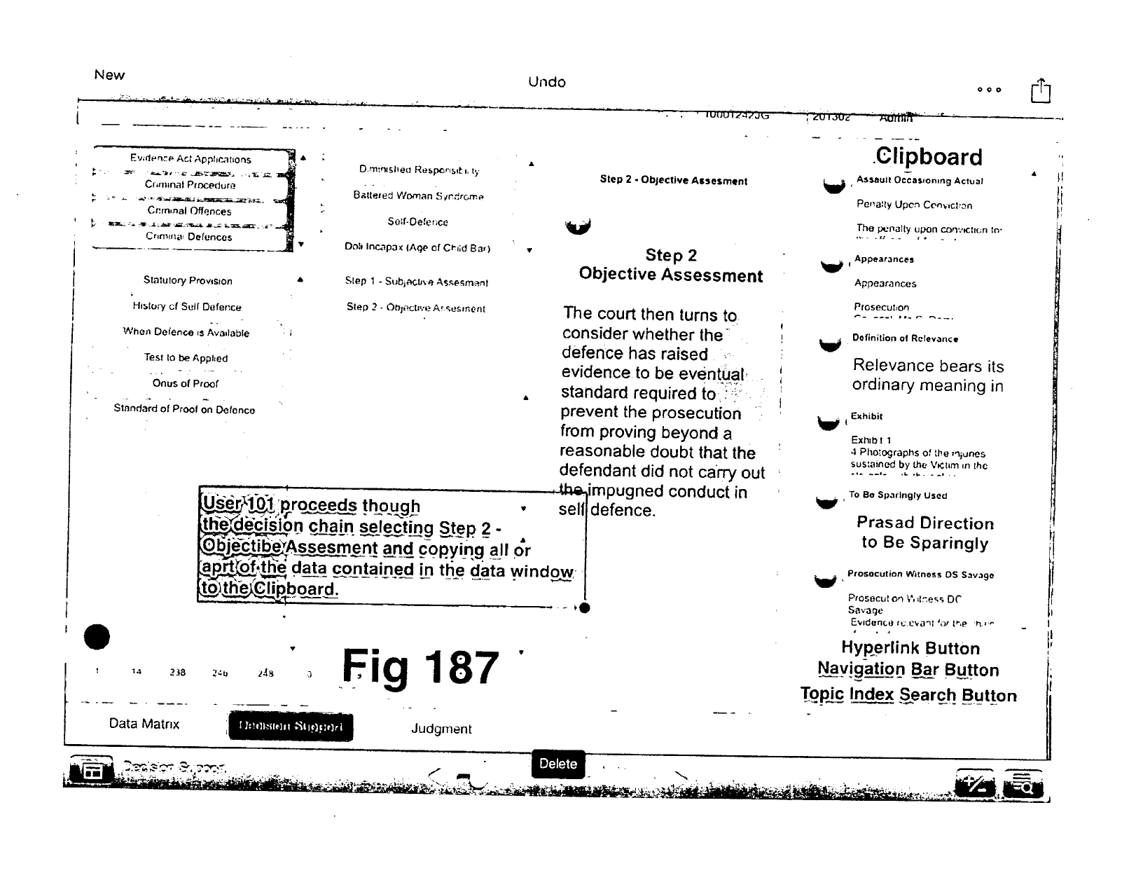

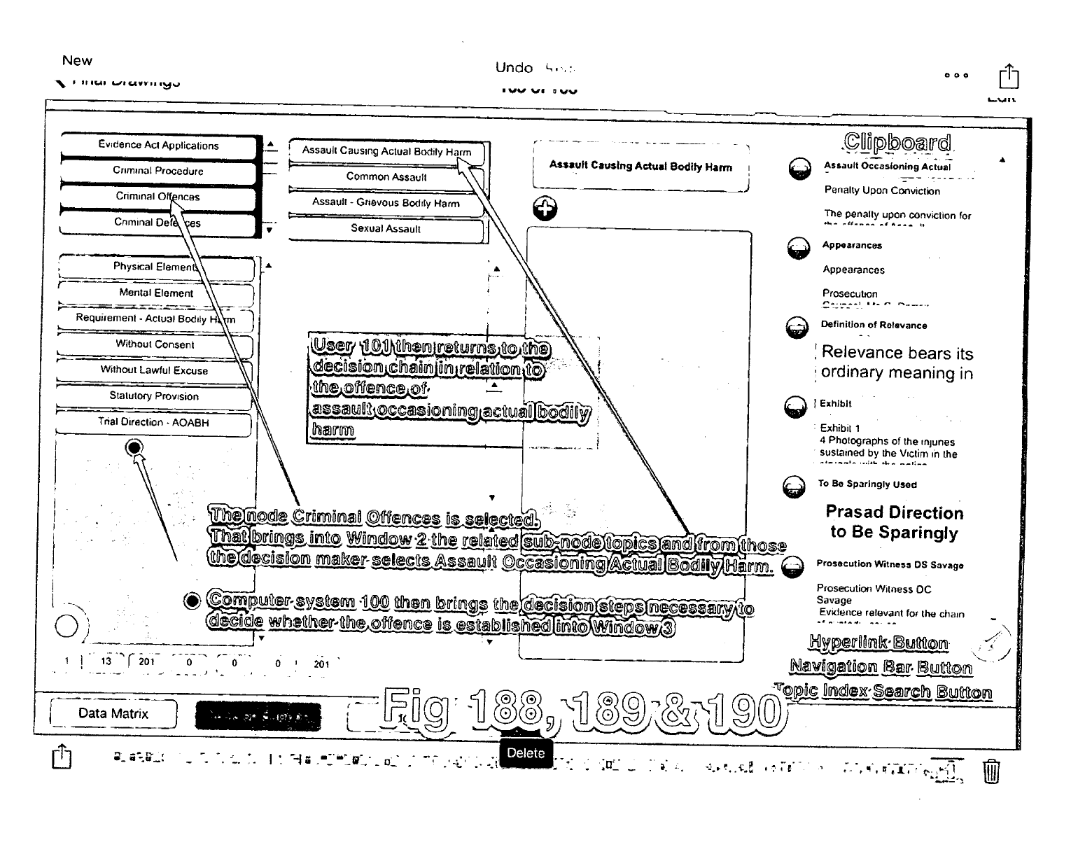

FIG. 14 illustrates another user interface 1400 that shows this a feature of the NNDS system and the mechanism through which the Data Matrix and Structured Decision Assistance modes integrate. If the link 1402 to the data matrix is activated, and the decision maker is taken to the Data Matrix mode, the decision maker may then explore all the available data in respect of that topic which is contained in the Data Matrix in window 1404.

If the decision maker has taken themselves into the terrain of the Data Matrix, and there obtains the data required (ie by cutting and pasting it then copying it to the Clipboard), the decision maker may then click on the SDA link 1406 in the permanent display and that will take the Decision Maker back to that step in the SDA mode.

For the purposes of illustrating how the Clipboard may facilitate a decision-making in SDA mode, it is noted that when a decision maker has identified the particular item of data that they require for their decision, they may utilise the Clipboard function to extract that data for inclusion in their decision or judgement.

The decision-makers selects that part of the data 1408 they wish to use and it is cut and pasted to the Clipboard. Each selected item of heart is saved into a separate Data Package on the Clipboard. Whilst in Clipboard mode, each Data Package retains the Header 1410 of the Data Window from which it was selected and cut. This will facilitate the decision maker organising the Data Packages when ultimately preparing to export the contents of the Clipboard into a word processing package utilising the Compilation function for the purposes of generating the decision-makers report or decision.

The decision maker may at any time open any Data Package, to edit its contents to add data in relation to the specific problem the decision maker is seeking to address to the data contained in that Data Package. For that purpose, the user interface 1400 provides an input window 1412.

To return to the illustrative example, once the decision maker has resolved that aspect of the problem relevant to the topic Node “Pre Sentence Considerations”, the decision maker activates a “Next” link to progress to the next stage in the decision system.

An input is made by a user either directly into the currently selected node, or automatically into a string of one or more successive nodes as determined by a selected historical pattern of entries.

The decision tree 300 also comprises resource information 321 and 322. The resource information 321 and 322 may be of different types, such as stored historical data or links to user manuals or other documentation.

The nodes 310 to 312 require inputs to satisfy a specified criterion. The input may be provided manually by a user via an input device. When the specified criterion is satisfied, one of the downstream nodes 311 and 312 for performing the next stage, is automatically selected. That way, the decision tree is traversed in a sequential manner from the start 301 to one of the terminals 313 to 316.

As described above, in one example, the input is provided directly by a user. In another example, the input is made automatically into a string of one or more successive nodes as determined by a selected historical pattern of entries. That is, a user enters training sequences that include the input. Each of these training sequences defines a path through the decision tree 300. As a result, each training sequence provides input to all the nodes in the path defined by that training sequence, that is into a string of nodes.

While in this example, the process control is based on a structure without reconverging paths, in other examples, a more general graph structure may be used, such that equivalent terminals and even equivalent sub-trees are merged.

The memory 402 stores the decision tree explained with reference to FIG. 3 and historical patterns of entries made by users between first and second nodes.

One example for which the control system may be used is for providing a decision aid in the legal context. Court cases are decided based on facts, statutes and common law references that are the inputs to different stages in the proceeding. Previously decided cases define paths through the stages and at each stage the input of the path and the next stage of this court case is stored. In order to be consistent with previous cases, a current case with similar facts needs to follow a similar path through the stages as the previous cases.

In one example, the input device 404 is a conventional computer keyboard and is connected to the processor 406 to enable a developer of the control process to input parameters, or the training sequence and refine the control. Using the input device, the developer may also select a node in the decision tree and enter data directly into the node. This may be necessary, for example, in cases where the learning based on the training sequences does not yield the required control outcome.

When in use, the screen 102 displays a user interface including a part of the decision tree or the entire decision tree. When the user selects a node, the user interface also includes the selected node and at least one generation of downstream nodes. In the example of FIG. 3, when the user selects the node 310, the user interface includes node 310 and downstream nodes 311 and 312. In examples where screen 102 is a touch screen the user can select a node of the decision tree 300 and enter data into the selected node by tapping the surface of the touch screen.

Although some of the above examples relate to legal decision making, it is to be understood that the system is equally applicable in other areas such as medical decision making or education and learning, such as in collaborative research systems and organisation of research data. Other areas include complex safety decision making, such as aircraft safety diagnostic manuals, or creative endeavours.

It will be appreciated by persons skilled in the art that numerous variations and/or modifications may be made to the specific embodiments without departing from the scope as defined in the claims.

It should be understood that the techniques of the present disclosure might be implemented using a variety of technologies. For example, the methods described herein may be implemented by a series of computer executable instructions residing on a suitable computer readable medium. Suitable computer readable media may include volatile (e.g. RAM) and/or non-volatile (e.g. ROM, disk) memory, carrier waves and transmission media. Exemplary carrier waves may take the form of electrical, electromagnetic or optical signals conveying digital data steams along a local network or a publically accessible network such as the internet.

It should also be understood that, unless specifically stated otherwise as apparent from the following discussion, it is appreciated that throughout the description, discussions utilizing terms such as “estimating” or “processing” or “computing” or “calculating”, “optimizing” or “determining” or “displaying” or “maximising” or the like, refer to the action and processes of a computer system, or similar electronic computing device, that processes and transforms data represented as physical (electronic) quantities within the computer system's registers and memories into other data similarly represented as physical quantities within the computer system memories or registers or other such information storage, transmission or display devices.

### Further Embodiment of the Invention

The Neural Net Decision Support System has 4 user interfaces.

A revised version of the invention has been prepared. The revised version of the invention has been illustrated in its operation using the tools available in Filemaker Pro. The first user interface is the portal providing access to the Decision System.

The portal provides access to the computer system 100. The computer system may operate on the computer being utilised by user 101 or may be access by user 101 though that computer on a cloud computing environment.

The portal provides secure log in access to the computer system and contains a list of all saved decisions of the user 101, whether those decisions are completed decisions or incomplete decisions and the decision maker may return to those previously saved decisions at any time.

In one example, the decisions include judgments which have been finalised or completed by a judge or which are partially completed by a judge.

In one example, they may include diagnostic reports or decisions a medical practitioner has made in relation to a patient and those saved files may be forwarded by email or other modes of electronic transfer to other medical practitioners (for example medical specialists to whom the patient may be on-referred)

The second user interface is the Data Matrix. It is selected by user 101 selecting the Data Matrix button on the permanent display.

The third user interface is Decision Assistance. It is selected by user 101 selecting the Decision Assistance button on the permanent display.

The fourth user interface is the Report (or Judgment) interface. It is selected by user 101 selecting the Decision Assistance button on the permanent display.

### Description of the Additional Drawings in Relation to the Further Embodiment of the Invention

14.

15. etc.

Structure of the Decision System

There are 4 modes.

1. The Portal

2. Data Matrix

3. Decision Assistance

4. Report (Judgment)

The Portal

FIG. 15 illustrates the decision support system which will be used as a working example in this Patent Application. It is a prototype prepared using the tools in FilemakerPro. The example of a computer system 100 decision support system relates to the data a judge requires for the discharge of their judicial function of deciding cases, hearing matters and applying the law. The decision system for the purposes of illustrating the various functions of computer system 100 has been called “Interactive Bench Book”.

In this one example, the Decision Support System is for resource materials available to Judges (or any judicial officer such as a Magistrate) in the discharge of their judicial function.

In FIG. 16, when the program is activated and opened, the decision maker is taken to the Portal. There may be a secure log in facility restricting access to the program and its data contents by means of password or other secure log in process—16-02.

The decision maker selects a new decision file, or opens an earlier (complete or partially complete) decision file—16-04.

A scroll bar may be utilised by user 101 to bring all decision files into the visual display—16-06.

User 101 selects an existing matter or in selecting Interactive Bench Book starts a new matter. The decision support system then opens in Data Matrix mode. The Data Matrix mode is the default display of computer system 100 on screen 102 when user 101 opens a file 16-04 from the Portal.

The Data Matrix

FIG. 17 illustrates a visual display of the decision support system opened in Data Matrix mode comprising a persistent menu identifying the plural different types of resource information, such as the Data Matrix button 17-02, Decision Assistance button 17-04, Data Windows 17-06, Clipboard 17-08, Topic Index Search 17-10, Navigation Bar 17-12 and Report (or in this example Judgment) button 17-14 and Hyperlink button 17-16.

The Navigation Bar 17-12 provides regions that the decision maker can activate in order to backtrack to an earlier node in the decision tree or to move from such a location further forward through the decision steps followed by user 101.

When the program is activated and opened, the program is activated in Data Matrix mode (which is computer system 100 default mode) and the decision maker is taken to Data Matrix mode by default. The decision maker may at any stage after the program is activated select Decision Support mode or Report (Judgment) mode by selecting the buttons for those modes, 17-04 or 17-14. User 101 may move freely and interchangeably between these modes at any stage when using computer system 100.

One example of the operation of computer system 100 will be a decision support system for use by a Judge or Magistrate in the discharge of their judicial function. This example will be used for the purposes of illustrating the operation of computer system 100 but there is no limit to the nature of applications to which computer system 100 may be applied, including medical diagnoses, engineering and architectural applications, preparation of teaching and learning materials, instruction manuals for any applications, presentation of teaching and learning materials, and product safety manuals (such as decision systems for diagnosis of faults in aircraft operation systems and steps for rectifying or responding to such faults).

FIG. 18 shows the Data Matrix mode of a Judicial Decision Support System. This Judicial Decision Support System contains the data resources which facilitates the discharge of a Judges (or Magistrates) judicial function—that is, the discharge of their duties in deciding cases and applying the law in court in relation to legal issues and problems which arise in matters which proceed before that judicial officer. The database relevant to the discharge of a judges judicial function is large, and includes (but is not limited to) many types of matters, from commercial disputes, sentencing defendants, criminal law proceedings, family law proceedings, personal injury proceedings, and administrative law proceedings, depending on the jurisdiction of the court over which the judge presides.

In one example, the primary topics relevant to the judicial function of a Judge or Magistrate are contained in a Data Matrix, called in this example the Interactive Bench Book. By way of illustration, a “Bench Book” is a common professional term for a book which contains the data and resources frequently used by a Judge when presiding over a specific court.

18-02 illustrates the primary nodes within the Data Matrix relevant to the Interactive Bench Book contained in the visual display.

A node is a topic. Every node within computer system 100 has at least 1 Data Window linked to it. In Data Matrix mode there are frequently more than one Data Window associated with each node.

Nodes may share Data Windows—that is, one Data Window may be linked to more than 1 node within decision system 100.

The number of topic nodes is not restricted by the size of the visual display as there is a directional arrow or scroll bar which allows the user to bring into the visual display other primary topics or nodes. The scroll bar is illustrated in 18-04.

The primary nodes are located at Tier 1 of the decision system 18-06. The decision maker may scroll though those nodes to select the node for which they require assistance.

When the node for which user 101 requires assistance is selected, computer system 100 operates to update the computer screen 102 to bring the downstream nodes (or sub-nodes) relevant to the selected node into the visual display. FIG. 19-1 shows the decision maker having selecting a Tier 1 node. That causes computer system 100 to bring into the visual display the sub-nodes relevant to the selected primary node topics.

Those sub-nodes are in the computer system 100 shown as Tier 2 nodes in FIG. 19-02. They are the downstream nodes relevant to the primary node and when the primary node is selected by user 101 these Tier 2 downstream topic nodes are brought into the visual display to replace the nodes in Tier 1 as shown in FIG. 19-02.

Computer system 100 has a vast capacity in relation to the number of Tiers of data that may be included in the Data Matrix. The plasticity or depth of the decision system 100 will be determined by the volume of data contained in the decision system, the complexity of both the data and the decision trees relevant to solving problems related to that data, and the extent of the inter-relationships between the nodes within and between the Data Matrix and Decision Assistance modes.

The number of Tiers of nodes in the Data Matrix reflects the complexity of the decision system and is identified by an index “n” 19-04. That index is a measure of the depth or complexity of the decision system. It is referred to as the Depth Index of the decision system. In one example, the Judicial Decision Support system used as one example in this Patent Application, the Decision Support System has a depth index of 10 19-06.

Every Tier in the Data Matrix takes the decision maker deeper into the primary node—providing increasingly greater specialisation and increasingly greater focus on the complexity of the subject area of that node. The decision maker may delve as deeply as they may require into the complexity of the subject area depending on the specific problem they are using the decision system 100 to solve.

FIGS. 20 and 21 illustrates the use of the scroll bar by the decision maker to navigate though all of the nodes within the primary node Tier of decision system 100 and illustrates that the number of nodes within any Tier of the decision system is not limited by the size of the computer screen 102.

FIG. 22 illustrates that the visual display may be resized by the decision maker to any size (for example to fit the screen or to any proportion of the screen) to enable more accessible visual access to the interface to the program.

The re-scaling of the visual display may be activated by the decision maker using their fingers to rescale the size of the contents of the screen using the capacitative function available on computer screens and tablet devices or by other means available from computer system 100 on non-capacitative computer screens.

FIG. 23 illustrates a computer screen visual display after the decision maker selects a node from Tier 1. In one example, the decision maker selects a primary node, Bail, from Tier 1 of computer system 100 23-02

FIG. 24 illustrates the visual display of the downstream (Tier 2) nodes displayed by computer system 100 when the the primary (Tier 1) node of “Bail” is selected 24-02. The selection of the Tier 1 node “Bail” brings its related sub-nodes (or downstream nodes) into the visual display.

Those Tier 2 nodes replace the Tier 1 primary topic nodes in the visual display. The nodes in Tier 2 which appear when a Tier 1 node is selected are the sub-topic nodes relevant to the upstream topic node selected.

The Tier 2 nodes which appear when a Tier 1 node is selected by the user are the downstream topics or related subtopic nodes to the Tier 1 topic selected.

Accordingly, and by way of illustration, when the primary node “Bail” is selected, all key sub-nodes relevant to Bail are brought into the visual display.

The Tier 2 button is highlighted 24-02 so the decision maker is made aware of their location in the sub-nodal hierarchy relevant to the primary node 24-02. That highlighted Tier 2 button shows the decision maker how far (or how deeply) into the Data Matrix they are in relation to the topic nodes in the display before them.

FIG. 25 illustrates that every node—whether primary or secondary (or further subsidiary) node—has at least one data window 25-02.

A Data Window may be shared by more than one node within computer system 100.

Every node also has an empty Data Window in addition to containing Data Window or Windows containing content so that a decision maker may add any additional notes they may wish in respect of that node topic 25-04.

Each Data Window or Windows relevant to a topic node appear in column 2 Data Windows when the node is selected 25-06.

As noted, every node in the Data Matrix has at least 1 Data Window. Each Data Window within computer system 100 (whether in Data Matrix, Decision Assistance, or Report or Judgment mode) may contain different types of information, including (but not limited to) text, graphics, images, intra-links (being links to other items within the Data Matrix), inter-links (links to other items in related decision support computer 100 systems within a network) and hyperlinks. When the user selects a hyperlink embedded in the Data Window, the hyperlink can open the document or resource (ie pdf, graphic, any image or other resource) within a window within computer system 100 in the visual display. Alternatively if user 101 selects the user may follow the hyperlink outside computer system 100 to the resource to which the hyperlink relates on the world wide web.

25-08 illustrates hyperlink button which remains in the persistent display. The decision maker may select the hyperlink embedded in the Data Window and by pressing the hyperlink button 25-08 may open that hyperlinked resource (which may include but is not limited to a document, images, videofile, or audiofile) within a window within computer system 100 and the decision maker may use the copy facility to remove data from a hyperlinked resource to insert into a Data Window within computer system 100.

FIGS. 26 and 27 illustrate that the number of Tier 2 nodes (sub-nodes for the primary node “Bail”) are not restricted by the size of the visual display. The decision-maker may use the scroll bar function to peruse all Tier 2 sub-nodes relevant to “Bail”.

FIG. 28 illustrates a decision maker selecting a further sub or downstream node in relation to the “Bail” node. In this example, the user selects the topic node “Criteria to be Applied in a Bail Application”.

FIG. 29 illustrates that when the decision maker selects the Tier 2 node “Criteria to be Applied in a Bail Application” illustrated in FIG. 28, there are 3 downstream sub-nodes relevant to that topic which computer system 100 then brings into the visual display.

By further example, and to illustrate the decision maker moving further into the Data Matrix, the particular problem the decision maker may require assistance with in one example is the Application of s 32 of the Bail Act. This section applies in relation to the law which is applicable to the question of whether a person will be considered likely to appear in answer to their Bail conditions. FIG. 30 illustrates the decision maker selecting the node “Application of s. 32”

FIG. 31 illustrates computer system 100 updating the screen display when activated by user 101 in selecting “Application of s. 32” and displays the screen display in which computer system 100 identifies the matters that relate to the Application of s. 32 of the Bail Act 718.

FIG. 32 illustrates the user selecting the node in respect of which they require further assistance—the Tier 4 node “The Probability a Person Will Appear in Answer to Bail” 32-02.

FIG. 33 illustrates computer system 100 displays the legal topic nodes a Judge is required to consider in determining whether a person is to be considered or concluded to be probable to appear in answer to Bail.

FIG. 34 provides a further illustration of the use of the Judicial Officers Decision System in Data Matrix mode.

The decision maker wishes to know the procedure in a Bail Application.

FIG. 34 illustrates the decision maker selecting the topic node Bail From Tier 1 nodes.

FIG. 35 illustrates that the selection of the Bail node within computer system 100 brings into the visual display the sub-topic nodes relevant to the node Bail.

FIG. 36 illustrates the decision maker selecting the node “Procedure in Bail Application” and the selection of that node causes computer system 100 to bring into the visual display the Tier 3 sub-nodes relevant to the node “Procedure in a Bail Application”—as illustrated, those nodes being:
Prosecution Commences the Application
Facts and Criminal Antecedents Tendered
Categories of Offender Identified
Onus and Standard of Proof on Application Determined
Offences in Which Prosecution bears the Onus of Proof
Offences in Which the Accused Bears the Onus of proof

FIG. 37-1 illustrates the decision maker selecting the first Tier 3 node—that is, the first sub-node relevant to the upstream Topic Procedure in a Bail Application. The decision maker selects “Prosecution Commences the Application” 37-02 and that opens the Data Window relevant to that topic in FIG. 37-2.

The Heading in the Data Window 37-04 is the same as the topic node which has been selected by user 101.

Every Data Window within computer system 100 (whether in Data Matrix, Decision Support or Report mode) may contain plural different types of resource information, including but not limited to:
(1) Intralinks—links between specific content in the Data Window to other Data Windows within that same decision system
(2) Interlinks—links between specific content in the Data Window and specific Data Windows within other distinct (but related) Decision Systems (such as a related Evidence Decision Support System, or a Complex Sentencing Decision System); and
(3) Hyperlinks—links between specific content in a Data Window and to sites on the World Wide Web, such that a specific document or image etc may be opened in a window within the computer program or at the election of the decision maker the decision maker may be taken outside the decision system to the website containing the hyperlinked resource.

There can be any number of Data Windows related to a topic node in the Data Matrix.

The decision maker may use the scroll bar in the Data Windows column to bring into the visual display of the computer screen 102 all of the Data Windows linked to that topic node. This is illustrated in FIGS. 38 and 39. These Data Windows relate to the node Application of s. 32 and provide a summary of the topics which may be selected and explored in greater detail by the user—progressing further into the Data Matrix as required—by selecting any of the nodes in FIG. 38. The decision maker may use the scroll bar to bring into the visual display those Data Windows shown in FIG. 39.

FIG. 40 illustrates how a Data Window may be opened by the decision maker by selecting it.

The Data Window has a scroll bar function 40-02 which permits the amount of Data in the Data Window to exceed the size of the visual display and which may be brought int the visual display by the decision maker utilising the scroll bar function.

FIGS. 40 and 41 illustrates the location of the scroll bar function and its use by the decision maker to read the contents of the Data Window.

All Data Windows in computer system 100 (whether in Data Matrix, Decision Support or Report mode) have the scroll bar facility enabling the Data Window to store more information than may appear immediately in the visual display and will allow the user to scroll through the data contained in the Data Window.

The decision maker may re-size the Data Window to permit more ready access to the contents of the Data Window when the Data Window appears in the Data Windows column or the Clipboard.

FIGS. 42 and 43 illustrates the decision maker re-sizing the Data Window. This may be done by a re-sizing button on a computer screen or by the decision maker using their fingers on the screen in a computer or tablet computing environment and the Data Window may be resized to the scale the decision maker considers useful. When the Data Window has been re-sized the Data Window retains the use of the scroll bar facility.

FIGS. 44 and 45 illustrates the decision maker using the scroll bar facility to scroll through the data contents of a resized Data Window.

If the decision maker considers the data contained in any Data Window of use in the problem the decision maker is seeking to solve, the decision maker may copy the entire contents of the Data Window to the clipboard by activating the Add to Clipboard Button relevant to that Data Window.

FIG. 46 illustrates a decision maker selecting the Add to Clipboard button and copying the Data Window onto the Clipboard.

Activating the Add to Clipboard Function 46-02 will copy the entire Data Window selected to the Clipboard, being column 3 of the visual display.

By way of one illustration, FIG. 47 illustrates a decision maker selecting the Data Window “Prosecution Commences the Application” by activating the Add to Clipboard Button.

FIG. 48 illustrates the Data Window now added to the Clipboard 48-02. The Topic of the Data Window is preserved under a separate heading on the Clipboard for ease of recognition, editing and management by the decision maker 48-04. The Data Window retains its scroll bar function and all data is copied when the Add to Clipboard function is activated.

The decision maker may not wish to utilise all the data in a particular data window. The decision maker may open a Data Window and using a cut and paste function select only that data which is of assistance to them in relation to the specific problem they are trying to solve.

FIG. 49 illustrates the decision maker re-sizing a Data Window from the Data Window column.

FIG. 50 illustrates a decision maker using the cut and paste function to select part of the data in that Data Window.

FIG. 51 illustrates the decision maker using the Add to Clipboard function to copy an empty Data Window onto the Clipboard.

FIG. 52 illustrates the decision maker using the paste function to copy the selected part of the Data Window in the Data Windows Column to the empty Data Window in the Clipboard.

This permits the decision maker to use only that part of the content of a Data Window which is relevant to the problem they are seeking to solve.

The Data Window on the Clipboard into which the decision maker has copied part of the contents of the Data Window in the Data Windows column retains the Heading within the Data Window of the Clipboard from that from which the Data Window was originally copied—that being the heading displayed in relation to the node from which it was selected.

By way of further example, FIGS. 53-56 illustrate the decision maker is accessing the Data Matrix in relation to the Tier 1 node of General Orders, then the Tier 2 node Compensation and Restitution, and then the Tier 3 node Time for Making Order. The Data Window relevant to the node “Time for Making Order” contains different Data Windows relevant to that node and the decision maker may for example only require the draft or sample order.

FIGS. 57 and 58 and 59 illustrates the decision maker opening the Data Window, “Sample Order”, resizing that window to read its content clearly, then uses the Add to Clipboard button to copy that Data Window onto the Clipboard.

The method provided by computer system 100 may be used by a decision maker to provide extremely rapid access to the information the decision maker may require to discharge their function—in one example, their judicial function.

A further illustration of the access the computer program 100 provides to the decision maker is found in access to common penalty nodes in the Data Matrix.

FIG. 60 illustrates the decision maker scrolling through the nodes in Tier 1 of the decision system to the node “Commonly Occurring Penalties”.

FIG. 61 illustrates the node “Commonly Occurring Penalties” being selected by the decision maker.

FIG. 62 illustrates the visual display when the node “Commonly Occurring Penalties” in FIG. 61 is selected.

FIG. 63 illustrates the decision maker selecting the node “Prescribed Content of Alcohol Offences”.

The downstream or sub-nodes relevant to the node “Prescribed Content of Alcohol Offences” appear in FIG. 64 as Tier 3 topic nodes.

FIGS. 65 and 66 shows the decision maker selecting the node “High Range PCA” and the Data Window relevant to that node appears in Data Windows, and that Data Window may be selected by the decision maker activating the “Add to Clipboard” button.

There may be different Data Windows with different types of data relevant to the node “High Range PCA”. They may include (but are not limited to) the statutory charge provisions and the driving disqualification periods which apply to that offence.

By way of further illustration, a decision maker may wish to gain the assistance of what is known as a “Guideline Judgment”—a decision of a superior court which contains a convenient statement of the approach of that court to its subject area. FIGS. 67 and 68 illustrate the decision maker selecting the “Guideline Judgment” node from the Tier 3 nodes and using the Copy to Clipboard function, copy that Data Window to the Clipboard.

By way of further example, FIGS. 69-72, show a decision maker selecting Tier 1, Commonly Occurring Penalties, then Serious Driving Offences, then Negligent Driving and the specific offences and penalties relevant to Negligent Driving causing Grievous Bodily Harm. This illustrates the very rapid access computer system 100 provides a decision maker to the data relevant to the exercise of their judicial function.

The Topic Search function in Data Matrix mode allows the user to type in a topic or part thereof. When selected, it will open a window with all nodes containing the search terms in the visual display and the decision maker may then select the applicable node and computer system 100 will take the decision maker to that node.

FIGS. 73, 74 and 75 illustrate the decision maker using the search function in relation to the term “assault”, selecting the appropriate node, and computer system 100 then updating the visual display to take user 101 to the selected node.

FIGS. 76 and 77 illustrates the decision maker using the navigation bar to retrace the steps the decision maker has taken though computer system 100.

The navigation bar traces the steps taken by the decision maker and when the decision maker activates the navigation bar computer system 100:
1. saves in electronic copy the history of the decision steps taken by user 101 to that point in the decision tree followed.
2. the decision maker may stop the navigation function at any point in the decision steps previously taken and re-commence moving through the decision tree from any prior historical point.

The decision maker may move interchangeably between the Data Matrix and Decision Assistance modes (as well as the Report mode) and the navigation function will record sequentially all steps taken whether user 101 is using computer system 100 in Decision Assistance or Data Matrix mode.

The Data Matrix mode provides a highly efficient structure for the provision of large amounts of data which a decision maker may wish to be able to rapidly and conveniently access. It further offers the convenience of providing all data relevant though the one computer system. In one example, all Bench Books for Judges relevant to one jurisdiction may be contained as the primary node topics in Tier 1—for example, the Sentencing Bench Book, the Criminal Trials Bench Book, the Family Law Bench Book, the Evidence Bench Book etc may all be accessed from within computer system 100.

Decision Assistance Mode

At any stage during the operation of the computer program the decision maker may select Decision Assistance Mode by selecting the Decision Assistance Button.

When selected the program activates Decision Assistance Mode.

FIG. 78 illustrates the visual display when the decision maker has activated Decision Support mode.

Decision Assistance mode provides the decision maker with the benefit of an experts decision chain in respect of problems falling within or related to the subject matter (nodes) of the Data Matrix.

FIG. 79 illustrates computer system 100 when Decision Assistance mode has been activated.

There are 6 windows in Decision Support mode topic areas, comprising columns 1 and 2 of the visual display of computer system 100 in FIG. 79.

Window 1 79-02 contains the following nodes:
1. the nodes contained in Tier 1 of the Data Matrix mode. That is all of the subject areas of the nodes contained within the Data Matrix. All of these nodes in the present example are contained in Window 1 of Decision Assistance mode.
2. the nodes which are relevant to the decision maker solving problems or making decisions in respect of the nodes contained in the Data Matrix. These nodes include expert decision trees providing the decision maker with the decision support assistance they require to solve problems arising in respect of the nodes in the Data Matrix and such additional nodes will in the present example include (but will not be limited to) judgment templates, expert guidance to the problems the judge will be required to solve in relation to the laws of evidence, expert guidance in relation to the law on any topic relevant to the subject area of the Data Matrix, including but not limited to criminal offences and defences, children's law, contempt of court, expert guidance in respect of matters related to criminal procedure, and expert guidance on how to (inter alia) approach applying the law on sentencing an offender.

All nodes in Decision Support mode have at least 1 Data Window linked to them and in addition a blank or empty Data Window to enable the decision maker to add any notes they wish which may not fall within the Data Windows topics linked to that topic node.

The illustration used in this Patent Application use one data window in Decision Assistance mode but computer system 100 may use any number of Data Windows linked to one node and the Data Windows column (being column 3 of the visual display of computer system 100 in Decision Support mode) will have a scroll bar facility so that the visual display will not restrict the number of Data Windows that may be linked to one node. See FIG. 80.

The Clipboard is illustrated in FIG. 81.

The Clipboard in Decision Assistance mode is the same as the Clipboard in Data Matrix mode.

Whether the user has entered Data Windows onto the Clipboard in Data Matrix mode or whether the user has entered Data Windows onto the Clipboard in Decision Assistance mode, the Clipboard in either mode will display the Data Windows which have been copied onto it from either mode.

FIG. 82 illustrates:

Window 1 82-02 contains
1. The primary node topics contained in Tier 1 of the Data Matrix. In the Judicial Officers example, there may be different categories of problems which may arise in relation to the Tier 1 nodes in the Data Matrix.
2. Any additional nodes relevant to the discharge of the decision makers functions. These may include evidence problems, how to approach sentencing an offender under State and Commonwealth Law, how to approach applying the law relevant to criminal offences or defences, dealing with applications in respect of specific legal applications (ie appeals against decisions of the authority to suspend a persons driving licence etc), applying general law and statutory causes of action (ie how to approach Sale of Goods Act claims, contract claims etc).

Each Window in the visual display of computer system 100 contains a scroll bar 80-04.

That means that the size of the Window in the visual display does not restrict the number of nodes the Window may contain.

Window 2 contains the specific topics for which decision support is available in computer system 100 in respect of each of the nodes in Window 1 82-06.

Window 3 contains the decision steps relevant to each topic for which decision support is available in Window 2. 82-08

Window 3 contains a scroll bar 80-04 so the number of steps in the expert decision tree is not restricted by the size of the visual display.

Window 3 is a larger window in the visual display present in this mode of computer system 100 as that larger window size will allow the decision maker a larger view of the steps in the decision tree or chain relevant to the specific problem.

Windows 1, 2 and 3 remain a permanent feature of the computer screen display in Decision Assistance mode within computer system 100. Each of these windows contains a scroll bar so that the number of nodes they may contain is not limited by the size of the visual display.

Window 4 82-10 contains those sub-node topics relevant to the first step in the expert decision tree contained in Window 3.

There may be more detailed or specialised information applicable to a Window 4 node and the user may proceed deeper into the expert decision chain or decision tree by selecting that node topic in Window 4 and computer system 100 will then cause the downstream nodes to the Window 4 node to open in Window 5 82-12. Window 6 is 82-14.

Diagram 83-1 shows a decision maker selecting the node “Criminal Offences” in Window 1. As illustrated in FIG. 83-2, computer system 100 then causes all sub-nodes or downstream nodes relevant to the node “Criminal Offences” to appear in Window 2. The decision maker scrolls through those nodes for which decision support is available and selects “Assault Occasioning Actual Bodily Harm”. That node is selected and the decision steps applicable to that offence are then brought into the visual display by computer system 100 in Window 3—see FIG. 83-3.

The decision maker selects the first step or node in the expert decision chain, “Physical Elements”. See FIG. 84. That causes the downstream nodes relevant to “Physical Elements” to appear in the visual display—those nodes being “Assault” and “Battery” in FIG. 85.

The decision maker selects the node “Assault” from Window 4 and as FIG. 86 illustrates the computer system 100 causes:
1. The Data Window relevant to the node “Assault” to open in the visual display; and
2. the related downstream nodes to the node “Assault” to open in Window 5.

When that selection is made, computer system 100 brings into the visual display the related sub-node topics in Window 5.

If further and more specialised assistance is required from computer system 100, the decision maker selects the node relevant in Window 5 and its related sub node or downstream nodes are brought into the decision system in Window 6.

Windows 4, 5 and 6 may not remain part of the fixed display in Decision Assistance mode. If the decision maker wishes to proceed further into the expert decision chain, and selects a node in Window 6, computer system 100 changes the display by moving Window 4 out of the visual display and showing Window 7 in the visual display of the computer screen 102. In other words, the last 3 Windows used by the decision maker will remain in the visual display of computer system 100 in the location of Windows 4, 5 and 6 if the decision maker has progressed that deeply into the decision tree contained within computer system 100. Windows 1, 2 and 3 do not change and remain in the visual display at all times in the operation of computer system 100.

By way of further example, in a highly complex problem, the visual display of computer system 100 in Decision Support mode may display Windows 1, 2 and 3, and Windows 9, 10 and 11. User 101 may use the scroll bar adjacent to the location of Windows 4, 5 and 6 to move the Windows in and out of the visual display at that location as may be appropriate.

The visual display of computer screen 102 will always display Windows 1, 2 and 3, and the last 3 windows used by the decision maker in the location originally displayed by Windows 4, 5 and 6.

The scroll bar relevant to the locations of Windows 4, 5 and 6, allows the user to move the different Windows from windows 4, 5 and 6 through to the last Window—Window “n”—used by the decision maker when utilising and following the expert decision chain which commences in Window 3. See FIG. 86-1.

The inventor notes that a problem would be extraordinarily complex to require more than 6 Windows for its resolution but those further steps are readily available to the user within computer system 100.

In one example, a Magistrate or Judge may have legal problems to solve in respect of the data contained in the Data Matrix concerning (inter alia):
How to Apply Sentencing Law
Civil Law Applications
Civil Law Motions
Applying the Evidence Act
Approaches to Applying Criminal Law Offences
Approaches to Applying Criminal Law Defences
Appeals to the Local Court
Applications to the Local Court
Contempt in the Local Court
etc.

These subject areas will be contained in Window 1 in addition to the nodes contained in Tier 1 of the Data Matrix mode.

A Judicial Officer may be provided with guidance in the form of (inter alia) judgment templates for Criminal and Civil proceedings, Application proceedings, may require assistance in approaching complex sentencing matters and in the steps involved in applying the law in relation to various criminal offences and defences as well as commercial and other causes of action.

Decision Assistance provides that decision support.

It is noted that similar issues arise in respect of any professional decision system. This is not a decision support system related only to legal problems but may apply in respect of (inter alia) medical and veterinary diagnosis and treatment, agricultural processes, building and architectural processes, teaching and instruction processes, and information manuals for large companies which have various processes employees must initiate in respect of certain matters (ie grievance procedures and training modules)

Decision Support is a meta-function of this decision support system.

Decision Support provides a mechanism which allows a replication of historical patterns, that being defined as the steps in the decision chain taken by a high level expert (or a decision chain prepared by an expert panel) in the resolution of a problem or problems which may arise in respect of the topics in the Data Matrix by way of structured paradigm of steps prepared by that expert (or panel of experts).

The steps in the decision chain may be prepared by 1 person, or a number of persons.

Computer system 100 will provide the expert decision tree to all persons seeking to solve the problem to which that expert decision tree is addressed. By way of one example, a medical general practitioner in a remote African village will be able to access the Infectious Diseases diagnostic decision tree of a leading Harvard medical professor. That decision chain will be of extremely high quality and will incorporate knowledge, experience and updated medical information that a general practitioner would not in the usual course have available to them. Indeed, the expert decision chain may be a collaborative project involving (for example) Harvard, Yale, Johns Hopkins, the University of Johannesburg, and the European University experts. It would be widely available to all medical practitioners seeking to solve infectious diseases problems and would greatly improve the quality of diagnosis and treatment offered—particularly in the context of less resourced medical environments, for example, in relation to the provision of medical information to the poor, the 3rd world, and to remote and poorly resourced regions. Experts could make available Decision Assistance though computer system 100 in relation to any subject area—for example, obstetrics and cardiology, and so on. The best practice treatment for Aids, for example, could be designed in a computer system 100 and made available to practitioners providing medical support for this condition throughout the 3rd world.

Accordingly, this decision support system greatly facilitates an unrestricted number of high level experts developing and maintaining a decision system in respect of a specific problem, and provides that decision chain to all persons seeking to solve a problem on the topic of the decision chain. That means that the decision chain will be of extremely high quality and widely available to all persons who are engaged in endeavouring to solve similar problems.

It is noted that this invention provides a computer system which will allow collaborative efforts of a potentially large number of experts in devising and updating a decision tree. That will mean that the power of such a decision tree—which may be made available to all persons seeking assistance with the subject of the decision tree—will be considerably greater than any decision system that may be able to be prepared by one person. The top 20 specialists in, for example, oncology in the United States (or the world) are, by way of example, likely to produce a collaborative decision system in computer system 100 than any one of them alone would be likely to generate and the diagnostic benefits of having that collaborative diagnostic decision system available to other medical practitioners, including general practitioners, hardly needs explanation.

The inventor says that the applications of this decision support system are significant and obvious.

In one example, lawyers who are engaged in highly complex legal problems will be able to avail themselves of the approach to such problems taken by the best legal practitioners (such as senior judges) and high level academic experts in respect of that problem or legal topic. Such a problem could involve but is not restricted to complex conveyancing issues, complex evidence issues, complex sentencing issues and problems arising in respect of the application of the law in specific topic areas such as contract, commercial law, property law and equity.

It is also to be noted that the decision system 100 also confers a high level of transparency in relation to the approach decision makers take to solving problems.

Apart from recording the steps a decision maker takes as they progress though a problem, the Navigation function permits the steps in that decision to be recorded and saved as a separate data file. That data file may be saved and emailed to another user (user 102) and may be loaded into user 102 decision system 100. User 102 may transparently retrace the steps taken by user 101 and user 102 will be able to follow every step user 101 took in deciding or solving the problem or coming to user 101's conclusion or diagnosis.

By way of example, that will mean that a general practitioner of medicine may email (or otherwise electronically transfer) their diagnostic decision process to a medical specialist when referring a patient. That medical specialist will be able to comprehensively review the basis on which the general practitioner determined the patient has a particular condition and why they determined a particular treatment (such as a specific drug) was appropriate. That will make it considerably easier for the specialist to review the patients history and in rendering very transparent the diagnostic approach of the general practitioner any errors are much more likely to become apparent when the patients diagnostic chain is reviewed at any level—whether it be a senior registrar reviewing a junior doctors diagnosis and treatment of a patient at hospital level, or a specialist practitioner reviewing a patients records. In the inventors view, there are very high levels of advantage in the use of decision system 100 in terms of the overall quality of service offered to patients, both in terms of the decision support offered by their treating practitioner who has the benefit of an expert decision chain in relation to the problem, and in the process of review of the diagnosis and treatment afforded to the patient.

The Decision Support mode also confers a high level of transparency in respect of the approach decision makers take to solving particular problems.

The Decision system records the decision steps which have been taken and that data is able to be retained, filed and if necessary forwarded to other practitioners or sources.

It would also significantly enhance transparency in the provision of medical professional services to patients and be a very valuable tool in exposing any error rapidly and allowing remedial activity to occur.

It is also a valuable teaching tool, in professional and any learning context, because it will expose the reasoning process which the student or learner has employed in the resolution of the problem.

In one example, the decision maker, a magistrate or judge, may wish to avail themselves of the steps an expert in sentencing law would take when engaged in sentencing a defendant appearing before the court.

Sentencing law falls within the subjects contained in the Data Matrix in one example.

FIG. 87 illustrates the decision maker opening Window 1 on Decision Assistance mode and selects Sentencing—NSW.

FIG. 88 illustrates the sub-nodes relevant to Sentencing—NSW appear in FIG. 88.

FIG. 89 illustrates the decision maker selecting Sentencing Template—NSW.

The steps involved in a judicial decision maker approaching sentencing an offender then appear in Window 3. See FIG. 89-1.

A decision maker may wish to proceed though the steps sequentially.

Every node has at least one related Data Window.

By way of example, a decision maker may proceed though the decision chain to the node Aggravating Circumstances.

Selecting the node Aggravating Circumstances will cause computer system 100 to update the visual display and bring into the visual display the relevant statutory principle—in this example, s. 21 Crimes (Sentencing and Procedure) Act—in the downstream node in Window 4. See FIG. 90.

The decision maker selects the node “s. 21 Crimes (Sentencing Procedure) Act in Window 4 and its downstream related sub-nodes appear in Window 5. See FIG. 91. They are
Statutory Provision
Approach to Aggravating Matters
Aggravating Factors

FIG. 92 illustrates the decision maker selecting the node “Aggravating Factors” and the sub-node topics relevant to Aggravating Factors is brought into Window 6. See FIG. 93.

The decision maker then selects the particular matter relevant to the circumstances before them for sentence—on one example, the victim of the assault is a emergence worker—and that node is selected. See FIG. 94.

The Data Window relevant to the law applicable to setting the appropriate sentence when the victim of the offence is an emergency worker then appears in its related Data Window. See FIG. 95.

The decision maker may open that data window, and edit its contents.

The decision maker may move the entire Data Window to the clipboard by activating the “Add to Clipboard” button. See FIGS. 96, and 96-02.

The Data Window in FIG. 96 is then copied to the Clipboard.

FIG. 97 shows the decision maker re-sizing that Data Window and editing its content by reference to the specific facts before the judicial decision maker —that is, the details of the victim of the present offence, the nature and extent of their injuries, and how the emergency worker victim came to be injured.

By way of further example, the decision maker may wish to obtain assistance in solving an Evidence problem that may arise in the course of a hearing. The decision maker scrolls though the topic nodes in Window 1 and selects “Evidence Act Applications”. See FIG. 97-1.

Computer system 100 then displays the following topic nodes in Window 2.
Competence of Witness
Compellability of Witness
Unsworn Evidence
Oaths
Leading Questions
Unfavourable Witness
Court Control of Witness
Reviving Memory
Documents—Cross Examination
Relevance
Hearsay Evidence
Opinion Evidence
Admissions
Admissibility—Judgments
Admissibility—Convictions
Tendency Evidence
Coincidence Evidence
Credibility Evidence
Character Evidence
Identification Evidence
Client Legal Privilege
Legal Professional Privilege
Sexual Assault Privilege
Public Interest Immunity
General Discretion to Exclude
Discretion—Illegally Obtained
Discretion—Prejudicial Evidence
Standard of Proof
Burden of Proof

Each of these nodes has an expert decision chain or tree which when selected will appear in Window 3. Each of the topics or problems for which decision assistance is available may be referred to as a module.

When each of the steps in the decision chain is selected, its related sub-node topics will appear in Window 4, and when the sub-topic nodes in Window 4 are selected, its downstream or sub-topic nodes appear in Window 5 and so on

Each node has its own Data Window or Windows and the user may copy and paste them to the Clipboard, either in whole or in part.

The following figures illustrate a worked illustration of a judicial decision maker using computer system 100 to provide decision assistance to the decision maker/judge when discharging their judicial function in making legal decisions during the course of a matter proceeding before them and illustrates how decision system 100 assists them in preparing a written judgment whilst a hearing is proceeding before them. This illustrates that decision system 100 provides decision support in relation to processes and procedures (such as judgment writing) as well as problems.

FIG. 98 illustrates user 101, a Judge, opening computer system 100 in Decision Assistance mode.

FIG. 99 illustrates user 101 selecting Judgment Templates from Window 1.

FIG. 100 illustrates user 101 selecting Judgment Template —Criminal from Window 2.

FIG. 101 illustrates uses 101 commencing the hearing by selecting Case History from Window 3, the decision steps in the conduct of a criminal trial.

FIG. 102 Illustrates user 101 selecting “Add to Clipboard” function in relation to the Case History Data Window.

FIG. 103 illustrates user 101 opening Data Window “Case History” and adding the information relevant—ie Day 1, Windsor Court. Matter commenced at 2 pm, and any other matter which may be applicable.

FIG. 104 illustrates user 101 selecting the next step in the decision chain in Window 3, Charges and Particulars.

FIG. 105 illustrates the user 101 selecting the “Add to Clipboard” function and copying this Data Window to the Clipboard.

FIG. 106 illustrates user 101 entering the charge and the particulars into the Data Window.

The charge before the judge in this example are Assault Occasioning Actual Bodily Harm. That charge is entered into the Data Window and the particulars of that offence are added into that Data Window.

The judge then wishes to know the penalties that apply to the charge before the court.

FIG. 107 illustrates user 101 selecting Data Matrix mode.

FIG. 108 illustrates user 101 selecting the node “Commonly Occurring Penalties” at Tier 1.

FIG. 109 illustrates user 101 then selecting the Criminal Offences node at Tier 2.

FIG. 110 “Assaults” is brought into the visual display by computer system 100 and is selected by user 101.

FIG. 110-1 then illustrates the downstream nodes related to the node “Assault”.

FIG. 111 illustrates user 101 selecting the Data Window Assault Occasioning Actual Bodily Harm and copying it to the Clipboard.

FIG. 112 illustrates the judge then selecting decision Assistance mode.

FIG. 113 illustrates the how the Data Window selected in Data Matrix mode retains its position in the Data Windows in the Clipboard relative to the Data Windows selected in Decision Assistance mode.

FIG. 114 illustrates the judge then selecting the node “Appearances”.

FIG. 115 illustrates the judge selecting the Data Window for the node “Appearances” and copying it to the Clipboard.

FIG. 116 illustrates the judge opening the Data Window for “Appearances” in the Clipboard and entering the data relevant from the matter proceeding before the judge.

FIG. 117 illustrates that if the parties make opening addresses, the judge may select the “Opening Addresses” node from the decision chain in Window 3.

FIG. 118 illustrates the judge copying the Data Window relevant to the node “Opening Addresses” the Clipboard and the judge may then make their notes as appropriate.

The same procedure applies if the Defence makes an Opening Submission.

The transcript may be linked to this Data Window by a hyperlink. This would allow the judge to open the written transcription of the proceedings of the Opening Submissions in a window within computer system 100 for the assistance of the judge when writing their judgment.

The first witness is called.

FIG. 119 illustrates the judge selecting the “Witness Summary” node from the Decision chain in Window 3.

FIG. 120 illustrates the judge copying the Data Window relevant to the node “List of Witnesses” onto the Clipboard.

FIG. 121 illustrates the judge entering the name of the first witness. FIG. 121-1 illustrates how user 101 may resize the Data Window to facilitate reading and editing that Data Window.

FIG. 122 illustrates the judge then selecting the node “Prosecution Witness” from the steps in the decision chain in Window 3.

FIG. 123 illustrates the judge then copying the Data Window relevant to the node “Prosecution Witness” in Window 3 to the Clipboard.

FIG. 124 then illustrates the judge opening the Data Window in the Clipboard, and entering that witnesses name and making notes in respect of that witnesses evidence.

The Data Window may have added to it a hyperlink allowing the transcription of that witnesses evidence able to be opened in a window within computer system 100 for the convenience and reference of the judge and that window may also have added a hyperlink to the audio recording of the witnesses evidence.

This process is continued for the evidence of all witnesses called.

FIG. 125 illustrates the operation of computer system 100 in respect of the tender of a document.

Objection may be taken to the tender of the document on the grounds of relevance.

FIG. 126 illustrates the judge returns to Window 1 of the Decision Support mode and selects the node, “Evidence Act Applications”.

FIG. 127 illustrates the judge then scrolls though the nodes relevant to “Evidence Act Applications” which appear in Window (2) and selects the node “Relevance”.

FIG. 128 shows the steps in the decision chain relevant to solving a problem in respect of the law of relevance then appear in Window 3.

The judge may follow the steps in that decision chain sequentially or may proceed directly to the node which addresses the specific aspect of the problem which presents itself.

The judge may by way of one example want to know the definition of the word “relevance” as a legal construct.

FIG. 129 illustrates the decision maker selecting the node “Definition of Relevance” and the Data Window relevant to that node opens.

The Decision maker may copy that Data Window to the Clipboard by selecting the “Add to Clipboard” function and the Data Window then appears in the Clipboard. See FIG. 130.

FIG. 130-1 illustrates the decision maker opening and editing that Data Window on the Clipboard as is appropriate by reference to the specific problem in the matter before the judge.

If the document is held by the judge decision maker to be relevant and admissible, FIG. 131 illustrates the judge returning to the node “Judgment Template—Criminal” in Window 1.

FIG. 132 illustrates the judge then selecting the node “Exhibit” from Window 3 and its Data Window opens.

FIG. 133 illustrates the judge copying the Data Window “Exhibit” onto the Clipboard.

FIG. 134 illustrates the judge then opening the Data Window in the Clipboard and entering the details of the Exhibit and any notes the Judge may have of the exhibit—in respect of its importance in the proceedings, or in relation to the specific part of the exhibit that is of significance in the proceedings.

A hyperlink may be included in the Data Window allowing a graphic picture of the exhibit to be opened within a window in computer system 100 for the assistance of the Judge.

If an interlocutory application is made during the proceedings, such as the defence making what in Australia is referred to as a “Prasad Application”, the decision maker may return to Window 1 and select the node “Criminal Procedure”. See FIG. 135.

FIG. 136 illustrates the sub node topics available within computer system 100 in relation to the node “Criminal Procedure”.

FIG. 137 illustrates the decision maker scrolling though these sub-node topics relevant to the node “Criminal Procedure” until the decision maker locates “Prasad Direction”.

FIG. 138 illustrates the Decision Maker selecting the node “Prasad Application” and its related sub-node topics—those topics relevant to the decision tree necessary for a judge to determine whether an application for a Prasad Direction should be made. FIG. 139 illustrates the decision step nodes—appear in Window 3.

The decision maker may proceed though each step in the decision chain and may select the node “Criteria for Prasad Direction”. That is illustrated in FIG. 140.

The decision maker may select the first step in the criteria to be applied and the Data Window relevant to that node opens. This is illustrated in FIG. 141.

FIG. 142 illustrates the decision maker copying the Data Box relevant to the node “To Be Sparingly Applied” into the Clipboard.

FIGS. 143 and 144 illustrates the decision maker resizing the Data Window to edit its contents and add data relevant to the matter proceeding before the judge.

The judge then makes a determination of whether the Prasad Direction should be made. More complex legal problems may require computer system 100 to take the decision maker deeper into the decision system, into Windows 6, 7 etc to “n” as may be appropriate.

This example illustrates how computer system 100 operates to provide the decision maker with access to that level of decision support relevant to the specific problem the decision maker is endeavouring to solve. More complex problems will progress further into the decision tree than will less complex problems. It is noted that computer system 100 provides user 101 with that level of detail and complexity necessary to solve the specific problem before that user.

Having made a decision on the Application for a Prasad Direction that the hearing will continue, the decision maker returns to the Judgment Templates in Window 1, illustrated in FIG. 145.

The decision maker then selects Judgment Template—Criminal in Window 2, as illustrated in FIG. 146, and then returns to the hearing by selecting the node relevant to the next stage in the hearing, in one example, Prosecution Witness.

FIG. 147 illustrates the decision maker selecting the node “Prosecution Witness”, its Data Box appearing in FIG. 148, and that Data Window copied to the Clipboard in FIG. 149, and in FIG. 150, the decision maker enters details of the witness and notes of the witnesses evidence.

The decision maker judge continued though the hearing and after the decision maker has heard the testimony of all witnesses, ruled on evidential issues and applications that have arisen during the hearing with the decision support assistance provided by the computer, the judge will hear the parties submissions and enter their notes of the parties submissions into computer system 100 by selecting the parties submissions.

FIG. 151 illustrates the decision maker selecting the node “Prosecution Submissions” from Window 1 of Decision Assistance mode. FIG. 152 illustrates the Data Window relevant to that node being copied onto the Clipboard and FIG. 153 illustrates the judge opening that Data Window and entering the judges notes in relation to the submissions. It is noted that a hyperlink to the transcription of the submissions may be entered into this Data Window and opened from within computer system 100 by the user for their assistance when the transcription is provided.

FIGS. 154, 155 and 156 illustrates the decision maker taking the same steps in relation to the submissions made on behalf of the defendant.

The hearing has then finished and the judicial decision maker then must decide whether the offence has been proven to the standard required by law and whether the defendant should be convicted.

That step in the decision chain requires the judge to identify the elements of the offence “Assault Occasioning Actual Bodily Harm”, and to apply those legal principles to the facts found.

FIG. 157 illustrates the decision maker returning to Window 1 and selecting the node “Criminal Offences”. The list of offences for which decision support is available in computer system 100 appears in FIG. 158 in Window 2.

FIG. 159 illustrates the decision maker/judge then selecting the offence which is before that decision maker in the present trial, the node “Assault Occasioning Actual Bodily Harm”

FIG. 160 illustrates the judge selecting the node “Assault Occasioning Actual Bodily Harm” and computer system 100 then brings the elements of that offence into the visual display.

FIG. 161 illustrates the decision maker selecting the node of the first step in the decision chain, Physical Elements.

FIG. 162 illustrates computer system 100 bringing the sub-node topics relevant to the node “Physical Elements” into the visual display.

FIG. 163 illustrates the decision maker selecting the node Assault and computer system 100 then brings the Data Window relevant to the node Assault into the visual display in column 3 The selection of the node “Assault” also brings into the visual display the sub-node (or downstream) node topics relevant to the node “Assault”, in the present example, being
Qualified Threats
Threat Must Be Immediate
Words as Assault; and
Victim Must Perceive Threat.

FIGS. 164, 165, 166 and 167 illustrate the user selecting each of the above Window 4 topics and computer system 100 bringing into the visual display the Data Windows relevant to those nodes.

The Decision Maker may copy all or any of the Data Windows (or using the copy and paste function) any part of those Data Windows which may be relevant to the matter proceeding before the judge, onto the clipboard.

The decision maker may progress though the steps in the expert decision chain.

In one example, in FIG. 168, the decision maker judge selects the Mental Element node in Window 3.

FIG. 169 illustrates computer system 100 brings into the visual display the downstream nodes relevant to the node Mental Element in Window 4.

By way of further example, FIG. 170 illustrates the user selecting the Window 4 node “Requirement of Intention to Harm” and illustrates how computer system 100 brings the Data Window relevant to that node into the visual display of the computer screen in Column 3.

FIG. 171 illustrates the decision maker selecting the next step in the decision chain in Window 3, “Without Consent”, and the computer system 100 bringing its related sub-node topics into the visual display in Window 4.

FIG. 171 illustrates the decision maker selecting the node “Effect of Consent on Offence” and illustrates how computer system 100 then brings the Data Window relevant to that node topic into the visual display.

FIG. 172 illustrates the decision maker selecting the node “Without Lawful Excuse” from Window 1 of the visual display.

FIG. 173 illustrates the selection of the node “Without Lawful Excuse” causes computer system 100 to perform 2 functions.

1. Computer system 100 causes the Data Window relevant to the node “Without Lawful Excuse” to open in Column 3. This provides the decision maker with a summary of the defences which are available to the offence of Assault Occasioning Actual Bodily Harm.”

2. Computer system 100 causes the defences which are available to the decision maker to open in its related sub-node or downstream window. The defences so displayed are
Self-Defence
Necessity
Automatism

FIG. 174 illustrates the decision maker selecting the defence of self-defence, raised on the facts before the judge in the hearing.

The selection of the node “Self-Defence” causes computer system 100 to open the related Data Window to the node self-defence.

FIG. 175 illustrates that the Data Window informs the judicial decision maker that the defence of Self-Defence is available in relation to a charge of “Assault Occasioning Actual Bodily Harm” and contains a link which takes the decision maker to the defence of Self-Defence within computer system 100.

FIG. 176 illustrates the decision maker selecting the link in the Data Window Self-Defence in the decision chain relevant to Assault Occasioning Actual Bodily Harm.

FIG. 177 illustrates computer system 100 taking the decision maker to the node Criminal Defences in Window 1, and its related sub-node “Self Defence” in Window 2, and opens the steps in the Decision Chain relevant to the defence of Self-Defence in Window 3.

In this way, computer system 100 takes the decision maker immediately to the expert steps required of a judge to determine whether or not the defence of self-defence is available to a defendant who is before the court in respect of a charge of Assault Occasioning Actual Bodily Harm.

FIG. 178 illustrates the steps an expert has prepared to guide a user 101 in respect of how such a user approaches applying the law in respect of the defence of self defence.

FIG. 179 illustrates the decision maker judge selecting the node Statutory Provision from Window 3.

FIG. 180 illustrates computer system 100 bringing into the visual display in Window 4 the related sub-node or downstream node “s. 418 Crimes Act 1900”.

FIG. 181 illustrates the decision maker selecting that node and illustrates computer system 100 bringing that node into the Data Window in Column 3, where it may be copied in whole (or parts selected and copied by the user) onto the Clipboard.

FIG. 182 illustrates the decision maker progressing though the decision steps in Window 1, selecting the next step, the Window 3 node, “When Defence is Available”.

FIG. 183 illustrates the selection of the node “When Defence is Available” opens the Data Window relevant to that node, which provides a summary of the circumstances when the defence is available and also opens the sub-nodes or downstream nodes relevant to each of the defences available which, when in turn selected, will allow the decision maker to explore each of those nodes in increasing level of their detail and complexity in their further related downstream nodes as the particular problem confronting the decision maker judge may require.

By way of further illustration, the decision maker, having been satisfied with the assistance provided by computer system 100 that the defence is available to the defendant, the decision maker returns to the decision steps contained in Window 3 and FIG. 184 illustrates the decision maker selecting the node “Test to be Applied”.

The selection of the node “Test to be Applied” causes the visual display to be updated by:

1.Opening the Data Window in Column 3 relevant to the node “Test to be Applied: and

2. Opening in Window 4 the sub-node or down stream nodes taking the decision maker more deeply into that topic.

FIG. 185 provides a further example of the decision maker selecting the Window 4 node “Step 1—Subjective Assessment”. That causes computer system 100 to update the visual display and open the Data Window relevant to the node “Step 1—Subjective Assessment” to open in Column 3 of the computer screen.

The decision maker judge many copy the entire Data Window to the Clipboard using the Copy to Clipboard button or may open the Data Window and using the select and copy function copy part of the contents of that Data Window to the Clipboard. The Data Window headed “Step 1—Subjective Assessment” may be edited and data relevant to the matter proceeding before the decision maker may be added.

The decision maker may then proceed to the next step within that step in the decision chain, selecting the node “Step 2—Objective Assessment.” FIG. 186 illustrates how the selection of this node causes its related Data Window to open in Column 3. That Data Window may be copied in whole or in part to the Clipboard by the user in the same steps described in respect of FIG. 187. FIG. 188 illustrates the decision maker having copied the Data Window “Step 2—Objective Assessment” onto the Clipboard.

The decision maker may progress though the expert steps contained within computer system 100 in Window 3 of the visual display.

Every time a node is selected the computer screen is updated to display the decision steps relevant to that point in the decision tree. The decision maker may progress through the decision chain to the depth of Window “n” which as previously described in this Application computer system 100 may bring into the visual display of the depth of the decision tree used by user 101 so requires.

The decision maker may then return to the nodes relating to the elements of the offence before the decision maker. FIG. 188 illustrates the decision maker selecting from Window 1 the node “Criminal Offences”. Computer system 100 brings its related topics into Window 2.

FIG. 189 illustrates the decision maker then selecting the node “Assault Occasioning Actual Bodily Harm” which causes computer system 100 to update the computer screen to bring into the visual display the nodes in Window 3, those being the expert steps in the decision chain relevant to that node.

FIG. 191 illustrates the decision maker selecting the node “Trial Direction”. That causes computer system 100 to update the visual display by causing the Data Window related to Trial Direction—AOABH to appear in Column 3.

The Data Window Trial Direction—AOABH may be copied onto the Clipboard using the Add to Clipboard button by the decision maker. It may be opened and edited by the decision maker on the Clipboard.

Computer system 100 in the manner described in this example provides a decision system providing high level support for a judicial decision maker writing a judgment. It provides support for
1. the process the judicial officer needs to follow in the conduct of the hearing
2. expert decision support in respect of legal problems the judge will be required to decide during the course of the hearing; and
3. expert decision support for how the judge will be required to approach the application of the law—in one example provided, in respect of the elements of the offence assault occasioning actual bodily harm, and the potential availability of a defence of self defence thereto.

This decision support system will raise the quality of decision making across the body of professionals, who share common task functions, such as, in one example, judges, who are as a group applying the same law to the cases proceeding before them. Having high quality decision trees available in respect of the many different legal problems they apply on a day to day basis will mean there will be a significant increase in the quality of decision making across this professional field and an increase in the consistency and predictability of the application of the law—both highly desirable attributes in any legal system. Further, the increase in the quality of decision making will reduce the costs associated with variable and wring decision making across the legal system. It will generate a reduction in the number of appeals, and the very high cost to the public purse of providing the court resources to hear and determine such appeals as well as the very substantial costs to litigants associated with correcting judicial error arising from misapplication of the law—that is, poor quality decision making. The system 100 provides a very high level of support for a decision maker in relation to the criteria to be applied to those specific steps necessary to comprehensively work their way through a legal problem.

As illustrated, the responses provided by the decision maker to the criteria, information, directions and questions within Decision Assistance mode will take the Decision Maker through divergent routes through the topics contained within the Data Matrix, depending upon the particular circumstances confronting the decision maker. They are supported throughout the decision process by the high quality expert decision tree contained in Decision Assistance mode. The system 100 responds to the input in respect of the specific item by directing the user 101 to a related downstream node and the computer screen102 is updated in response.

The purpose of Decision Support is to allow a decision maker to be guided through the decision chain relevant to solving their problem by their responses to a serious of questions, information, directions, and criteria designed by the expert or experts who have designed the decision assistance module.

By way if illustration, in relation to a Decision Support topic in the illustrated Data Base, a Sentencing Module may have been prepared by a Supreme Court Judge who has had 30 years experience, and has an established jurisprudential reputation. This way, the historical patterns stored in Decision Assistance mode in the sentencing module between the nodes within the network are made by that Supreme Court Judge. This decision assitance module may of course be collaboratively designed, wither by groups of judges, and academics, and senior practitioners.

There may well be designed a court specific or accredited Decision Support System using computer system 101 on specific topics, and industry standard decision support systems which insurance, due diligence and other prudential requirements require be used or complied with.

Further, the experience, knowledge and expertise of in one example a senior judicial officer (or expert panel) in respect of their approach to sentencing law may be available in Decision Assistance mode to any person, whether Judge, Magistrate, practicing lawyer, student or layperson, who has access to this decision support system. Computer system 100 may be designed with laypersons in mind, and the language and accessibility of the system designed accordingly. By way of one example, computer system 100 could easily be designed to provide laypersons with a resource to assist them if they had to go to court to be sentenced for an offence. At present, clients pay legal practitioners very substantial sums of money—to attend court on their behalf and make submissions in respect of pleas of guilty before sentence. There are in busy courts sometimes 5 minutes available for a plea to be made by a practitioner and there is insufficient time for the practitioner to make a quality plea which puts before the Magistrate all the matters relating to the offender which are legally relevant on the plea, and assuming the practitioner representing the offender has themselves a high sentencing decision chain—that is, is skilled and knowledgeable about this area of the law. Computer system 100 could readily be designed so take a user—a layperson who is to appear before the court for sentence—through the steps the Judge has to consider, and computer system 100 could invite such a user to enter the information the Judge must take into account at the various stages of the sentencing decision chain as illustrated in this Patent Application. The layperson user could print the report and hand that information to the judge at court when their matter proceeds to sentence. Such a report would greatly assist the judge—they would then have before them the information from the offender which addressed all the decision criteria the judge should consider in imposing sentence and these are in effect highly specialised written submissions relevant to sentence that the layperson has been assisted in providing without having to go though a legal practitioner. The very high costs of the provision of legal services is and should be a concern to the community. There are very substantial numbers of persons within the community who cannot afford to pay a solicitor and who may not qualify for legal assistance and they simply have to turn up at court and under the significant time constraints, and the fact that Judges cannot without the risk of compromising their judicial function, give an offender legal advice on how to best present their plea. Computer system 100 may well offer a very significant contribution to giving lay people access to the law and thereby to their rights. It is trite to say that if members of the community cannot afford to access their legal rights they do not in real terms have them—what they have is privileges which money can buy. Further, it may be used in one example as an adjunct to the provision of legal services. For example, the legal aid authorities may direct a user to complete the steps in a computer system 100 on sentencing so that the resultant report could be provided to the legal aid lawyer at court. That would save potentially hours of the lawyers time in taking instructions before court or at court and provide that lawyer with a comprehensive foundation for their submissions. Computer system 100 could also be made available in computer terminals at the Court House to enable users to complete their report for sentence at Court before their matter goes before the Judge.

It is clear that any government process or steps in any complex application could be made available to the community through computer system 100. There would be significant savings in relation to the provision of public servants, who currently staff counters to assist people in making complex applications, and the time public servants currently take in providing such assistance. That expert function would significantly be incorporated into decision system 100. The assertion is not made that computer system 100 would remove the need for some assistance by public servants but the assertion is made that it will significantly support the decision assistance functions those public servants currently provide and will result in significant cost savings to government.

The design of a decision system 100 as a laypersons guide to sentencing illustrates how computer system 100 will operate to democratise knowledge. It may be designed using any complex database of knowledge in the Decision Matrix and may be designed to me as sophisticated in its language and the level of specific instruction contained in Decision Assistance mode as the user base to which it is directed is appropriate.

By way of one example, an instruction and/or user manual may be provided for the operation of a motor vehicle. The Data Matrix would contain the detailed information in respect of the component parts of the vehicle (that large amount of data now provided in small print and detailed manuals) and instruction steps on how to operate the vehicle, or how to identify or diagnose the nature of problems with the operation of the vehicle, contained in Decision Support mode.

The Decision Support mode also has a Search Function in its permanent display. That function allows the user to enter a term or terms and computer system 100 then brings into the visual display a list of all the nodes within Decision Support mode which contain that term or terms. User 101 may then select the desired node and computer system 100 will take the user to that location within Decision Support.

Such a search function permits a user to go to any stage in a decision tree that may be of convenience to them in relation to the specific problem they are required to solve.

FIGS. 193-194 illustrate the operation of the search function in computer system 100.

Computer system 100 also has a navigation function. That operates whether user 101 is using computer system 100 in Data Matrix or Decision Assistance mode. The Navigation system records any steps taken whether in Data Matrix or Decision Assistance mode. The Navigation System, when activated by user 101, allows user 101, by sliding their finger backwards or forwards across the Navigation Bar (or by using any device to control input) to retrace the steps they have previously taken and to re-commence their steps though the decision tree in a different direction from some earlier node.

Computer system 100 makes an electronic record of the steps taken in the decision tree by the user to the point at which the Navigation bar is activated by user 101 and stores that decision chain. A new record commences from the point at which user 101 starts to take a different step through decision system 100. User 101 may retrieve and re-load any prior decision chain into computer system 100 at any time during their use of the decision system and the decision chains will be saved until deleted by user 101.

The Navigation function works in the same way whether the decision maker is in Data Matrix or Decision Assistance mode of computer system 100. When activated the Navigation system allows the user to retrace the steps they have taken though the decision tree and to recommence steps taking a different path from any previous step. Computer system 100 will save an electronic copy of any decision chain if the decision maker alters the steps they have taken and all decision chains will be available to the user until they have been deleted from computer system 100.

The Clipboard Function

The clipboard function is always present whether the computer system is operating in Data Matrix, Decision Assistance or Report (or Judgment) Writing modes.

In Data Matrix, Decision Assistance, or Judgment Writing modes, the Data Windows may be opened by the user and data edited or entered by user 101.

The Data Windows in Clipboard mode will contain the sequentially entered Data Windows entered by user 101 in Data Matrix or Decision Assistance mode.

All Data Windows will have a scroll bar so that the amount of data they contain are not limited to the size of the window in the visual display.

Each Data Window may be opened, resized and edited at any stage of the decision process.

FIG. 195 illustrates a user opening computer system 100 in Report or Judgment mode by the user selecting Report (or Judgment) mode from the permanent display when in Data Matrix or Decision Support mode. User 101 may select the different modes of computer system 100 as may be convenient.

FIG. 196 illustrates computer system 100 in Report or Judgment mode.

Each Data Window may have different content contained within it, including but not limited to graphics, pictures, audio recordings, links to other Data Windows in the instant and other linked computer system 100 decision systems and hyperlinks to resources on the world wide web. The user may chose to open a hyperlink within a window within computer system 100, from which data may be selected, copied and pasted into a Data Window on the clipboard, or the user may elect to use the hyperlink to go to the site or resource on the wide wide web to which the hyperlink relates.

User 101 may re-order the location of the Data Windows on the Clipboard in Report mode. That will facilitate the preparation of the final report (or judgment). See FIG. 197. The Clipboard has the same content as it does when used by user 101 in Data Matrix and Decision Support modes and any changes made by user 101 to the Clipboard in Report or Judgment mode will remain with the Clipboard if user 101 returns to either Data Matrix or Decision Support modes.

The Clipboard has a scroll bar so the number of Data Boxes it contains is not limited by the size of its visual display or screen display.

User 101 may at any stage in the use of computer system 100 activate the “Compile Notes” button in Report (or Judgment) mode. Computer system 100 will automatically copy the contents of the Clipboard into the Report or Judgment Window.

FIG. 201 illustrate user 101 may also open any Data Window on the Clipboard and select and copy the contents (or part thereof) into the report or Judgment using the select, copy and paste function.

User 101 may at any stage during the operation of computer system 100 open the Report or Judgment in Report (or Judgment mode) and edit its content.

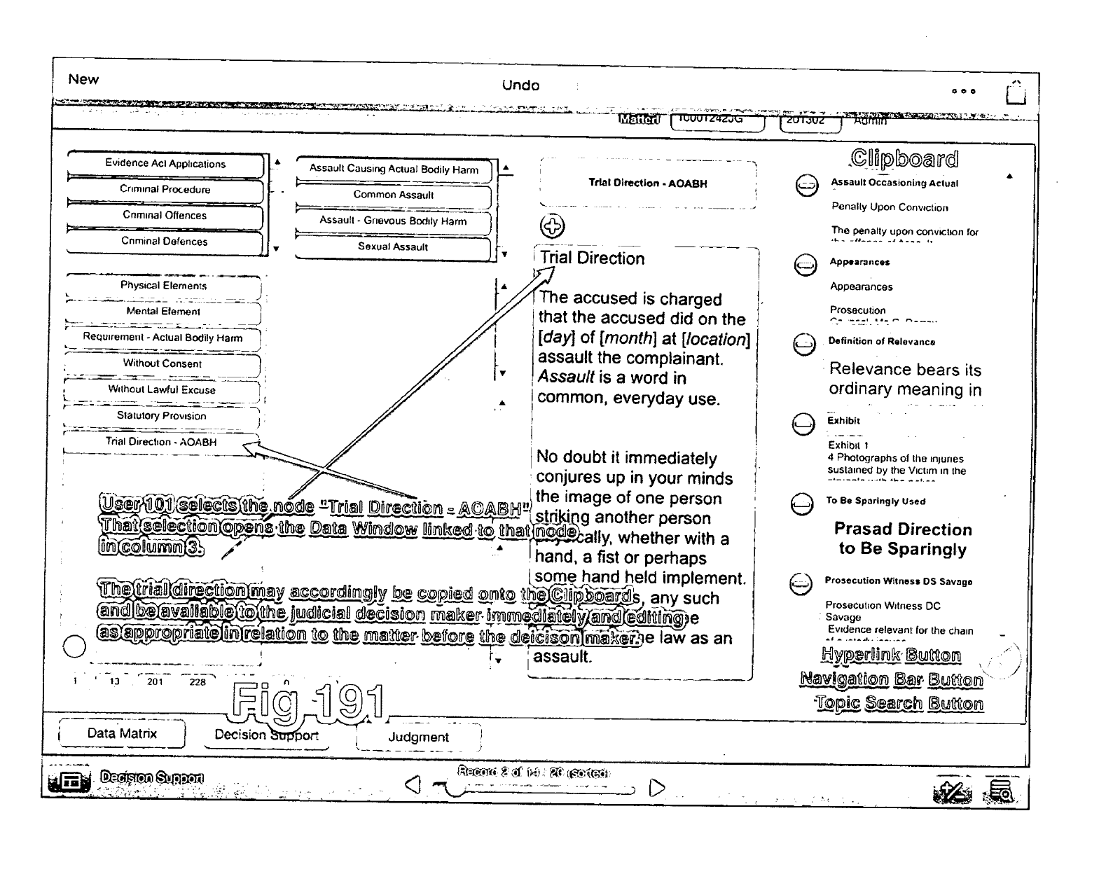

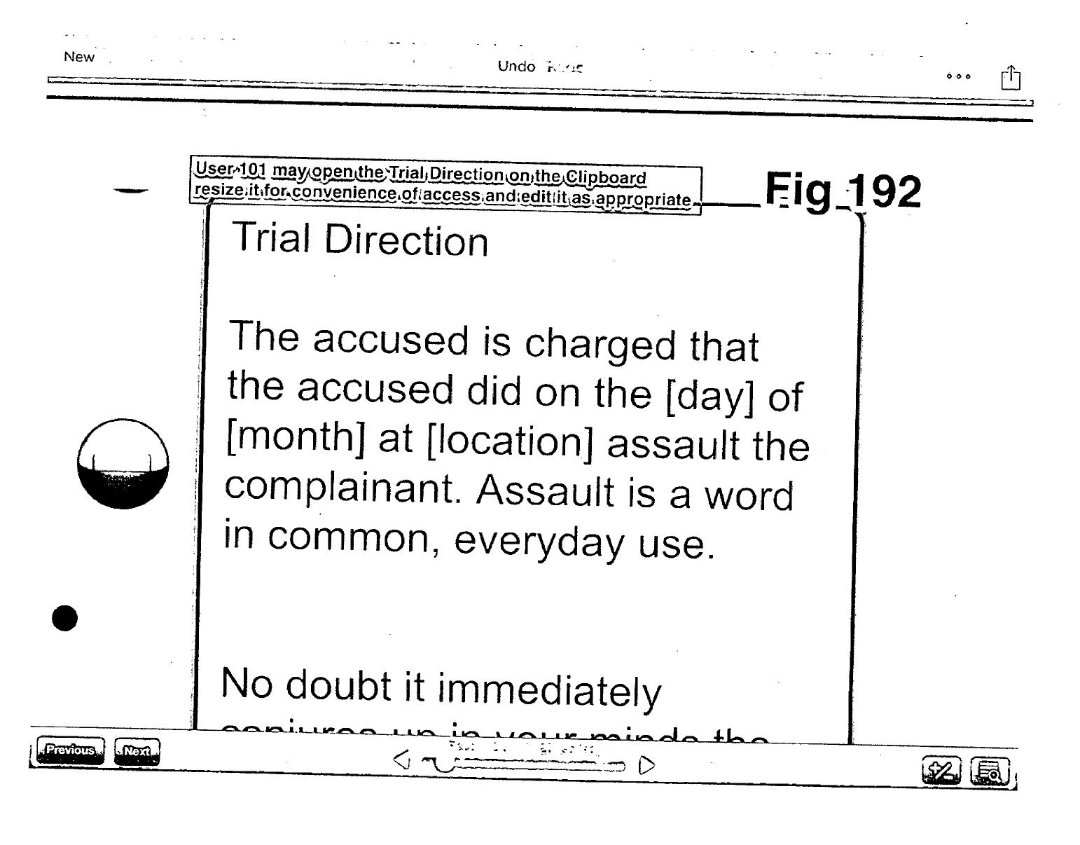

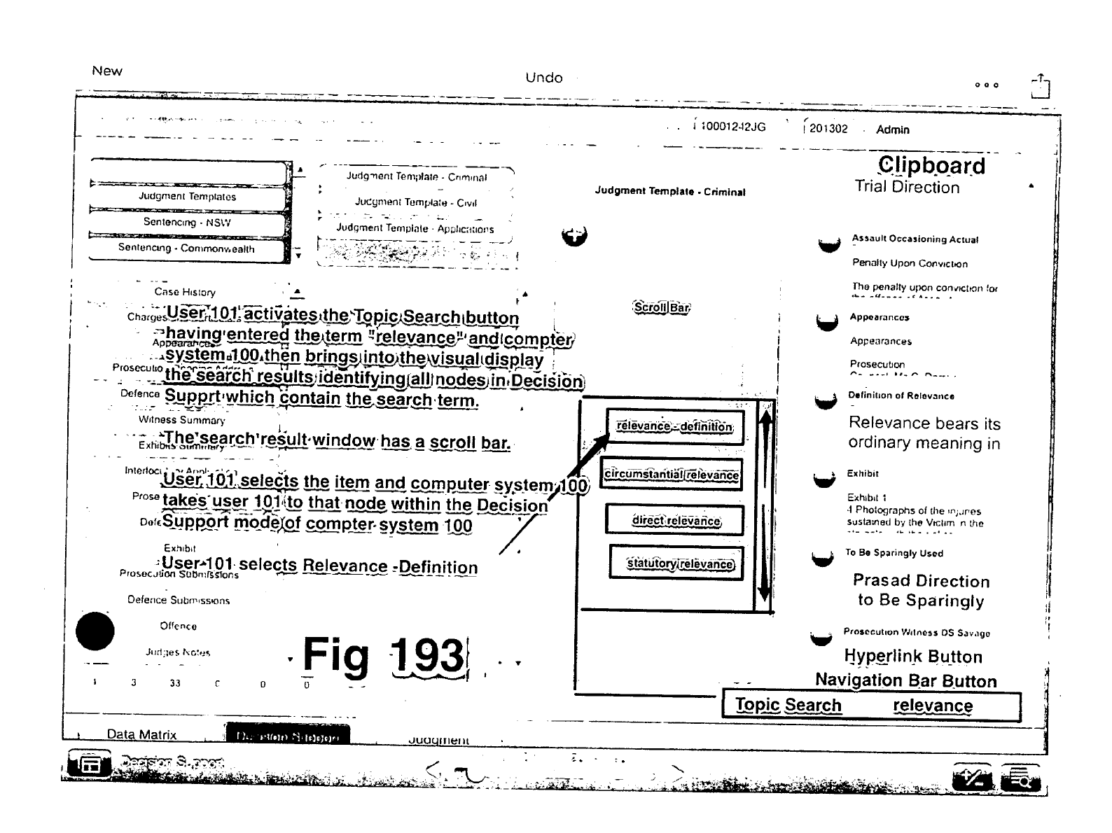

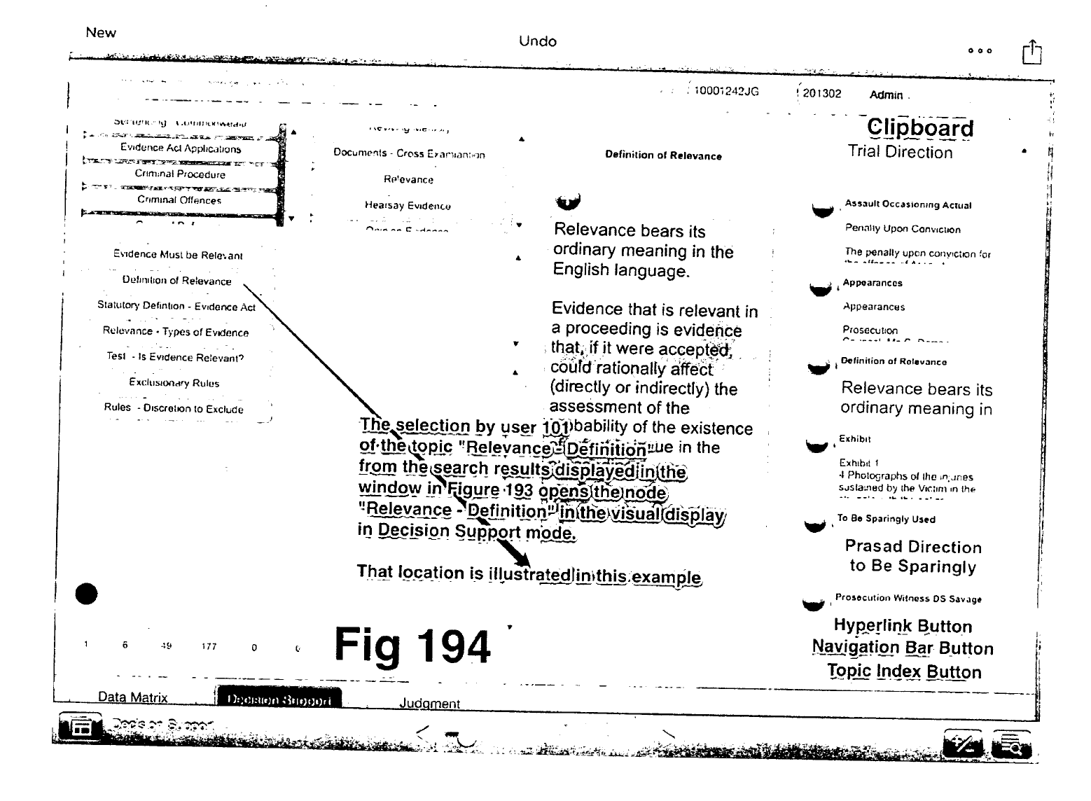

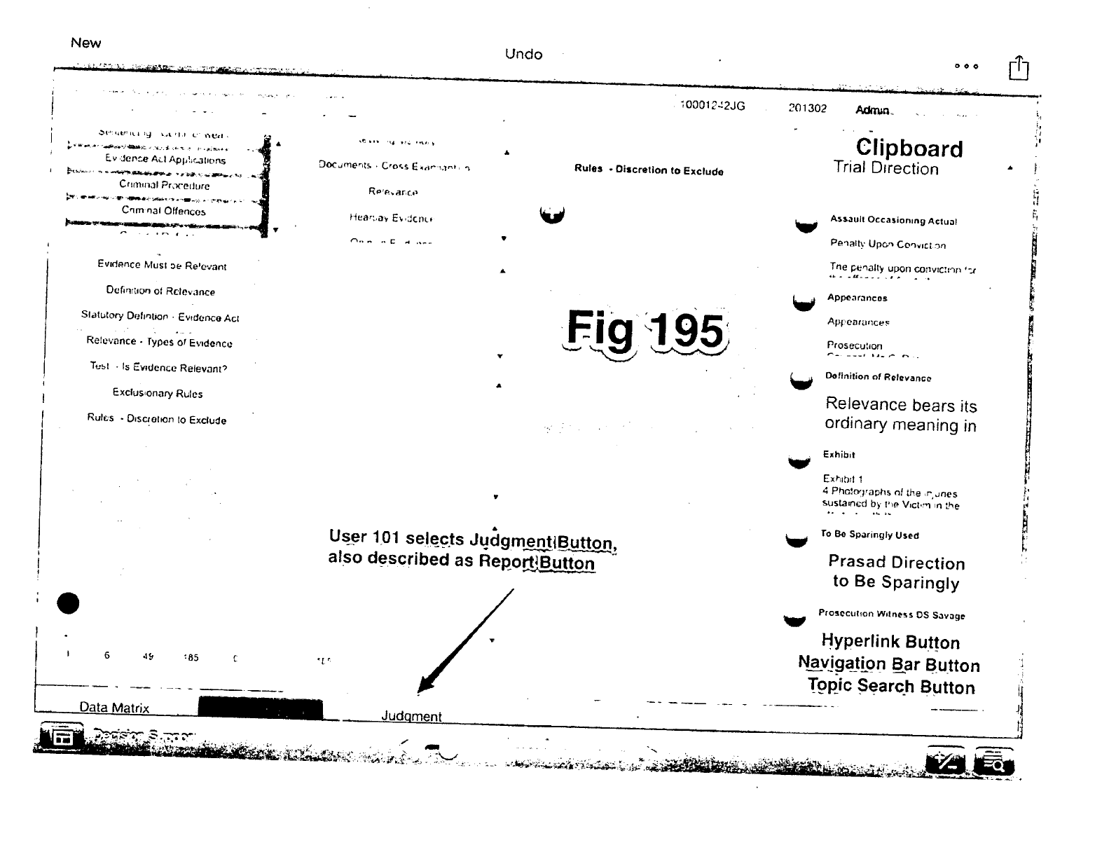

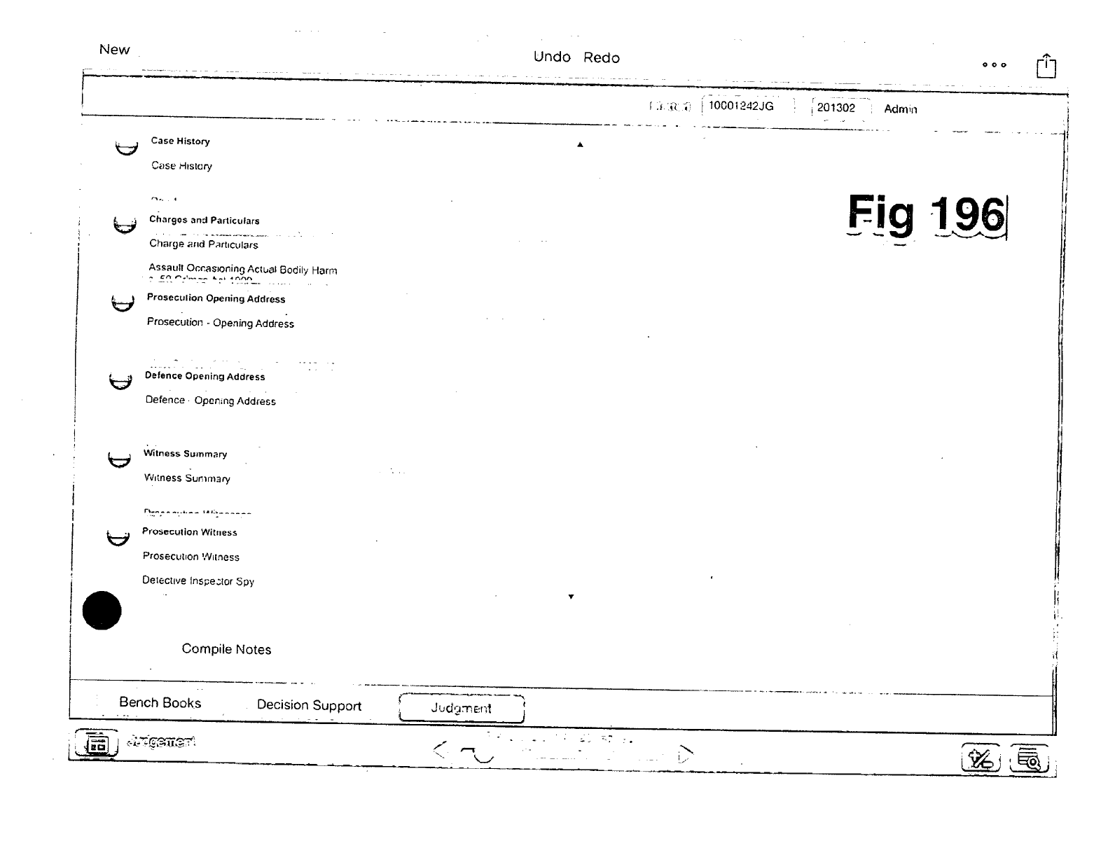

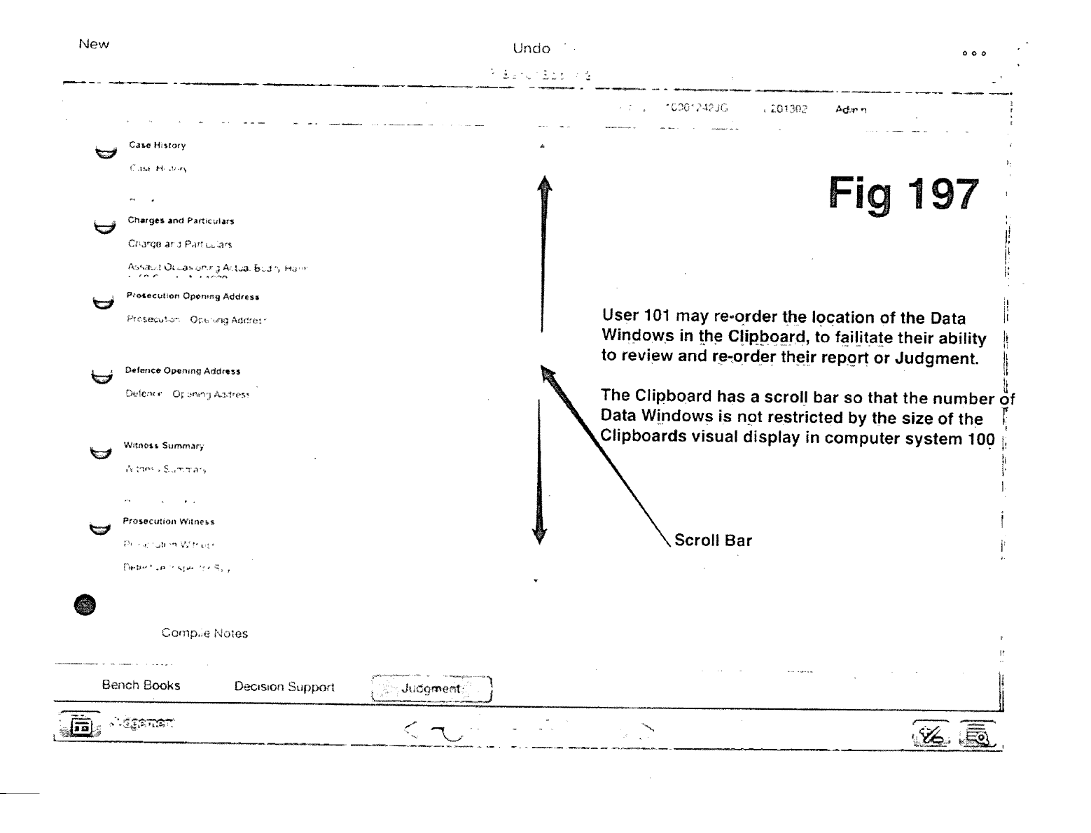

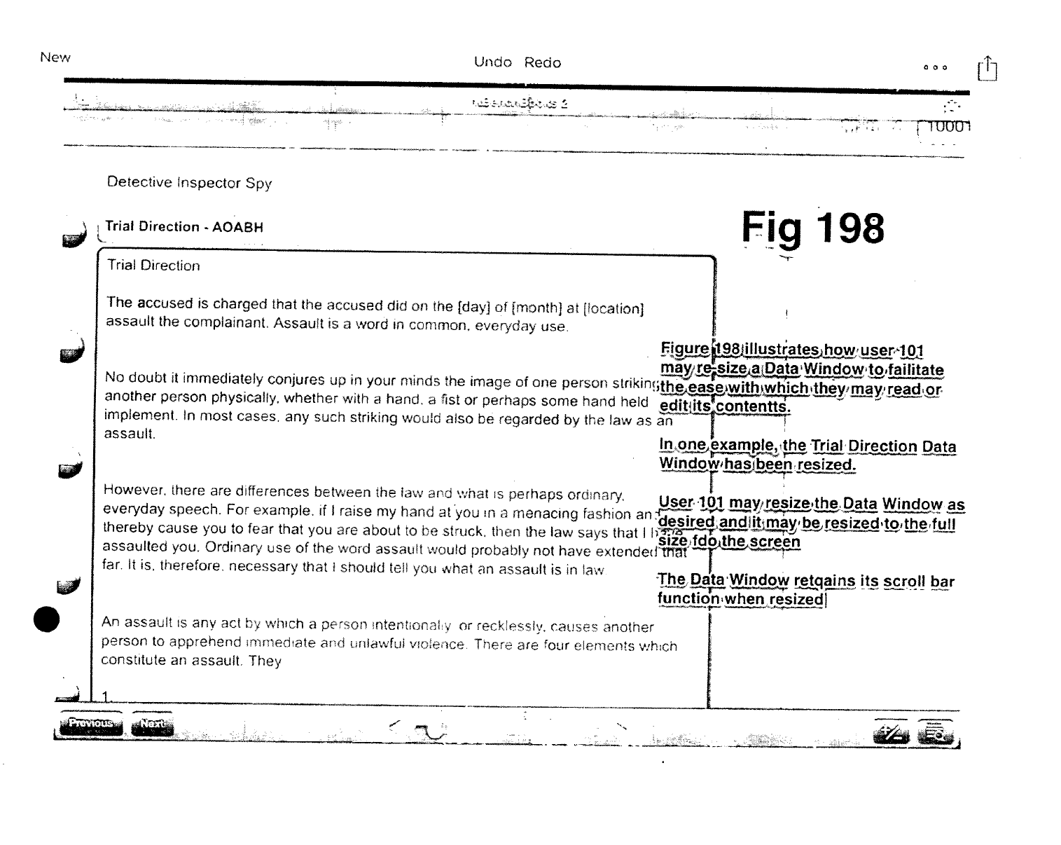

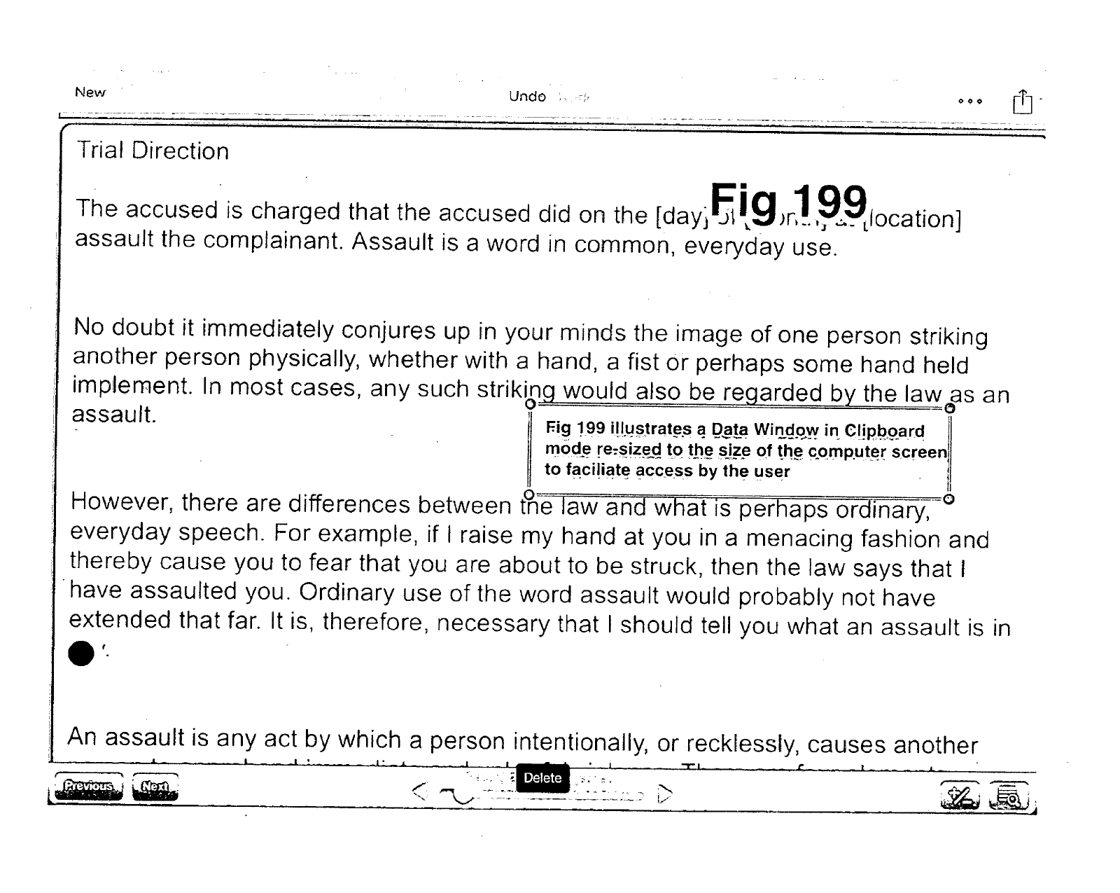

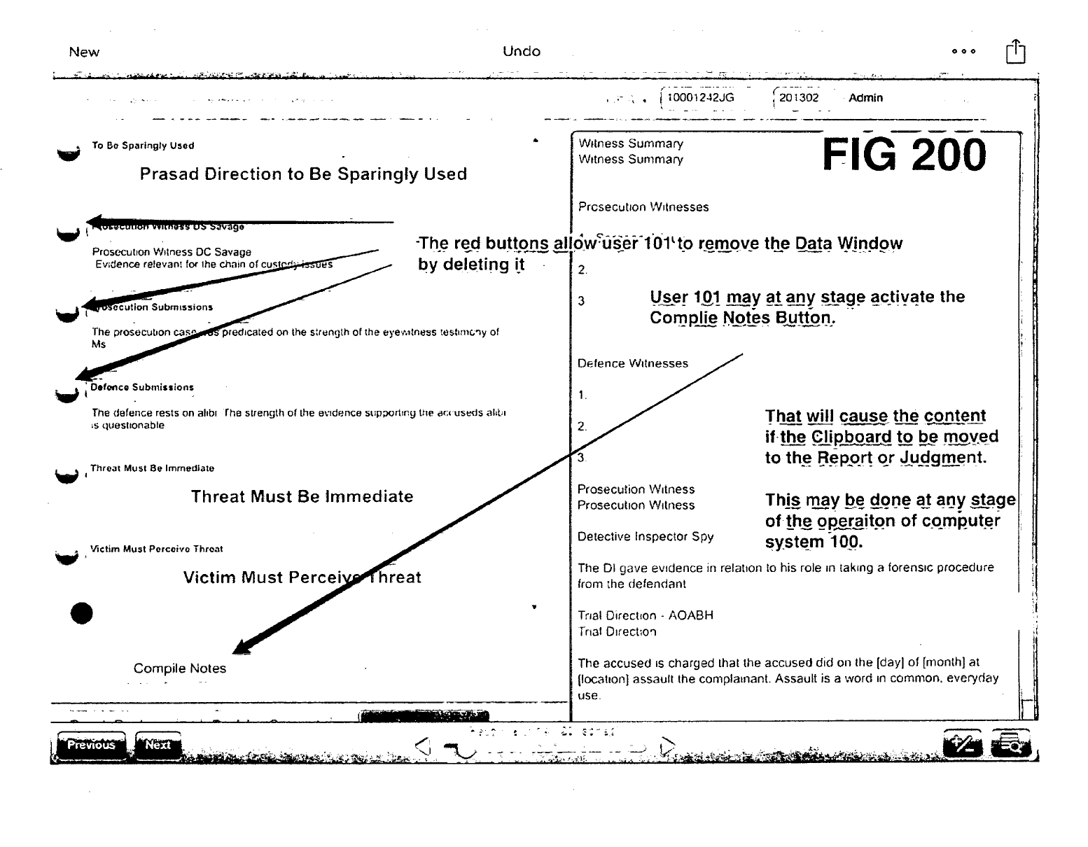

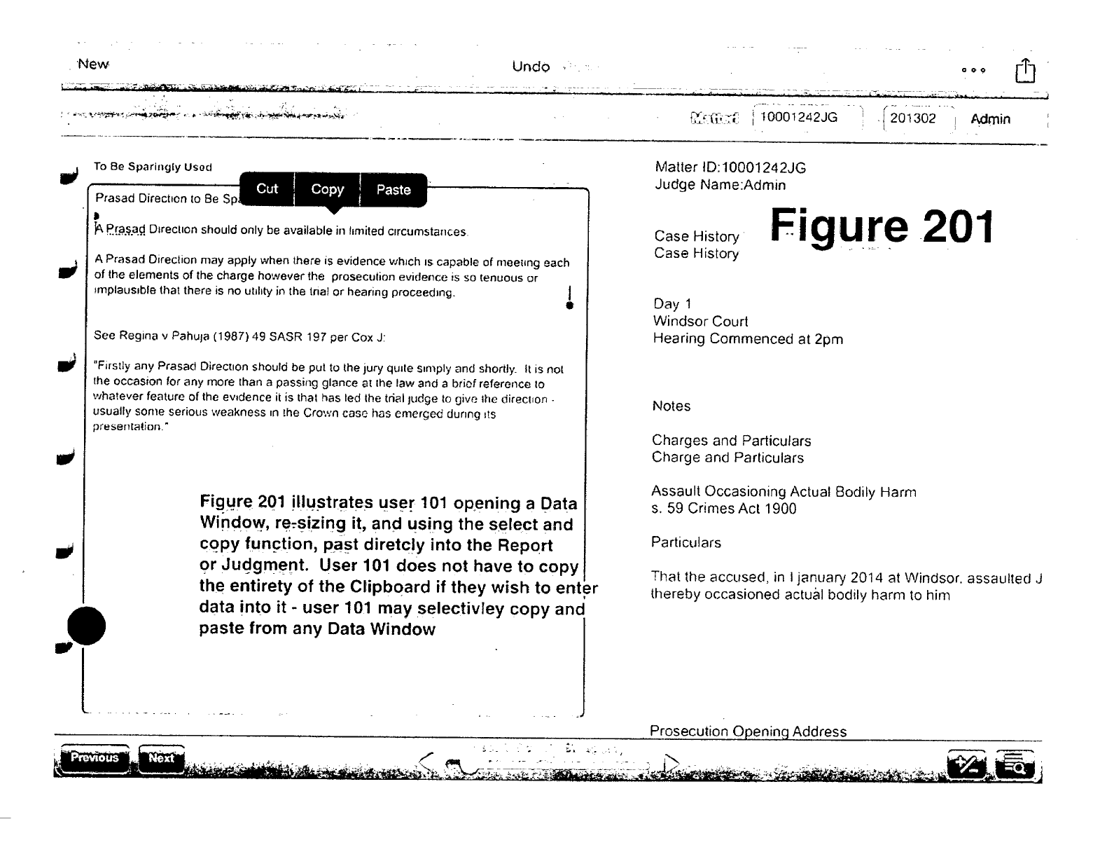

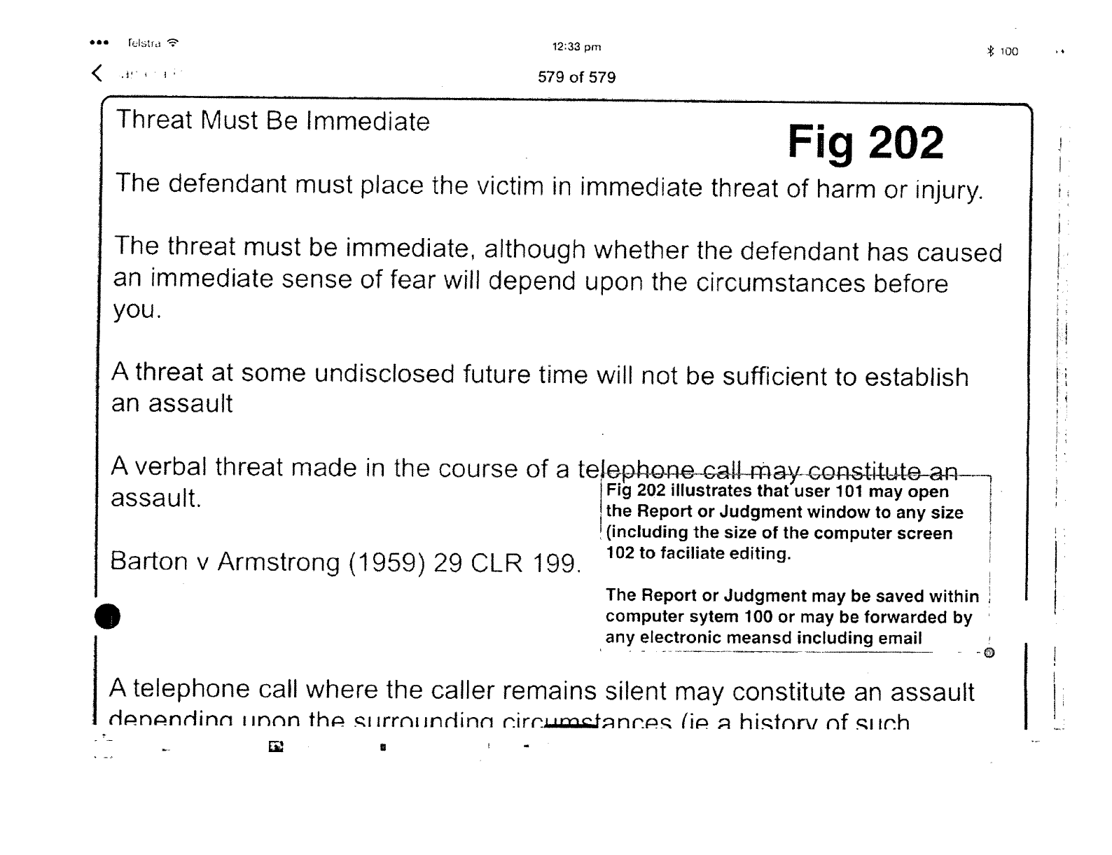

FIG. 202 illustrates user 101 opening and resizing the Report or Judgment Window. The Report or Judgment Window may be resized to the size selected by user 101 and it may be resized to fit the full size of computer screen 102.

The Report (or Judgment) Window has a scroll bar and the content of the window is not restricted by the size of the visual display.

FIG. 201 illustrates user 101 using the scroll bar facility to scroll though the Report (or Judgment).

User 101 may at any time export the content of the judgment or report by email (or any form of electronic transmission).

What is claimed:

1. A control system for control of a multi-stage process, the system comprising:
a computer memory that stores:
a decision tree having a network of plural interconnected nodes, each of which represents a stage of the multi-stage process being controlled;
historical patterns of entries made by users between first and second nodes in the network; and
plural different types of resource information for each stage of the multi stage process;
a computer input device to receive commands from a user:
to select a node in the decision tree; and
to enter data into a selected node;
wherein entering data into a node includes entering it into windows linked to the node;
a computer processor operable to interpret computer program code, resource information and user input; and
a computer screen that, in use, displays a user interface to a user including at least part of the decision tree including the selected node and at least one generation of downstream nodes;
wherein in use:
each node requires an input to satisfy a specified criterion;
in response to input into a selected node that satisfies a specified criterion, one of the downstream nodes is automatically selected and the computer screen is updated; and
input is made by a user either directly into the currently selected node, or automatically into a string of one or more successive nodes as determined by a selected historical pattern of entries.

2. The control system of claim 1, wherein the user interface further includes a persistent menu identifying the plural different types of resource information.

3. The control system of claim 2, wherein the computer processor operates to cause the resource information accessible via the persistent menu to automatically change, in a context aware manner, each time the user selects a different node in the decision tree.

4. The control system of claim 1, wherein the control system includes a navigation tool that allows backtracking to any earlier node of the decision tree.

5. The control system of claim 1, wherein the control system includes a search function in relation to any node in the decision tree

6. The control system of claim 1, wherein the system further includes a data entry port to receive updated resource information.

7. The control system of claim 1, wherein the control system further includes a data entry port to receive data relating to the stages of the process.

8. The control system of claim 1, wherein the computer memory of the control system stores status information about one or more of the stages of the process.

9. The control system of claim 1, wherein the computer memory of the control system stores user input provided at one or more nodes so that the same input is available for consideration or reuse at a later time.

10. A method for controlling a multi-stage process, the method comprising:
receiving or accessing a decision tree having a network of plural interconnected nodes, each of which represents a stage of the multi-stage process being controlled;
receiving historical patterns of entries made by users between first and second nodes in the network;
receiving plural different types of resource information for each stage of the multi-stage process;
receiving commands from a user:
to select a node in the decision tree; and
to enter data into a selected node and/or its related data windows; and
displaying a user interface to a user including:
at least part of the decision tree including the selected node and at least one generation of downstream nodes;
wherein in use:
each node requires an input to satisfy a specified criterion;
in response to input into a selected node that satisfies a specified criterion, one of the downstream nodes is automatically selected and the computer screen is updated; and
input is made by a user either directly into the currently selected node, or automatically into a string of one or more successive nodes as determined by a selected historical pattern of entries.
